(19) United States
(12) Patent Application Publication
(10) Pub. No.: US 2026/0048289 A1
(43) Pub. Date: Feb. 19, 2026

(54) ENVIRONMENTALLY-SAFE WATER-BASED FIRE RETARDANT BIOCHEMICAL COMPOSITIONS FORMULATED USING ALKALI METAL SALTS, FREE FROM PHOSPHATES, NITRATES, AND AMMONIUM-SALTS, FOR NON-CORROSIVE AERIAL AND GROUND DELIVERY ONTO PROPERTY REQUIRING LONG-TERM PROTECTION AGAINST WILDFIRE

(71) Applicant: Mighty Fire Breaker LLC, Lima, OH (US)

(72) Inventor: Stephen Conboy, Carlsbad, CA (US)

(73) Assignee: Mighty Fire Breaker LLC, Lima, OH (US)

(21) Appl. No.: 19/213,947

(22) Filed: May 20, 2025

Related U.S. Application Data
(63) Continuation-in-part of application No. 18/964,428, filed on Nov. 30, 2024.
Application No. 18/964,428 is a continuation-in-part of application No. 18/814,508, filed on Aug. 24, 2024.
Application No. 18/814,508 is a continuation-in-part of application No. 18/669,077, filed on May 20, 2024.
Application No. 18/669,077 is a continuation-in-part of application No. 18/496,862, filed on Oct. 28, 2023.
Application No. 18/496,862 is a continuation of application No. 17/167,084, filed on Feb. 4, 2021, now Pat. No. 11,865,390.

(51) Int. Cl. A62D 1/00; A62C 3/02; A62C 27/00; C09K 21/02

(52) U.S. Cl. CPC A62D 1/0035; A62C 3/02; C09K 21/02; A62C 3/0242; A62C 3/0271; A62C 27/00; A62D 1/005

(57) ABSTRACT

A long-term fire retarding biochemical liquid composition including: a dispersing agent realized in the form of a major amount of water, for dispersing alkali metal ions dissolved in the water; a major amount of a first fire retarding agent realized in the form of a primary alkali metal salt of a nonpolymeric saturated carboxylic acid, for example, tripotassium citrate, for providing metal potassium ions dispersed in the water when the at least one alkali metal salt is dissolved in the water to form a mixed retardant solution; a minor amount of a second fire retarding agent realized in the form of a secondary alkali metal salt of a nonpolymeric saturated carboxylic acid, for example, potassium, sodium, calcium and/or magnesium benzoate, for providing benzoate ions dispersed in the water when the secondary alkali metal salt is dissolved in the mixed retardant solution, for functioning as a secondary fire retardant agent and also inhibiting surface corrosion reactions involving metals contacting the mixed retardant solution, including specific metals, namely aluminum, steel, bright steel, brass, and magnesium; a minor amount of thickening agent in the form of a biomolecular polymer consisting essentially of polysaccharides; a minor amount of a dispersing agent for dispersing benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving the metals; and a minor amount of coloring agent in the form of fugitive color dye powder, or non-fugitive pigment powder, for imparting a visible color characteristics when the fire retarding biochemical liquid composition is being applied to a surface to be protected against fire, to form a thin fire retardant coating deposited on treated surfaces, comprising a mixture of metal alkali salt crystals within the polysaccharides of the biomolecular polymer. Wet and dry concentration formulations of the fire retarding biochemical liquid composition are disclosed for use with both aerial and ground delivery methods and apparatus.

### RELATED CASES

The present Patent Application is a Continuation-in-Part (CIP) of: copending U.S. application Ser. No. 18/964,428 filed Nov. 30, 2024, which is a Continuation-in-Part of copending U.S. patent application Ser. No. 18/814,508 filed Aug. 24, 2024; and copending U.S. patent application Ser. No. 18/669,077 filed May 20, 2024, which is a Continuation-in-Part of co-pending U.S. patent application Ser. No. 18/496,862 filed Oct. 28, 2023, which is a Continuation of U.S. patent application Ser. No. 17/167,084 filed Feb. 4, 2021, now U.S. Pat. No. 11,865,390; wherein each said US Patent Application is commonly owned by Mighty Fire Breaker LLC and incorporated herein by reference as if fully set forth herein.

### BACKGROUND OF INVENTION

### Field of Invention

The present invention is directed towards improvements in long-term fire retarding (i.e. inhibiting) chemical formulations that are environmentally-clean, water-soluble, non-corrosive and sustainable for use in aerial and ground delivery applications, and based on the use of alkali metal salts that protect property against wildfire by reducing the risk of fire ignition and flame spread when applied after dried on treated surfaces.

### Brief Description of the State of Knowledge in the Art

Conventional methods of wildfire fighting defense are proving inadequate for many reasons including the change in demographics where people live and work relative to presence of wildfire. This is having many consequences including:
Making firebreaks with bulldozers and shovels not viable in most urbanized communities;
Making firebreaks by lighting backfires ineffective and often dangerous as wildfires themselves;
Making the air-dropping of water-based fire retarding chemical liquid from high above urban areas often dangerous and not viable during proactive wildfire defense.

Current methods of wildfire defense and fighting are becoming unsustainable because the financial losses due to wildfire are exceeding what the insurance industry is willing to insure, as the damage caused by wildfire to the environment is typically catastrophic and destructive. Notwithstanding, any effort to thin or otherwise remove dead trees and debris from ground surfaces will be helpful in reducing the risk of wildfire ignition risk and flame spread in urban regions, especially near power poles, buildings, and utility structures.

FIG. 1 provides a table summarizing the primary conventional methods currently being used when fighting and defending against wild fires and forest fires, alike: aerial water dropping illustrated in FIG. 2A; aerial fire retardant chemical (e.g. PhosChek (R) MVP-F Fire Retardant) dropping illustrated in FIGS. 2B1, 2B2 and 2B3; physical fire break by bulldozing, to stall the advance of wild fire; physical fire break by pre-burning, to stall the advance of wild fire; and chemical fire breaks by dropping fire retardant chemical such as PhosChek (R) MVP-F chemical over land, to stall the advance of wild fire.

While these methods are used frequently in the USA, the results have not been adequate in most instances where wild fires rage across land under strong prevailing winds. It will be helpful at this juncture to review the nature of conventional fire retardants being in fighting wildland fires by the USDA Fire Service, and others around the world.

### Composition Of Phoschek™ MVP-F Fire Retardant: MAP, DAP, Gum Thickener & Coloring Agent

PhosChek® MVP-F is a dry concentrate formulation that uses a combination of monoammonium phosphate [MAP; NH4H2PO4] and diammonium phosphate [DAP; (NH4)2HPO4] as the fire-retardant salts. PhosChek® MVP-F fire retardant also contains a gum thickener to provide a medium viscosity product for improved drop characteristics. The formulation contains a coloring agent having a fluorescent red color. The color fades over time with exposure to sunlight. A quick look at the chemical composition of the MAP and DAP components of PhosChek® fire retardant will be illuminating.

Monoammonium phosphate (MAP) is soluble in water and crystallizes as the anhydrous salt in the tetragonal system, as elongated prisms, or needles. It is practically insoluble in ethanol. Solid monoammonium phosphate (MAP) can be considered stable in practice for temperatures up to 200° C., when it decomposes into gaseous ammonia NH3 and molten phosphoric acid H3PO4. At 125° C. the partial pressure of ammonia is 0.05 [mm Hg]. A solution of stoichiometric monoammonium phosphate is acidic (pH 4.7 at 0.1% concentration, 4.2 at 5%).

According to the diammonium phosphate MSDS from CF Industries, Inc., decomposition starts as low as 70° C. “Hazardous Decomposition Products: Gradually loses ammonia when exposed to air at room temperature. Decomposes to ammonia and monoammonium phosphate at around 70° C. (158° F.). At 155° C. (311° F.), DAP emits phosphorus oxides, nitrogen oxides and ammonia.”

When air-dropped from planes, the gum thickener contained in PhosChek® MVP-F fire retardant binds MAP and DAP to water to increase the mass and viscosity, to help drop the water-based composition onto a raging wildfire in effort to extinguish it, but less so in applying the fire retardant salt content to combustible surfaces to proactive reduce fire ignition and flame spread. When Phoschek® airdrops are made on targeted property of home owners and towns in effort to protect the targeted property against wildfire, depositing the red-colored Phoschek® MVP-F fire retardant coating all over ground surfaces, the weight of air-dropped fire retarding chemical liquid is often dangerous to people and animals beneath the airplane or helicopter tanker supporting the retardant delivery operations.

Many photographs are posted on the WWW showing the airdropping of Phoschek® MVP-F fire retardant from airplanes and helicopters (i.e. air-tankers). However, these firefighting operations should be viewed as a final effort to save property and lives from a raging wildfire. Also, the most effective use of a long-term fire retardant formulation, such as Phoschek MVP-F, would be to apply the water-based chemical retardant long before the arrival of a wildfire so as to proactively create a chemical firebreak on and/or before property to be protected.

While the physical consequences of dropping Phoschek® MVP-F fire retardant from airplanes can be problematic in highly populated areas in the WUI Region, the US EPA has identified other important environmental issues associated with the dispensing of phosphorus-based and nitrogen-based long-term chemical fire retardants, such as Phoschek® MVP-F fire retardant, during aerial liquid retardant drop operations.

While generally not considered harmful to humans, these phosphorus and nitrogen based wildland fire fighting products can cause unintended harm to ecosystems if these chemical products are not used carefully. Components of these mixtures can be toxic to aquatic life (for example, if they are accidentally dropped into streams or bodies of water). For this reason, the US Forest Service has promulgated a policy of not dropping retardant within 300 or more feet of waterways. In addition, use of these fire retardant mixtures may contribute to reduced plant diversity in areas of re-growth after a fire.

Clearly, phosphorus, like nitrogen, is a critical nutrient required for all life. The most common form of phosphorus used by biological organisms is phosphate (PO4), which plays major roles in the formation of DNA, cellular energy, and cell membranes (and plant cell walls). Phosphorus is also a common ingredient in commercial fertilizers. However, through decades of scientific research, testing and study, phosphorus has come to be known to be a significant contributor to freshwater, coastal, and estuarine algal blooms. Too much phosphorus can stimulate excess growth of algae, which leads to: (i) low dissolved oxygen levels; (ii) potential for harmful algal toxins; (iii) blockage of sunlight needed by organisms and plants in the water, and (iv) degraded habitat conditions for benthic macroinvertebrates and other aquatic life-commonly known as “nutrient pollution.” Sources of excess phosphorus to rivers and streams, lakes, and coastal waters include: fertilizers; runoff from urban areas; leaking septic systems; and discharges from wastewater treatment plants.

In appropriate quantities, phosphorus can be used by vegetation and soil microbes for normal growth. However, in excess quantities, phosphorus can lead to water quality problems such as eutrophication and harmful algal growth. Some aquatic resources, such as wetlands, naturally serve as sinks for phosphorus found in sediments or dissolved in water. However, since phosphorus generally occurs in small quantities in the natural environment, even small increases can negatively affect water quality and biological condition.

To make matters even more complex, in the USA, for any long-term fire retardant product to be qualified for use on federal land during wildland firefighting applications (e.g. to be dropped from airplanes, helicopters, and ground-based vehicles alike), the long-term fire retardant product must be approved by the USDA Fire Service (FS) and listed on the USDA Fire Service's Qualified Product Listing (QPL) that is governed by the USDA FS's “Long-Term Retardant, Wildland Firefighting” Specification 5100-304d dated Jan. 7, 2020 (hereinafter “the USDA FS Specification”).

In general, the USDA FS Long-Term Retardant, Wildland Firefighting Specification 5100-304d covers Products that are intended for use in wildland firefighting. This involves mixing and loading the fire retardant product at mobile or permanent sites (e.g. permanent air tanker bases), and delivering and applying the mixed fire retardant to combustible property from the air and ground. The tests prescribed in the Specification are selected to assess the effectiveness of the products to meet the USDA Fire Service's goals and objectives. The prescribed toxicity and environmental tests are selected to minimize hazards to firefighters, members of the general public, and the environment.

Wildland Fire Chemical Products that have been evaluated in accordance with the Standard Test Procedures and satisfy the USDA Forest Service's Specification 5100-304d to be described in detail below, shall be deemed qualified for use in fighting wildland fires on federal property, and listing on the USDA FS's Qualified Product List (QPL).

### Searching for Better Solutions For Fighting Wildfires Fires By Way of Aerial Delivery

Despite the existence of strict quality standards for Wildland Fire Chemical Products established by the USDS Fire Service, as detailed above, it is clear that the use of phosphorous and nitrogen rich fire retardants to defend combustible property against wildfires, does not represent the very best in technology capable of advancing the art of wildland firefighting and promoting greater firefighter and environmental safety, especially within the rapidly expanding wildfire urban interface (WUI) regions across the USA, and countries around the world. Also, it's clear that long term fire retardants must not contain concentrations of toxic metals (V, Cr, Mn, Cu, As, Cd, Sb, Ba, Tl, and Pb) that excess the drinking water regulatory limits set by the US EPA, and must not be potentially greater than aquatic toxicity thresholds set by the US EPA and other regulatory authorities, when released into the environment.

U.S. Pat. No. 11,607,570 discloses magnesium chloride hydrate based formulations for long-term fire retardants, having corrosion inhibitors to protect metal components during aerial delivery to ground targets.

US Patent Application Publication No. 2020/0254290 discloses liquid concentrate fire retardant composition containing mixtures of ammonium phosphates for use in aerial delivery to ground targets having enhanced strength (i.e., a higher proportion of fire retardant component per unit volume), reduced toxicity, and/or reduced corrosion.

However, Applicant believes the world can and must do significantly better in response to the growing threat of climate-change driven wildfires, and this includes developing better and safer, more environmentally-friendly and more sustainable solutions, for fighting wildfires and forest fires.

A brief overview of the state of the art in the field of fire inhibiting/retarding chemistry will be very helpful at this juncture.

Back in 2012, U.S. Pat. No. 8,273,813 assigned to BASF Aktiengesellscha comprehensive overview of the state of the art at that time, representing worldwide efforts to develop and deliver chemical solutions for preventing and fighting wildfires and forest fires around the world.

As disclosed in BASF's U.S. Pat. No. 8,273,813, firefighters have long utilized solutions of inorganic salts, for example, alkali metal or alkaline earth metal salts of carbonic acid, phosphoric acid, or boric acid. The salts augment the extinguishing action of water and are used as concentrated solutions. As disclosed, these inorganic salts are effective because they release inert gases, for example carbon dioxide from carbonates, or melt and so form an air-impervious layer on combustible materials. In either case, access of air to combustible material is controlled. The disadvantage with this approach is the formation of a coating which is later difficult to remove. They have no cooling effect and are barely able to extinguish burning matter, since the latter, like water as well, runs off very rapidly. Any protective effect is solely due to preceding and repeated spraying of objects. A salt solution does not adhere to smooth or waxy objects, such as leaves, planks, or glass panes, to any significant extent, if at all.

Since the 1970s, the use of salts of organic carboxylic acids, for example oxalic acid, tartaric acid, or citric acid, has been known in the field of firefighting. In contradistinction to inorganic salts mentioned above, the coatings formed from the salts of organic carboxylic acids are easy to remove after the fire has been extinguished. Examples of the use of salts of organic carboxylic acids in firefighting are identified in the following patent documents: DE-C 13 02 520, DE-A 35 25 684, EP-A 059 178, EP-A 426 178, U.S. Pat. Nos. 1,278,718, 4,888,136, 5,945,025, and WO 88/00482. A brief overview of these prior art references will be useful at this juncture.

DE-C 13 02 520 discloses the use of alkali metal salts of oxy carboxylic acids in dry extinguishing powders.

DE-A 35 25 684 describes solutions consisting of citric acid/citrate, potassium hydroxide and water that are useful for firefighting and for impregnating combustible materials. More particularly, the solution is said to be capable of binding acidic gases generated in a fire.

EP-A 059 178 describes the use of concentrated solutions of alkali metal salts of citric acid as extinguishing compositions.

EP-A 426 178 discloses fire-retardant asphalt compositions, the fire-retarding component comprising potassium citrate and a silicone polymer.

U.S. Pat. No. 1,278,718 discloses compositions consisting of concentrated solutions of alkali metal salt of citric acid and alkali metal bicarbonate, as filling for fire extinguishers.

U.S. Pat. No. 4,888,136 describes the use of aluminum salts of citric acid and of lactic acid for fire-retarding impregnations of cellulosic fibers.

U.S. Pat. No. 5,945,025 describes compositions of potassium citrate and sodium bicarbonate for firefighting.

WO 88/00482 to discloses compositions of matter for firefighting and for producing fire-retarding coatings based on alkali metal salts of citric acid.

The compositions mentioned above can be applied as aqueous solutions and retain their fire-retarding effect even after drying, and therefore, have a pronounced long-term effect in retarding fire ignition and flame spread.

The use of hydrogels was proposed more than 35 years, for example in U.S. Pat. Nos. 3,229,769 and 5,849,210, for the purpose of cooling the source of the fire by retaining water close to the flame. As illustrated in FIG. 3A, these hydrogels are produced from a water-absorbing polymer and water. The hydrogel binds the water and so stops the water from flowing away from the source of the fire. Because hydrogels can maintain a large amount of water near the fire, hydrogels have a good immediate extinguishing effect. In contrast, the long-term effect of hydrogels is poor. Hydrogels can dry and thereby rapidly lose their effect. The remaining salt-like dried hydrogels have a very low fire-retarding effect.

U.S. Pat. No. 8,273,813 (assigned to BASF) proposed combining water-absorbing polymers with fire-retarding salts to form fire-retarding compositions having a good immediate extinguishing effect and a good long-term effect. This prior art fire retarding chemical solution is schematically depicted in FIG. 3A.

As illustrated in FIG. 3B, Hartindo's aqueous-based anti-fire (AF) chemical solution AF31 employs as its active ingredient, tripotassium citrate, or TPC, dissolved in water, with minor amounts of a natural gum added to provide some cling. Hartidino's AF31 chemical solution has been used by others in many diverse applications, namely: (i) preventing and suppressing peat fires in Malaysia, as disclosed on Hartindo's WWW site, (ii) treating wood to provide Class-A fire-protection as taught in U.S. Pat. No. 10,260,232 (Conboy); and (iii) proactively treating native fuel, ground cover and fixtures and buildings on real property, for the purpose of defending life and property against the threat of wildfires as taught in U.S. Pat. No. 10,653,904.

More recently, US Patent Application Publication Nos. US20220008773A1 and US20220054876A1 by Conboy (assigned to Mighty Fire Breaker LLC) disclose a family of new and improved potassium-based fire inhibiting biochemical formations, adapted for long-term aerial and ground applications, comprising, in preferred embodiments, tripotassium citrate dissolved in water with a citric-acid based dispersing and coalescing agent, namely triethyl citrate, that promotes the formation of thin potassium salt crystalline coatings on combustible surfaces as water molecules evaporate to the environment, thereby providing durable long-term inhibition/resistance to fire ignition, flame spread, and smoke production.

Subsequently, U.S. Pat. Nos. 11,975,231, 12,109,446 granted to Hulbert et al (and assigned to FRS Group, LLC) proposed long-term fire retardant formulations, based on various kinds of potassium salt (including tripotassium citrate and potassium bicarbonate), in effort to satisfy the technical requirements set forth in the USDA Forest Service Specification 5100-304d (Jan. 7, 2020) titled “Specification for Long Term Retardant, Wildland Fire, Aircraft or Ground Application”, hereby incorporated by reference. While these prior art aerial and ground long-term fire retardant formulations avoid the use of phosphates, nitrates, and ammonium salts, they specify corrosion inhibitors and coloring agents that may not be environmental-friendly in many environments, while meeting the requirements of the USDA Forest Service Specification 5100-304d (Jan. 7, 2020).

Clearly, in these times of great climate change and narrowing gaps between wildfire regions and urbanized areas, we must adapt to and defend against wildfires in new, better and smarter ways, especially when using aircraft and ground vehicles, containing metal alloy components used to mix, pump, store and apply mixed long-term fire retardant chemical products by aerial delivery on property and ground applications at risk of fire ignition and flame spread in the presence of wildland wildfire.

Thus, there is a great need for better, safer, and more effective fire retardant (i.e. inhibiting) chemical compositions that can be applied to proactively defend property and life from wildfires in the rapidly expanding WUI region, and to do so, (i) without producing smoke and creating risk of injury to firefighters, property owners, animals and the human population at large, (ii) without corroding metal alloy and plastic components used in aerial delivery and ground applications, and (iii) without polluting the air and water of our natural environment, while offering a 100% biodegradable and truly sustainable solution that overcomes the shortcomings and drawbacks of prior art compositions, apparatus, and methodologies.

### Objects and Summary of the Present Invention

Accordingly, a primary object of the present is to provide new and improved environmentally-safe water-based fire retardant biochemical compositions formulated using non-corrosive alkali metal salts for mixing with water, free from phosphates, nitrates, nitrogenous compounds, and ammonium-salts, and designed for delivery onto combustible ground surfaces requiring long-term protection against fire ignition and flame spread caused by wildfire, while offering a 100% biodegradable and truly sustainable solution that overcomes the shortcomings and drawbacks of prior art compositions and methods.

Another object of the present invention is to provide new and improved fire retarding biochemical liquid comprising: a dispersing agent realized in the form of a major amount of water, for dispersing alkali metal ions dissolved in the water; a major amount of a first fire retarding agent realized in the form of a first alkali metal salt of a nonpolymeric saturated carboxylic acid, specifically, tripotassium citrate, for providing potassium ions dispersed in the water when the at least one alkali metal salt is dissolved in the water to form a mixed retardant solution; a minor amount of a second fire retarding agent realized in the form of a second alkali metal salt of a nonpolymeric saturated carboxylic acid, specifically, sodium benzoate, potassium benzoate, calcium benzoate or magnesium benzoate, for providing benzoate ions dispersed in the water when the at least one alkali metal salt is dissolved in the mixed retardant solution, for inhibiting surface corrosion reactions involving metals contacting the mixed retardant solution, including specific metals, namely 2024-T3 Aluminum, 4130 Steel, Yellow Brass, and Az31B Magnesium, while functioning as a secondary fire retardant agent; a minor amount of thickening agent in the form of a biomolecular polymer consisting essentially of polysaccharide chains, for increasing the viscosity of the mixed retardant liquid during application operations, when the fire retarding biochemical liquid composition is applied to a surface to be protected against fire; and a minor amount of a dispersing agent (e.g. triethyl citrate) for dispersing benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals; wherein while water molecules in the retardant liquid evaporate during drying, to a thin fire retardant coating is formed not having a characteristic color (e.g. red or green) comprising potassium (and sodium) salt crystals mixed within polysaccharide chains of biomolecular polymer material, to provide long duration fire protection on the treated surfaces.

Another object of the present invention is to provide such a new and improved fire retarding biochemical liquid, wherein the thickening agent comprises Xanthan gum which is an extracellular polysaccharide produced by the bacterium Xanthomonas, and wherein the primary structure of xanthan gum is a biomolecular polymer that consists of a cellulose backbone of β-glucose-linked β-units substituted on glucose residues replaced by a side-chain trisaccharide.

Another object of the present invention is to provide a new and improved a fire retarding biochemical liquid comprising: a fire inhibiting agent realized in the form of major amount of a first alkali metal salt of a nonpolymeric saturated carboxylic acid, specifically, tripotassium citrate (TPC), for providing metal potassium ions to be dissolved and dispersed in a quantity of water; a minor amount of a second fire retarding agent realized in the form of a second alkali metal salt of a nonpolymeric saturated carboxylic acid, specifically, sodium benzoate, potassium benzoate, calcium benzoate or magnesium benzoate, for providing benzoate ions dispersed in the water when the at least one alkali metal salt is dissolved in the mixed retardant solution, for inhibiting surface corrosion reactions involving metals contacting the mixed retardant solution, including specific metals, namely 2024-T3 Aluminum, 4130 Steel, Bright Steel, Yellow Brass, and Az31B Magnesium, while functioning as a secondary fire retarding agent along with the potassium ions; a minor amount of thickening agent such as biomolecular polymer consisting essentially of polysaccharide chains, for increasing the viscosity of the mixed retardant liquid during application operations; a minor amount of a dispersing agent (e.g. triethyl citrate) for dispersing benzoate ions present in the water when sodium benzoate is dissolved in the mixed retardant solution, so as to promote the formation of a corrosion inhibiting coating on metals contacting the mixed retardant solution and inhibiting surface corrosion reactions involving said metals; a minor amount of coloring agent in the form of fugitive red dye pigment powder, for imparting a visible color (e.g. red or green) of fugitive type, when the fire retarding biochemical liquid composition is applied to a surface to be protected against fire; wherein the dry powder components described above are mixed together and dissolved in a major amount of water to produce a mixed retardant solution in either read-to-use non-diluted form, or wet concentrate form for mixing with a specified amount of water, to produce a mixed fire retardant product adapted for application to combustible surfaces by aerial or ground delivery application, while water molecules in the retardant liquid evaporate during drying, to form a thin fire retardant coating having a characteristic red color and comprising potassium and sodium salt crystals mixed within the polysaccharide chains of biomolecular polymer material, to provide long duration fire protection over the treated combustible surfaces.

Another object of the present invention is to provide a new and improved mixed fire retarding biochemical liquid composition for use in forming thin fire retarding metal alkali salt crystal and polysaccharide coatings on ground surface targets, the mixed fire retarding biochemical liquid composition comprising: a dispersing agent in the form of water for providing an aqueous solution; a fire inhibiting agent in the form of at least one first alkali metal salt dissolved in the water, functioning as a fire inhibiting agent, and derived from a first non-polymerized saturated carboxylic acid characterized by having carbon chain length of less than eight carbon atoms (C1-C7), wherein the alkali metal contained in the alkali metal salt is selected from the group consisting of potassium, calcium, sodium and/or magnesium; a corrosion inhibiting agent in the form of an alkali metal such as sodium, potassium, calcium, or magnesium salt derived from a second non-polymerized saturated carboxylic acid, namely benzoic acid, and dissolved in the water to produce benzoate ions in the aqueous solution that promote the formation of a corrosion inhibiting coating on metal surfaces contacting the mixed retardant solution and inhibiting surface corrosion reactions involving the metal surfaces; a thickening agent in the form of a biomolecular polymer consisting essentially of polysaccharides dissolved in the aqueous solution, to form a wet concentrate liquid that can be used as is in ready-to-use form or diluted with additional water according to a wet concentrate mix ratio; a dispersing agent derived from the saturated non-polymerized carboxylic acid and/or another saturated non-polymerized carboxylic acid, for dispersing benzoate ions present in the mixed retardant solution, so as to promote the formation of the corrosion inhibiting coating on metal surfaces contacting the mixed retardant solution and inhibiting surface corrosion reactions involving the metal surfaces; and wherein the mixed fire retarding liquid can be delivered to ground surface targets to form thin fire retarding coatings comprising alkali metal potassium salt crystals mixed with polysaccharide chains of the biomolecular polymer, to provide proactive wildfire protection to treated ground surfaces; wherein the water is present in a major amount having a weight percent from about 70.00% to about 95.00% relative to the total weight of the mixed fire retarding biochemical liquid composition; wherein the fire inhibiting agent is present in a major amount having a weight percent from about 5.00% to about 30.00% relative to the total weight of the mixed fire retarding biochemical liquid composition; wherein the corrosion inhibiting agent is present in a minor amount having a weight percent from about 0.05% to about 10.00% relative to the total weight of the mixed fire retarding biochemical liquid composition; wherein the dispersing agent is present in a minor amount having a weight percent from about 0.05% to about 5.00% relative to the total weight of the mixed fire retarding biochemical liquid composition; wherein the thickening agent in the form of a biopolymer consisting of polysaccharides is present in a minor amount having a weight percent from about 0.01% from about 5.00% relative to the total weight of the mixed fire retarding biochemical liquid composition; and wherein the sum of the weight percent % of the chemical components in the mixed fire retarding biochemical liquid composition does not exceed 100% by weight.

Another object of the present invention is to provide such a mixed fire retarding biochemical liquid composition, wherein the thickening agent is biomolecular polymer selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan.

Another object of the present invention is to provide such a mixed fire retarding biochemical liquid composition, which further comprises a minor amount of coloring agent dissolved in the water for imparting a visible color of the fugitive or non-fugitive type when the fire retarding biochemical liquid is applied to a surface to be protected against fire, while water molecules in the retardant liquid evaporate during drying, to form the thin fire retardant coating having a characteristic visible color and comprising alkali metal potassium and sodium salt crystals mixed with the polysaccharide chains of the biomolecular polymer material; wherein the coloring agent is present in a minor amount having a weight percent from about 0.01% to about 2.00% relative to the total weight of the liquid fire inhibiting composition.

Another object of the present invention is to provide such a mixed fire retarding biochemical liquid composition, wherein the specific metals are selected from the group consisting of Aluminum, Steel, Bright Steel, Yellow Brass, and Magnesium.

Another object of the present invention is to provide such a mixed fire retarding biochemical liquid composition, wherein the mixed fire retarding biochemical liquid has a viscosity suitable for use in aerial delivery of the mixed fire retarding liquid from an airtanker flying at a speed and altitude relative to ground surface targets to form the thin fire retarding coatings comprising alkali metal potassium and sodium salt crystals mixed with polysaccharide chains of the biomolecular polymer, to provide proactive wildfire protection to the treated ground surfaces.

Another object of the present invention is to provide such a mixed fire retarding biochemical liquid composition, wherein the mixed fire retarding biochemical liquid has a viscosity suitable for use in ground-based delivery of the mixed fire retarding liquid from a ground-based tanker moving at a speed relative to ground surface targets to form the thin fire retarding coatings comprising alkali metal potassium and sodium salt crystals mixed with polysaccharide chains of the biomolecular polymer, to provide proactive wildfire protection to the treated ground surfaces.

Another object of the present invention is to provide such a mixed fire retarding biochemical liquid composition, wherein the at least one first alkali metal salt is derived from the non-polymeric saturated carboxylic acid (R—COOH) selected from the group consisting of formic acid (i.e. methanoic acid); carbonic acid (i.e. hydroxymethanoic acid): acetic acid (ethanoic acid); glycolic acid (hydroxyacetic acid); glyoxylic acid; propionic acid; lactic acid; glyceric acid; tartaric acid: malic acid; malonic acid; caproic acid; adipic (hexanedioic) acid; citric acid; and benzoic acid.

Another object of the present invention is to provide such a mixed fire retarding biochemical liquid composition, wherein the at least one first alkali metal salt is derived from the C1 carboxylic acid (R—COOH), called formic acid (i.e. methanoic acid), and selected from the group consisting of: potassium formate; calcium formate; sodium formate; and magnesium formate.

Another object of the present invention is to provide such a mixed fire retarding biochemical liquid composition, wherein the at least one first alkali metal salt is derived from the C1 carboxylic acid (R—COOH), carbonic acid (i.e. hydroxymethanoic acid), and selected from the group consisting of: potassium carbonate; sodium bicarbonate; and magnesium carbonate.

Another object of the present invention is to provide such a mixed fire retarding biochemical liquid composition, wherein the at least one first alkali metal salt is derived from the C2 carboxylic acid (R—COOH), called acetic acid (ethanoic acid), and selected from the group consisting of: potassium acetate; calcium acetate; sodium acetate; and magnesium acetate. Another object of the present invention is to provide such a mixed fire retarding biochemical liquid composition of claim 1, wherein the at least one first alkali metal salt is derived from the C2 carboxylic acid (R—COOH), called glycolic acid (hydroxyacetic acid), and are selected from the group consisting of: potassium glycolate; calcium glycolate; and sodium glycolate.

Another object of the present invention is to provide such a mixed fire retarding biochemical liquid composition, wherein the at least one first alkali metal salt is derived from the C2 carboxylic acid (R—COOH), called glyoxylic acid C₂H₂O₃, and are selected from the group consisting of: potassium glyoxylate; calcium glyoxylate; and sodium glyoxylate (monohydrate).

Another object of the present invention is to provide such a mixed fire retarding biochemical liquid composition, wherein the at least one first alkali metal salt is derived from the C2 carboxylic acid (R—COOH), called oxalic acid, and are selected from the group consisting of: potassium oxalate; calcium oxalate; and sodium oxalate.

Another object of the present invention is to provide such a mixed fire retarding biochemical liquid composition, wherein the at least one first alkali metal salt is derived from the C3 carboxylic acid (R—COOH), called propionic acid, and are selected from the group consisting of: potassium propionate; calcium propionate; sodium propionate; and magnesium propionate.

Another object of the present invention is to provide such a mixed fire retarding biochemical liquid composition, wherein the at least one first alkali metal salt is derived from the C3 carboxylic acid (R—COOH), called lactic acid, specifically, and are selected from the group consisting of: potassium lactate; calcium lactate; sodium lactate; and magnesium lactate.

Another object of the present invention is to provide such a mixed fire retarding biochemical liquid composition, wherein the at least one first alkali metal salt is derived from the C3 carboxylic acid (R—COOH), called glyceric acid, and are selected from the group consisting of: potassium glycerate; calcium glycerate; and sodium glycerate.

Another object of the present invention is to provide such a mixed fire retarding biochemical liquid composition, wherein the at least one first alkali metal salt is derived from the C3 carboxylic acid (R—COOH), called pyruvic acid, and are selected from the group consisting of: potassium pyruvate; calcium pyruvate; sodium pyruvate; and magnesium pyruvate.

Another object of the present invention is to provide such a mixed fire retarding biochemical liquid composition, wherein the at least one first alkali metal salt is derived from alkali metal salts produced from the C3 carboxylic acid (R—COOH), called tartaric acid C3H45, and are selected from the group consisting of: potassium tartrate (potassium bitartrate): calcium tartrate: sodium tartrate; and magnesium tartrate.

Another object of the present invention is to provide such a mixed fire retarding biochemical liquid composition, wherein the at least one first alkali metal salt is derived from the C4 carboxylic acid (R—COOH), called butyric acid CH3(CH2)2COOH, and are selected from the group consisting of: potassium butyrate (or butanoate); calcium butyrate; sodium butyrate; and magnesium butyrate.

Another object of the present invention is to provide such a mixed fire retarding biochemical liquid composition, wherein the at least one first alkali metal salt is derived from the C4 carboxylic acid (R—COOH), called malic acid, and are selected from the group consisting of: potassium malate; calcium malate; sodium malate; and magnesium malate.

Another object of the present invention is to provide such a mixed fire retarding biochemical liquid composition, wherein the at least one first alkali metal salt is derived from the C4 carboxylic acid (R—COOH), called malonic acid, and are selected from the group consisting of: potassium malonate; calcium malonate; sodium malonate; and di-magnesium malonate.

Another object of the present invention is to provide such a mixed fire retarding biochemical liquid composition, wherein the at least one first alkali metal salt is derived from the C5 carboxylic acid (R—COOH), called pivalic acid, and are selected from the group consisting of: potassium pivalate; calcium pivalate; sodium pivalate; and magnesium pivalate.

Another object of the present invention is to provide such a mixed fire retarding biochemical liquid composition, wherein the at least one first alkali metal salt is derived from the C6 carboxylic acid (R—COOH), called caproic acid, and are selected from the group consisting of: potassium caproate (hexanoate); calcium caproate; sodium caproate; and magnesium caproate.

Another object of the present invention is to provide such a mixed fire retarding biochemical liquid composition, wherein the at least one first alkali metal salt is derived from the C6 carboxylic acid (R—COOH), called adipic (hexanedioic) acid, and are selected from the group consisting of: potassium adipate; calcium adipate; sodium adipate; and magnesium adipate.

Another object of the present invention is to provide such a mixed fire retarding biochemical liquid composition, wherein the at least one first alkali metal salt is derived from the C6 carboxylic acid (R—COOH), called citric acid, and are selected from the group consisting of: (tri) potassium citrate; calcium citrate; sodium citrate; and magnesium citrate.

Another object of the present invention is to provide such a mixed fire retarding biochemical liquid composition, wherein the at least one alkali first metal salt is derived from the C6 carboxylic acid (R—COOH), called d-gluconic acid, and are selected from the group consisting of: potassium gluconate; calcium gluconate; sodium gluconate; and magnesium gluconate.

Another object of the present invention is to provide such a mixed fire retarding biochemical liquid composition, wherein the at least one second alkali metal salt is derived from the C7 carboxylic acid (R—COOH), benzoic acid, and are selected from the group consisting of: potassium benzoate; calcium benzoate; sodium benzoate; and magnesium benzoate.

Another object of the present invention is to provide such a mixed fire retarding biochemical liquid composition, wherein the at least one first alkali metal salt, derived from the nonpolymeric saturated carboxylic acid, is selected from the group consisting of: (i) Alkali metal salts produced from the C1 carboxylic acid (R—COOH) called formic acid (i.e. methanoic acid), specifically: potassium formate; calcium formate; sodium formate; and magnesium formate; (ii) Alkali metal salts produced from the C1 carboxylic acid (R—COOH) called carbonic acid (i.e. hydroxymethanoic acid): specifically: potassium carbonate; sodium bicarbonate; magnesium carbonate; (iii) Alkali metal salts produced from the C2 carboxylic acid (R—COOH) called acetic acid (ethanoic acid), specifically: potassium acetate; calcium acetate; sodium acetate; and magnesium acetate; (iv) Alkali metal salts produced from the C2 carboxylic acid (R—COOH) called glycolic acid (hydroxyacetic acid); specifically: potassium glycolate; calcium glycolate; and sodium glycolate; (v) Alkali metal salts produced from the C2 carboxylic acid (R—COOH) called glyoxylic acid, specifically: potassium glyoxylate; calcium glyoxylate; sodium glyoxylate (monohydrate); (vi) Alkali metal salts produced from the C3 carboxylic acid (R—COOH) called propionic acid, specifically: potassium propionate; calcium propionate; sodium propionate; and magnesium propionate; (vii) Alkali metal salts produced from the C3 carboxylic acid (R—COOH) called lactic acid, specifically: potassium lactate; calcium lactate; sodium lactate; and magnesium lactate; (viii) Alkali metal salts produced from the C3 carboxylic acid (R—COOH) called glyceric acid, specifically: potassium glycerate; calcium glycerate; and sodium glycerate; (ix) Alkali metal salts produced from the C3 carboxylic acid (R—COOH), pyruvic acid, specifically: potassium pyruvate; calcium pyruvate; sodium pyruvate; and magnesium pyruvate; (x) Alkali metal salts produced from the C3 carboxylic acid (R—COOH) called, tartaric acid C3H45, specifically: potassium tartrate (potassium bitartrate): calcium tartrate: sodium tartrate; and magnesium tartrate; (xi) Alkali metal salts produced from the carboxylic acid (R—COOH) called butyric acid, specifically: potassium butyrate (or butanoate); calcium butyrate; sodium butyrate C₄H₇NaO₂; and magnesium butyrate; (xii) Alkali metal salts produced from the C4 carboxylic acid (R—COOH) called malic acid specifically: potassium malate; calcium malate; sodium malate; and magnesium malate; (xiii) Alkali metal salts produced from the C4 carboxylic acid (R—COOH) called malonic acid, specifically: potassium malonate; calcium malonate; sodium malonate; and di-magnesium malonate; (xiv) Alkali metal salts produced from the C5 carboxylic acid (R—COOH) called pivalic acid, specifically: potassium pivalate; calcium pivalate; sodium pivalate; and magnesium pivalate; (xv) Alkali metal salts produced from the C6 carboxylic acid (R—COOH) called caproic acid, specifically: potassium caproate (hexanoate); calcium caproate; sodium caproate; and magnesium caproate; (xvi) Alkali metal salts produced from the C6 carboxylic acid (R—COOH) called adipic (hexanedioic) acid, specifically: potassium adipate; calcium adipate; sodium adipate; and magnesium adipate; (xvii) Alkali metal salts produced from the C6 carboxylic acid (R—COOH) called citric acid, specifically: (tri) potassium citrate; calcium citrate; sodium citrate; and magnesium citrate; (xviii) Alkali metal salts produced from the C6 carboxylic acid (R—COOH) called d-gluconic acid, specifically: potassium gluconate; calcium gluconate; sodium gluconate; and magnesium gluconate.

Another object of the present invention is to provide such a mixed fire retarding biochemical liquid composition, wherein the first fire retarding agent is realized in the form of tripotassium citrate, for providing potassium ions dispersed in the water when the first one alkali metal salt is dissolved in the water to form a mixed retardant solution; and the corrosion inhibiting agent is realized in the form of sodium, potassium, calcium, or magnesium salt derived from benzoic acid and dissolved in the water to produce (i) benzoate ions in the aqueous solution that promote the formation of a corrosion inhibiting coating on metal surfaces contacting the mixed retardant solution and inhibiting surface corrosion reactions involving the metal surfaces, and (ii) metal alkali ions dispersed in the mixed retardant solution, functioning as a secondary fire retardant agent.

Another object of the present invention is to provide such a mixed fire retarding biochemical liquid composition, wherein the major amount of water as a solvent and dispersant is from 60% to 95% by weight, preferably from 60% to 90% by weight, and more preferably from 65% to 85% by weight, relative to the total weight of the mixed fire retarding biochemical liquid composition; the major amount of fire inhibiting agent in the form of at least one first alkali metal salt of a nonpolymeric saturated carboxylic acid, is from 5% to 40% by weight, preferably from 10% to 30% by weight, and more preferably from 15% to 20% by weight, relative to the total weight of the mixed fire retarding biochemical liquid composition; the minor amount of corrosion inhibiting agent in the form of least one second alkali metal salt of a nonpolymeric saturated carboxylic acid, is from 0.10% to 5% by weight, preferably from 0.5% to 3% by weight, and more preferably from 0.7% to 2.0% by weight, relative to the total weight of the mixed fire retarding biochemical liquid composition; the minor amount of thickening agent in form of a biopolymer consisting of polysaccharides, is from 0.08% to 5% by weight, preferably from 0.1% to 2% by weight, and more preferably from 0.5% to 1.0% by weight, relative to the total weight of the mixed fire retarding biochemical liquid composition; the minor amount an (alkali metal ion) dispersing agent, is from 0.08% to 5% by weight, preferably from 0.1% to 2% by weight, and more preferably from 0.5% to 1.5% by weight, relative to the total weight of the mixed fire retarding biochemical liquid composition; and the minor amount of coloring agent, is from 0.08% to 5% by weight, preferably from 0.1% to 3% by weight, and more preferably from 0.5% to 2.0% by weight, relative to the total weight of the mixed fire retarding biochemical liquid composition; wherein the sum of the weight percent % of the chemical components in the mixed fire retarding biochemical liquid composition should not exceed 100% by weight precent.

Another object of the present invention is to provide a new and improved dry concentrate fire retarding biochemical composition for mixing with water according to a mix ratio to produce a mixed fire retarding biochemical liquid for use in aerial retardant dropping operations, the dry concentrate fire retarding biochemical composition comprising: a fire inhibiting agent in the form of at least one first alkali metal salt dissolved in the water, functioning as a fire inhibiting agent, and derived from a first non-polymerized saturated carboxylic acid characterized by having carbon chain length of less than eight carbon atoms (C1-C7), wherein the alkali metal contained in the alkali metal salt is selected from the group consisting of potassium, calcium, sodium and/or magnesium; a corrosion inhibiting agent in the form of an alkali metal such as sodium, potassium, calcium, or magnesium salt derived from a second non-polymerized saturated carboxylic acid, namely benzoic acid, and dissolved in the water to produce benzoate ions in the aqueous solution that promote the formation of a corrosion inhibiting coating on metal surfaces contacting the mixed retardant solution and inhibiting surface corrosion reactions involving the metal surfaces; a thickening agent in the form of a biomolecular polymer consisting essentially of polysaccharide chains, for increasing the viscosity of the mixed fire retarding biochemical liquid during aerial dropping operations; an alkali metal ion dispersing agent derived from the saturated non-polymerized carboxylic acid and/or another saturated non-polymerized carboxylic acid, for dispersing alkali metal ions and benzoate ions when present in a mixed retardant aqueous solution, so as to promote the formation of the corrosion inhibiting coating on metal surfaces contacting the mixed retardant solution and inhibiting surface corrosion reactions involving the metal surfaces used in the fabrication of mixing, storage and/or delivery equipment, with which the mixed fire retarding biochemical liquid may come in surface contact during expected use; wherein the dry powder components described above are mixed together and can be dissolved in the water to produce the mixed retardant product, for application to combustible surfaces on the ground by aerial delivery or ground delivery methods, while water molecules in the mixed retardant liquid evaporate during drying, form a thin fire retardant coating on the combustible surfaces, and comprising alkali metal salt crystals mixed with the polysaccharides chains of the biomolecular polymer material, that provide proactive fire protection long after the water molecules have evaporated to the ambient environment.

Another object of the present invention is to provide such a dry concentrate fire retarding biochemical composition, wherein the fire inhibiting agent is present in a major amount having a weight percent from about 60.00% to about 95.0% relative to the total weight of the dry concentrate fire retarding biochemical composition; wherein the corrosion inhibiting agent is present in a minor amount having a weight percent from about 0.50% to about 20.00% relative to the total weight of the dry concentrate fire retarding biochemical composition; wherein the dispersing agent is present in a minor amount having a weight percent from about 0.10% to about 10.00% relative to the total weight of the dry concentrate fire retarding biochemical composition; wherein the thickening agent in the form of a biopolymer consisting of polysaccharides is present in a minor amount having a weight percent from about 0.01% from about 5.00% relative to the total weight of the dry concentrate fire retarding biochemical composition.

Another object of the present invention is to provide such a dry concentrate fire retarding biochemical composition of, wherein the thickening agent is biomolecular polymer selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan.

Another object of the present invention is to provide such a dry concentrate fire retarding biochemical composition, which further comprises a coloring agent dissolved in the water for imparting a visible color of the fugitive or non-fugitive type when the fire retarding biochemical liquid is applied to a surface to be protected against fire, while water molecules in the retardant liquid evaporate during drying, to form the thin fire retardant coating having a characteristic visible color and comprising alkali metal potassium and sodium salt crystals mixed with the polysaccharide chains of the biomolecular polymer material, deposited on the treated ground surfaces.

Another object of the present invention is to provide such a dry concentrate fire retarding biochemical composition, wherein the specific metals are selected from the group consisting of Aluminum, Steel, Yellow Brass, Magnesium, and Bright Steel.

Another object of the present invention is to provide such a dry concentrate fire retarding biochemical composition, wherein the mixed fire retarding biochemical liquid has a viscosity suitable for use in aerial delivery of the mixed fire retarding biochemical liquid from an airtanker flying at a speed and altitude relative to ground surface targets to form the thin fire retarding coatings comprising alkali metal potassium and sodium salt crystals mixed with polysaccharide chains of the biomolecular polymer, to provide proactive wildfire protection to the treated ground surfaces.

Another object of the present invention is to provide such a dry concentrate fire retarding biochemical composition, wherein the mixed fire retarding biochemical liquid has a viscosity suitable for use in ground-based delivery of the mixed fire retarding biochemical liquid from a ground-based tanker moving at a speed relative to ground surface targets to form the thin fire retarding coatings comprising alkali metal potassium and sodium salt crystals mixed with polysaccharide chains of the biomolecular polymer, to provide proactive wildfire protection to the treated ground surfaces.

Another object of the present invention is to provide such a dry concentrate fire retarding biochemical composition, wherein the major amount of fire inhibiting agent in the form of at least one first alkali metal salt of a nonpolymeric saturated carboxylic acid, is from 60% to 95% by weight, preferably from 70% to 90% by weight, and more preferably from 75% to 85% by weight, relative to the total weight of the dry concentrate fire retarding biochemical composition; the minor amount of corrosion inhibiting agent in the form of least one second alkali metal salt of a nonpolymeric saturated carboxylic acid, is from 4.0% to 20% by weight, preferably from 7.0% to 15% by weight, and more preferably from 8.0% to 13.0% by weight, relative to the total weight of the dry concentrate fire retarding biochemical composition; the minor amount of thickening agent in form of a biopolymer consisting of polysaccharides, is from 0.10% to 5% by weight, preferably from 0.75% to 1.5% by weight, and more preferably from 0.8% to 1.0% by weight, relative to the total weight of the dry concentrate fire retarding biochemical composition; the minor amount an (alkali metal ion) dispersing agent, is from 0.08% to 5% by weight, preferably from 0.1% to 2% by weight, and more preferably from 0.5% to 1.5% by weight, relative to the total weight of the dry concentrate fire retarding biochemical composition; and the minor amount of coloring agent, is from 0.10% to 5% by weight, preferably from 0.3% to 3% by weight, and more preferably from 0.9% to 1.5% by weight, relative to the total weight of the dry concentrate fire retarding biochemical composition; wherein the sum of the weight percent % of the chemical components in the dry concentrate fire retarding biochemical composition should not exceed 100% by weight precent.

Another object of the present invention is to provide a new and improved mixed fire retarding biochemical liquid for use in forming thin fire retarding metal alkali salt crystal and polysaccharide coatings on ground surface targets, the mixed fire retarding biochemical liquid comprising: water as a solvent and dispersant for providing an aqueous solution; a fire inhibiting agent in the form of an alkali metal potassium salt derived from the citric carboxylic acid is dissolved in the water to produce potassium ions in the aqueous solution; a corrosion inhibiting agent in the form of an alkali metal sodium, potassium, calcium, or magnesium salt derived from benzoic acid and dissolved in the water to produce benzoate ions in the aqueous solution that promote the formation of a corrosion inhibiting coating on metal surfaces contacting the mixed retardant solution and inhibiting surface corrosion reactions involving the metal surfaces; a thickening agent in the form of a biomolecular polymer consisting essentially of polysaccharides dissolved in the aqueous solution, to form a wet concentrate liquid that can be used as is in ready-to-use form or diluted with additional water according to a wet concentrate mix ratio; a dispersing agent derived from the saturated non-polymerized carboxylic acid and/or another saturated non-polymerized carboxylic acid, for dispersing benzoate ions present in the mixed retardant solution, so as to promote the formation of the corrosion inhibiting coating on metal surfaces contacting the mixed retardant solution and inhibiting surface corrosion reactions involving the metal surfaces; and wherein the mixed fire retarding liquid can be delivered to ground surface targets to form thin fire retarding coatings comprising alkali metal salt crystals mixed with polysaccharide chains of the biomolecular polymer, to provide proactive wildfire protection to treated ground surfaces.

Another object of the present invention is to provide such a mixed fire retarding biochemical liquid, wherein the thickening agent is biomolecular polymer selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan.

Another object of the present invention is to provide such a mixed fire retarding biochemical liquid, which further comprises a minor amount of coloring agent dissolved in the water for imparting a visible color of the fugitive or non-fugitive type when the fire retarding biochemical liquid is applied to a surface to be protected against fire, while water molecules in the retardant liquid evaporate during drying, to form the thin fire retardant coating having a characteristic visible color and comprising alkali metal potassium and sodium salt crystals mixed with the polysaccharide chains of the biomolecular polymer material.

Another object of the present invention is to provide such a mixed fire retarding biochemical liquid, wherein the specific metals are selected from the group consisting of Aluminum, Steel, Bright Steel, Yellow Brass, and Magnesium.

Another object of the present invention is to provide such a mixed fire retarding biochemical liquid, wherein the mixed fire retarding biochemical liquid has a viscosity suitable for use in aerial delivery of the mixed fire retarding liquid from an airtanker flying at a speed and altitude relative to ground surface targets to form the thin fire retarding coatings comprising alkali metal potassium and sodium salt crystals mixed with polysaccharide chains of the biomolecular polymer, to provide proactive wildfire protection to the treated ground surfaces.

Another object of the present invention is to provide such a mixed fire retarding biochemical liquid, wherein the mixed fire retarding biochemical liquid has a viscosity suitable for use in ground-based delivery of the mixed fire retarding liquid from a ground-based tanker moving at a speed relative to ground surface targets to form the thin fire retarding coatings comprising alkali metal potassium and sodium salt crystals mixed with polysaccharide chains of the biomolecular polymer, to provide proactive wildfire protection to the treated ground surfaces.

Another object of the present invention is to provide a new and improved environmentally-clean aqueous-based long-term fire retardant liquid biochemical composition for aerial and ground delivery applications, derived from the C6-Class of saturated non-polymerized carboxylic acid called citric acid, comprising: a fire inhibiting agent in the form of tripotassium citrate for dissolving in a quantity of water providing an aqueous solution, and providing magnesium ions for use in forming fire retarding potassium salt crystalline structures; a dispersing agent in the form of triethyl citrate (TEC) for dispersing potassium ions and benzoate ions in aqueous solution; a corrosion inhibiting agent in the form of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal; a thickening agent in the form of a biomolecular polymer added to the aqueous solution for thickening the solution and increasing its viscosity to a desired amount (e.g. 150-400 cP); and a coloring agent added to the aqueous solution for imparting particular color characteristics to the aqueous solution; wherein the dispersing agent disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving the metals; wherein when the mixed aqueous retardant solution is aerially delivered and applied to combustible target surfaces, it forms thin coatings on treated surfaces comprising potassium salt crystals mixed within biomolecular polymer constructed from polysaccharide chains, upon the evaporation of water molecules from the applied aqueous mixed retardant solution, thereby providing protection against fire ignition and flame spread without polluting or harming the environment; wherein the water is present in a major amount having a weight percent from about 70.00% to about 95.00% relative to the total weight of the mixed fire retarding biochemical liquid composition; wherein the fire inhibiting agent is present in a major amount having a weight percent from about 5.00% to about 30.00% relative to the total weight of the mixed fire retarding biochemical liquid composition; wherein the corrosion inhibiting agent is present in a minor amount having a weight percent from about 0.05% to about 10.00% relative to the total weight of the mixed fire retarding biochemical liquid composition; wherein the dispersing agent is present in a minor amount having a weight percent from about 0.05% to about 5.00% relative to the total weight of the mixed fire retarding biochemical liquid composition; wherein the thickening agent in the form of a biopolymer consisting of polysaccharides is present in a minor amount having a weight percent from about 0.01% from about 5.00% relative to the total weight of the mixed fire retarding biochemical liquid composition.

Another object of the present invention is to provide a new and improved environmentally-clean aqueous-based long-term fire retardant liquid biochemical composition for aerial and ground delivery applications, derived from the C6-Class of saturated non-polymerized carboxylic acid called citric acid, comprising: a fire inhibiting agent in the form of calcium citrate for dissolving in a quantity of water and providing magnesium ions for use in forming fire retarding calcium salt crystalline structures; a dispersing agent in the form of triethyl citrate (TEC) for dispersing calcium ions and benzoate ions in aqueous solution; a corrosion inhibiting agent in the form of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal; a thickening agent in the form of a biomolecular polymer added to the aqueous solution for thickening the solution and increasing its viscosity to a desired amount (e.g. 150-400 cP); and a coloring agent added to the aqueous solution for imparting particular color characteristics to the aqueous solution; wherein the dispersing agent disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving the metals; wherein when the mixed aqueous retardant solution is aerially delivered and applied to combustible target surfaces, it forms thin coatings on treated surfaces comprising calcium salt crystals mixed within biomolecular polymer constructed from polysaccharide chains, upon the evaporation of water molecules from the applied aqueous mixed retardant solution, thereby providing protection against fire ignition and flame spread without polluting or harming the environment; wherein the water is present in a major amount having a weight percent from about 70.00% to about 95.00% relative to the total weight of the mixed fire retarding biochemical liquid composition; wherein the fire inhibiting agent is present in a major amount having a weight percent from about 5.00% to about 30.00% relative to the total weight of the mixed fire retarding biochemical liquid composition; wherein the corrosion inhibiting agent is present in a minor amount having a weight percent from about 0.05% to about 10.00% relative to the total weight of the mixed fire retarding biochemical liquid composition; wherein the dispersing agent is present in a minor amount having a weight percent from about 0.05% to about 5.00% relative to the total weight of the mixed fire retarding biochemical liquid composition; wherein the thickening agent in the form of a biopolymer consisting of polysaccharides is present in a minor amount having a weight percent from about 0.01% from about 5.00% relative to the total weight of the mixed fire retarding biochemical liquid composition.

Another object of the present invention is to provide a new and improved environmentally-clean aqueous-based long-term fire retardant liquid biochemical composition for aerial and ground delivery applications, derived from the C6-Class of saturated non-polymerized carboxylic acid called citric acid, comprising: a fire inhibiting agent in the form of sodium citrate for dissolving in a quantity of water and providing magnesium ions for use in forming fire retarding sodium salt crystalline structures; a dispersing agent in the form of triethyl citrate (TEC) for dispersing sodium ions and benzoate ions in aqueous solution; a corrosion inhibiting agent in the form of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal; a thickening agent in the form of a biomolecular polymer added to the aqueous solution for thickening the solution and increasing its viscosity to a desired amount (e.g. 150-400 cP); and a coloring agent added to the aqueous solution for imparting particular color characteristics to the aqueous solution; wherein the dispersing agent disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving the metals; wherein when the mixed aqueous retardant solution is aerially delivered and applied to combustible target surfaces, it forms thin coatings on treated surfaces comprising sodium salt crystals mixed within biomolecular polymer constructed from polysaccharide chains, upon the evaporation of water molecules from the applied aqueous mixed retardant solution, thereby providing protection against fire ignition and flame spread without polluting or harming the environment; wherein the water is present in a major amount having a weight percent from about 70.00% to about 95.00% relative to the total weight of the mixed fire retarding biochemical liquid composition; wherein the fire inhibiting agent is present in a major amount having a weight percent from about 5.00% to about 30.00% relative to the total weight of the mixed fire retarding biochemical liquid composition; wherein the corrosion inhibiting agent is present in a minor amount having a weight percent from about 0.05% to about 10.00% relative to the total weight of the mixed fire retarding biochemical liquid composition; wherein the dispersing agent is present in a minor amount having a weight percent from about 0.05% to about 5.00% relative to the total weight of the mixed fire retarding biochemical liquid composition; wherein the thickening agent in the form of a biopolymer consisting of polysaccharides is present in a minor amount having a weight percent from about 0.01% from about 5.00% relative to the total weight of the mixed fire retarding biochemical liquid composition.

Another object of the present invention is to provide a new and improved environmentally-clean aqueous-based long-term fire retardant liquid biochemical composition for aerial and ground delivery applications, derived from the C6-Class of saturated non-polymerized carboxylic acid called citric acid, comprising: a fire inhibiting agent in the form of magnesium citrate for dissolving in a major quantity of water and providing magnesium ions for use in forming fire retarding magnesium salt crystalline structures; a dispersing agent in the form of triethyl citrate (TEC) for dispersing magnesium ions and benzoate ions in aqueous solution; a corrosion inhibiting agent in the form of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal; a thickening agent in the form of a biomolecular polymer added to the aqueous solution for thickening the solution and increasing its viscosity to a desired amount (e.g. 150-400 cP); and a coloring agent added to the aqueous solution for imparting particular color characteristics to the aqueous solution; wherein the dispersing agent disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving the metals; wherein when the mixed aqueous retardant solution is aerially delivered and applied to combustible target surfaces, it forms thin coatings on treated surfaces comprising magnesium salt crystals mixed within biomolecular polymer constructed from polysaccharide chains, upon the evaporation of water molecules from the applied aqueous mixed retardant solution, thereby providing protection against fire ignition and flame spread without polluting or harming the environment; wherein the water is present in a major amount having a weight percent from about 70.00% to about 95.00% relative to the total weight of the mixed fire retarding biochemical liquid composition; wherein the fire inhibiting agent is present in a major amount having a weight percent from about 5.00% to about 30.00% relative to the total weight of the mixed fire retarding biochemical liquid composition; wherein the corrosion inhibiting agent is present in a minor amount having a weight percent from about 0.05% to about 10.00% relative to the total weight of the mixed fire retarding biochemical liquid composition; wherein the dispersing agent is present in a minor amount having a weight percent from about 0.05% to about 5.00% relative to the total weight of the mixed fire retarding biochemical liquid composition; wherein the thickening agent in the form of a biopolymer consisting of polysaccharides is present in a minor amount having a weight percent from about 0.01% from about 5.00% relative to the total weight of the mixed fire retarding biochemical liquid composition.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is a table listing conventional prior art methods for fighting and defending against wild fires including (i) aerial water drop methods using airplanes and helicopters, (ii) aerial fire retardant chemical (e.g. PhosChek (R) Fire Retardant) drop using airplanes and helicopters, (iii) physical fire breaks formed by bulldozing land and other landscaping methods to remove combustible vegetation from the land, (iv) physical fire breaks by pre-burning combustible material on the land, and (v) chemical fire break by fire retardant chemical drop;

FIG. 2A is a first image illustrating a prior art method of wild fire suppression involving an airplane dropping water on a wild fire from the sky;

FIG. 2B1 is a second image illustrating a prior art method of wild fire suppression involving an airplane dropping prior art chemical fire retardant (e.g. PhosChek (R)) on a wild fire, from the sky;

FIG. 2B2 is third image showing a prior art ground-based tank containing the chemical fire retardant (e.g. PhosChek (R) fire retardant chemical) that is shown being contained in a storage tank in FIG. 2B2, and dropped from an airplane in FIG. 2B1;

FIG. 2B3 is a fourth image showing a prior art ground-based tank containing a supply of PhosChek (R) fire retardant chemical mixed in the tank shown in FIG. 2B3, and dropped from an airplane in FIG. 2B1;

FIG. 2B4 is a schematic representation illustrating the primary components of the PhosChek® fire retardant chemical, namely monoammonium phosphate (MAP), diammonium hydrogen phosphate (DAP) and water;

FIG. 3A is a schematic representation illustrating the primary active components of the fire-retardant chemical disclosed and claimed in BASF's prior art U.S. Pat. No. 8,273,813 to Beck et al., namely tripotassium citrate (TPC) and a water-absorbing polymer dissolved in water;

FIG. 3B is a schematic representation illustrating the primary components of Hartidino's prior art AF-31 fire retardant chemical, namely, tripotassium citrate (TPC) and a natural gum dissolved in water, as described in the Material Safety Data Sheet for Hartindo AF31 (Eco Fire Break) dated Feb. 4, 2013 (File No. DWMS2013);

FIG. 3C is a schematic representation illustrating the prior art Specification 5100-304d dated Jan. 7, 2020, issued by the US Department of Agriculture (USDA) Forest Service (FS) under the title “LONG-TERM RETARDANT, WILDLAND FIREFIGHTING” which governs all wildland fire fighting chemicals registered on the USDA FS's Qualified Product Listing (QPL) and approved for use in firefighting on federally owned/managed land in the USA;

FIG. 3C1 is Table 1 from the prior art USDA FS Specification 5100-304d for Long-Term Wildland Firefighting Retardant, describing the toxicity and irritation requirements for Wet or Dry Concentrate Product manufacture under the USDA FS Specification 5100-304d;

FIG. 3C2 is Table 2 from the prior art USDA FS Specification 5100-304d for Long-Term Wildland Firefighting Retardant, describing the toxicity and irritation requirements for Mixed Product manufactured under the USDA FS Specification 5100-304d;

FIG. 3C3 is Table 3 from the prior art USDA FS Specification 5100-304d for Long-Term Wildland Firefighting Retardant, describing the maximum allowable corrosion rates (mils-per-year) allowed for specific metals, namely 2024-T3Aluminum, 4130 Steel, Yellow Brass, and Az31B Magnesium, when exposed to Wildland Fire Chemical Products under the USDA FS Specification 5100-304d;

FIG. 3C4 is Table 4 from the prior art USDA FS Specification 5100-304d for Long-Term Wildland Firefighting Retardant, describing whether or not intergranular corrosion is allowable for specific alloy metals, namely 2024-T3 Aluminum and Az-31-B Magnesium, when used in specific Application Methods and exposed to Wildland Fire Chemical Products under the USDA FS Specification 5100-304d;

FIG. 3C5 is Table 5 from the prior art USDA FS Specification 5100-304d for Long-Term Wildland Firefighting Retardant, describing the effect of exposure to Wet Concentrate and Mixed Product on Non-Metallic Materials, and determining the changes in hardness and volume of each of the materials, caused by exposure to Wildland Fire Chemical Products under the USDA FS Specification 5100-304d;

FIG. 3C6 is Table 6 from the prior art USDA FS Specification 5100-304d for Long-Term Wildland Firefighting Retardant, describing the allowable variation of physical properties (i.e. steady-state viscosity, density and pH) of Mixed Retardant (stored for 14 days) and Mixed Retardant prepared from Concentrate and stored for 52 weeks, under the USDA FS Specification 5100-304d;

FIG. 3C7 is Table 7 from the prior art USDA FS Specification 5100-304d for Long-Term Wildland Firefighting Retardant, describing the allowable variation of physical properties (i.e. steady-state viscosity, density and pH) of Mixed Retardant (stored for 52 weeks) and Wet Concentrates stored for 52 weeks, under the USDA FS Specification 5100-304d;

FIG. 4A is a schematic representation of the wireless system network of the present invention designed for managing the supply, production and delivery of the environmentally-clean mixed fire retarding biochemical liquid products of the present invention on private and public property for the purpose of reducing the risks of property damage and/or destruction and harm to life caused by wild fires;

FIG. 4B is a schematic representation illustrating exemplary multi-spectral imaging (MSI) and hyper-spectral imaging (HSI) based remote sensing technology platforms supported by the US Geological Survey (USGS) Agency including, for example, the MODIS (Moderate Resolution Imaging Spectroradiometer) satellite system, the World View 2 Satellite System, the Octocopter unmanned airborne system (UAS)(e.g. OnyxStar Hydra-12 heavy-lifting drone), and the SenseFly eBee SQ UAS, for use in supporting and practicing the system network of the present invention;

FIG. 4C is a perspective view of the OnyxStar Hyra-12 heavy lifter drone supporting MSI and HSI camera systems, and providing remove data sensing services that can be used to help carry out the GPS-directed methods of wild fire suppression disclosed herein in accordance with the principles of the present invention;

FIG. 5A is a perspective view of an exemplary mobile computing device deployed on the system network of the present invention, supporting (i) the mobile fire retardant management application of the present invention deployed as a component of the system network of the present invention as shown in FIGS. 4A and 4B, as well as (ii) conventional wildfire alert and notification systems as shown in FIGS. 3A through 3E;

FIG. 5B shows a system diagram for an exemplary mobile client computer system deployed on the system network of the present invention;

FIG. 6 is a schematic representation of the formulation of the environmentally-clean long-term fire retardant biochemical composition (i.e. aqueous solution) of the present invention for aerial and ground delivery operations, comprising (i) a major amount of a metal alkali salt dissolved in a major amount of water and derived from a saturated non-polymerized carboxylic acid, wherein the carbon chain length of the Carboxylic Acid is less than eight (C1-C7), and the resulting water-based liquid solution is stable when mixed so that its chemical components do not precipitate in the Aqueous Solution when stored in a storage container, making the Aqueous Solution ready for use in diverse temperature environments ranging from, for example, 32° F. to 130° F., (ii) Minor Amount of Alkali Metal Salt Derived from of Benzoic Acid, wherein the alkali metal is selected from group consisting of potassium, sodium, calcium and magnesium, (iii) Minor Amount of the Biomolecular Polymer consisting essentially of polysaccharides, such as: storage polysaccharides, such as starch, glycogen and galactogen; and structural polysaccharides such as cellulose and chitin, (iv) a minor amount of coloring agent (e.g. fugitive or non-fugitive type)(e.g. realized using DayGlo ELX-2100FR hybrid pigment powder), (v) a minor amount of dispersing agent as an estate of the carboxylic acid or triethyl citrate ester (CAS RN 77-93-0), and (vi) a polar solvent such as water for dissolving the chemical ingredients above into an aqueous solution that provides a long-term fire retardant for aerial and ground delivery;

FIG. 6A is a schematic representation illustrating the primary components of a “wet concentrate” type of environmentally-clean aqueous-based fire retarding liquid biochemical composition of the present invention consisting essentially of major amounts of tripotassium citrate (TPC), minor amounts of sodium benzoate, minor amounts of Xanthan gum, minor amounts of dispersing agent (e.g. triethyl citrate), and minor amounts of fugitive red dye powder, formulated with a major amount of water functioning as a solvent, carrier, and dispersant;

FIG. 6B is a schematic representation illustrating the primary components of a “dry concentrate” type of fire retarding biochemical composition of the present invention (i.e. dry concentrate) consisting essentially of major amounts of dry tripotassium citrate monohydrate (TPC), minor amounts of dry powder sodium benzoate, potassium benzoate, calcium benzoate or magnesium benzoate, minor amounts of dry powder Xanthan gum, a minor amounts of a dispersing agent (e.g. triethyl citrate) for dispersing benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and minor amounts of fugitive red dye powder, as components in a package (e.g. bag or container) prepared and ready for mixing with a predetermined quantity of water functioning as a solvent, carrier and dispersant, to make up a predetermined quantity of environmentally-clean liquid fire retarding biochemical composition (i.e. mixed retardant product) for proactively treating and protecting combustible surfaces, and/or suppressing and extinguishing an active wildfire;

FIG. 6C1 is a schematic representation illustrating the primary components of an environmentally-clean aqueous-based long-term file retardant liquid biochemical composition of the present invention for aerial and ground delivery applications, derived from the C1-Class of saturated non-polymerized carboxylic acid called formic acid, comprising (i) a major amount of potassium formate, and (ii) a minor amount of methyl formate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl formate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6C2 is a schematic representation illustrating the primary components of an environmentally-clean aqueous-based long-term fire retardant liquid biochemical composition of the present invention for aerial and ground delivery applications, derived from the C1-Class of saturated non-polymerized carboxylic acid called formic acid, comprising (i) major amounts of calcium formate, and (ii) a minor amount of methyl formate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl formate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6C3 is a schematic representation illustrating the primary components of an environmentally-clean aqueous-based long-term fire retardant liquid biochemical composition of the present invention for aerial and ground delivery applications, derived from the C1-Class of saturated non-polymerized carboxylic acid called formic acid, comprising (i) major amounts of sodium formate, and (ii) minor amounts of methyl formate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl formate or triethyl citrate) disperses benzoate ions present in the water when the at least one alkali metal salt is dissolved in the mixed retardant solution, so as to promote the formation of a corrosion inhibiting coating on metals (e.g. iron, steel, brass, and/or aluminum) contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6C4 is a schematic representation illustrating the primary components of an environmentally-clean aqueous-based long-term fire retardant liquid biochemical composition of the present invention for aerial and ground delivery applications, derived from the C1-Class of saturated non-polymerized carboxylic acid called formic acid, comprising (i) major amounts of sodium formate, and (ii) minor amounts of methyl formate or triethyl citrate (TEC) as a dispersing agent for dispersing benzoate ions in aqueous solution; (iii) a minor amount of one or more alkali metal salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl formate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6D1 is a schematic representation illustrating the primary components of an environmentally-clean aqueous-based long-term fire retardant liquid biochemical composition of the present invention for aerial and ground delivery applications, derived from the C1-Class of saturated non-polymerized carboxylic acid called carbonic acid, comprising (i) a major amount of potassium carbonate, and (ii) a minor amount of triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6D2 is a schematic representation illustrating the primary components of an environmentally-clean aqueous-based long-term fire retardant liquid biochemical composition of the present invention for aerial and ground delivery applications, derived from the C1-Class of saturated non-polymerized carboxylic acid called carbonic acid, comprising (i) a major amount of sodium (bi) carbonate, and (ii) a minor amount of triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6E1 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called acetic acid, comprising (i) a major amount of potassium acetate, and (ii) a minor amount of ethyl acetate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl acetate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6E2 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called acetic acid, comprising (i) a major amount of calcium acetate, and (ii) a minor amount of ethyl acetate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl acetate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6E3 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called acetic acid, comprising (i) a major amount of sodium acetate, and (ii) a minor amount of ethyl acetate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl acetate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6E4 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called acetic acid, comprising (i) a major amount of magnesium acetate, and (ii) a minor amount of ethyl acetate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl acetate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6F1 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called glycolic acid, comprising (i) a major amount of potassium glycolate, and (ii) a minor amount of ethyl glycolate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl glycolate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6F2 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called glycolic acid, comprising (i) a major amount of calcium glycolate, and (ii) a minor amount of ethyl glycolate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl glycolate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6F3 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called glycolic acid, comprising (i) a major amount of sodium glycolate, and (ii) a minor amount of ethyl glycolate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl glycolate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6G1 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called glyoxylic acid, comprising (i) a major amount of potassium glyoxylate, and (ii) a minor amount of triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6G2 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called glyoxylic acid, comprising (i) a major amount of calcium glyoxylate, and (ii) a minor amount of triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6G3 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called glyoxylic acid, comprising (i) a major amount of sodium glyoxylate, and (ii) a minor amount of triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6H1 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called oxalic acid, comprising (i) a major amount of potassium oxalate, and (ii) a minor amount of dimethyl oxalate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl oxalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6H2 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called oxalic acid, comprising (i) a major amount of calcium oxalate, and (ii) a minor amount of dimethyl oxalate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl oxalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6H3 is a schematic representation illustrating the primary components of an environmentally-clean aqueous-based long-term fire retardant liquid biochemical composition of the present invention for aerial and ground delivery applications, derived from the C2-Class of saturated non-polymerized carboxylic acid called oxalic acid, comprising (i) a major amount of sodium oxalate, and (ii) a minor amount of dimethyl oxalate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl oxalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6I1 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called propionic acid, comprising (i) a major amount of potassium propionate, and (ii) a minor amount of ethyl propionate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl propionate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6I2 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called propionic acid, comprising (i) a major amount of calcium propionate, and (ii) a minor amount of ethyl propionate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl propionate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6I3 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called propionic acid, comprising (i) a major amount of sodium propionate, and (ii) a minor amount of ethyl propionate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl propionate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6I4 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called propionic acid, comprising (i) a major amount of magnesium propionate, and (ii) a minor amount of ethyl propionate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl propionate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6J1 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called lactic acid, comprising (i) a major amount of potassium lactate, and (ii) a minor amount of ethyl lactate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl lactate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6J2 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called lactic acid, comprising (i) a major amount of calcium lactate, and (ii) a minor amount of ethyl lactate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl lactate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6J3 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called lactic acid, comprising (i) a major amount of sodium lactate, and (ii) a minor amount of ethyl lactate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl lactate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6J4 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called lactic acid, comprising (i) a major amount of magnesium lactate, and (ii) a minor amount of ethyl lactate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl lactate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6K1 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called glyceric acid, comprising (i) a major amount of potassium glycerate, and (ii) a minor amount of dimethyl glycerate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl glycerate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6K2 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called glyceric acid, comprising (i) a major amount of calcium glycerate, and (ii) a minor amount of dimethyl glycerate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl glycerate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6K3 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called glyceric acid, comprising (i) a major amount of sodium glycerate, and (ii) a minor amount of dimethyl glycerate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl glycerate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6L1 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called pyruvic acid, comprising (i) a major amount of potassium pyruvate, and (ii) a minor amount of ethyl pyruvate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl pyruvate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6L2 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called pyruvic acid, comprising (i) a major amount of calcium pyruvate, and (ii) a minor amount of ethyl pyruvate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl pyruvate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6L3 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called pyruvic acid, comprising (i) a major amount of sodium pyruvate, and (ii) a minor amount of ethyl pyruvate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl pyruvate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6L4 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called pyruvic acid, comprising (i) a major amount of magnesium pyruvate, and (ii) a minor amount of ethyl pyruvate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl pyruvate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6M1 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called tartaric acid, comprising (i) a major amount of potassium tartrate, and (ii) a minor amount of diethyl tartrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl tartrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6M2 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called tartaric acid, comprising (i) a major amount of calcium tartrate, and (ii) a minor amount of diethyl tartrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl tartrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6M3 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called tartaric acid, comprising (i) a major amount of sodium tartrate, and (ii) a minor amount of diethyl tartrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl tartrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6M4 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called tartaric acid, comprising (i) a major amount of magnesium tartrate, and (ii) a minor amount of diethyl tartrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl tartrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6NI is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called butyric acid, comprising (i) a major amount of potassium butyrate, and (ii) a minor amount of ethyl butyrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl butyrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6N2 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called butyric acid, comprising (i) a major amount of calcium butyrate, and (ii) a minor amount of ethyl butyrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl butyrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6N3 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called butyric acid, comprising (i) a major amount of sodium butyrate, and (ii) a minor amount of ethyl butyrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl butyrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6N4 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called butyric acid, comprising (i) a major amount of magnesium butyrate, and (ii) a minor amount of ethyl butyrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl butyrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6O1 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malic acid, comprising (i) a major amount of potassium maleate, and (ii) a minor amount of diethyl maleate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl maleate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6O2 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malic acid, comprising (i) a major amount of calcium maleate, and (ii) a minor amount of diethyl maleate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl maleate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6O3 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malic acid, comprising (i) a major amount of sodium maleate, and (ii) a minor amount of diethyl maleate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl maleate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6O4 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malic acid, comprising (i) a major amount of magnesium maleate, and (ii) a minor amount of diethyl maleate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl maleate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6P1 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malonic acid, comprising (i) a major amount of potassium malonate, and (ii) a minor amount of diethyl malonate (DEM) or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl malonate (DEM) or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6P2 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malonic acid, comprising (i) a major amount of calcium malonate, and (ii) a minor amount of diethyl malonate (DEM) or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl malonate (DEM) or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6P3 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malonic acid, comprising (i) a major amount of sodium malonate, and (ii) a minor amount of diethyl malonate (DEM) or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl malonate (DEM) or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6P4 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malonic acid, comprising (i) a major amount of magnesium malonate, and (ii) a minor amount of diethyl malonate (DEM) or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl malonate (DEM) or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6Q1 is a schematic representation illustrating the primary components of an environmentally-clean aqueous-based long-term fire retardant liquid biochemical composition of the present invention for aerial and ground delivery applications, derived from the C5-Class of saturated non-polymerized carboxylic acid called pivalic acid, comprising (i) a major amount of potassium pivalate, and (ii) a minor amount of methyl pivalate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl pivalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6Q2 is a schematic representation illustrating the primary components of an environmentally-clean aqueous-based long-term fire retardant liquid biochemical composition of the present invention for aerial and ground delivery applications, derived from the C5-Class of saturated non-polymerized carboxylic acid called pivalic acid, comprising (i) a major amount of calcium pivalate, and (ii) a minor amount of methyl pivalate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl pivalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6Q3 is a schematic representation illustrating the primary components of an environmentally-clean aqueous-based long-term fire retardant liquid biochemical composition of the present invention for aerial and ground delivery applications, derived from the C5-Class of saturated non-polymerized carboxylic acid called pivalic acid, comprising (i) a major amount of sodium pivalate, and (ii) a minor amount of methyl pivalate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl pivalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6Q4 is a schematic representation illustrating the primary components of an environmentally-clean aqueous-based long-term fire retardant liquid biochemical composition of the present invention for aerial and ground delivery applications, derived from the C5-Class of saturated non-polymerized carboxylic acid called pivalic acid, comprising (i) a major amount of magnesium pivalate, and (ii) a minor amount of methyl pivalate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl pivalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6R1 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising (i) a major amount of potassium caproate, and (ii) a minor amount of ethyl caproate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl caproate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6R2 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising (i) a major amount of calcium caproate, and (ii) a minor amount of ethyl caproate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl caproate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6R3 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising (i) a major amount of sodium caproate, and (ii) a minor amount of ethyl caproate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl caproate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6R4 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising (i) a major amount of magnesium caproate, and (ii) a minor amount of ethyl caproate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl caproate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6S1 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising (i) a major amount of potassium adipic, and (ii) a minor amount of dimethyl adipate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl adipate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6S2 is a schematic representation illustrating the primary components of an environmentally-clean aqueous-based fire inhibiting liquid biochemical composition of the present invention derived from the C6-Class of saturated non-polymerized carboxylic acid called caproic acid, comprising (i) a major amount of calcium adipic, and (ii) a minor amount of dimethyl adipate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl adipate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6S3 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising (i) a major amount of sodium adipic, and (ii) a minor amount of dimethyl adipate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl adipate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6S4 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising (i) a major amount of magnesium adipic, and (ii) a minor amount of dimethyl adipate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl adipate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6T1 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called citric acid, comprising (i) a major amount of tripotassium citrate (TPC), and (ii) a minor amount triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6T2 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called citric acid, comprising (i) a major amount of calcium citrate, and (ii) a minor amount triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6T3 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called citric acid, comprising (i) a major amount of sodium citrate, and (ii) a minor amount triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6T4 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called citric acid, comprising (i) a major amount of magnesium citrate, and (ii) a minor amount triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6U1 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called d-gluconic acid, comprising (i) a major amount of potassium gluconate, and (ii) a minor amount methyl gluconate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl gluconate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6U2 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called d-gluconic acid, comprising (i) a major amount of calcium gluconate, and (ii) a minor amount methyl gluconate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl gluconate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6U3 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called d-gluconic acid, comprising (i) a major amount of sodium gluconate, and (ii) a minor amount methyl gluconate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl gluconate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6U4 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called d-gluconic acid, comprising (i) a major amount of magnesium gluconate, and (ii) a minor amount methyl gluconate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl gluconate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6V1 is a schematic representation illustrating the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising (i) a major amount of potassium benzoate, and (ii) a minor amount ethyl benzoate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl benzoate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6V2 is a schematic representation illustrating the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising (i) a major amount of calcium benzoate, and (ii) a minor amount ethyl benzoate or triethyl citrate (TEC), (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl benzoate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6V3 is a schematic representation illustrating the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising (i) a major amount of sodium benzoate, and (ii) a minor amount ethyl benzoate or triethyl citrate (TEC), (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl benzoate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 6V4 is a is a schematic representation illustrating the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising (i) a major amount of sodium benzoate which, when dissolved in a major amount of water, provides sodium ions to inhibit ignition of fire and flame spread, and benzoate ions to promote the formation of a corrosion inhibiting coating or layer on the surface of a metal used or supported by the application, and (ii) a minor amount ethyl benzoate or triethyl citrate (TEC) as a dispersing agent for dispersing benzoate ions in aqueous solution, to promote the benzoate ions to form a corrosion inhibiting coating or layer on the surface of the metal that inhibits metal alkali ions in the aqueous solution from undergoing chemical reactions with the metals used in the application;

FIG. 6V5 is a schematic representation illustrating the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising (i) a major amount of magnesium benzoate, and (ii) a minor amount ethyl benzoate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application, (iv) a minor amount of biomolecular polymer (e.g. xanthan gum (XG)) added to the aqueous solution for thickening the solution and increasing its viscosity to a desired amount (e.g. 150-400 cP), and (v) a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl benzoate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals, and wherein when the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment;

FIG. 7A is a schematic representation of a classification schema for long-term fire retardant biochemical products of present invention formulated according to the USDA FS Specification “Long Term Retardant, Wildland Firefighter” 5100-304d-dated Jan. 7, 2020, comprising (i) Forms of Product namely, Wet Concentrate-applied at a Mix Ratio to yield a Mixed Product, and Dry Concentrate-applied at a Mix Ratio to yield a Mixed Product; Color or Uncolored, namely, Red Dye Pigment; Fugitive Color, namely Red Dye Powder; and Uncolored (relying on use with GPS-tracking and mapping techniques); Storability, namely >52 Weeks in Dry and Wet Concentrate Forms, and when produced as a Mixed Product; Application Methods, namely, HF-Fixed-wing (all delivery systems) land-based, FW-Multi-Engine-Fixed-wing (all delivery systems)-land-based, single-engine (SEAT) aircraft, and HB/G-Helicopters having a bucket suspended below the helicopter; Viscosity Range, namely, Mixed Product Viscosity, 150 and 400 cP; and Base Type, from which the Product will be deployed/applied, namely Mobile and Stationary Airbases;

FIG. 7B is a schematic representation illustrating a process of forming a fire retardant coating comprising a mixture of potassium and sodium salt crystals and biomolecular polymer material consisting essentially of polysaccharides, such as Xanthan gum, applied to combustible surfaces, such as ground cover, native fuel, plant tissue, tree bark, and other combustible plant tissue and like materials in the wildland regions that are coated with the wet chemical fire retarding biochemical liquid/fluid using aerial application equipment and methods, and comprising the aqueous-based fire retarding (i.e. inhibiting) solution of the present invention as illustrated in FIGS. 6, 6A1, and 6A2 and described herein;

FIG. 8 is a schematic representation of a fire retardant product mixing station located on or near an air and/or ground base supporting aircraft and ground-based vehicles of various types (e.g. airtankers and ground tanker) adapted and equipped for carrying large volumes of Mixed Retardant Product produced in accordance with the principles of the present invention and the USDA FS Specification “Long Term Retardant, Wildland Firefighter” 5100-304d, wherein the fire retardant mixing station employs storage containers for containing dry and wet concentrate products according to the present invention, water tanks and/or sources, mixing tanks with stirring equipment for mixing concentrate and water to form mixed retardant product, pumping systems, piping system and mixers, and storage containers for containing mixed retardant product, and filling equipment for filling delivery vehicles with the mixed retardant product, wherein all such equipment may be made from metal and non-metallic materials that may experience corrosion when coming in contact with alkali metal salts, but not when coming in contact with the dry concentrate products, wet concentrate products, and mixed fire retardant products formulated using water during the mixing stage in accordance with the principles of the present invention;

FIG. 9A is a perspective view of a GPS-tracked aircraft system (i.e. helicopter) adapted for depositing an environmentally-clean fire retarding biochemical liquid of the present invention, from the air onto ground and property surfaces in accordance with the principles of the present invention;

FIG. 9B is a schematic representation of the GPS-tracked aircraft system (i.e. helicopter) shown in FIG. 9A, comprising a GPS-tracked and remotely monitored retardant chemical liquid delivery control subsystem interfaced with a micro-computing platform for monitoring the application of fire retarding biochemical liquid from the aircraft when located at specific GPS-indexed location coordinates, and automatically logging and recording such retardant biochemical liquid application operations within the network database system;

FIG. 10A is a perspective view of an autonomously-driven or remotely-controlled unmanned airborne system (i.e. UAS or “drone”) adapted for delivering retardant chemical liquid on building and ground surfaces for coating/treating the same with environmentally-clean fire retarding biochemical liquid in accordance with the principles of the present invention;

FIG. 10B is a schematic representation of the autonomously-driven or remotely-controlled aircraft system (i.e. drone) shown in FIG. 10A, comprising a GPS-tracked and remotely monitored retardant biochemical liquid application control subsystem interfaced with a micro-computing platform for monitoring the application of fire retarding biochemical liquid from the aircraft when located at specific GPS-indexed location coordinates, and automatically logging and recording such fire retardant application operations within the network database system;

FIG. 11A is a perspective view of a GPS-tracked manned or autonomous vehicle system for applying and treating building and ground surfaces with environmentally-clean fire retarding biochemical liquid, in accordance with the principles of the present invention; and

FIG. 11B is a schematic representation of the manned or autonomously-driven vehicle system shown in FIG. 11A, comprising a GPS-tracked and remotely-monitored retardant biochemical liquid spray control subsystem interfaced with a micro-computing platform for monitoring the application of fire retarding biochemical liquid from the vehicle when located at any specific GPS-indexed location coordinates, and automatically logging and recording such retardant biochemical liquid application operations within the network database system.

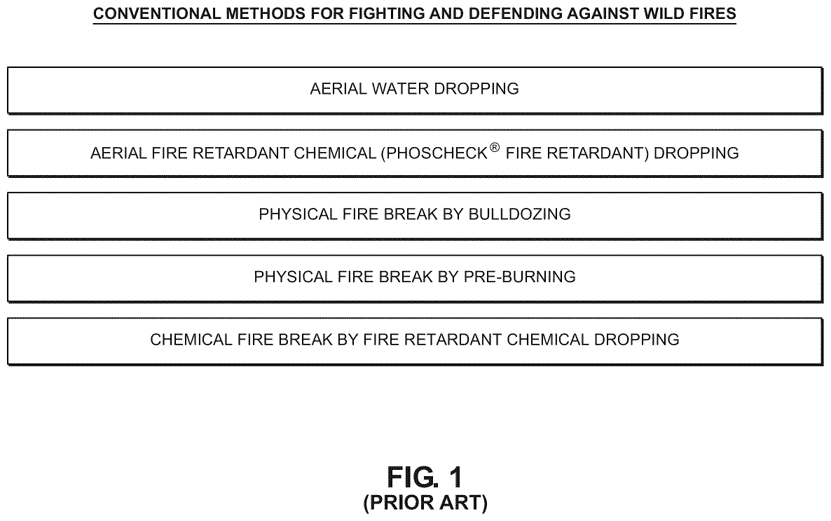

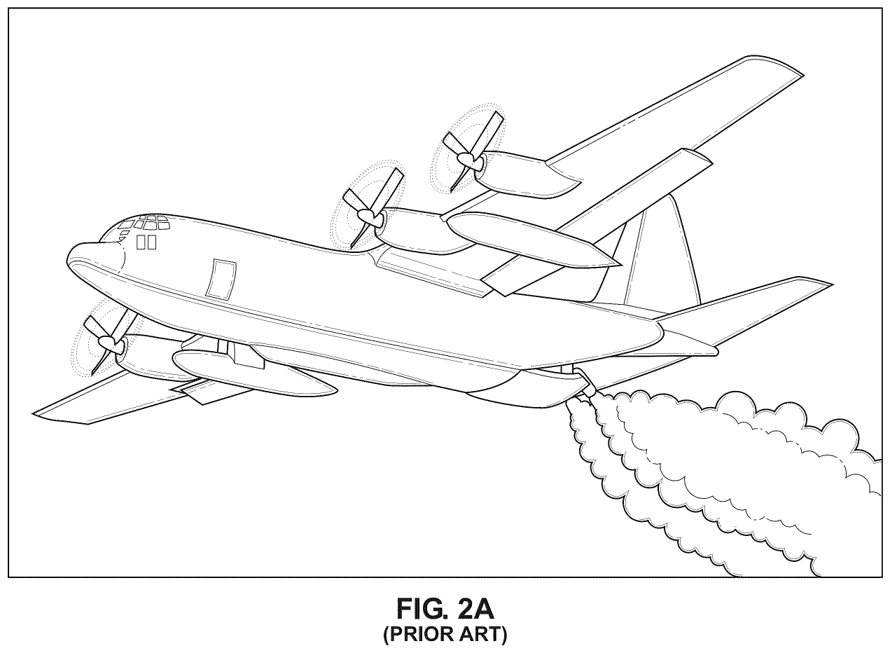

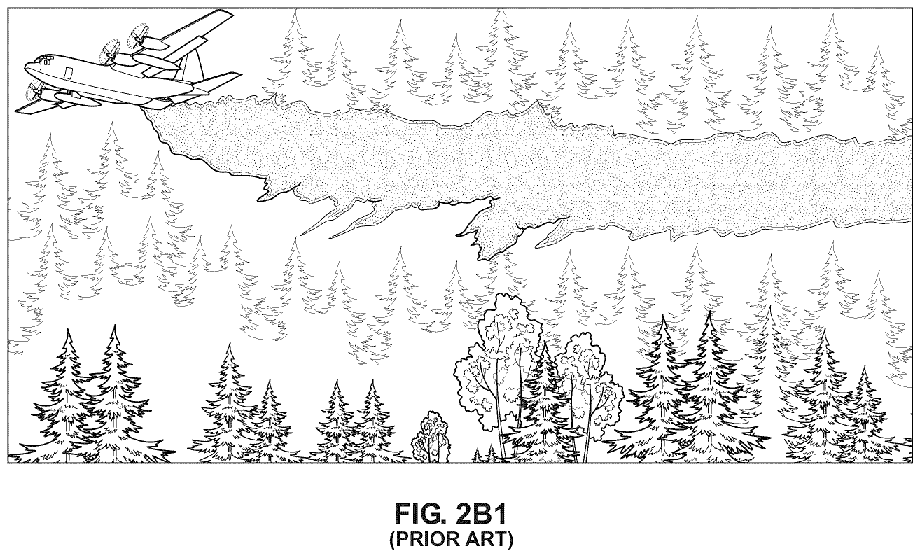

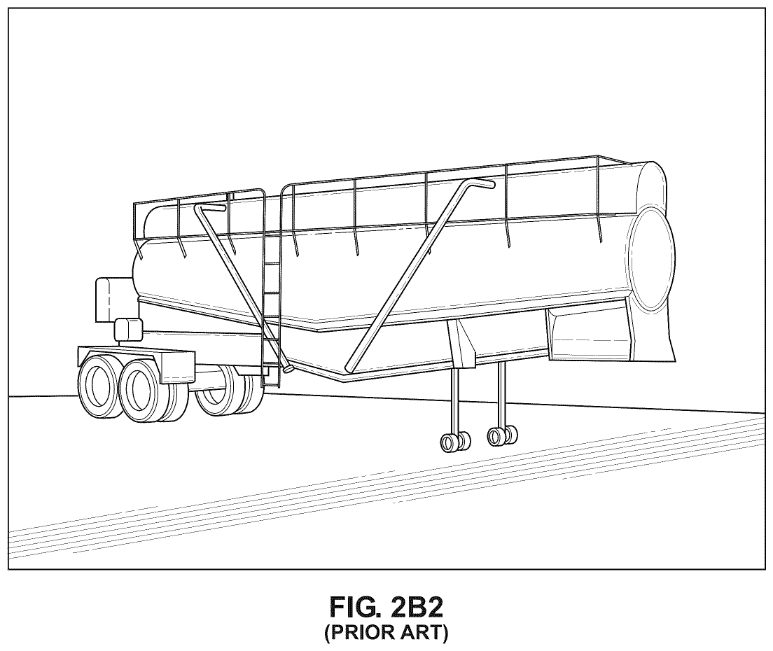

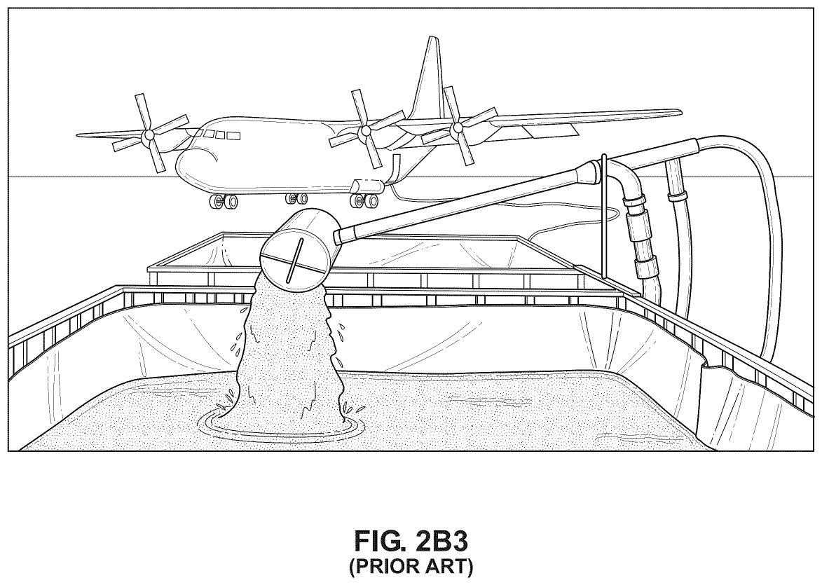

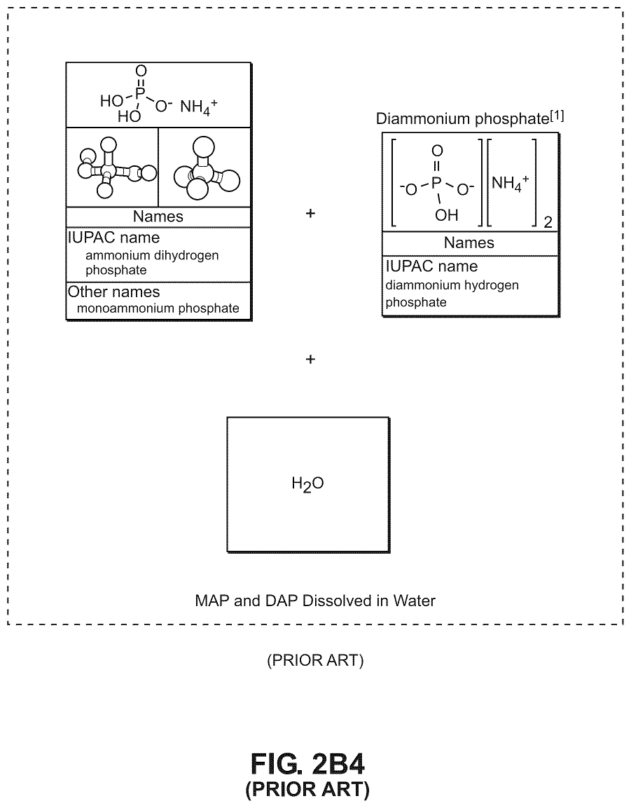

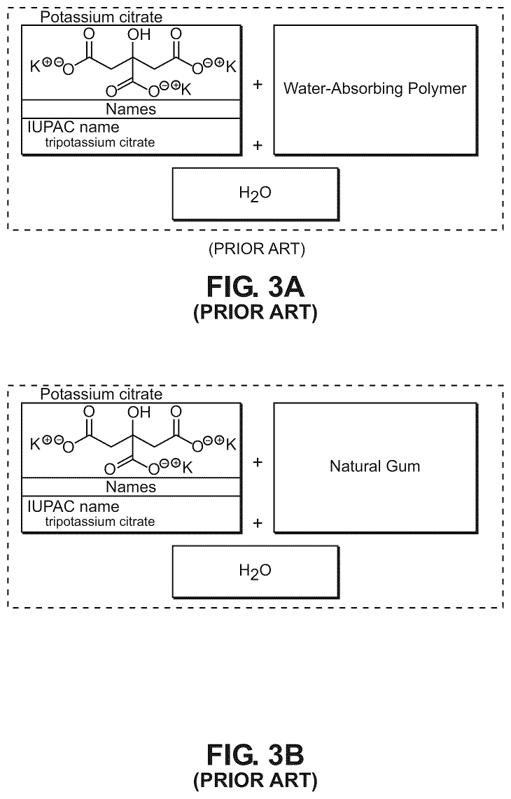

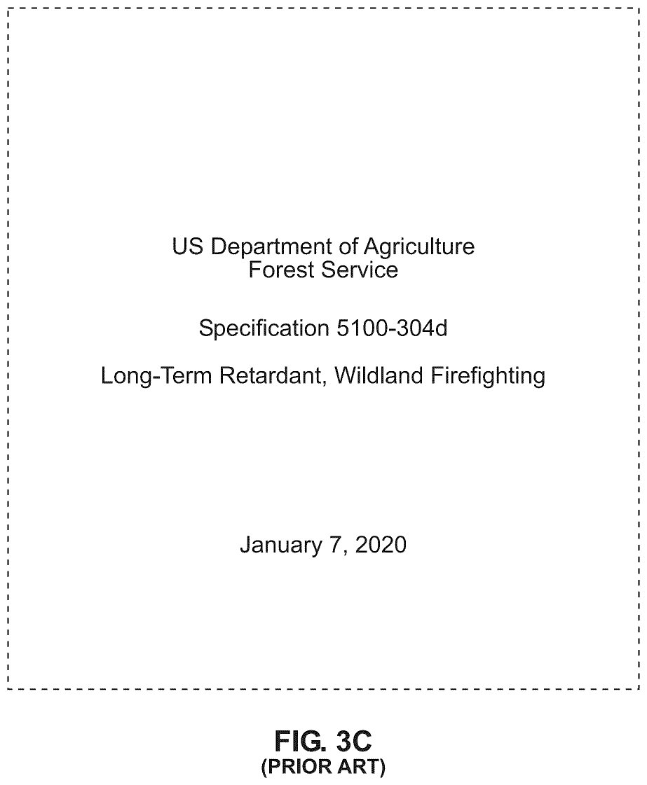

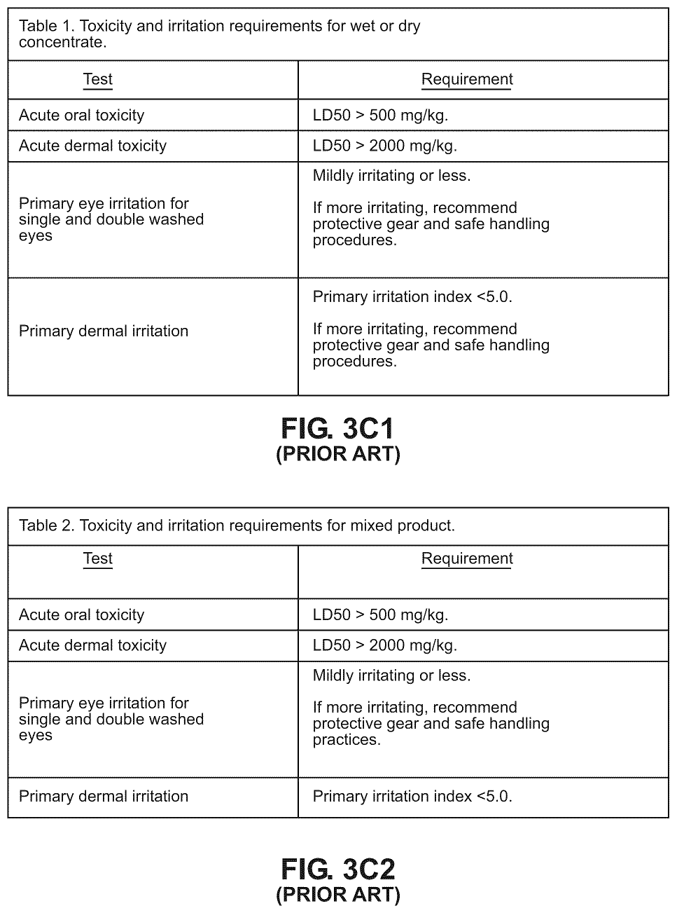

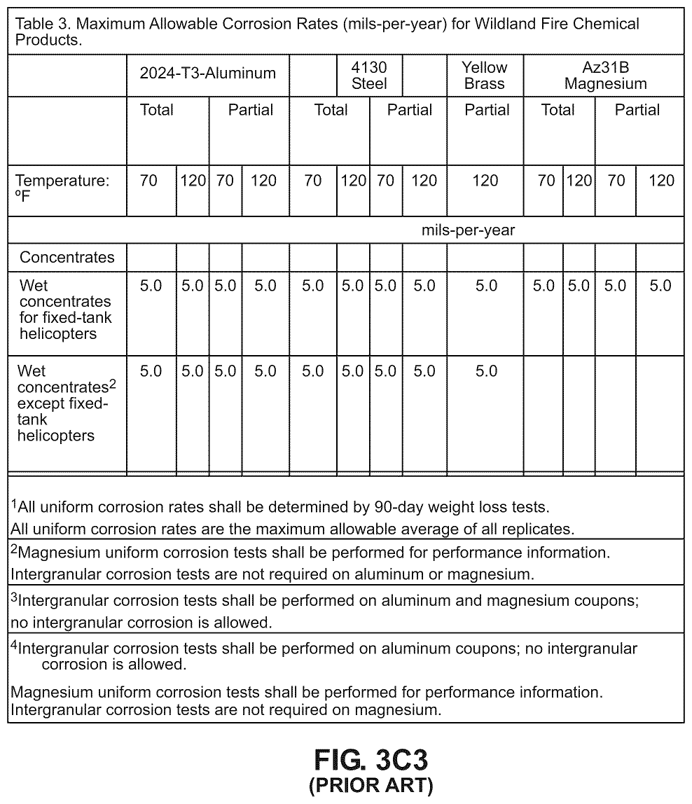

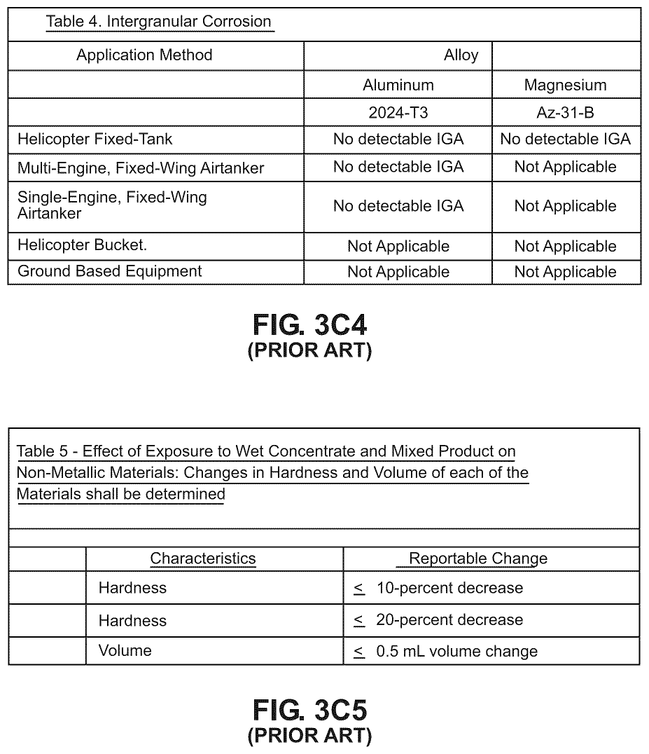

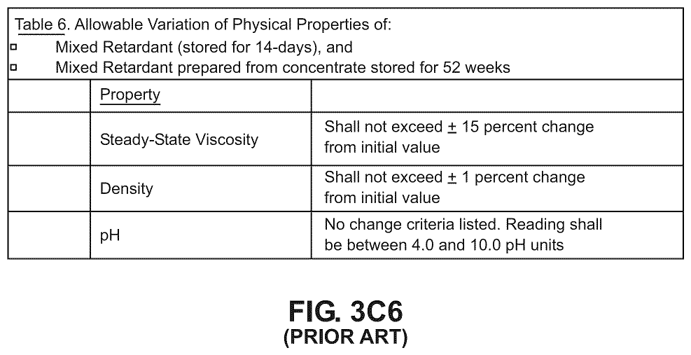

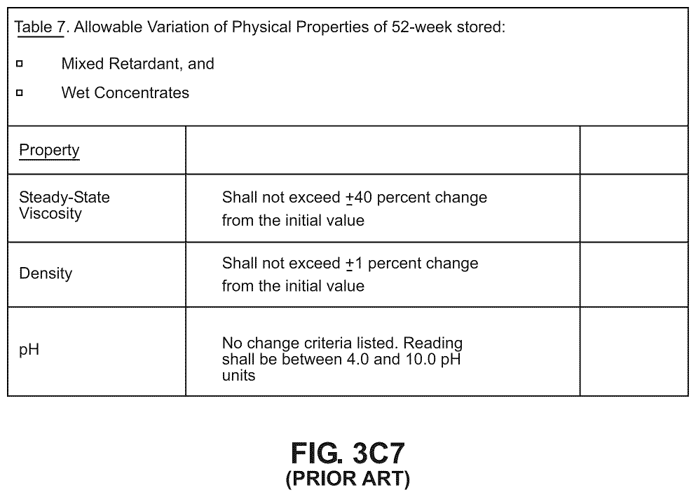

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

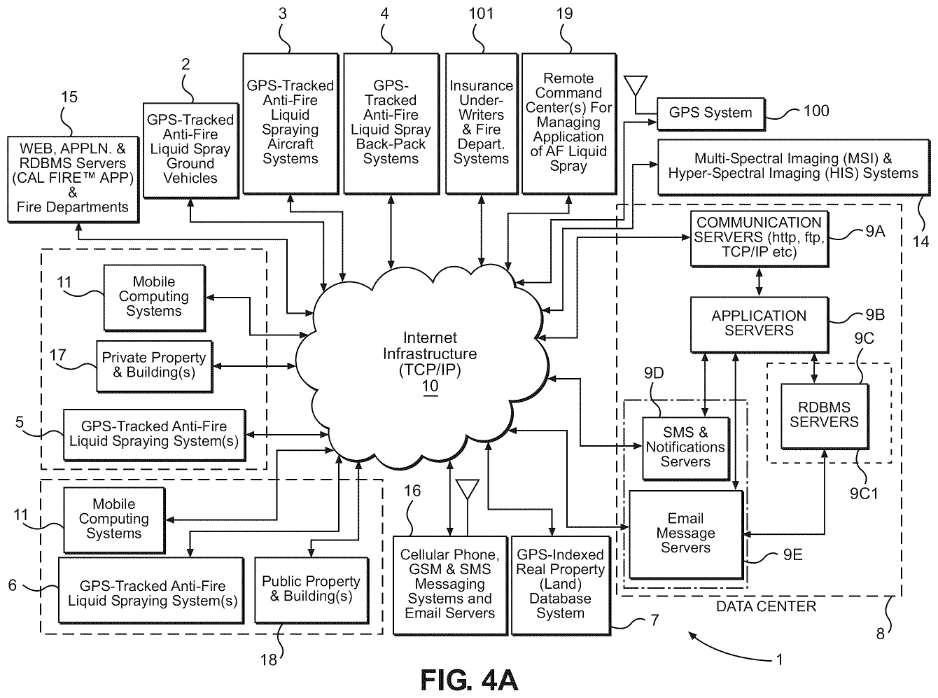

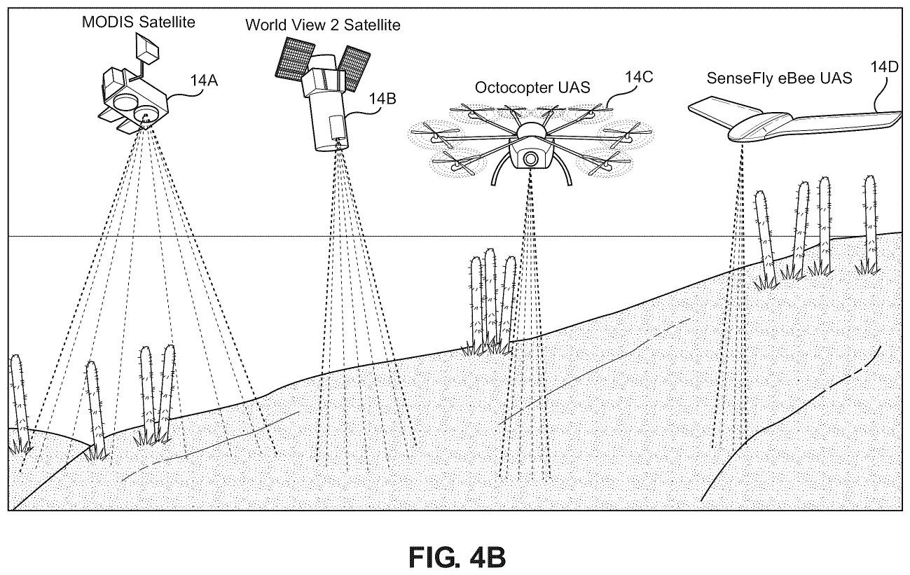

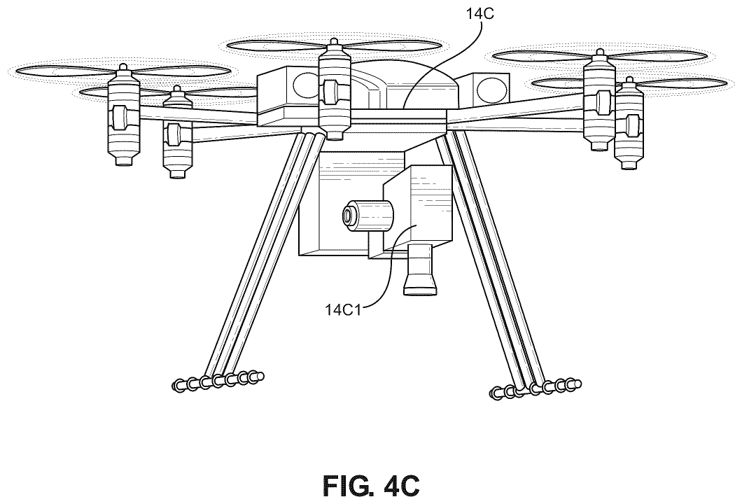

FIG. 4A shows the wireless system network of the present invention 1 designed for managing the supply, delivery, and application of environmentally-clean fire retardant biochemical liquid composition of the present invention, on private and public property to reduce the risks of damage and/or destruction caused by wild fires.

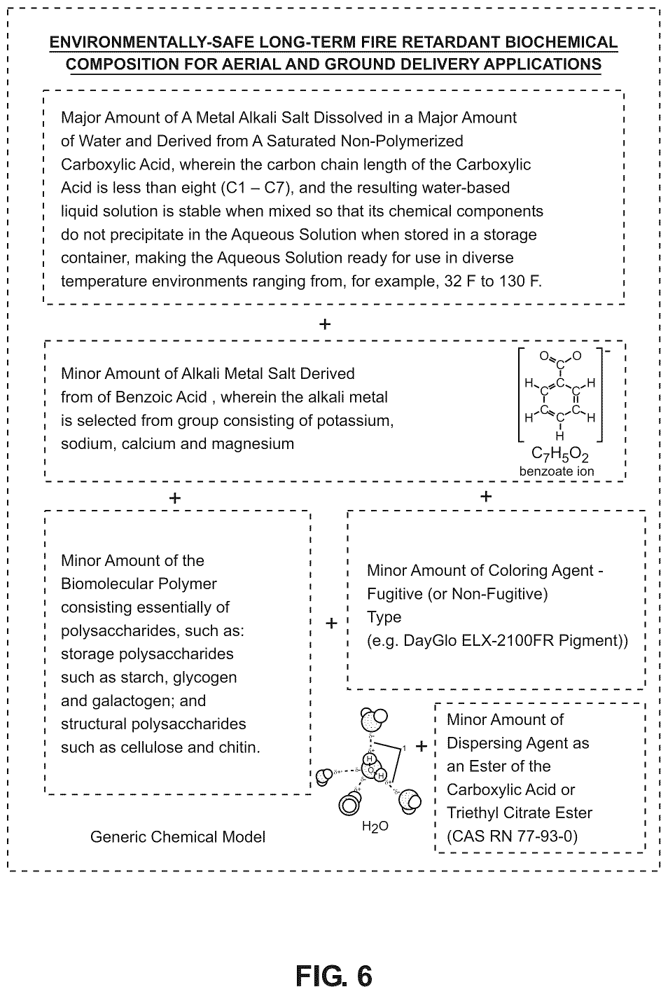

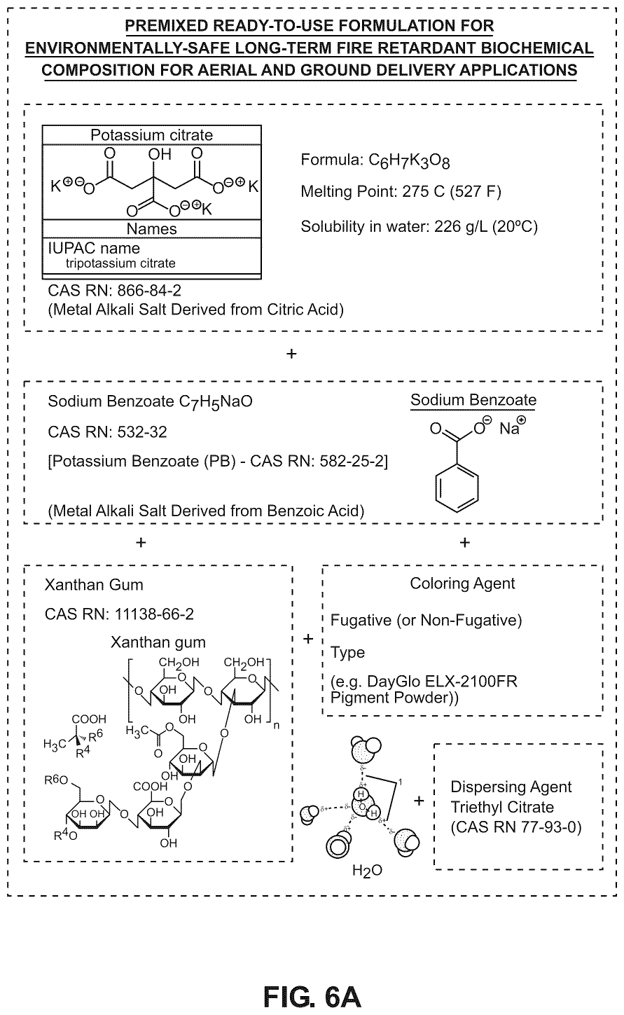

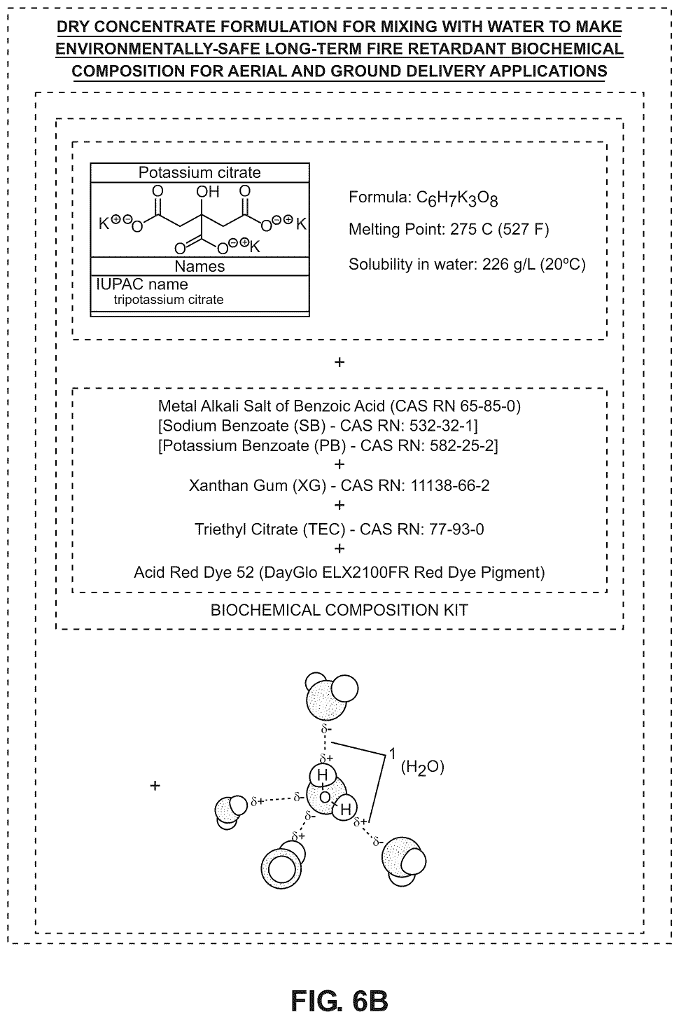

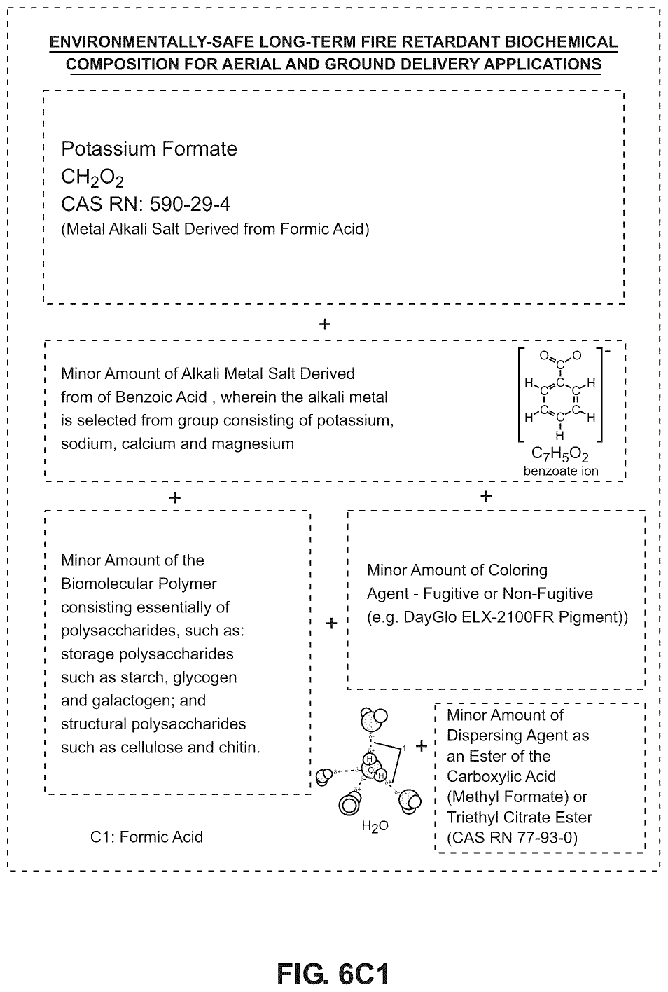

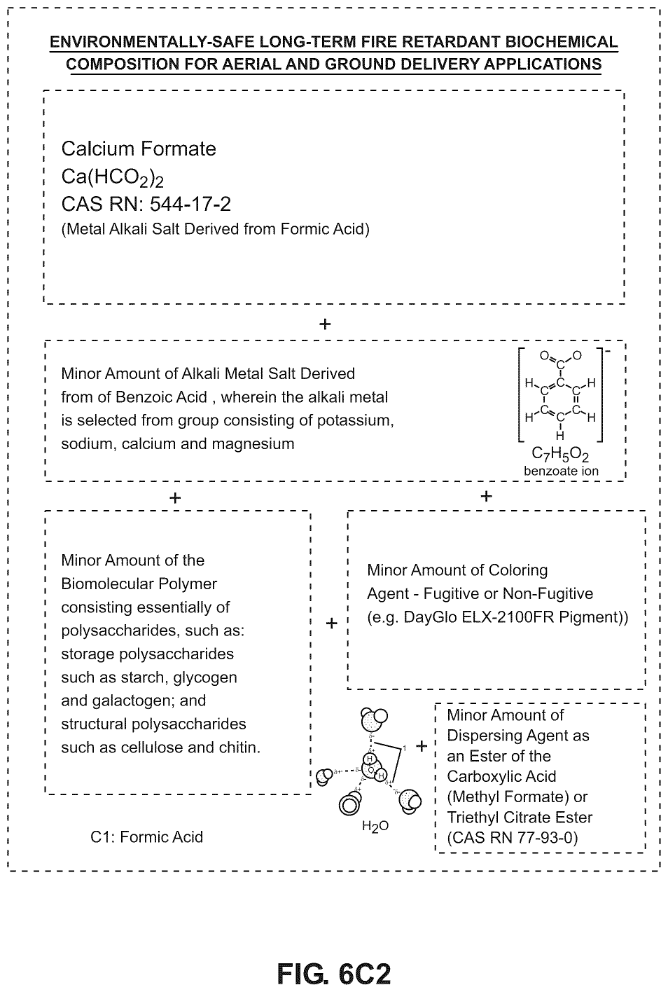

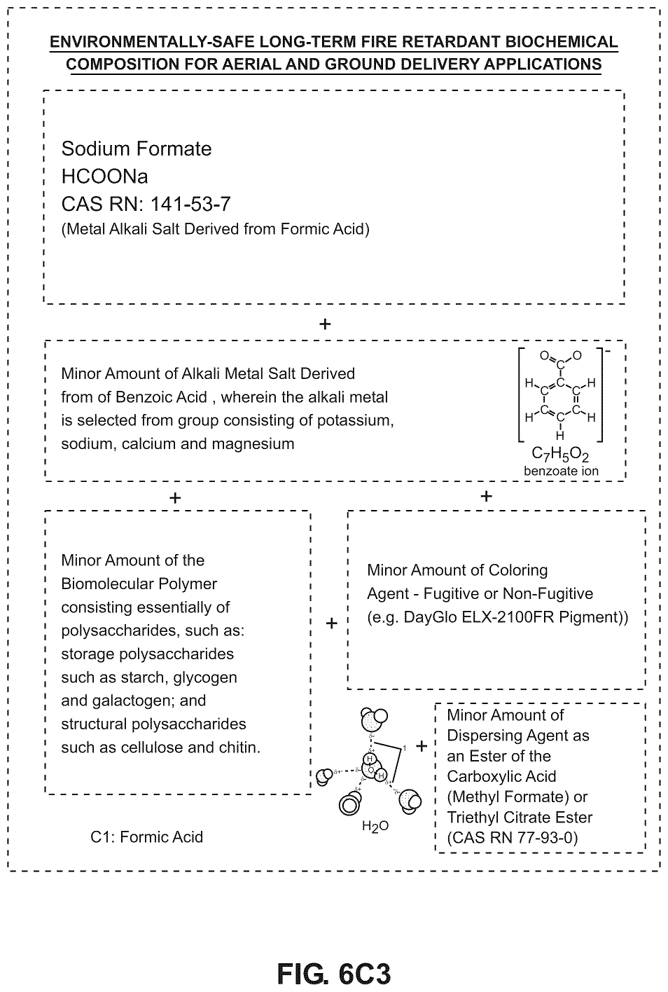

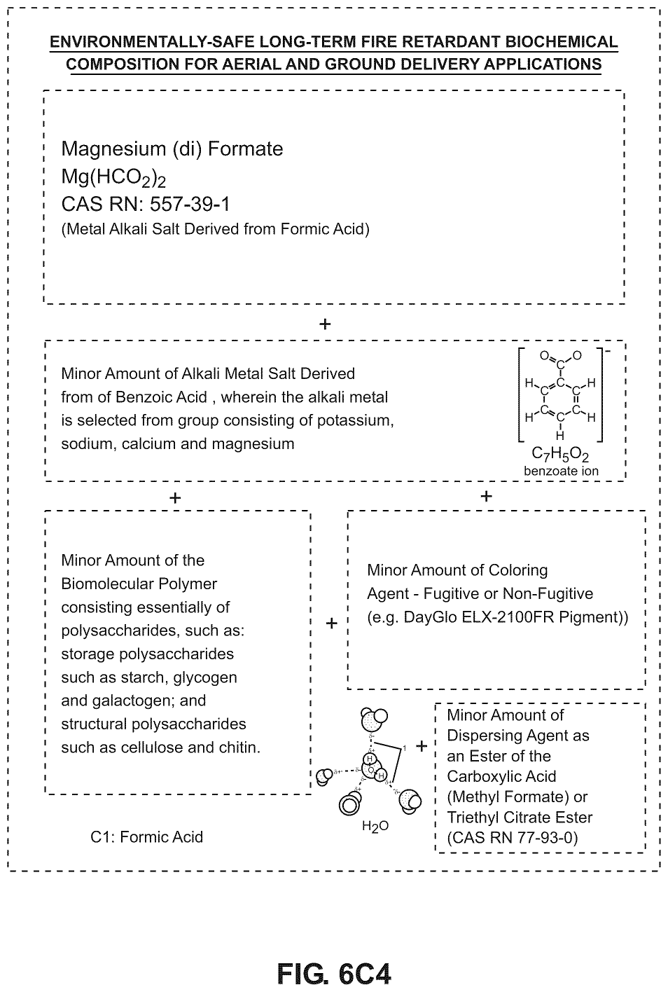

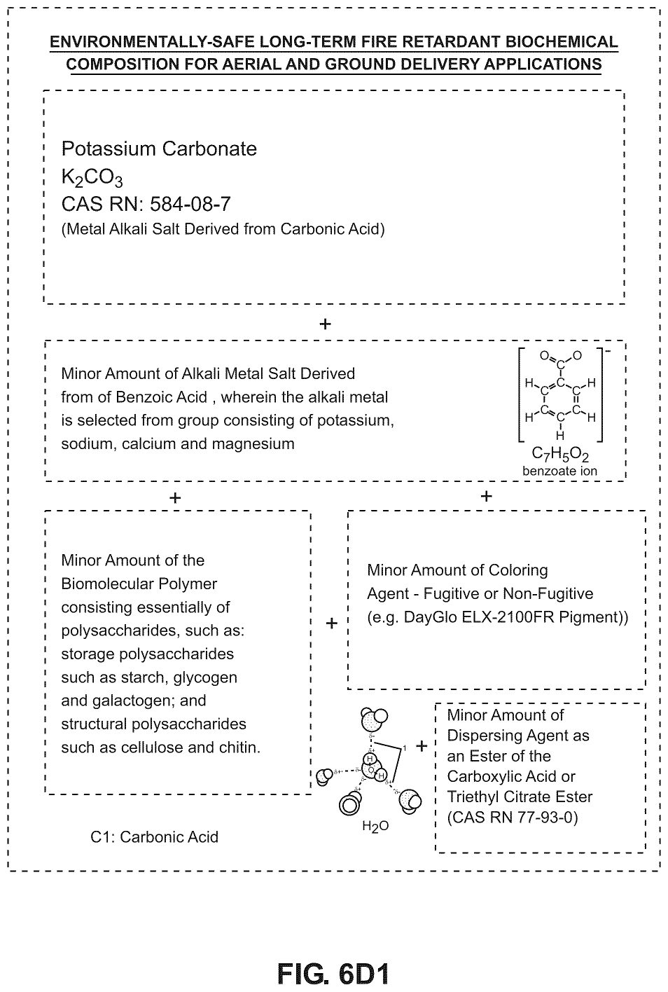

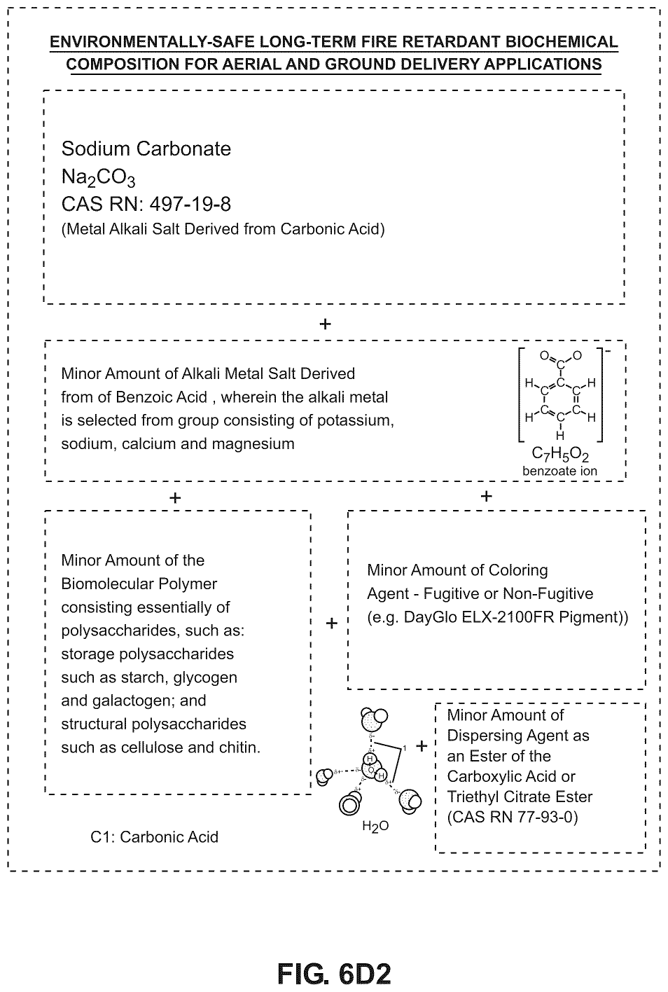

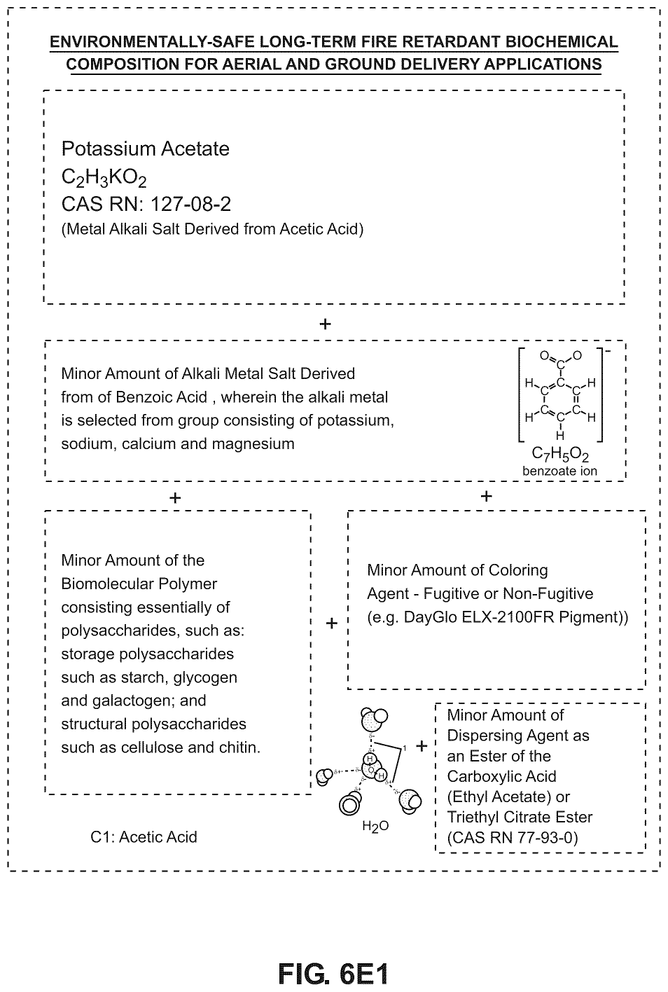

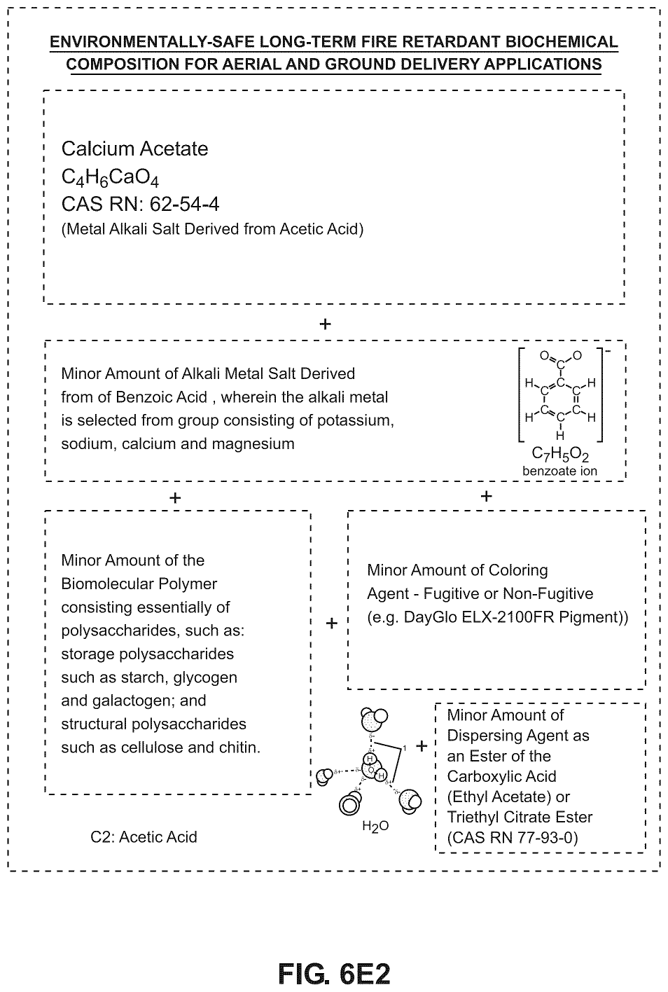

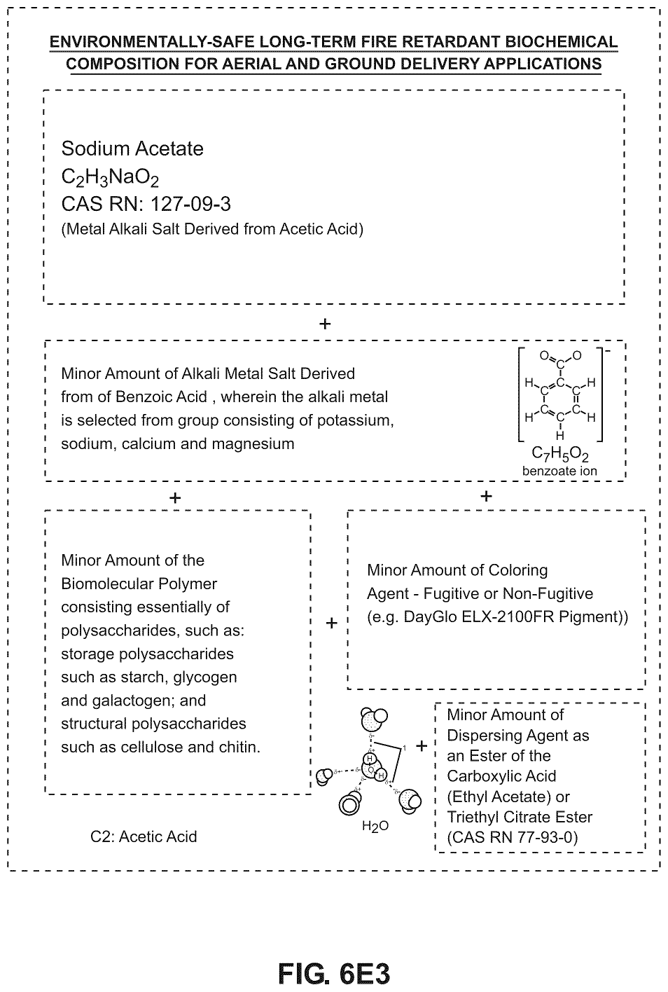

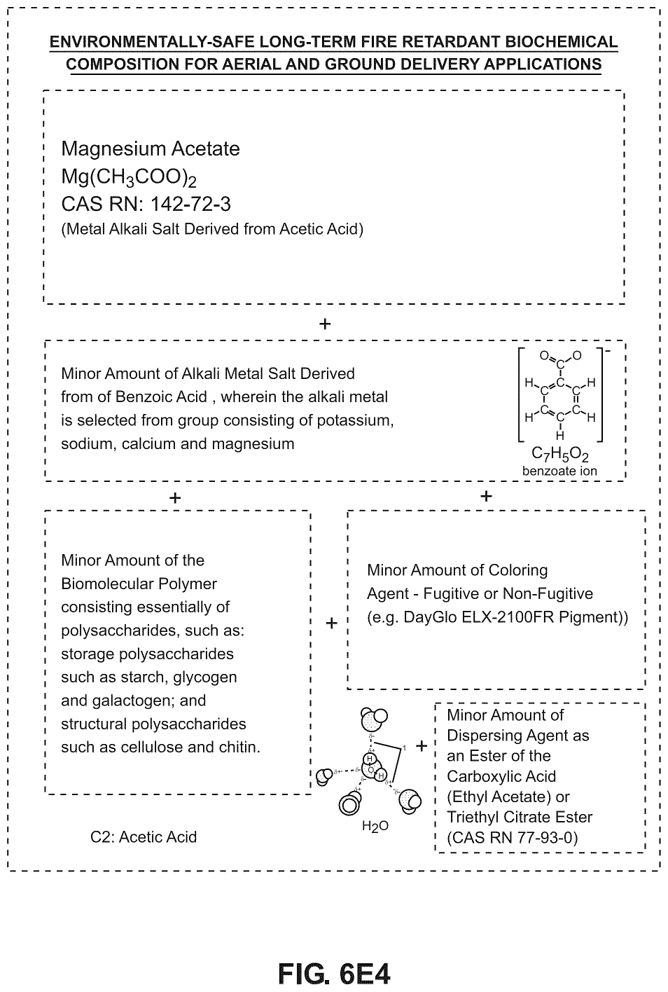

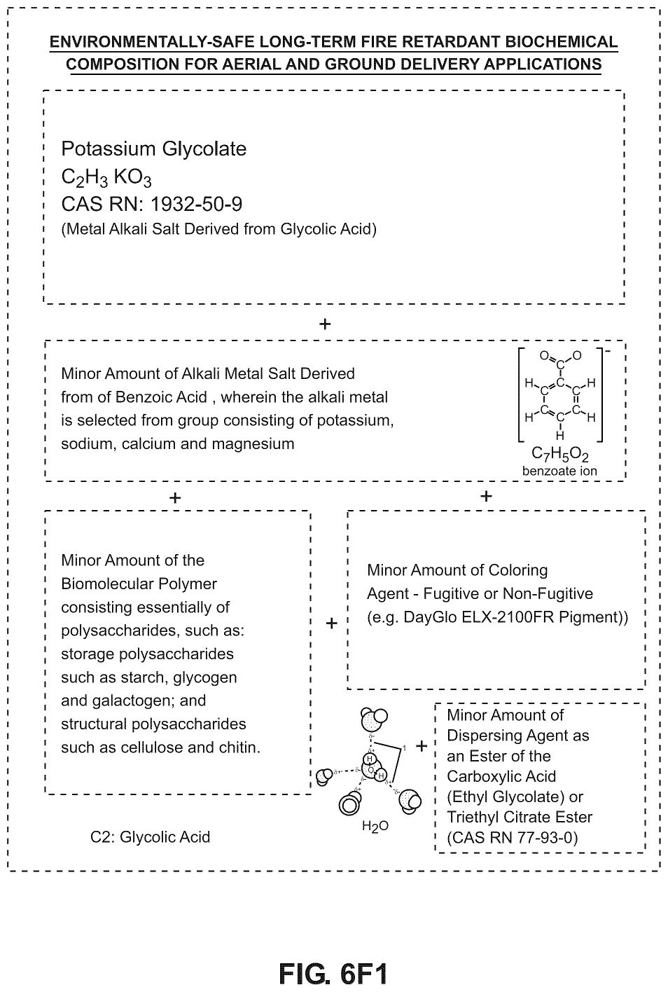

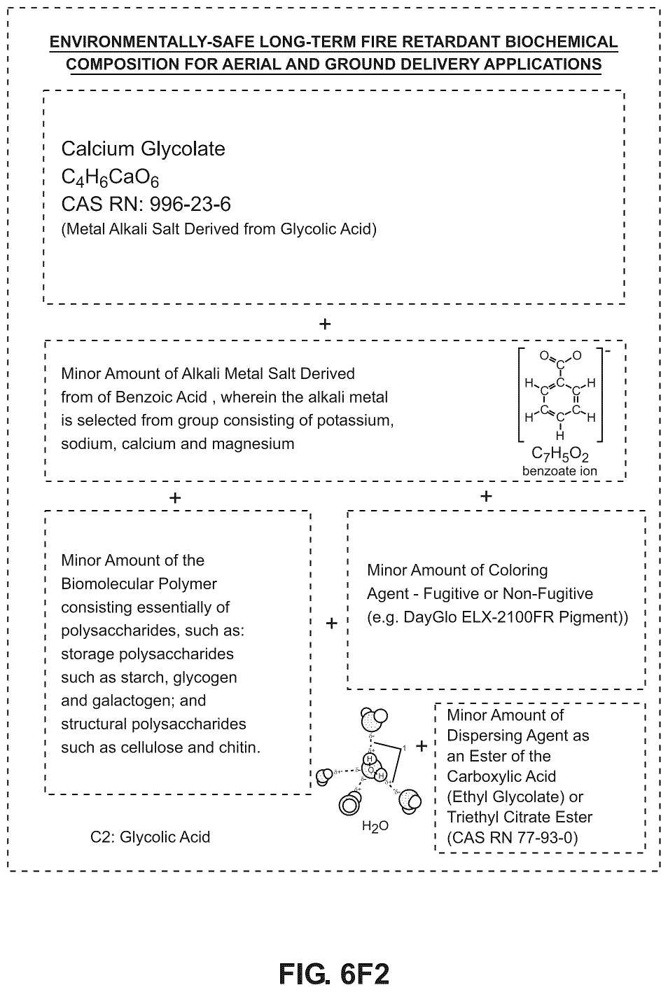

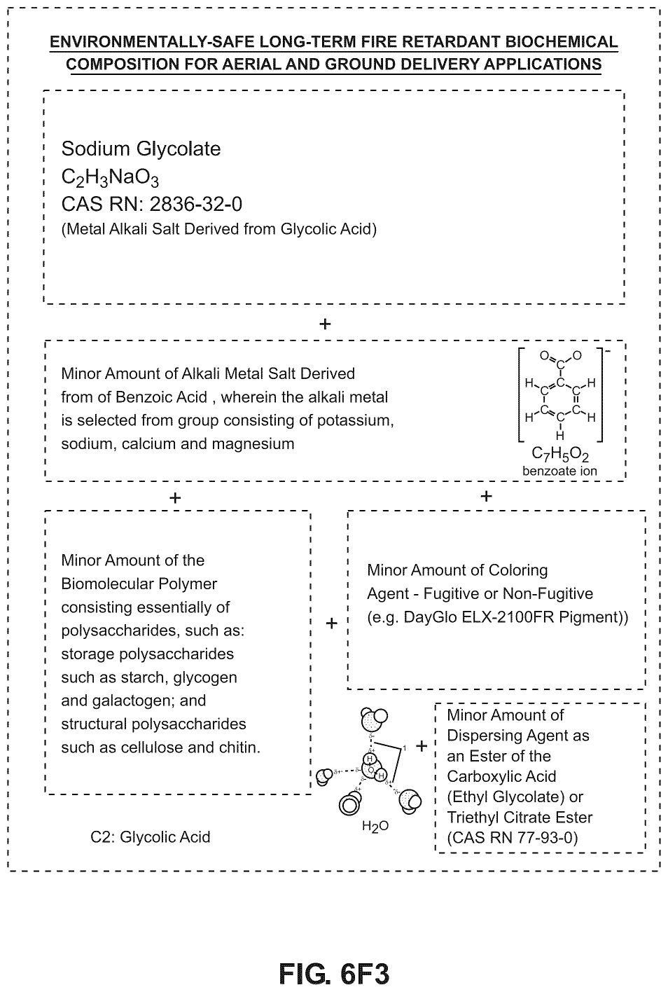

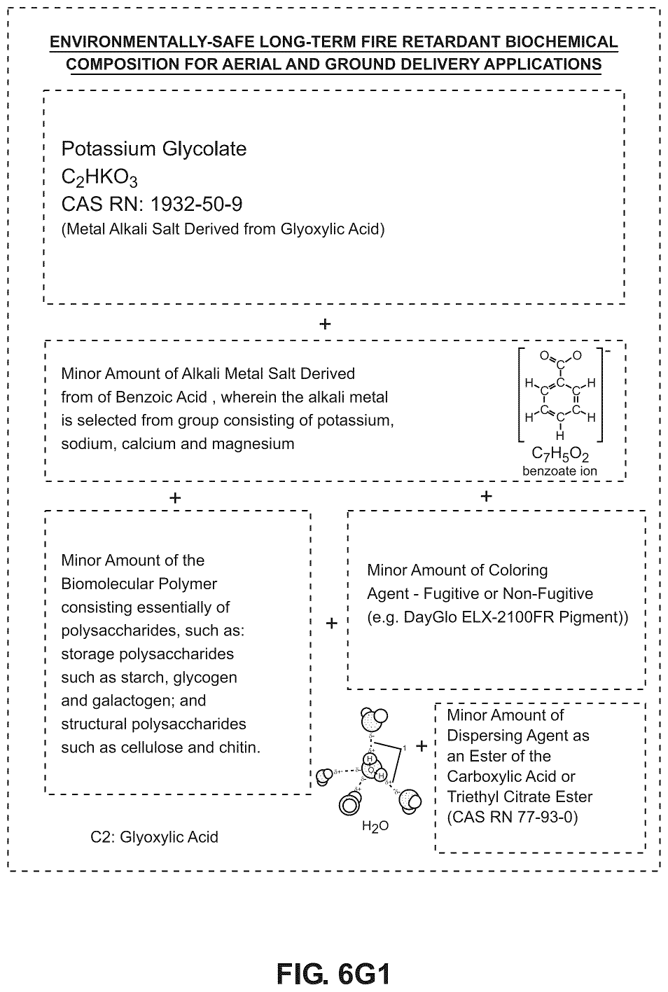

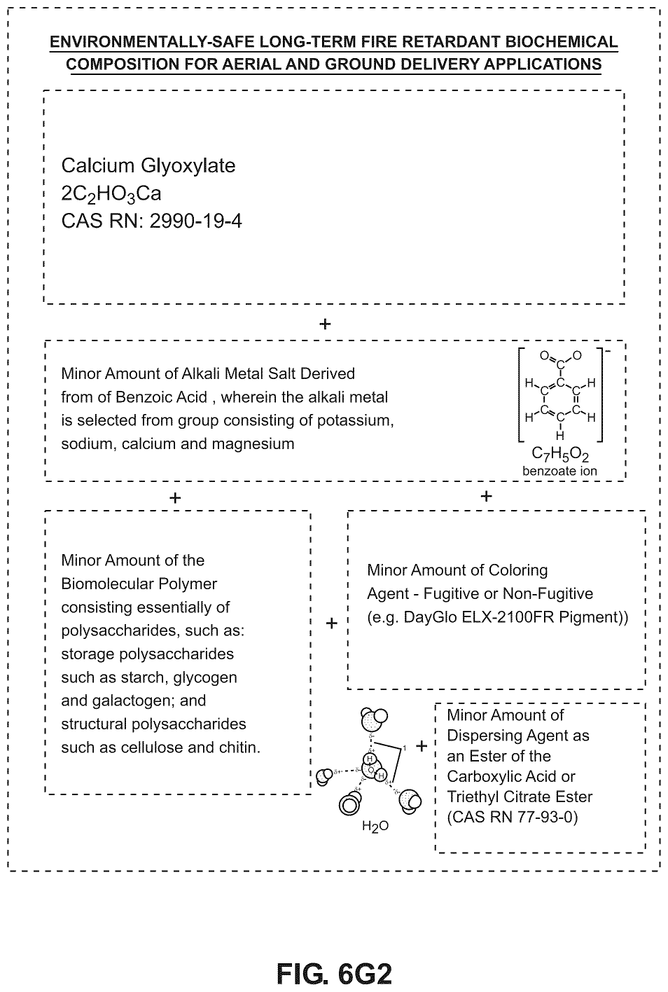

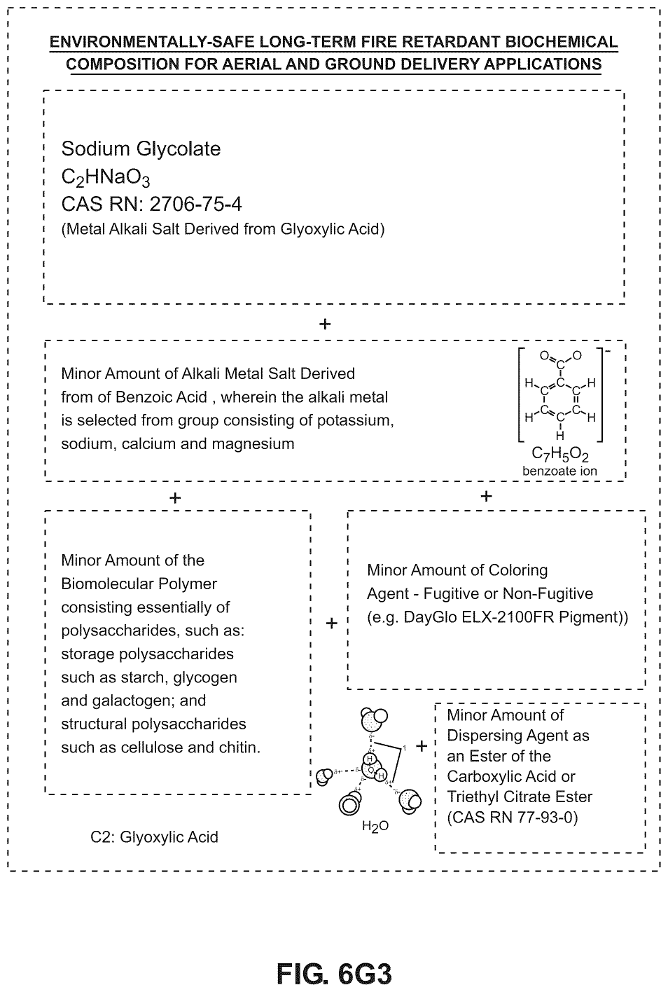

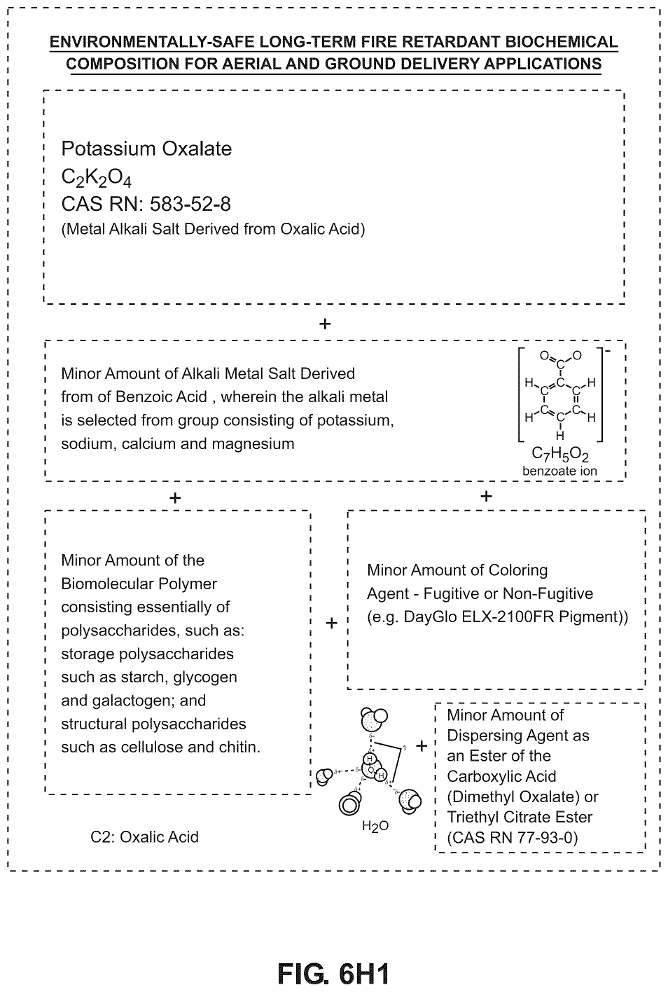

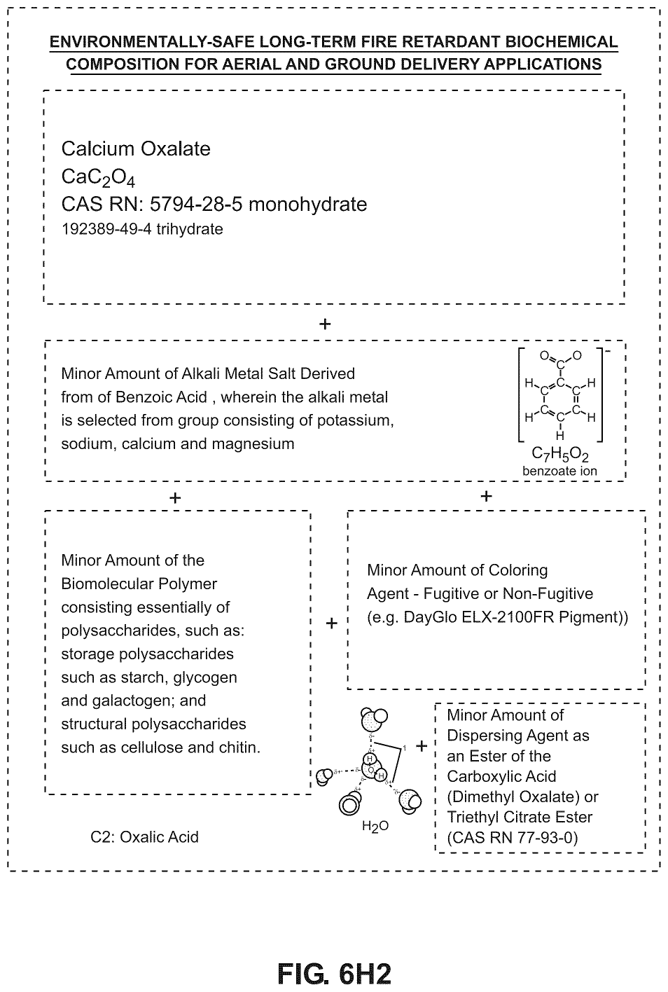

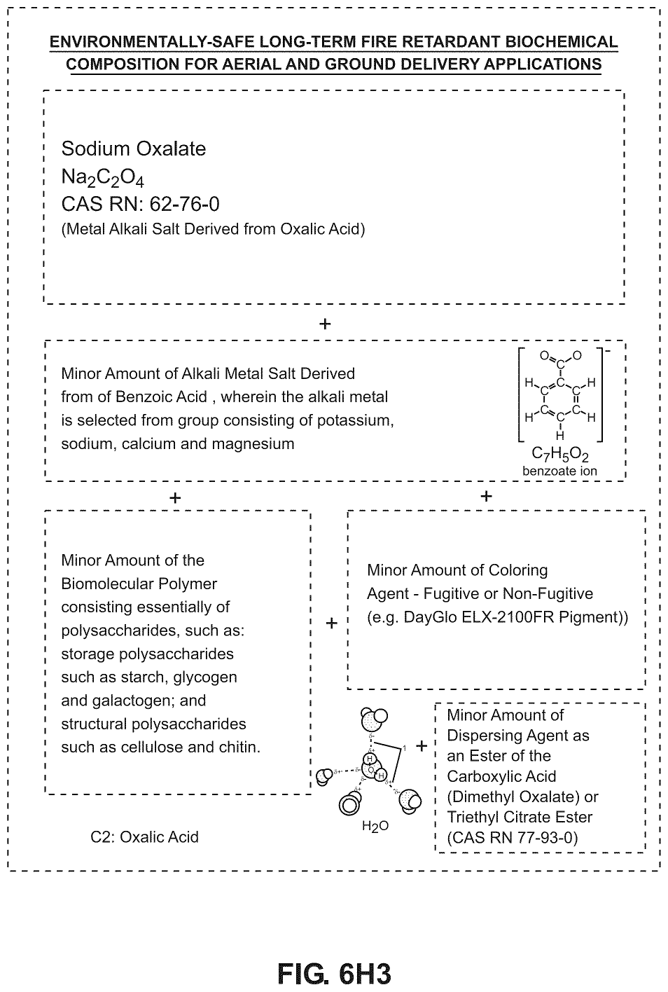

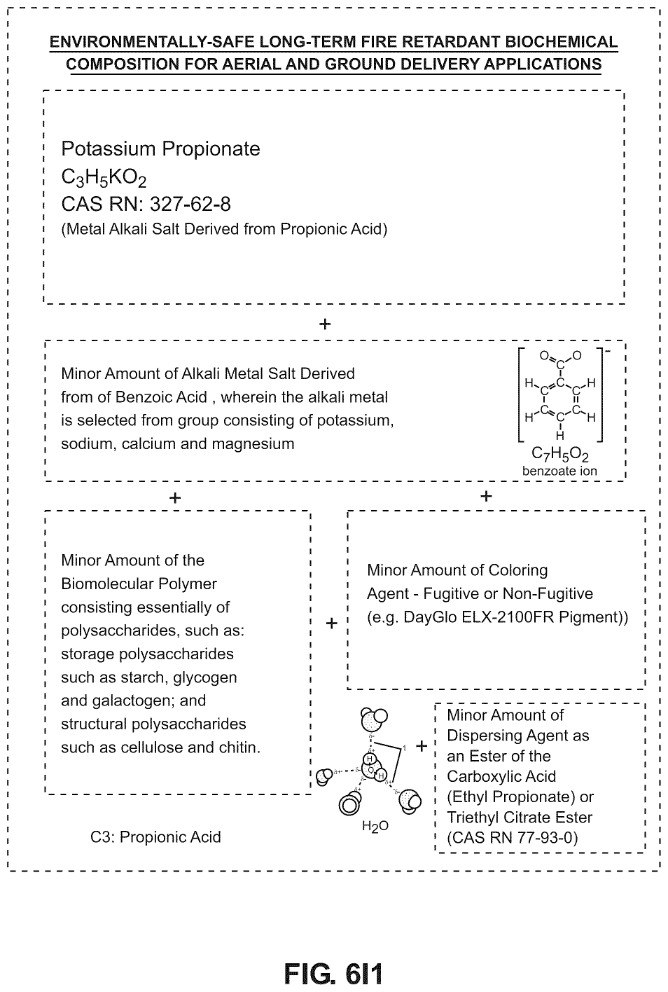

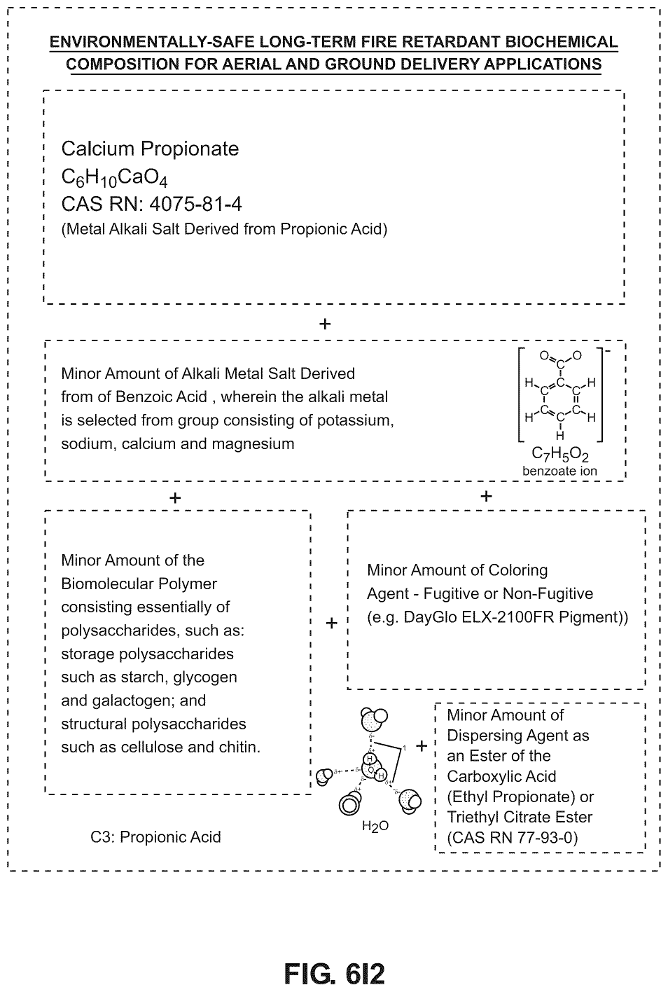

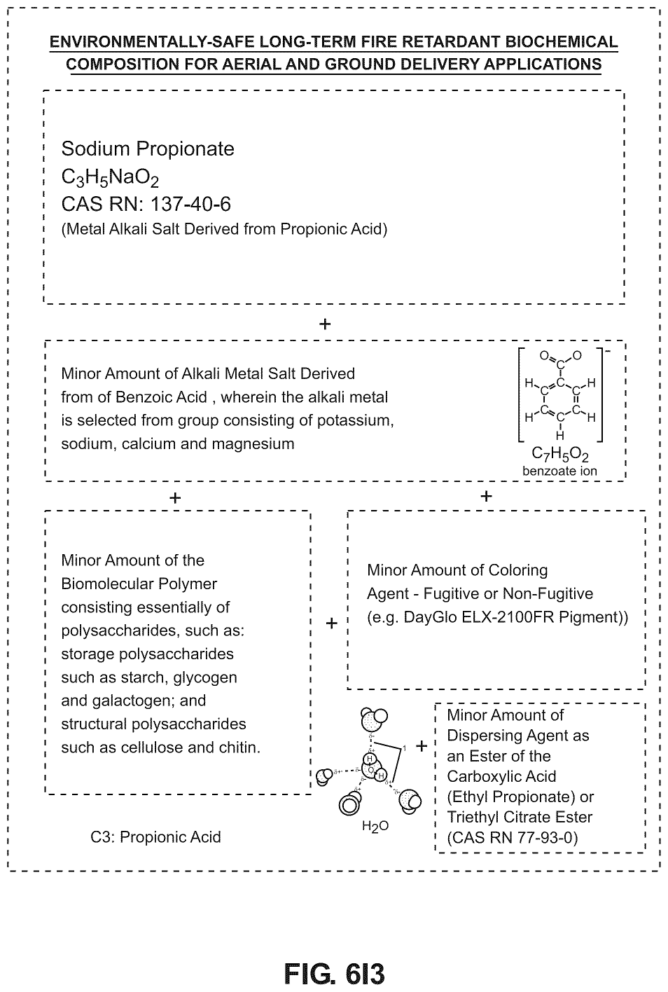

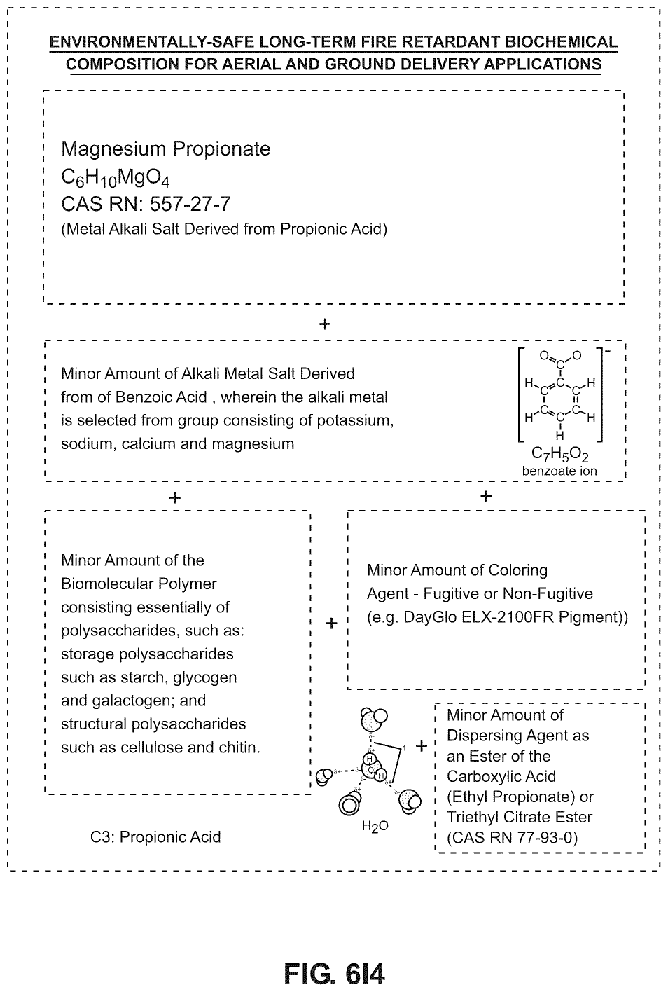

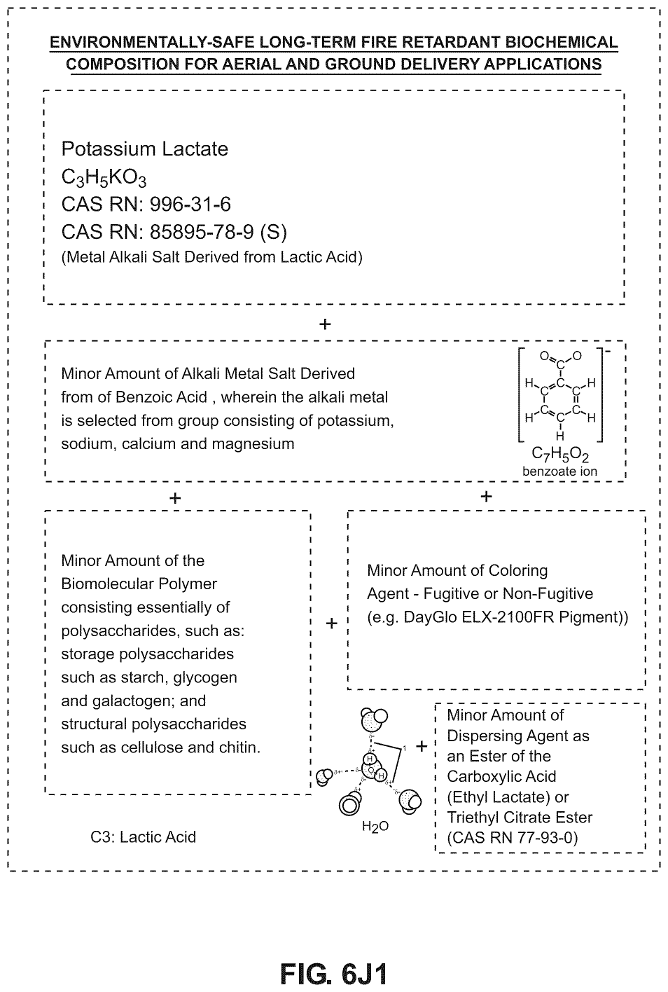

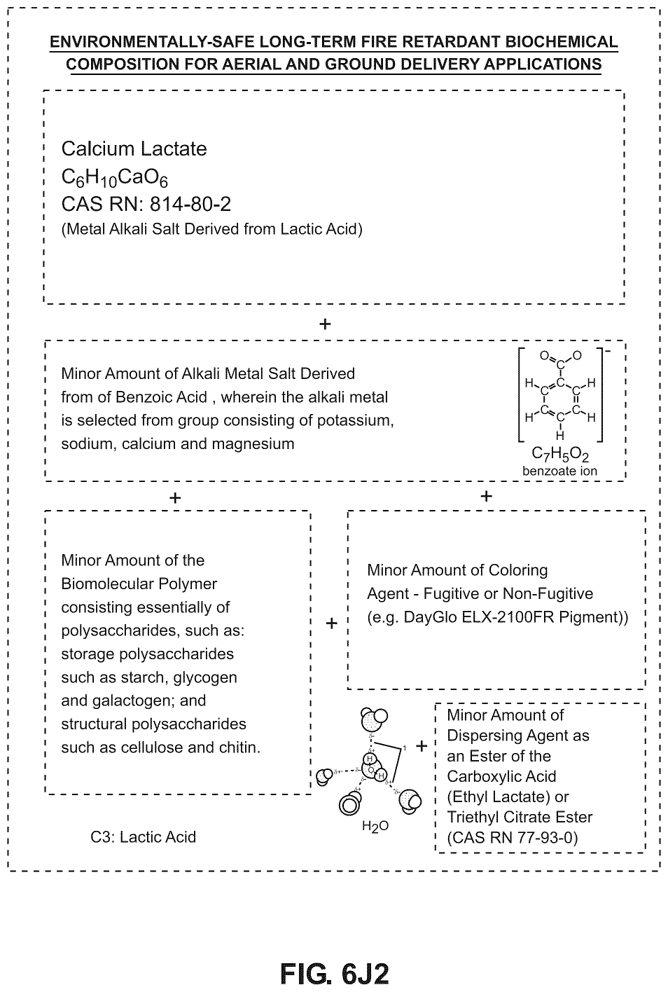

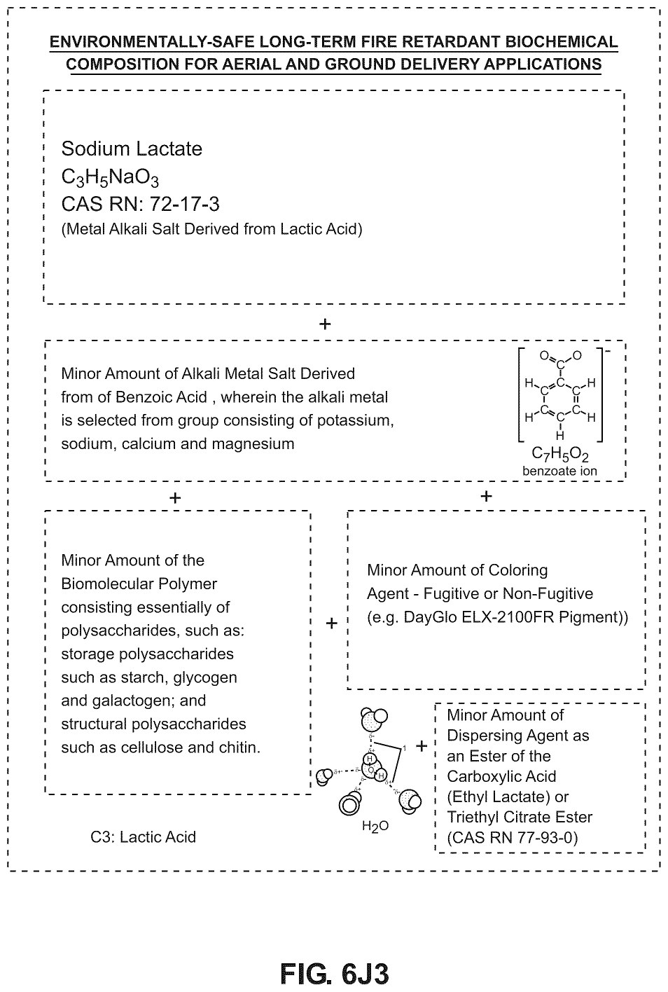

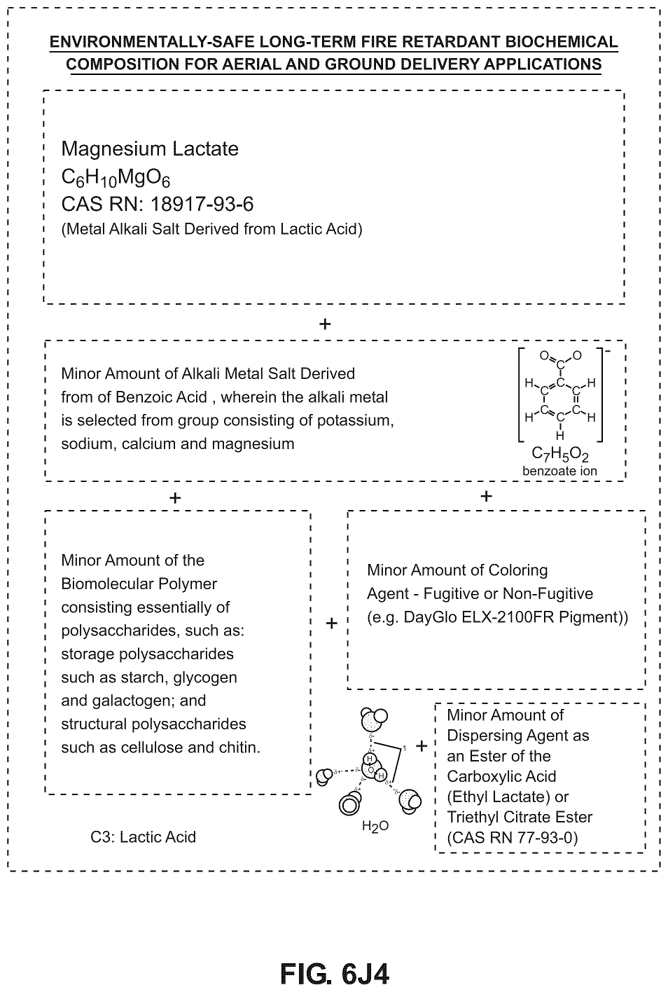

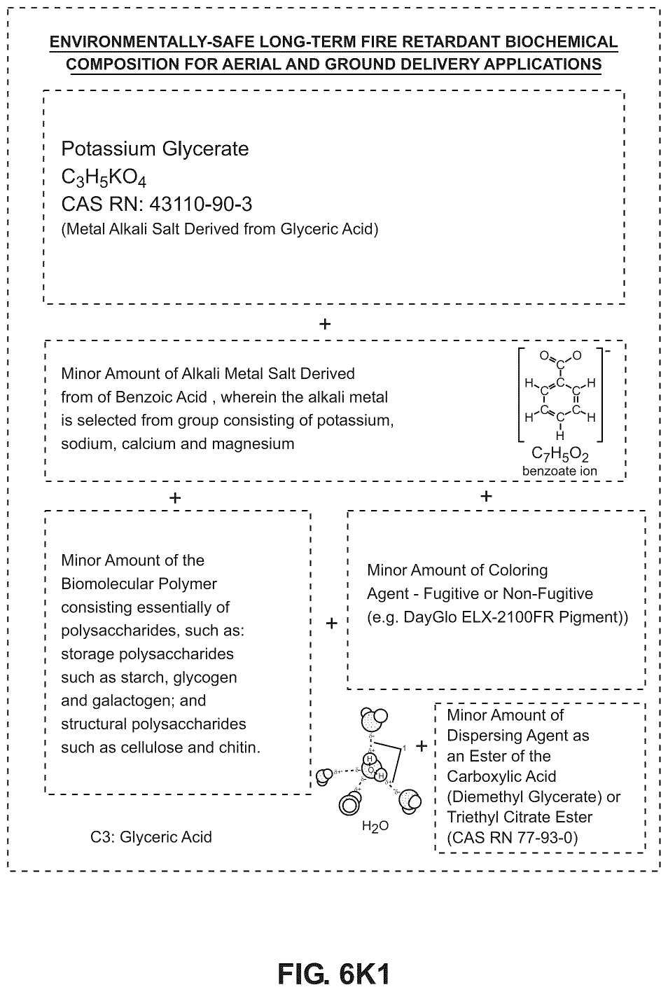

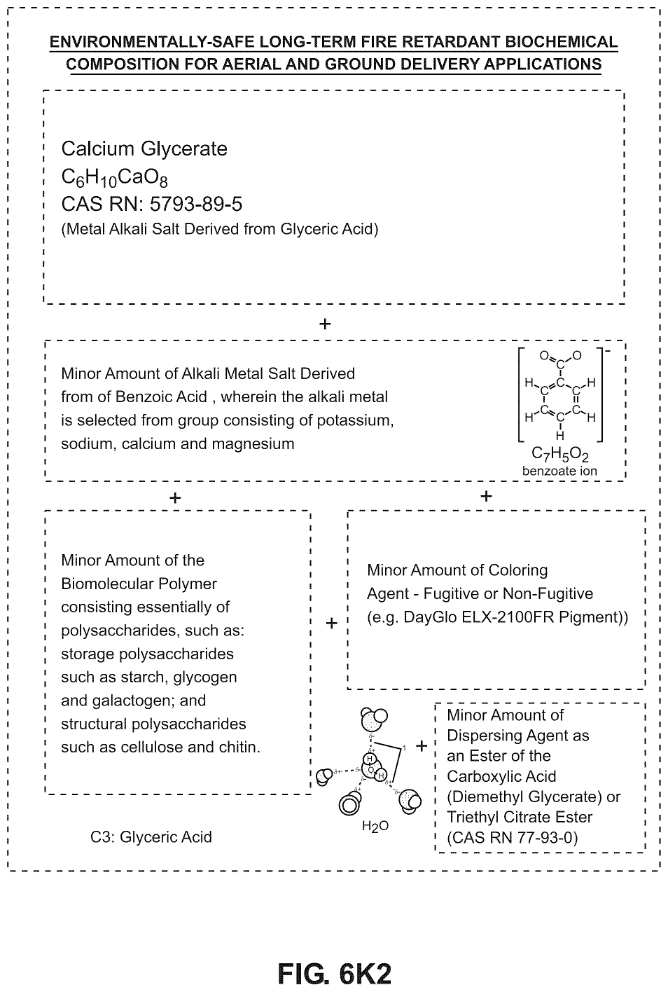

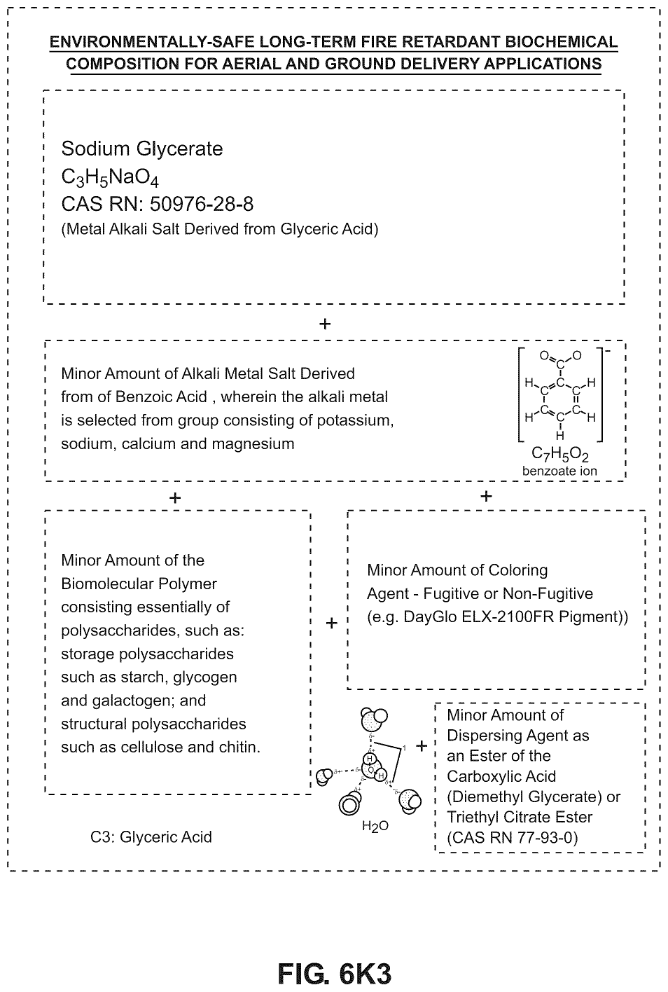

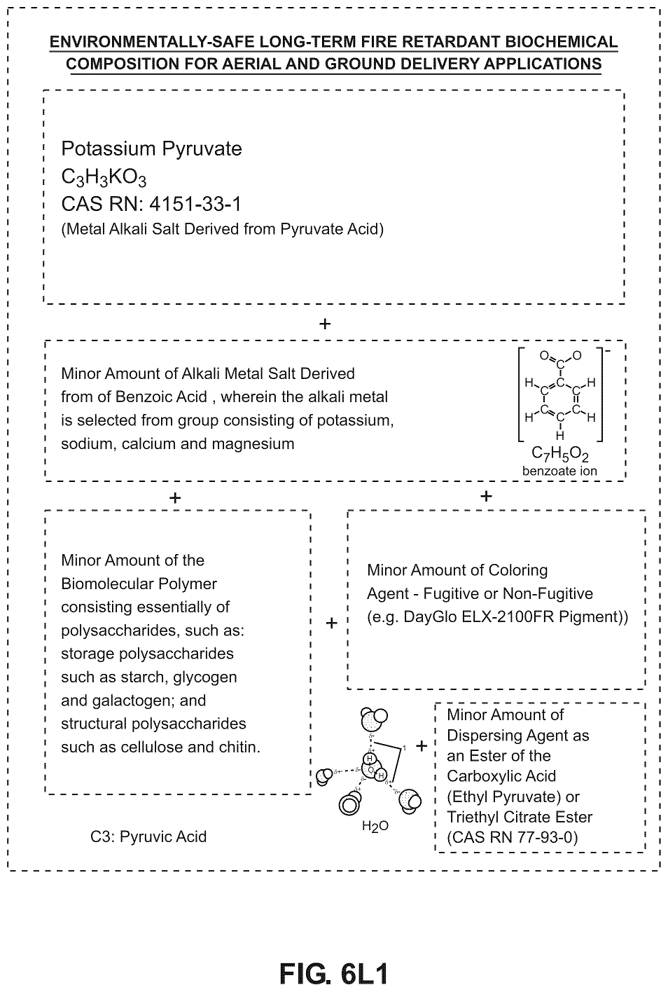

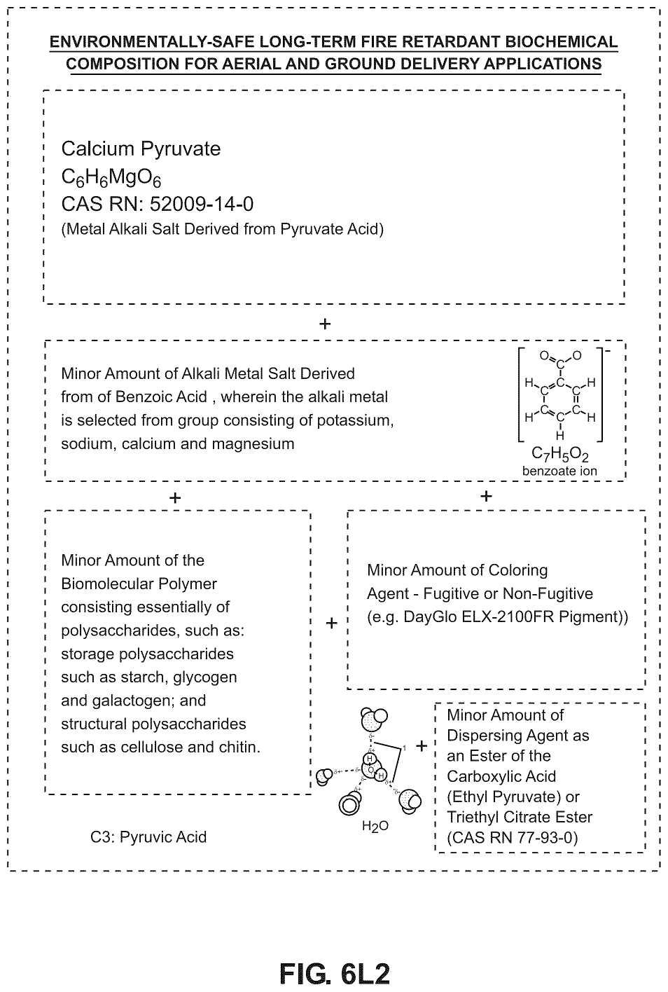

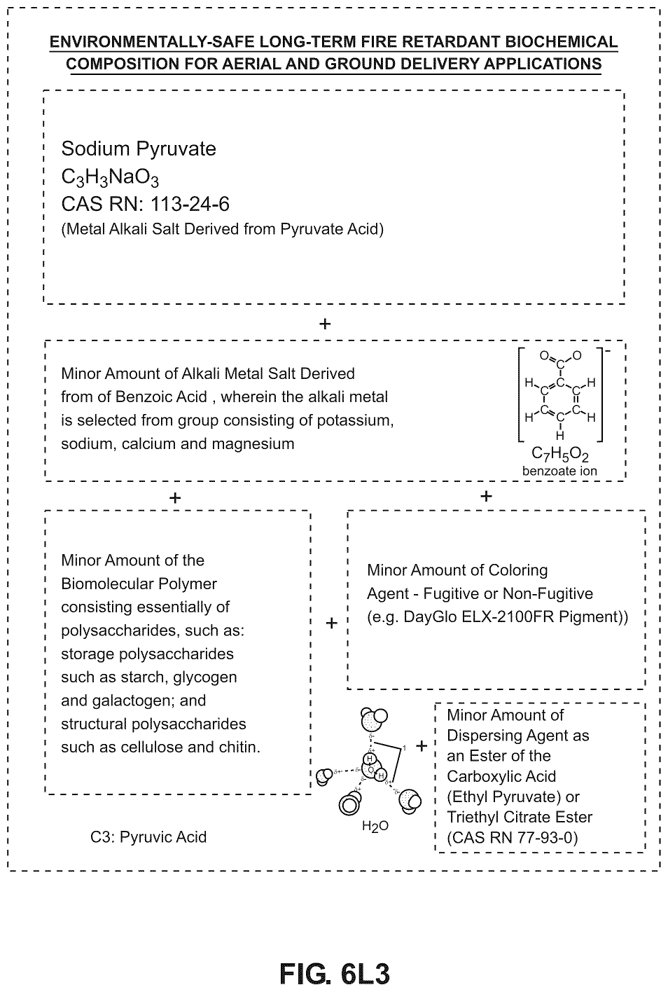

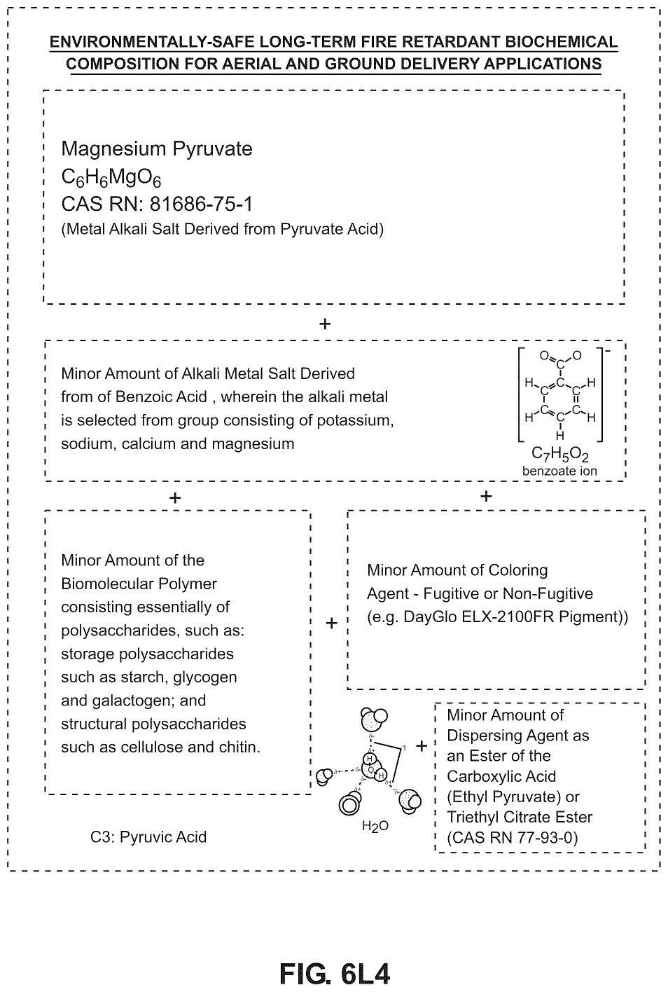

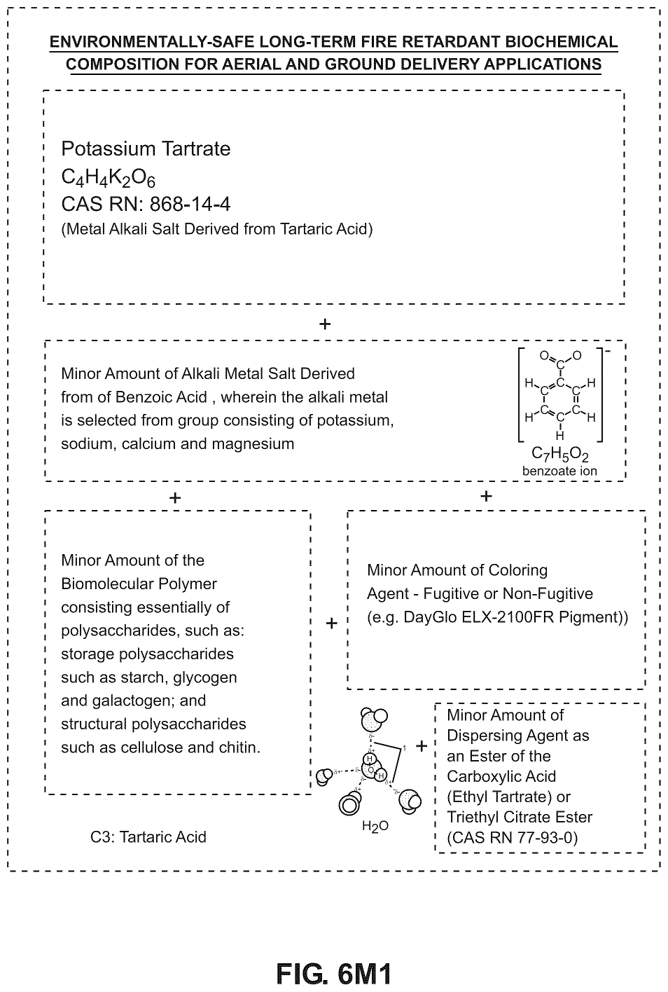

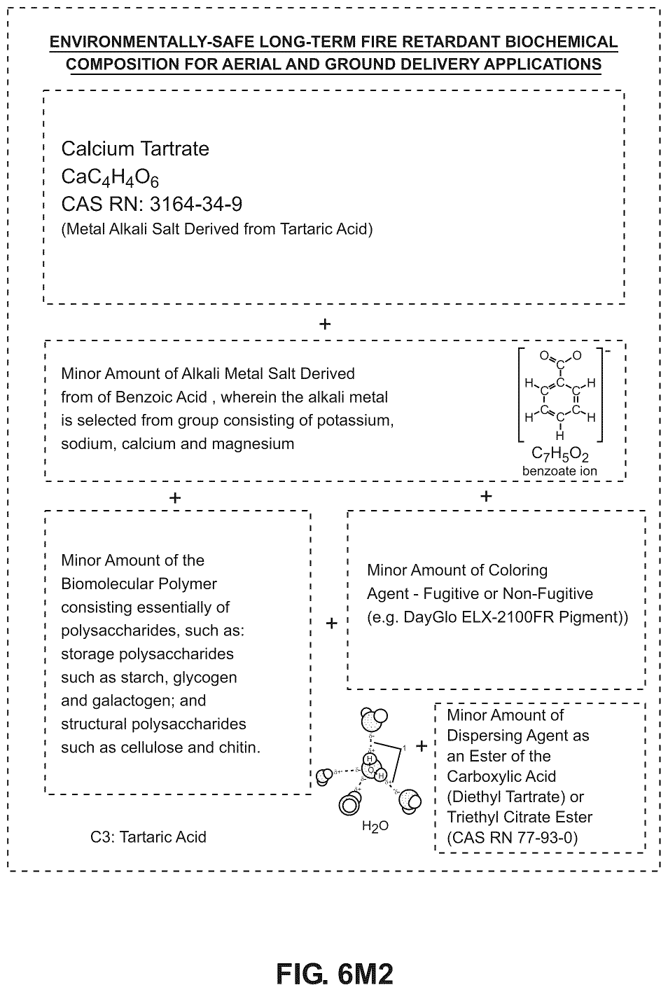

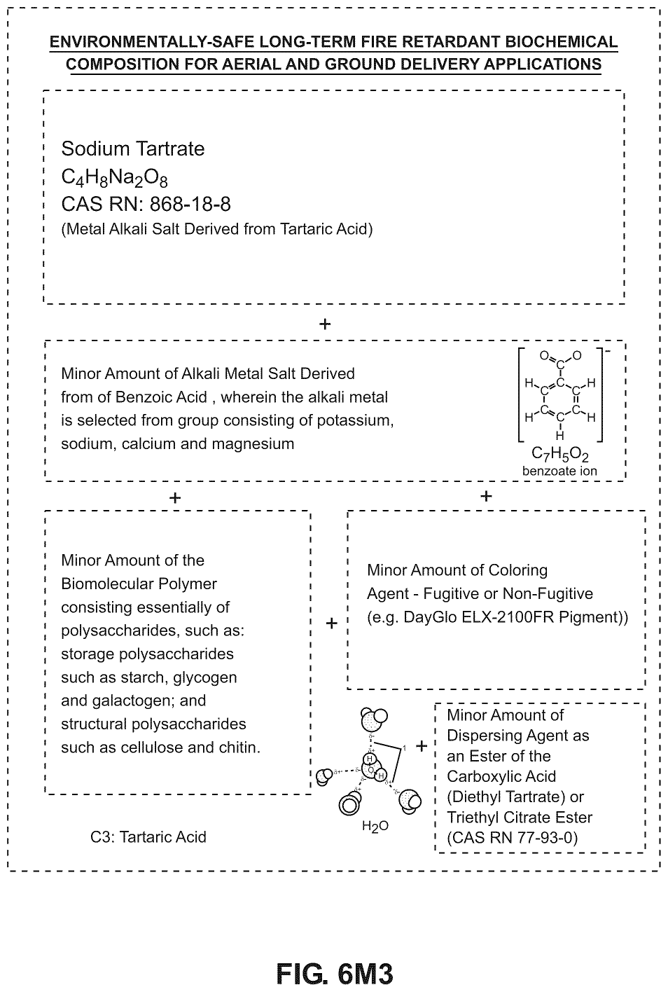

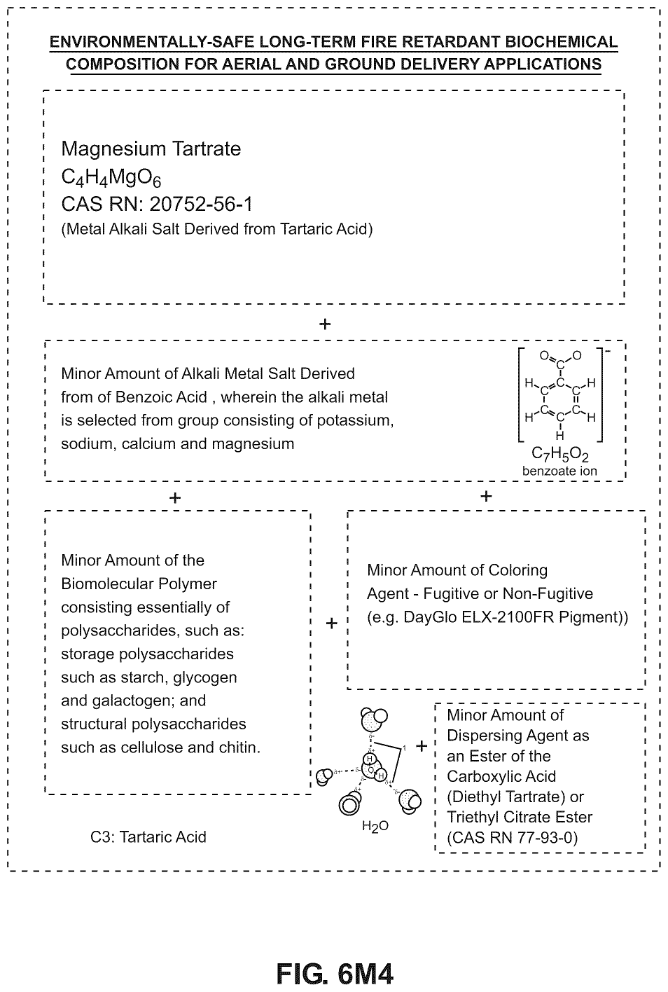

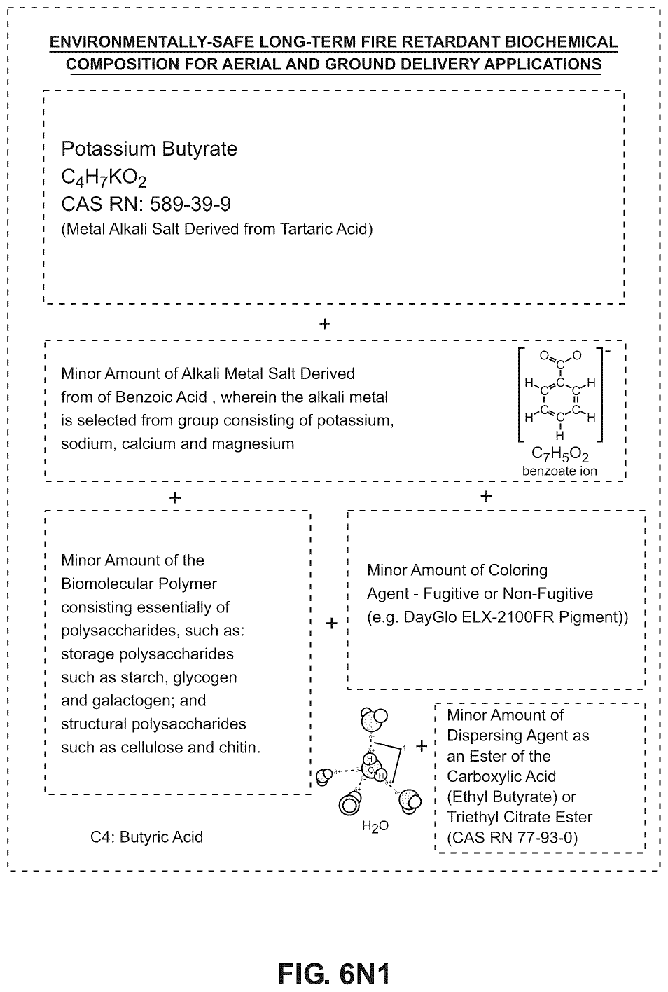

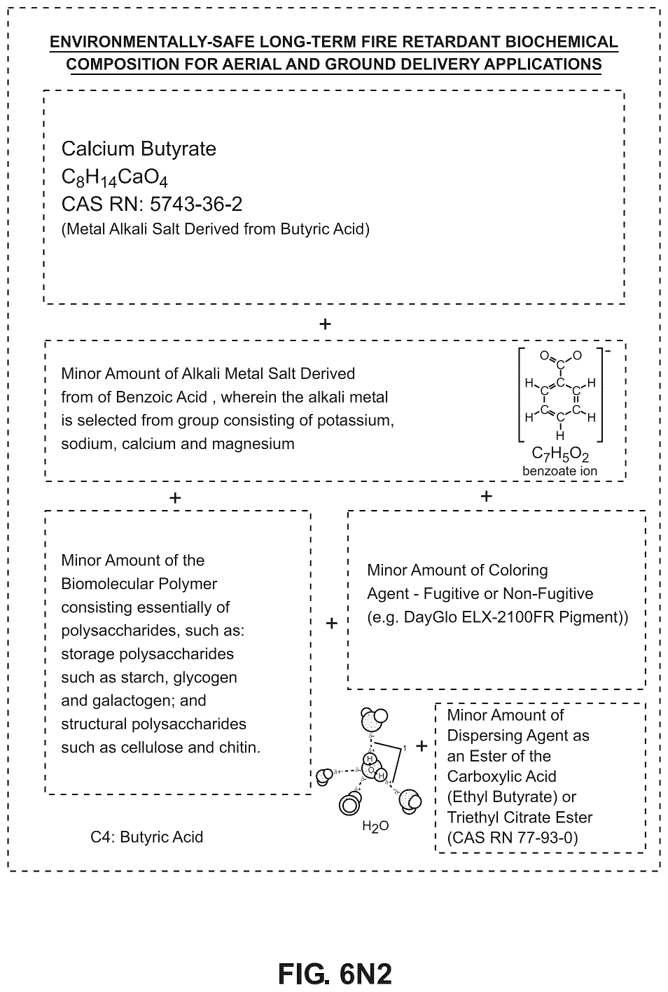

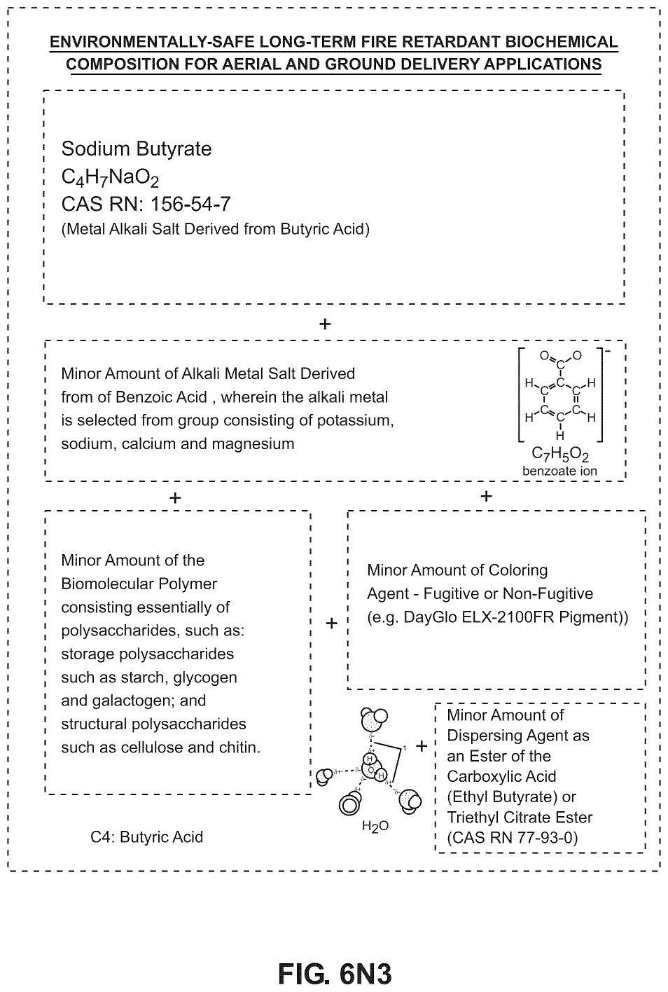

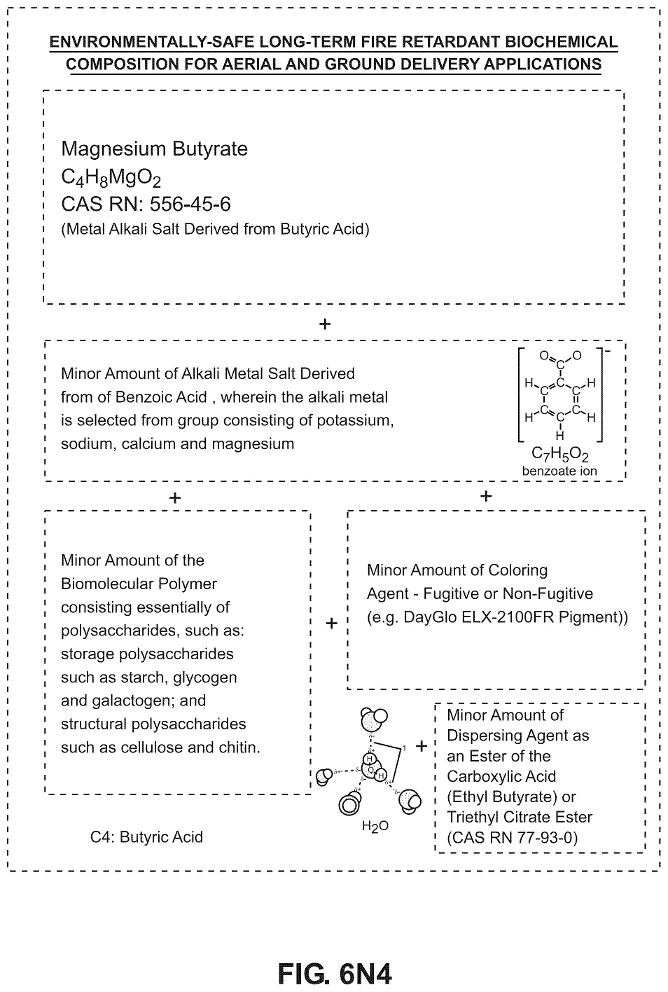

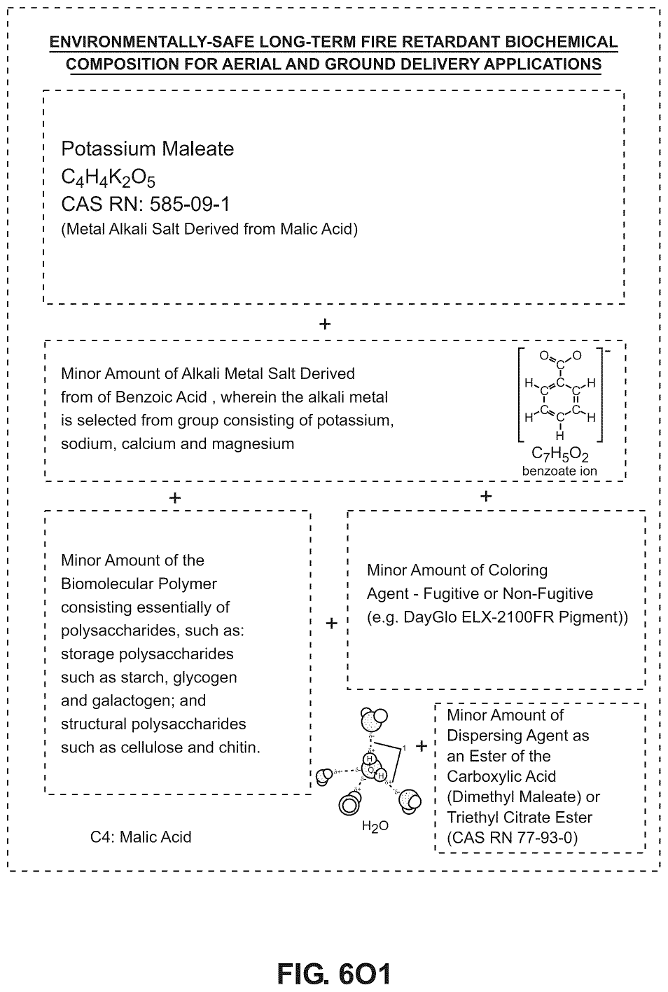

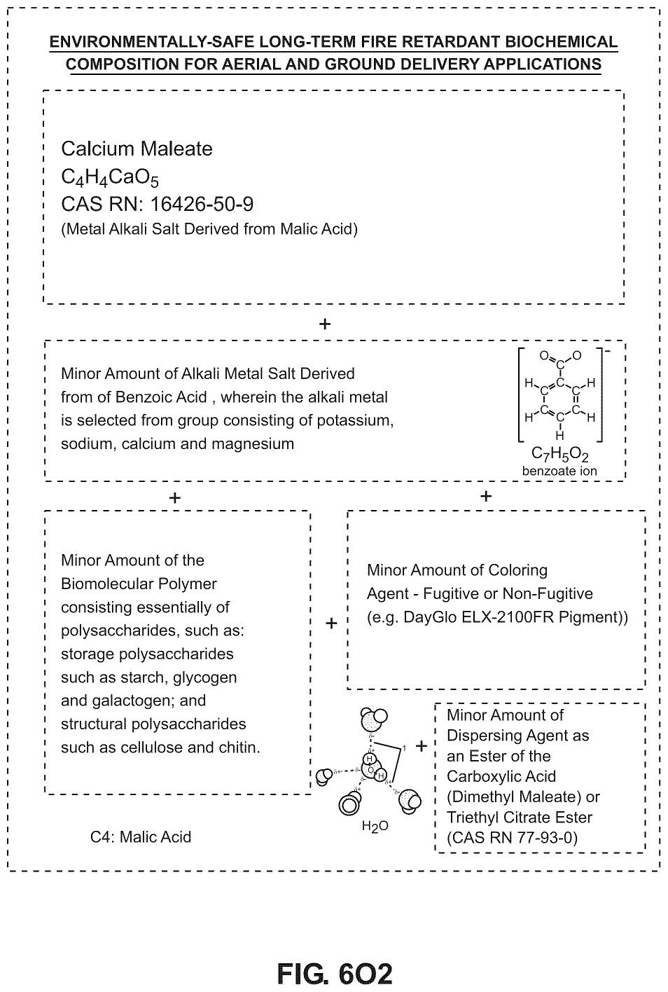

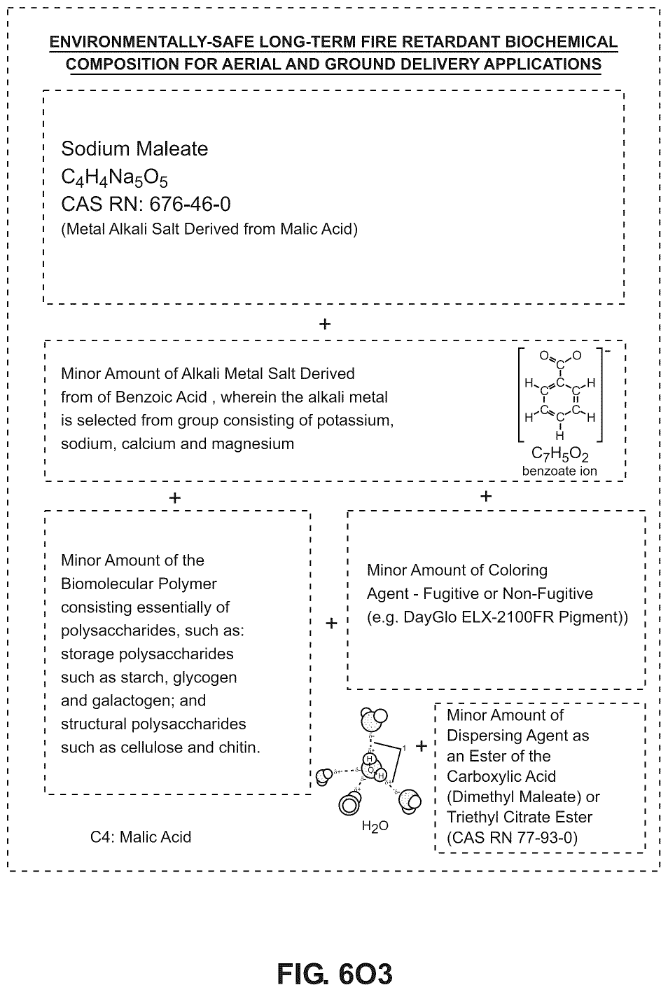

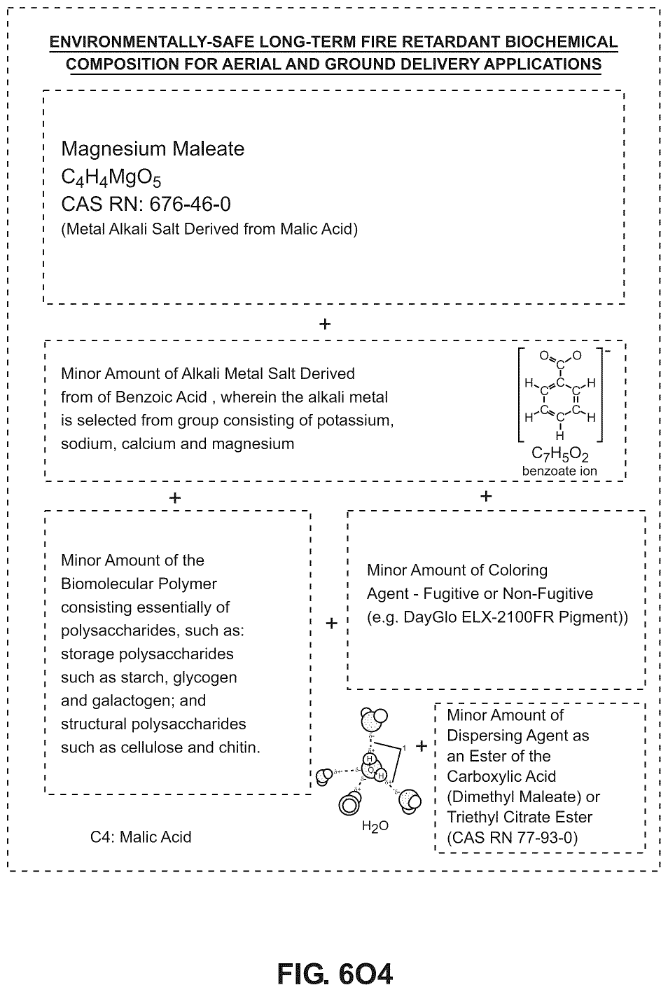

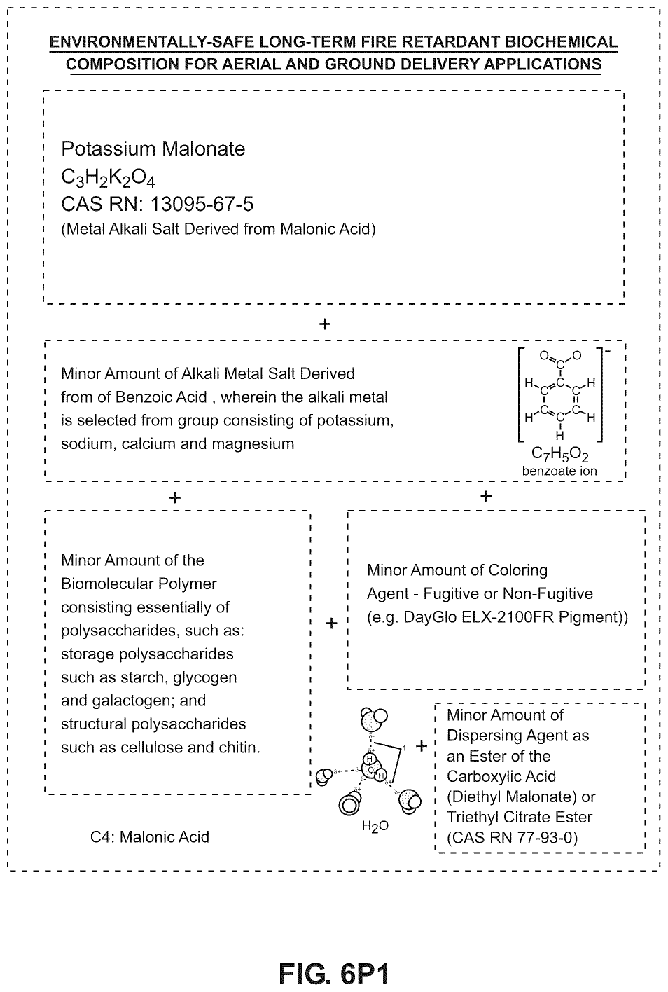

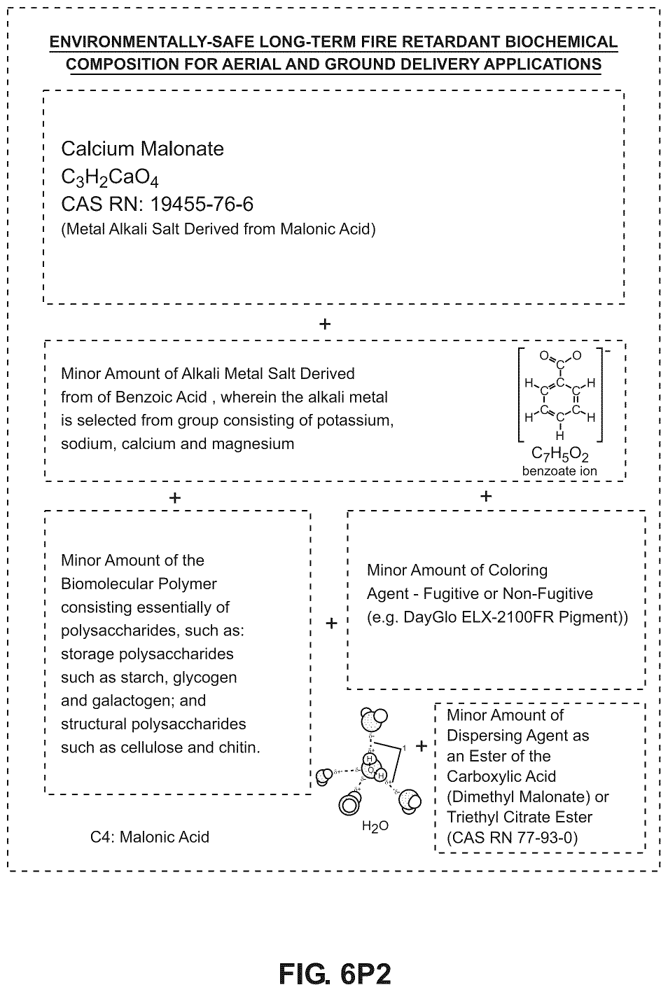

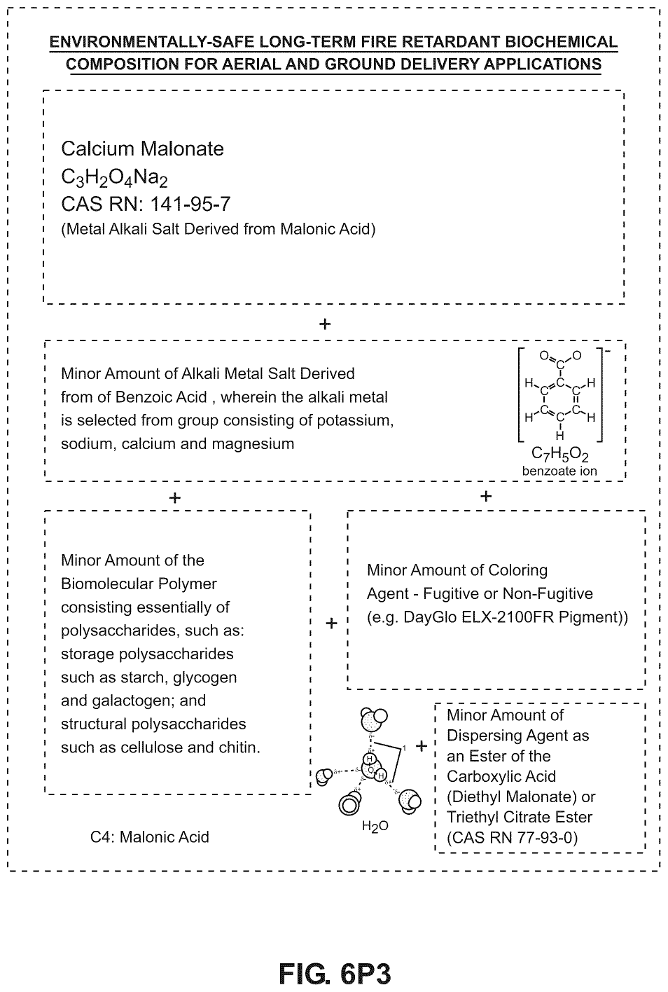

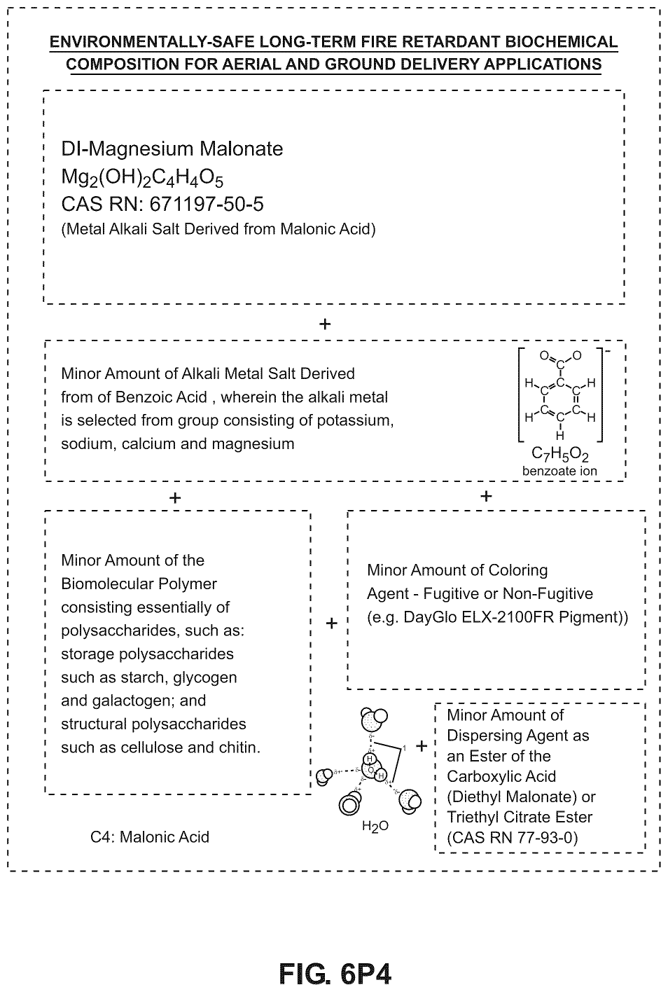

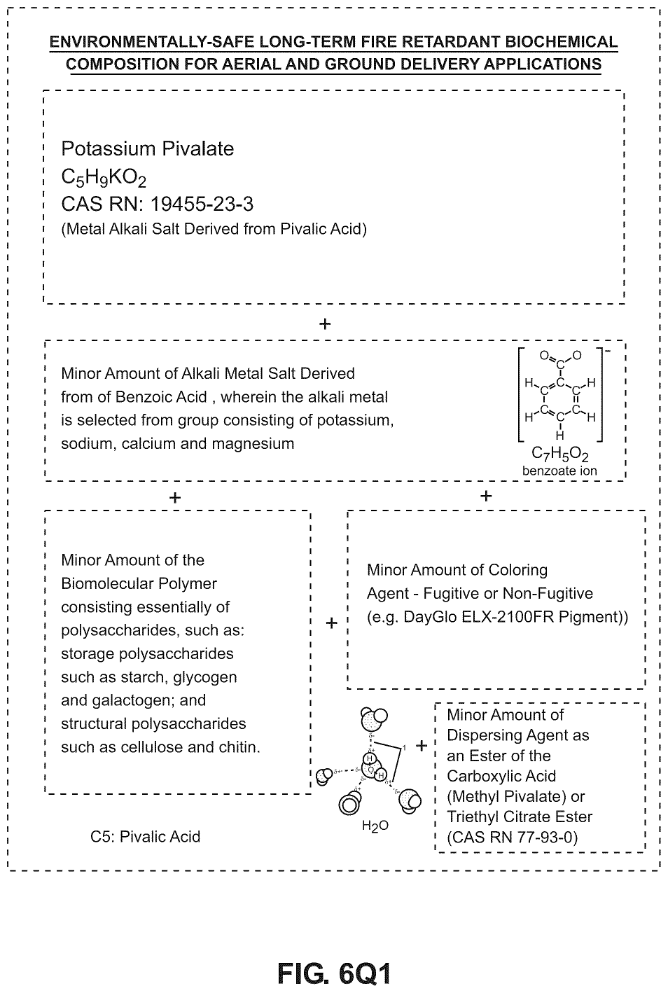

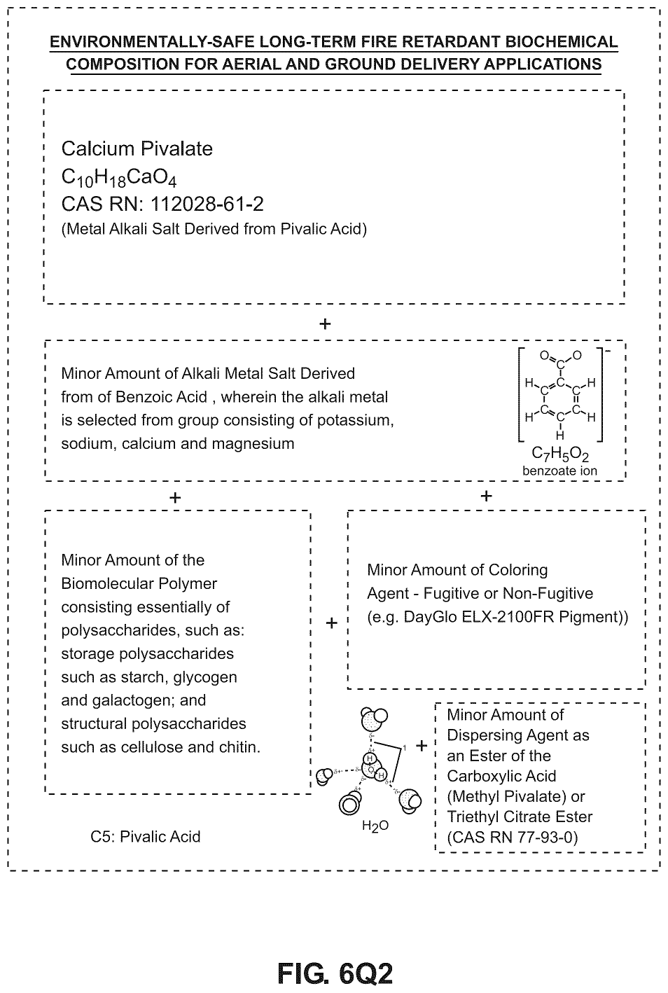

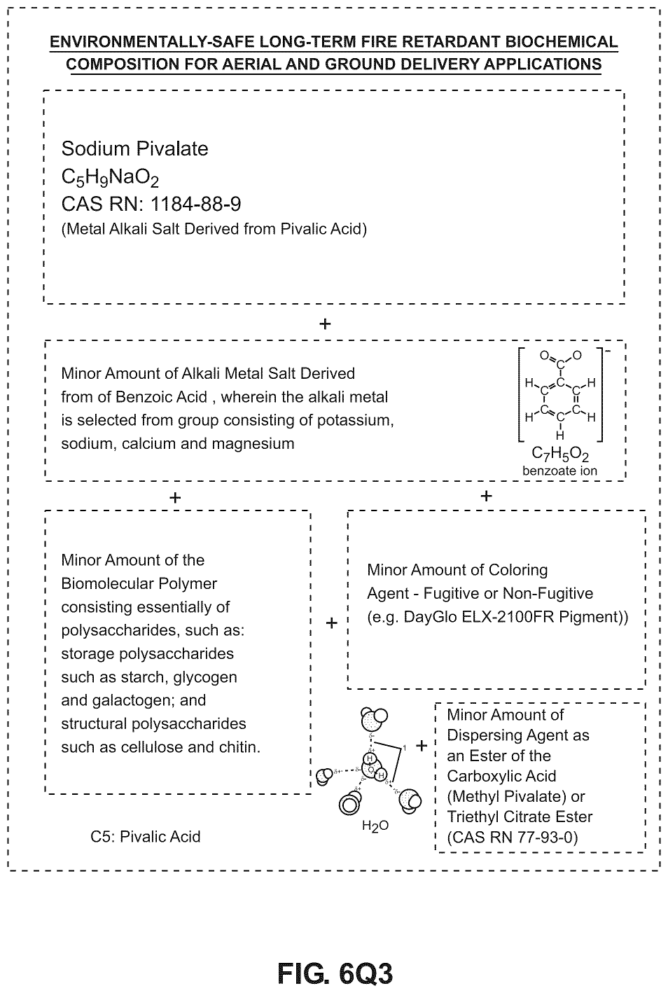

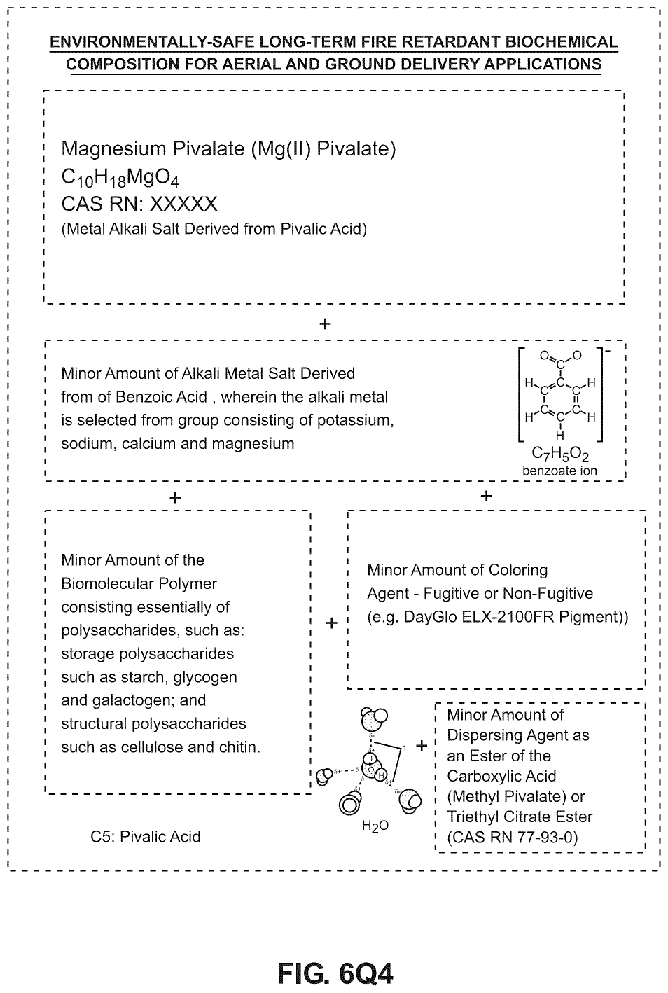

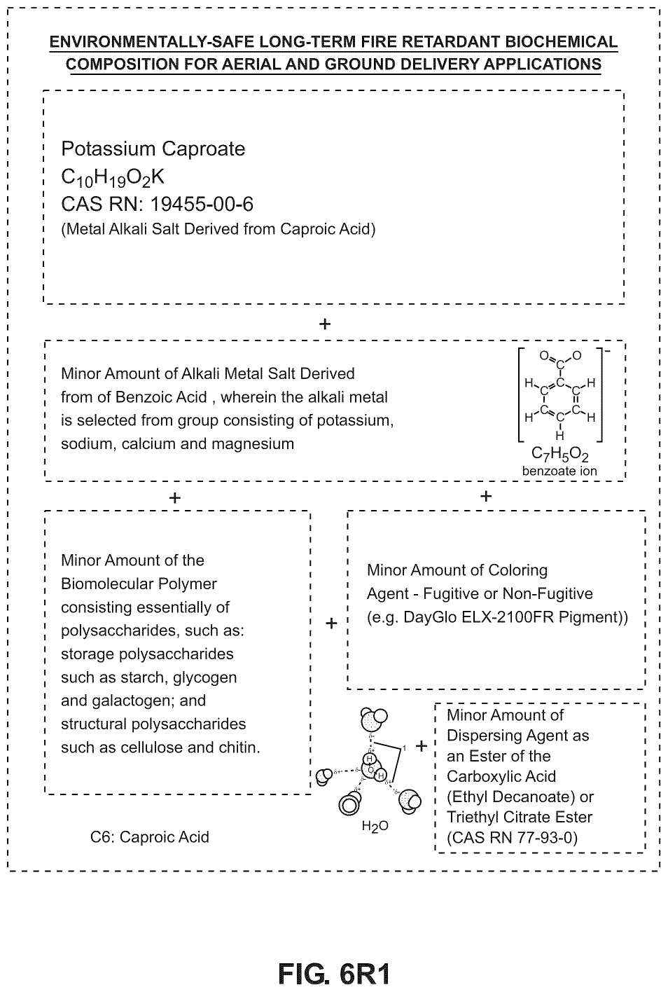

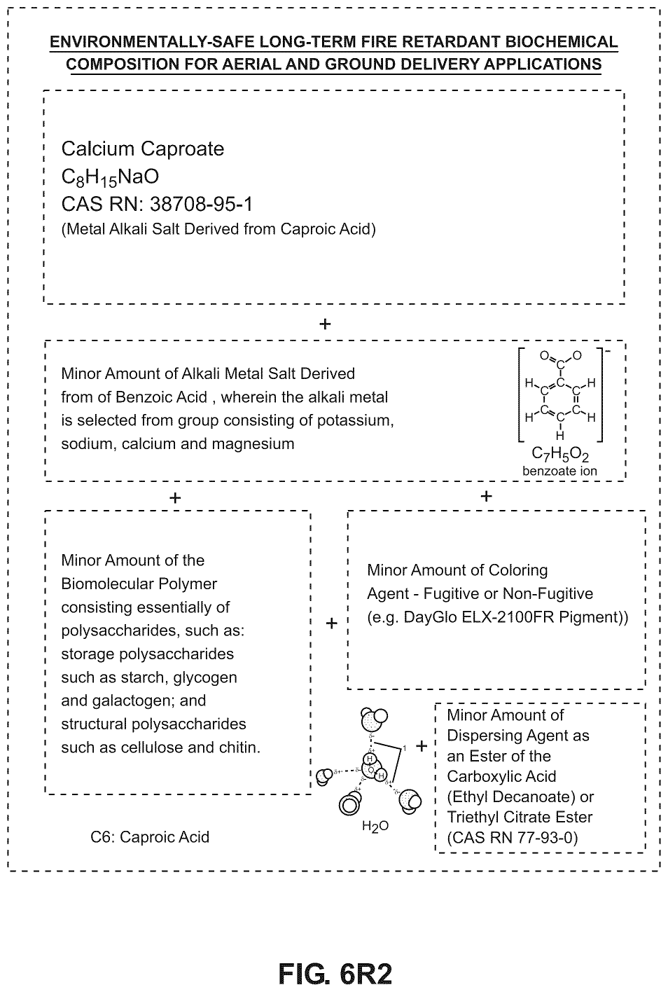

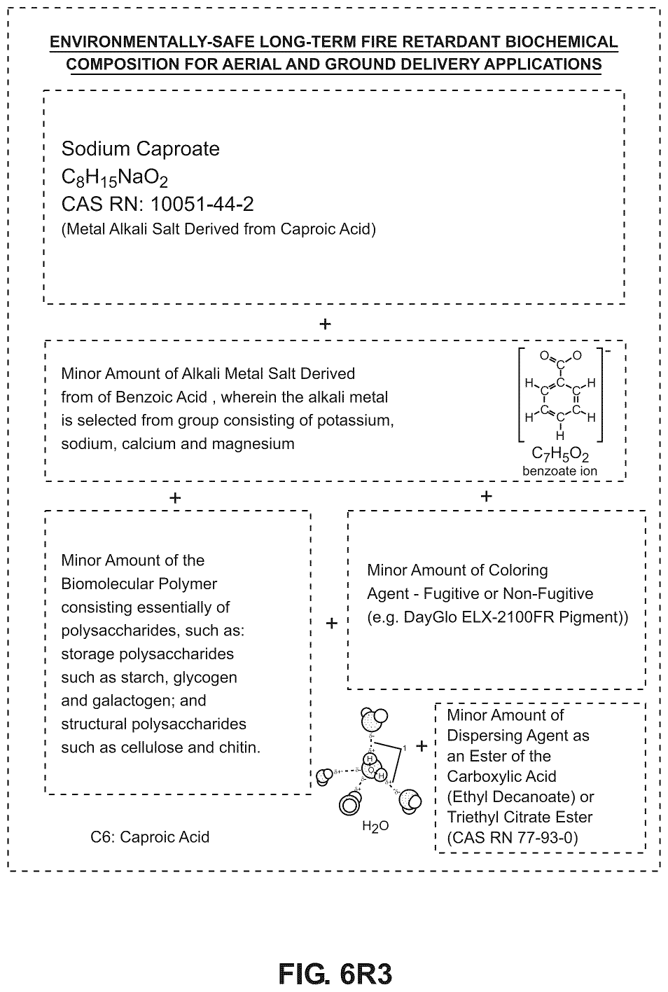

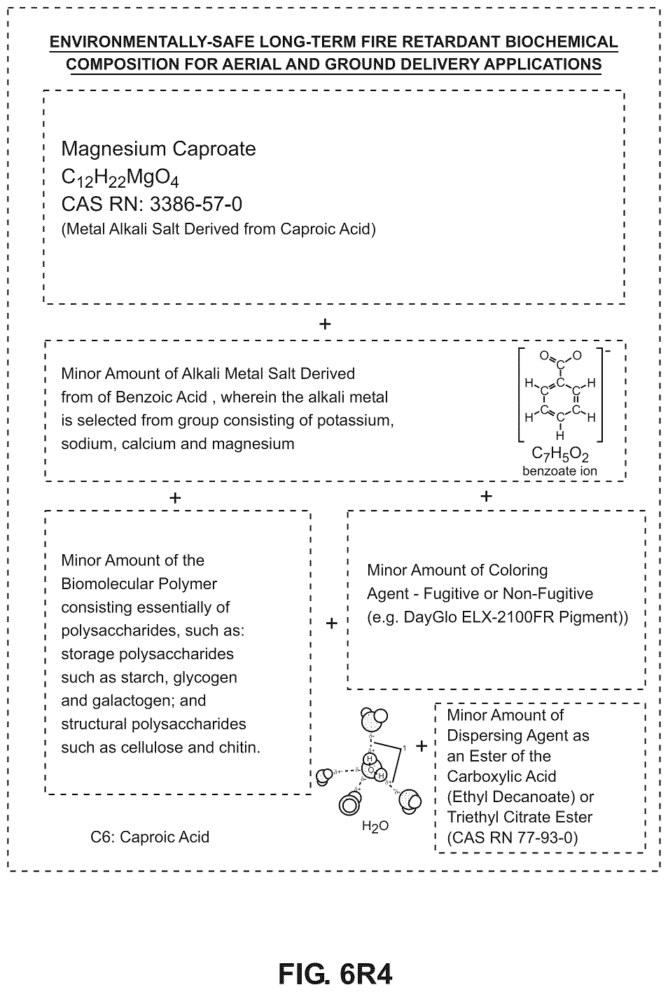

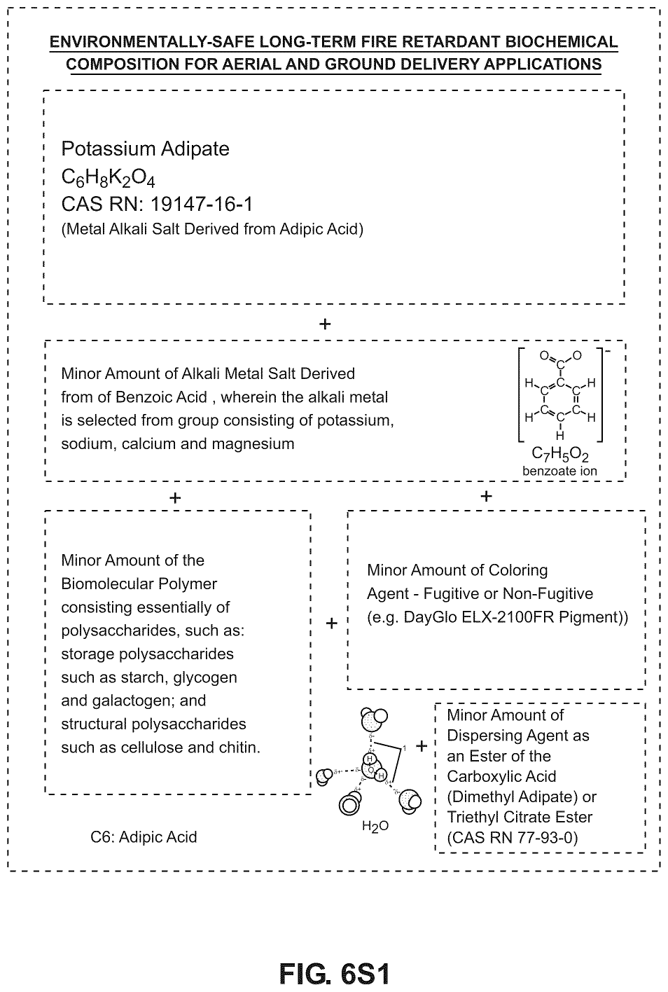

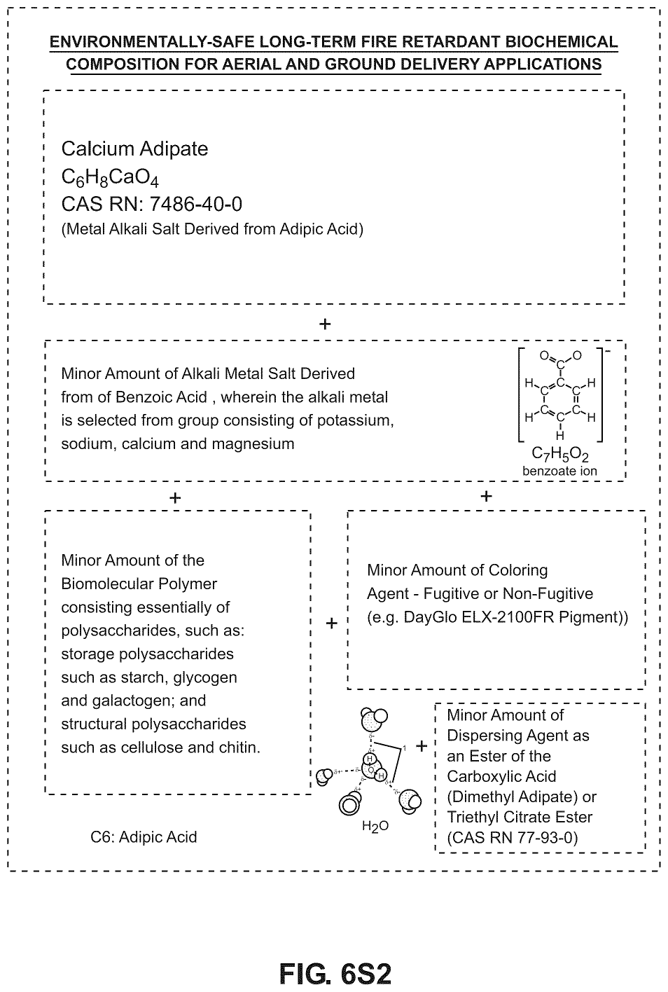

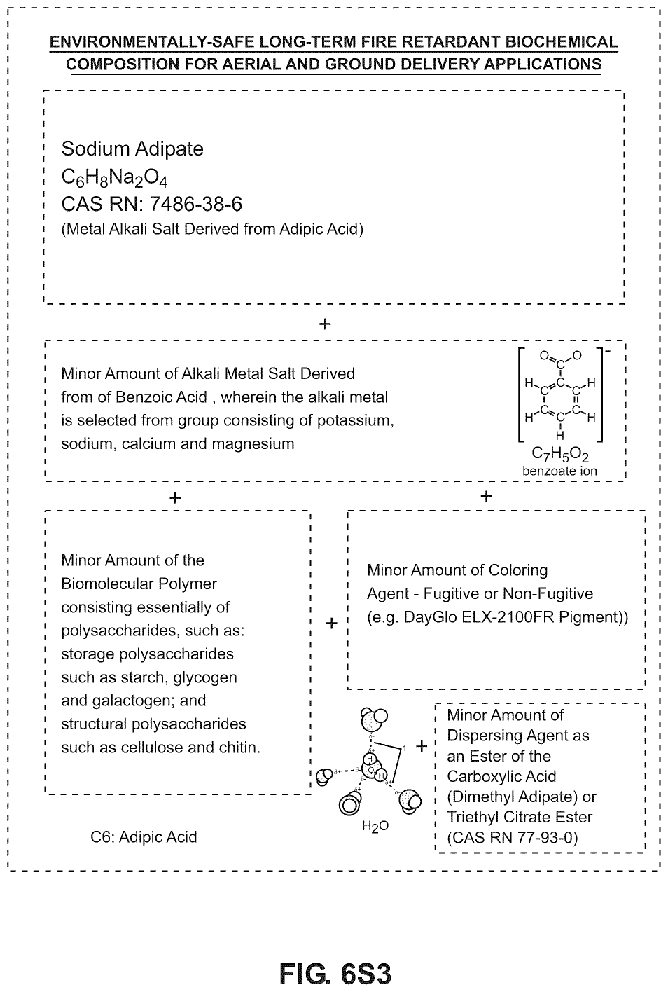

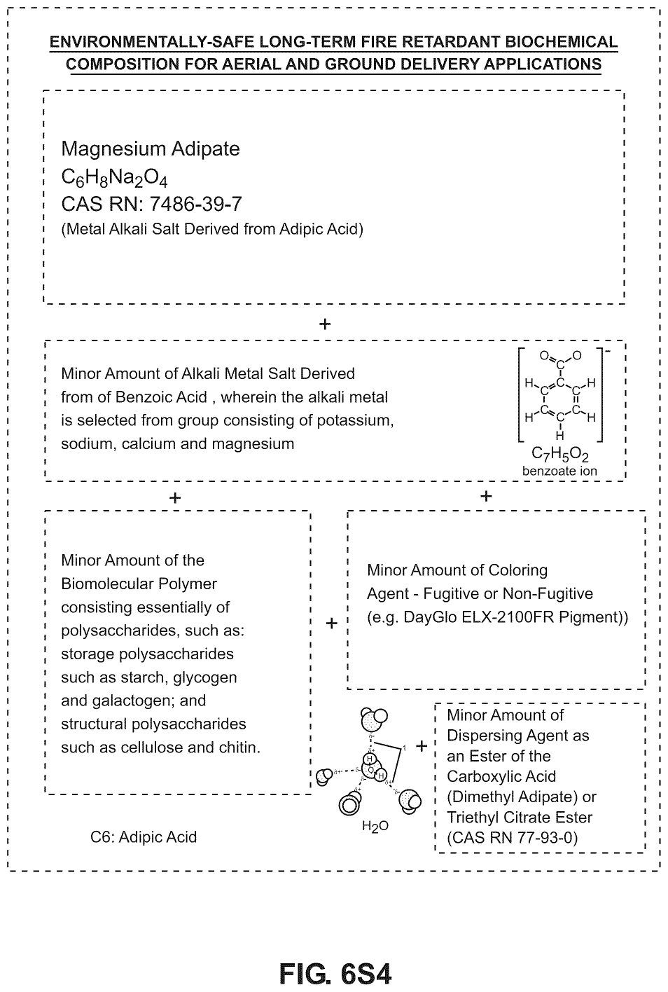

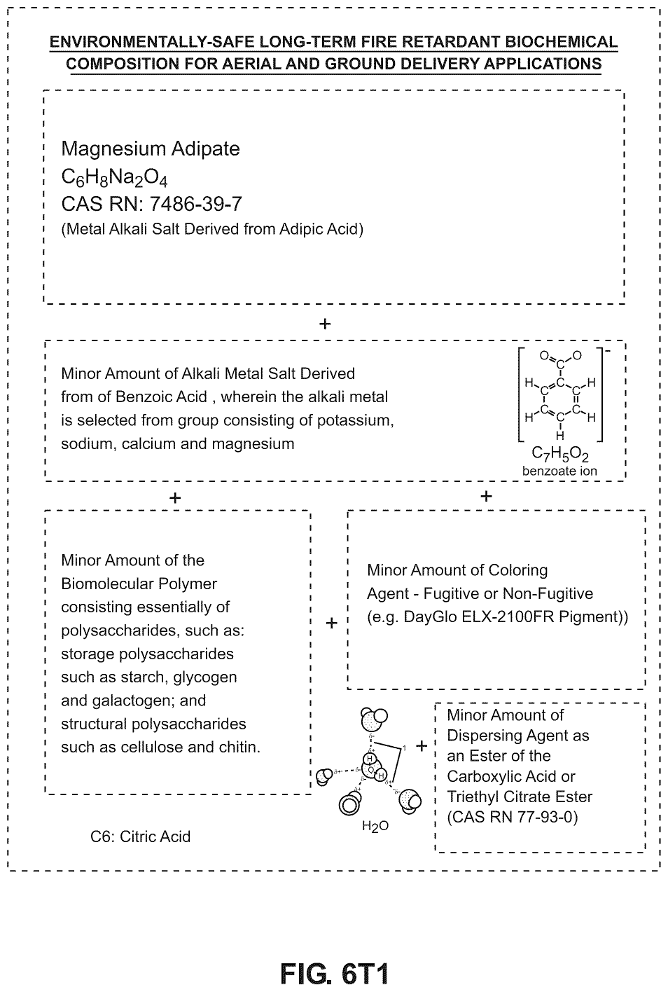

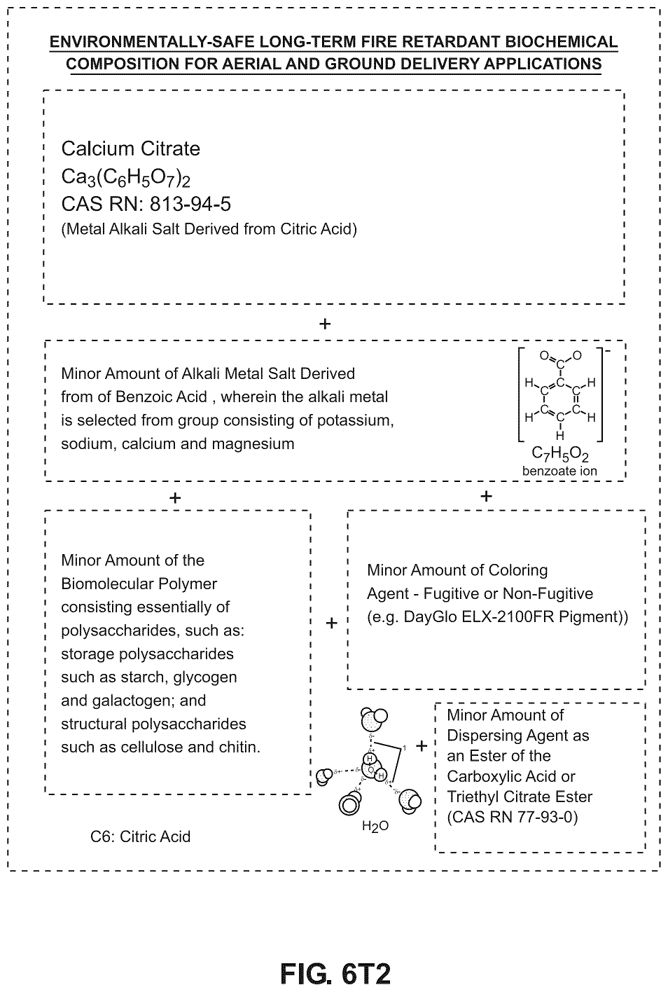

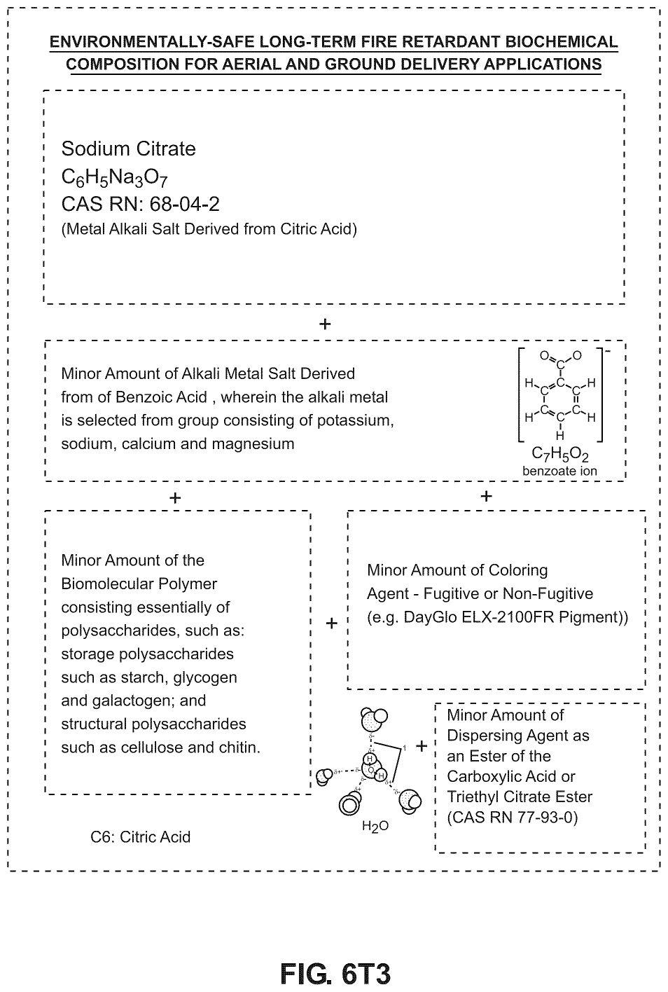

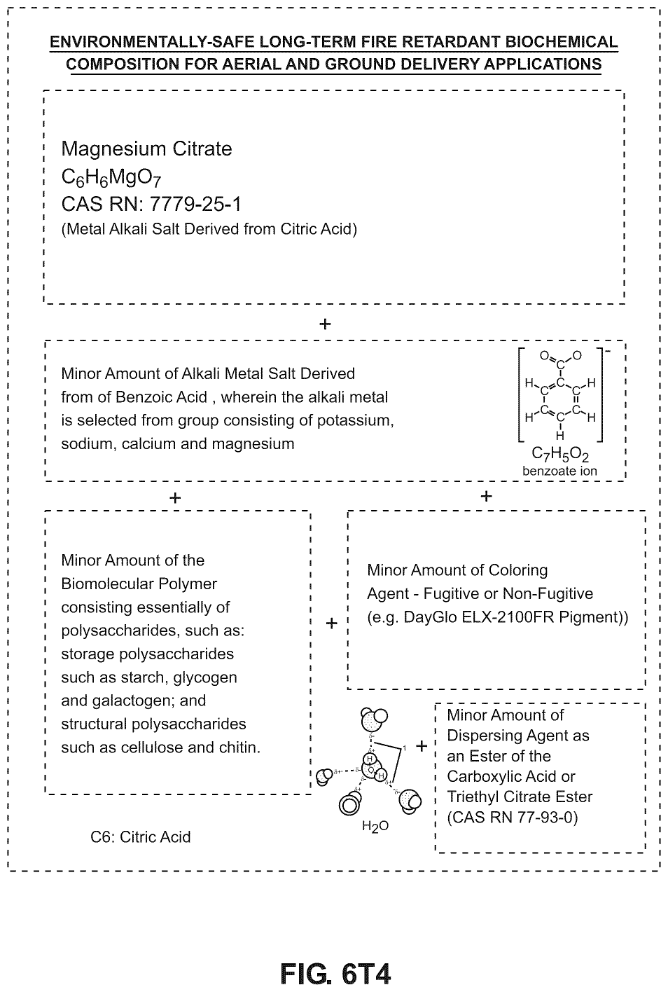

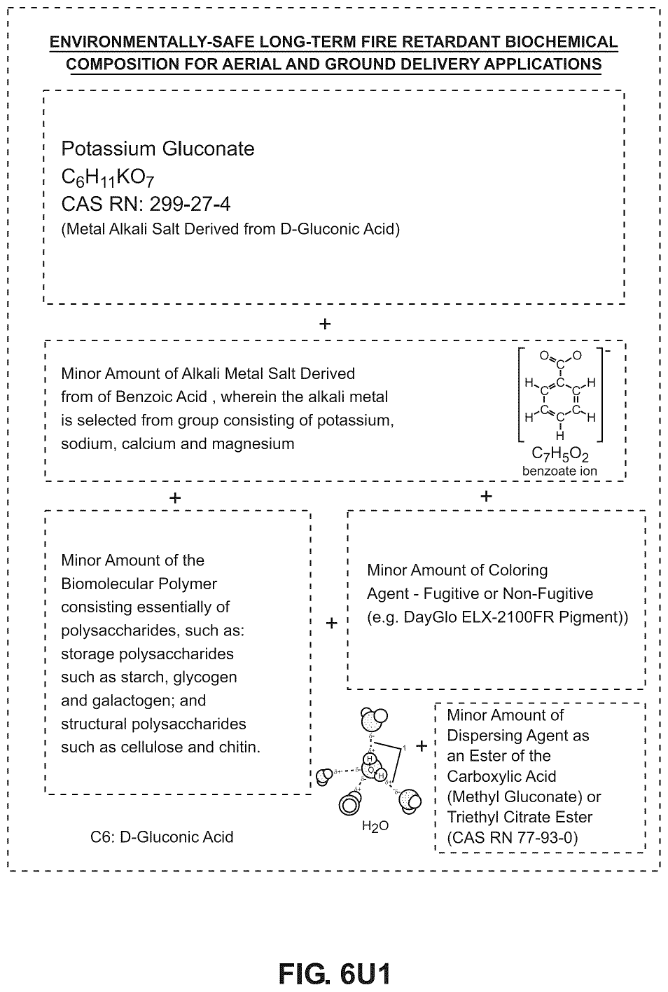

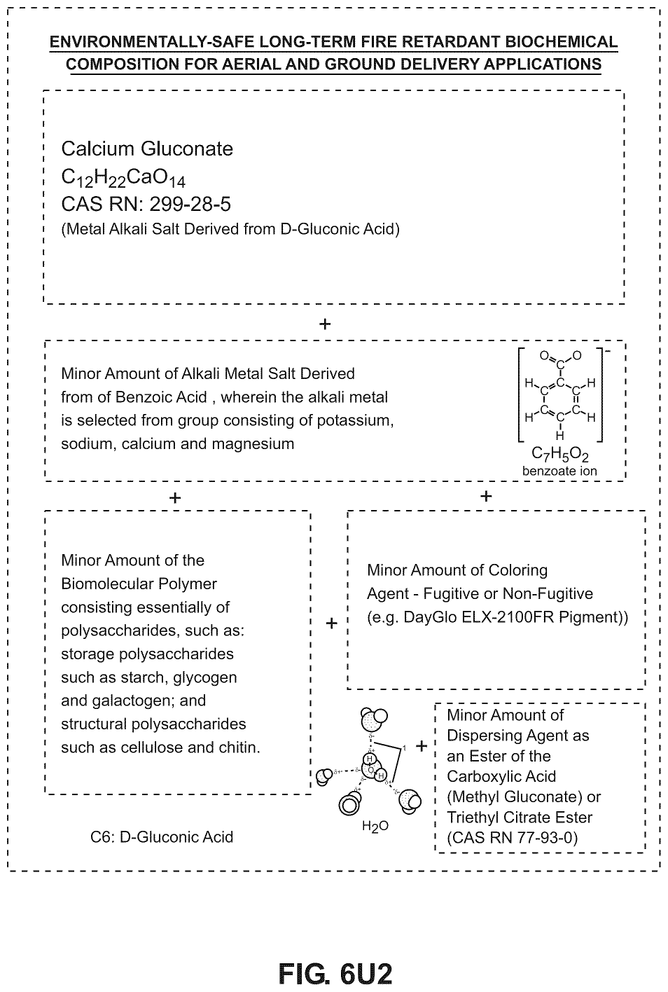

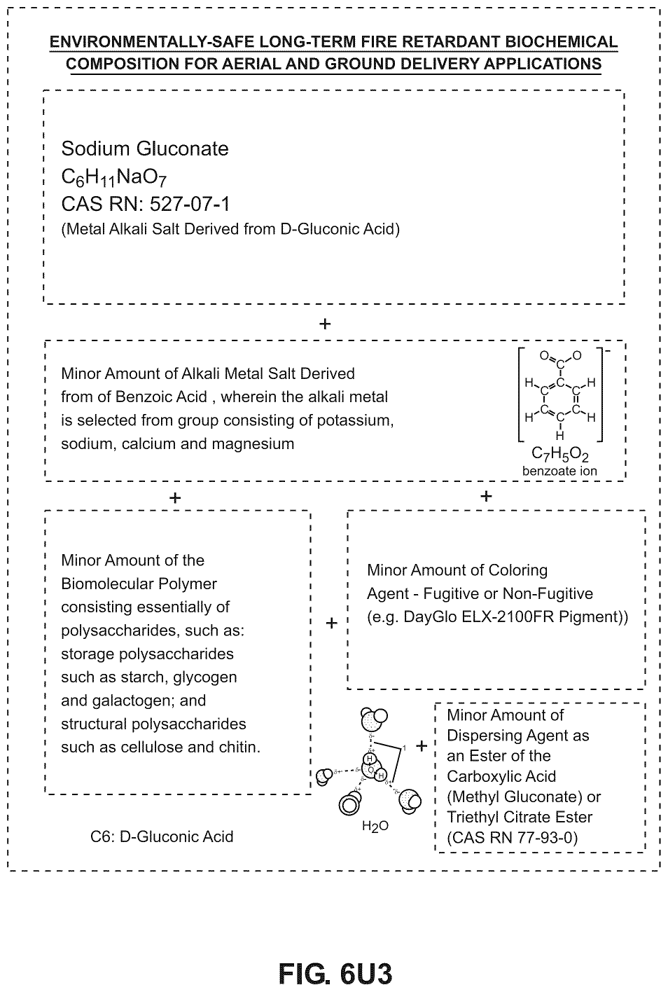

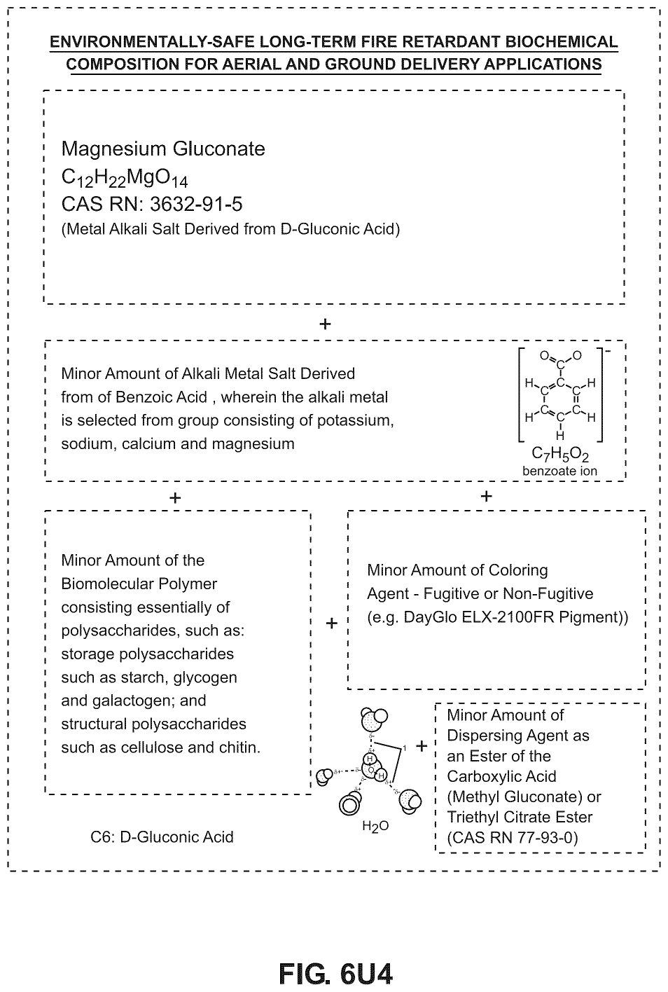

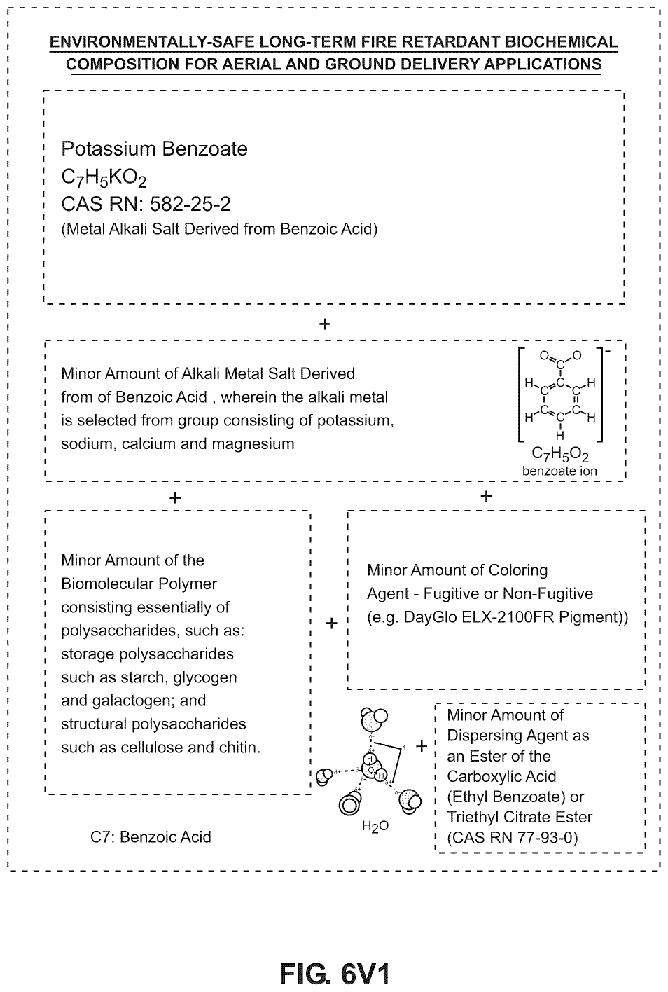

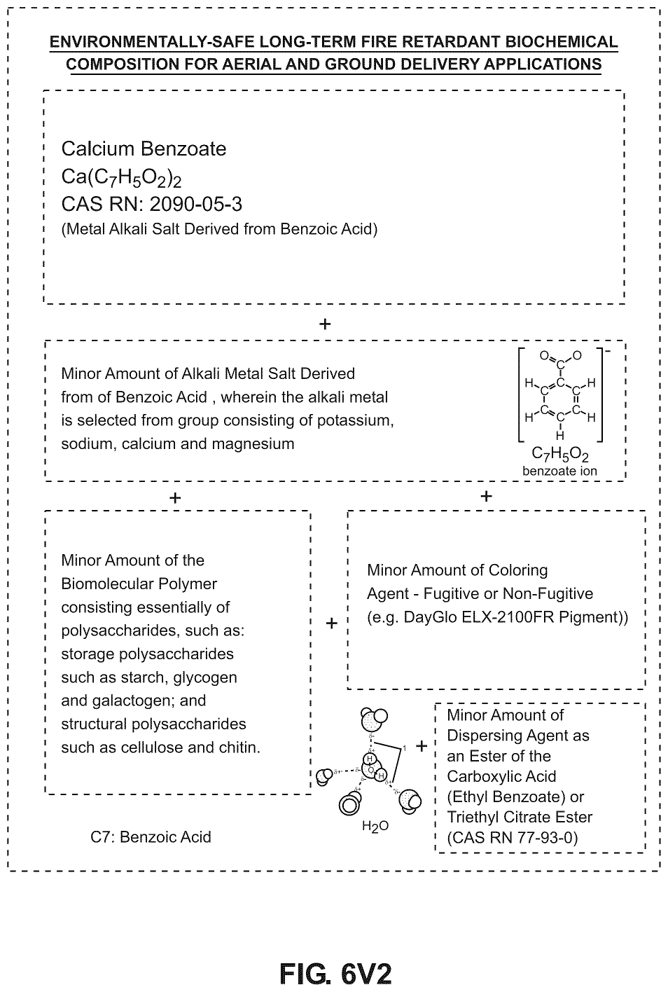

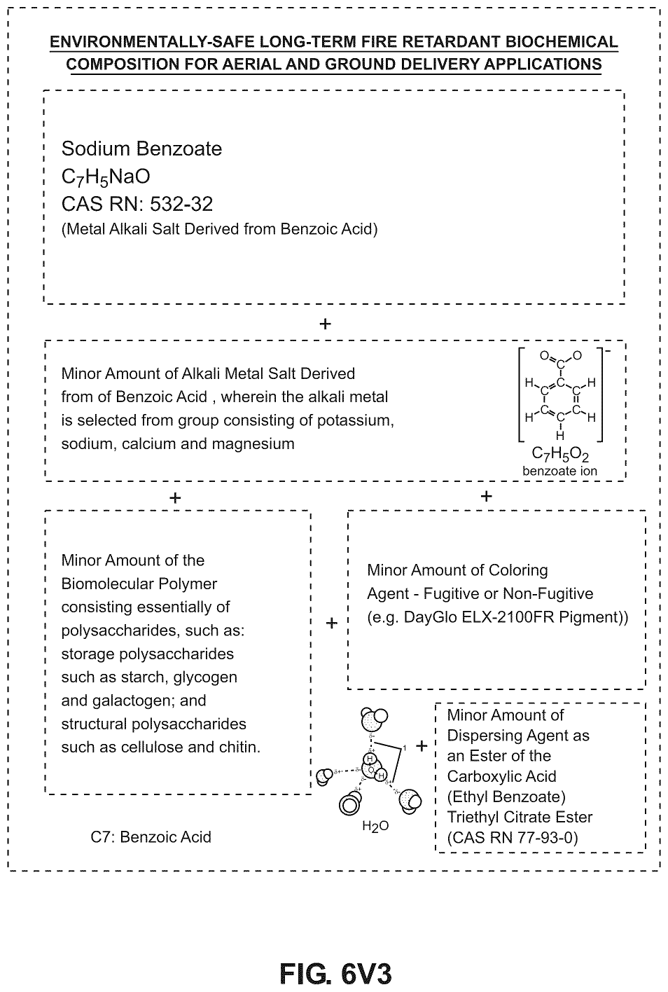

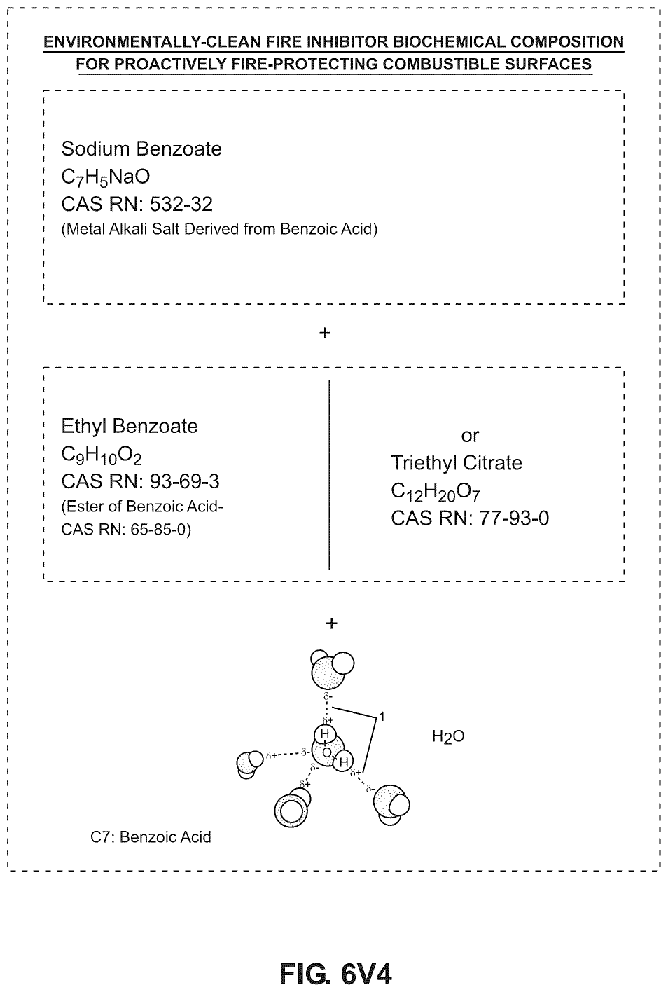

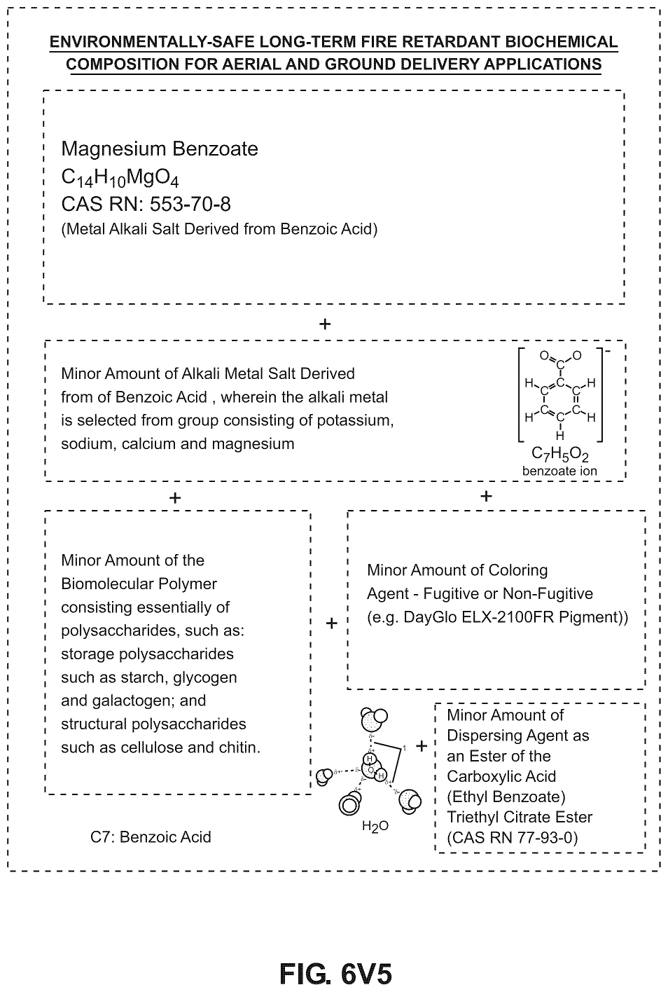

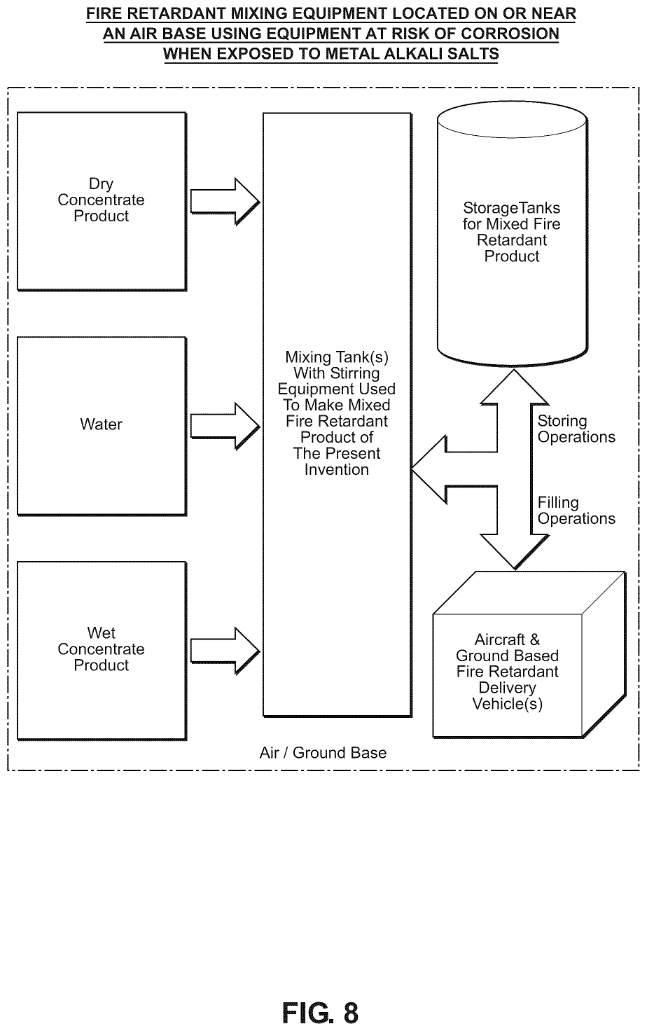

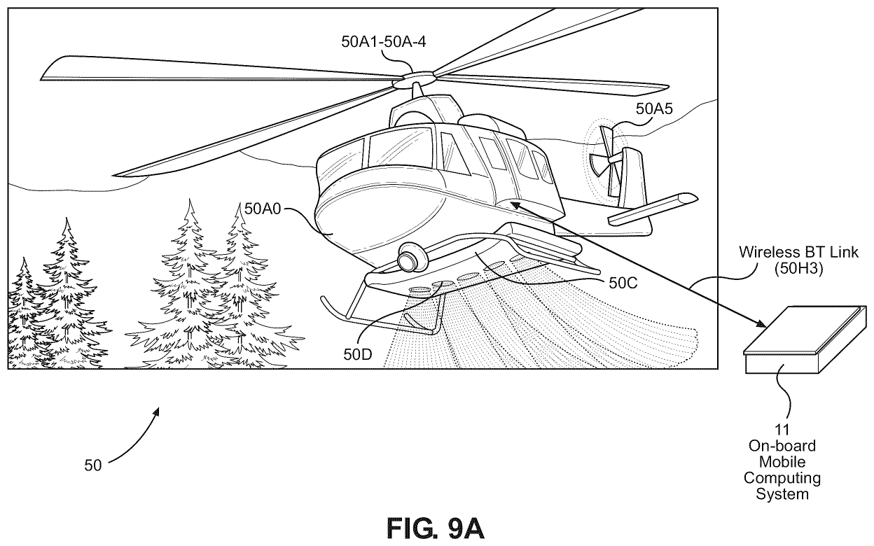

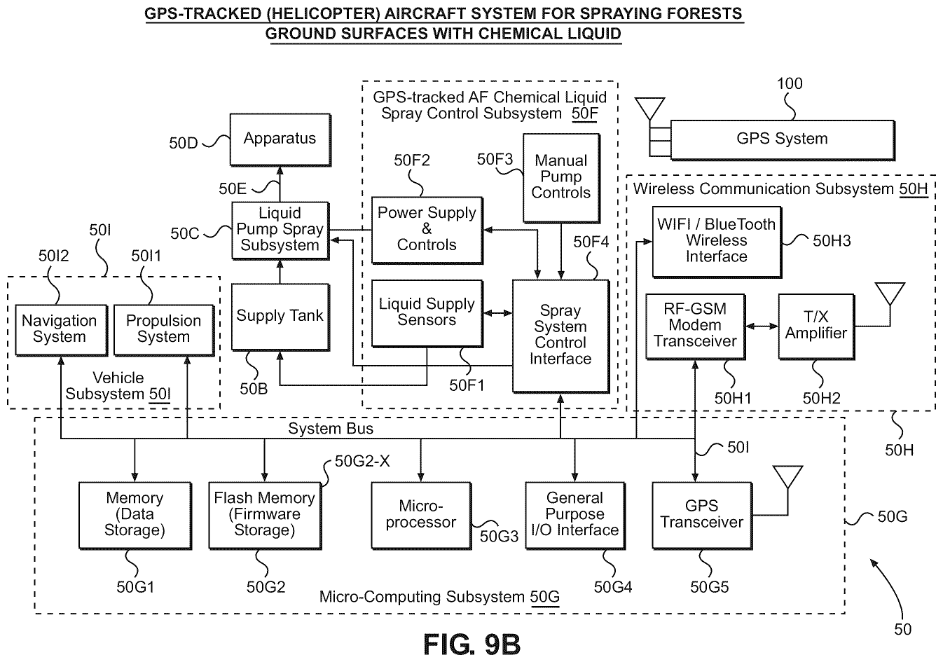

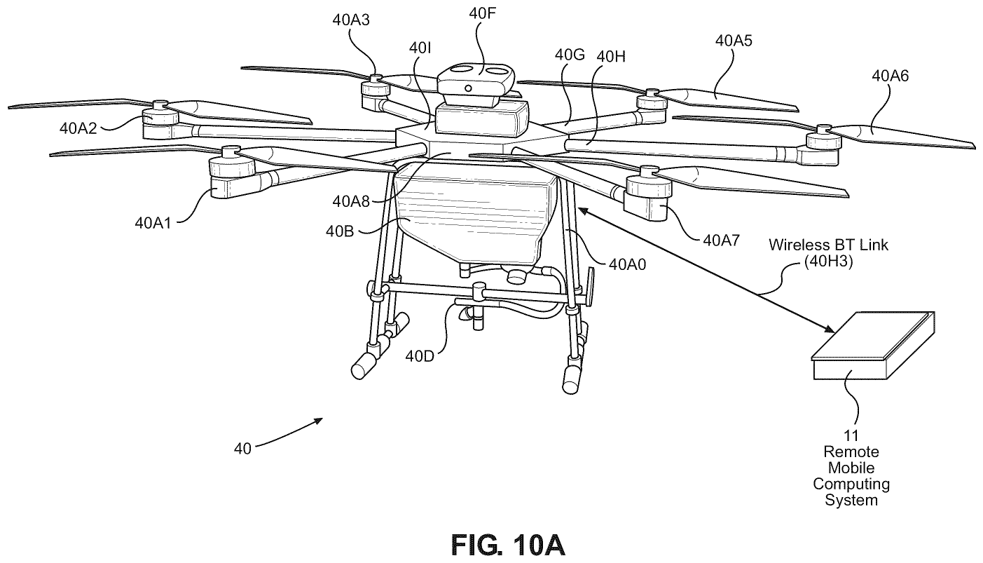

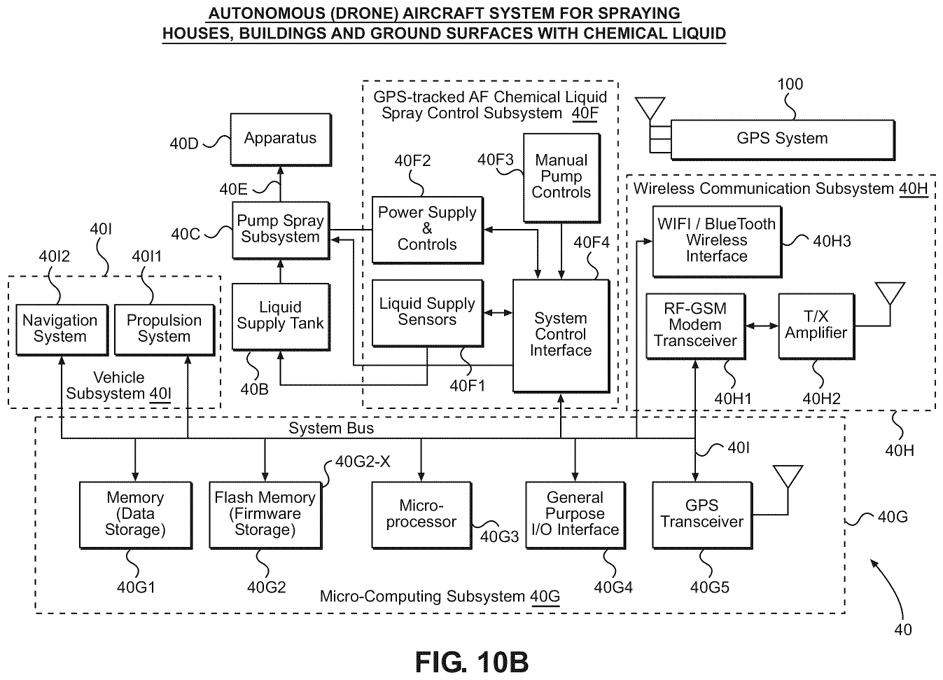

As shown, the wireless system network 1 comprises a distribution of system components, namely: ground-based GPS-tracked/GSM-linked liquid delivery systems 2 (30), as shown in FIG. 10B, for applying fire retarding biochemical liquid (formulated as illustrated in FIGS. 6 through 6C) to combustible surfaces on public real property and buildings and surrounding properties; air-based GPS-tracked fire retarding biochemical liquid delivery vehicles 3 (40, 50, as shown in FIGS. 8A and 9B, for applying fire retarding biochemical liquid(s) of the present invention (specified and formulated as illustrated in FIGS. 6 through 6V4) from the air to ground surfaces, brush, bushes and other forms of organic material on real property; GPS-tracked/GSM-linked fire retardant delivery systems 5, 6 (30, 40, and 50) for applying fire retarding biochemical liquid to combustible surfaces on private and public real property and surrounding areas; a GPS-indexed real-property (land) database system 7 for storing the GPS coordinates of the vertices and maps of all land parcels, including private property and building 17 and public property and building 18, situated in every town, county and state in the region over which the system network 1 is used to manage wild fires as they may occur; a cellular phone, GSM, and SMS messaging systems and email servers, collectively 16; and one or more data centers 8 for monitoring and managing GPS-tracking/GSM-linked fire retarding biochemical liquid supply and application systems, including web servers 9A, application servers 9B and database servers 9C (e.g. RDBMS) operably connected to the TCP/IP infrastructure of the Internet 10, and including a network database 9C1, for monitoring and managing the system and network of GPS-tracking fire retarding biochemical liquid application systems and various functions supported by the command center 19, including the management of wild fire suppression and the GPS-guided application of fire retarding biochemical liquid over public and private property, as will be described in greater technical detail hereinafter.

As shown in FIG. 4A, each data center 8 also includes an SMS server 9D and an email message server 9E for communicating with registered users on the system network 1 who use a mobile computing device (e.g. an Apple® iPhone or iPad tablet) 11 with the mobile application 12 installed thereon and configured for the purposes described herein. Such communication services will include SMS/text, email and push-notification services known in the mobile communications arts.

During system network operation, the GPS-indexed real-property (land) database system 7 stores the GPS coordinates of the vertices and maps of all land parcels contained in every town, county, and state of the region over which the system network is deployed and used to manage wild fires as they may occur. Typically, databases and data processing methods, equipment and services known in the GPS mapping art, will be used to construct and maintain such GPS-indexed databases 7 for use by the system network, when managing GPS-controlled application of clean fire-retardant chemical liquid over GPS-specified parcels of land, at any given time and date, under the management of the system network. Examples of such GPS-indexed maps of land parcels are reflected by the task report, and examples of GPS-indexed maps.

As shown in FIG. 4A, the system network 1 also includes a GPS system 100 for transmitting GPS reference signals transmitted from a constellation of GPS satellites deployed in orbit around the Earth, to GPS transceivers installed aboard each GPS-tracking ground-based or air-based fire retarding biochemical liquid application system of the present invention, shown in FIGS. 6A through 10B, as part of the illustrative embodiments. From the GPS signals it receives, each GPS transceiver aboard such fire retarding biochemical liquid application systems is capable of computing in real-time the GPS location of its host system, in terms of longitude and latitude. In the case of the Empire State Building in NYC, NY, its GPS location is specified as: N40° 44.9064′, W073°59.0735′; and in number only format, as: 40.748440,-73.984559, with the first number indicating latitude, and the second number representing longitude (the minus sign indicates “west”).

As shown in FIG. 4B, the system network 1 further includes multi-spectral imaging (MSI) systems and/or hyper-spectral-imaging (HSI) systems 14 for remotely data sensing and gathering data about wild fires and their progress. Such MSI and HSI systems may be space/satellite-based and/or drone-based (supported on an unmanned airborne vehicle or UAV). Drone-based systems can be remotely-controlled by a human operator, or guided under an artificial intelligence (AI) navigation system. Such AI-based navigation systems may be deployed anywhere, provided access is given to such remote navigation system the system network and its various systems. As the flight time will be limited using available battery technology, there will be a need to provide provisions for recharging the batteries of such drones/UASs in the field. There may also be a need or desire for the actual presence or telepresence of human field personnel to support the flight and remote data sensing and mapping missions of each deployed drone, flying about raging wild fires in connection with the system network of the present invention.

During each wild fire data sensing and mapping mission, carried out by such UAS, a series of MSI images and HSI images can be captured during a wild fire, and mapped to GPS-specific coordinates, and this mapped data can be transmitted back to the system network for storage, analysis and generation of GPS-specified flight plans for fire retarding biochemical liquid delivery operations carried out using methods seeking to stall, retard, and suppress such wild fires, and mitigate risk of damage to property and harm to human and animal life.

FIG. 4B shows a suite of MSI and HSI remote sensing and mapping instruments and technology 14 that is currently being used by the US Geological Survey (USGS) Agency to collect, monitor, analyze, and provide science about natural resource conditions, issues, and problems on Earth. It is an object of the present invention to exploit such instruments and technology when carrying out and practicing the various methods of the present invention disclosed herein. As shown in FIG. 4B, these MSI/HSI remote sensing technologies 14 include: MODIS (Moderate Resolution Imaging Spectro-radiometer) satellite system 14A for generating MODIS imagery subsets from MODIS direct readout data acquired by the USDA Forest Service Remote Sensing Applications Center, to produce satellite fire detection data maps and the like https://fsapps.nwcg.gov/afm/activefiremaps.php; the World View 2 Satellite System 14B manufacture from the Ball Aerospace & Technologies and operated by DigitalGlobe, for providing commercially available panchromatic (B/W) imagery of 0.46 meter resolution, and eight-band multi-spectral imagery with 1.84 meter resolution; Octocopter UAS (e.g. OnyxStar Hyra-12 heavy lifting drone) 14C as shown in FIG. 4B supporting MSI and HSI camera systems for spectral imaging applications, http://www.onyxstar.net and http://www.genidrone.com; and SenseFly eBee SQ UAS 14D for capturing and mapping high-resolution aerial multi-spectral images https://www.sensefly.com/drones/ebee-sq.html.

Any one or more of these types of remote data sensing and capture instruments, tools and technologies can be integrated into and used by the system network 1 for the purpose of (i) determining GPS-specified flight/navigation plans for GPS-tracked fire retarding biochemical liquid application/delivery aircraft and ground-based vehicle systems described above, and (ii) practicing the various GPS-guided methods of wild fire suppression and described in detail herein.

### Specification of the Network Architecture of The System Network Of The Present Invention

FIG. 4A illustrates the network architecture of the system network 1 implemented as a stand-alone platform deployed on the Internet. As shown, the Internet-based system network comprises: cellular phone and SMS messaging systems and email servers 16 operably connected to the TCP/IP infrastructure of the Internet 10; a network of mobile computing systems 11 running enterprise-level mobile application software 12, operably connected to the TCP/IP infrastructure of the Internet 10; an array of mobile GPS-tracked fire retarding biochemical liquid application/delivery systems (20, 30, 40, 50), each provided with GPS-tracking and having wireless internet connectivity with the TCP/IP infrastructure of the Internet 10, using various communication technologies (e.g. GSM, Bluetooth, WIFI, and other wireless networking protocols well known in the wireless communications arts); and one or more industrial-strength data center(s) 8, preferably mirrored with each other and running Border Gateway Protocol (BGP) between its router gateways, and operably connected to the TCP/IP infrastructure of the Internet 10.

As shown in FIG. 4A, each data center 8 comprises: the cluster of communication servers 9A for supporting http and other TCP/IP based communication protocols on the Internet (and hosting Web sites); a cluster of application servers 9B; the cluster of RDBMS servers 9C configured within a distributed file storage and retrieval ecosystem/system, and interfaced around the TCP/IP infrastructure of the Internet well known in the art; the SMS gateway server 9D supporting integrated email and SMS messaging, handling and processing services that enable flexible messaging across the system network, supporting push notifications; and the cluster of email processing servers 9E.

Referring to FIG. 4A, the cluster of communication servers 9A is accessed by web-enabled mobile computing clients 11 (e.g. smart phones, wireless tablet computers, desktop computers, computer workstations, etc.) used by many stakeholders accessing services supported by the system network 1. The cluster of application servers 9A implement many core and compositional object-oriented software modules supporting the system network 1. Typically, the cluster of RDBMS servers 9C use SQL to query and manage datasets residing in its distributed data storage environment, although non-relational data storage methods and technologies such as Apache's Hadoop non-relational distributed data storage system may be used as well.

As shown in FIG. 4A, the system network architecture shows many different kinds of users supported by mobile computing devices 11 running the mobile application 12 of the present invention, namely: the plurality of mobile computing devices 11 running the mobile application 12, used by fire departments and firemen to access services supported by the system network 1; the plurality of mobile computing systems 11 running mobile application 12, used by insurance underwriters and agents to access services on the system network 1; the plurality of mobile computing systems 11 running mobile application 12, used by building architects and their firms to access the services supported by the system network 1; the plurality of mobile client systems 11 (e.g. mobile computers such as iPad, and other Internet-enabled computing devices with graphics display capabilities, etc.) used by spray-project technicians and administrators, and running a native mobile application 12 supported by server-side modules, and various supporting client-side and server-side processes on the system network of the present invention; and a GPS-tracked fire retarding biochemical liquid application/delivery systems 30, 40 and 50 for applying fire retardant on buildings and ground cover to provide protection and defense against wild-fires.

In general, the system network 1 will be realized as an industrial-strength, carrier-class Internet-based network of object-oriented system design, deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by Oracle; a non-Java IDE such as Microsoft's .NET IDE; or other suitably configured development and deployment environment well known in the art. Preferably, although not necessary, the entire system of the present invention would be designed according to object-oriented systems engineering (OOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C, Java, PHP, Python, Google's GO, and other computer programming languages known in the art. Preferably, the system network is deployed as a three-tier server architecture with a double-firewall, and appropriate network switching and routing technologies well known in the art. In some deployments, private/public/hybrid cloud service providers, such Amazon Web Services (AWS), may be used to deploy Kubernetes, an open-source software container/cluster management/orchestration system, for automating deployment, scaling, and management of containerized software applications, such as the mobile enterprise-level application 12 of the present invention, described above.

### Specification Of System Architecture Of An Exemplary Mobile Smartphone System Deployed On The System Network Of The Present Invention

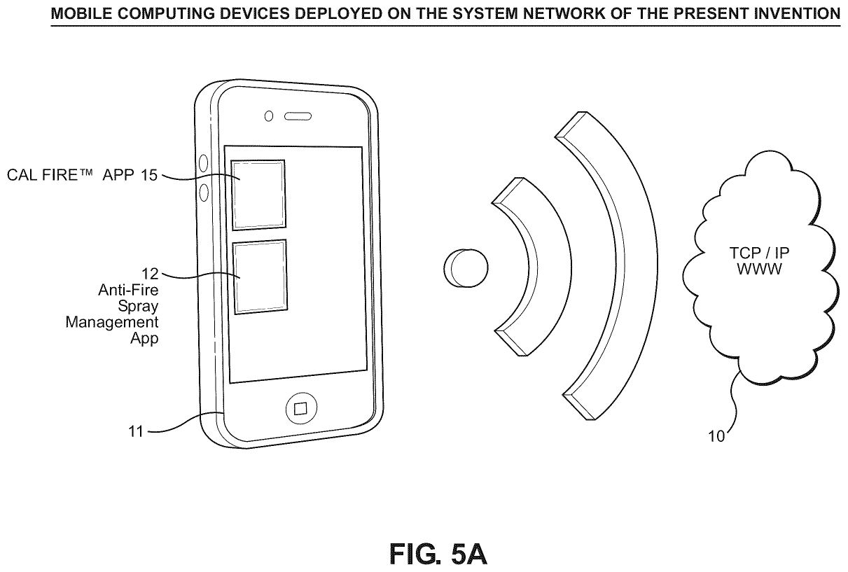

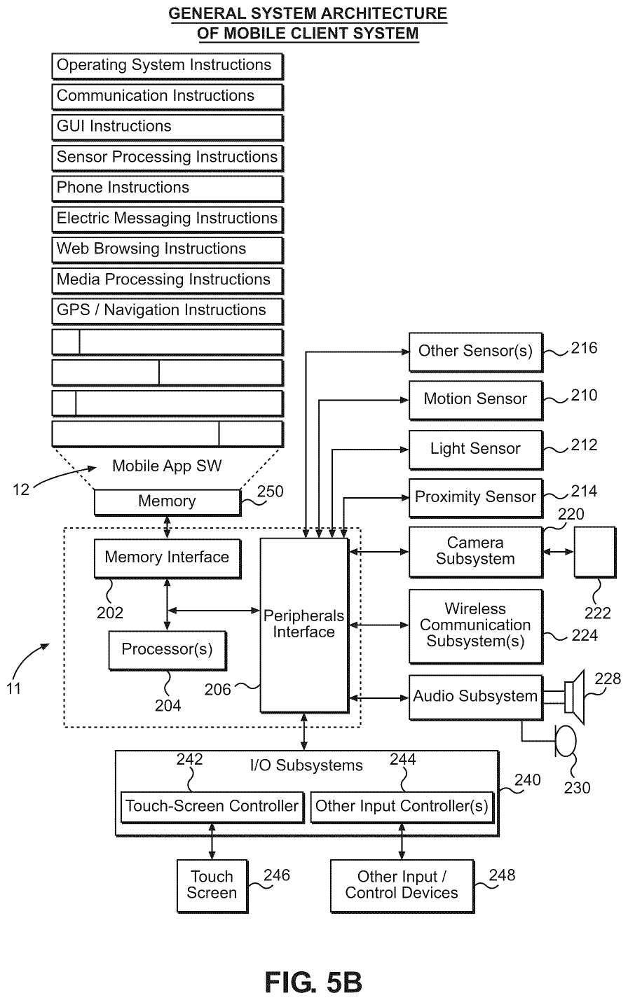

FIG. 5A shows an exemplary mobile computing device 11 deployed on the system network of the present invention, supporting conventional wildfire alert and notification systems (e.g. CAL FIRE® wild fire notification system 14), as well as the mobile fire retardant management application 12 of the present invention, that is deployed as a component of the system network 1. FIG. 5B shows the system architecture of an exemplary mobile client computing system 11 that is deployed on the system network 1 and supporting the many services offered by system network servers 9A, 9B, 9C, 9D, 9E. As shown, the mobile smartphone device 11 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g. GPS receiver), a temperature sensor, a biometric sensor, a gyroscope, or other sensing device, to facilitate related functionalities. A camera subsystem 220 and an optical sensor 222, e.g. a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g. infrared) receivers and transmitters. The specific design and implementation of the communication subsystem 224 can depend on the communication network(s) over which the mobile device is intended to operate. For example, the mobile device 11 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 11 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of mobile smartphone device 11 can be found in U.S. Pat. No. 8,631,358 incorporated herein by reference in its entirety.

### Different Ways Of Implementing The Mobile Client Machines And Devices On The System Network Of The Present Invention

In one illustrative embodiment, the enterprise-level system network is realized as a robust suite of hosted services delivered to Web-based client subsystems 1 using an application service provider (ASP) model. In this embodiment, the Web-enabled mobile application 12 can be realized using a web-browser application running on the operating system (OS)(e.g. Linux, Application IOS, etc.) of a mobile computing device 11 to support online modes of system operation, only. However, it is understood that some or all the services provided by the system network 1 can be accessed using Java clients, or a native client application, running on the operating system of a client computing device, to support both online and limited off-line modes of system operation. In such embodiments, the native mobile application 12 would have access to local memory (e.g. a local RDBMS) on the client device 11, accessible during off-line modes of operation to enable consumers to use certain or many of the system functions supported by the system network during off-line/off-network modes of operation. It is also possible to store in the local RDBMS of the mobile computing device 11, most if not all relevant data collected by the mobile application for any fire-protection project, and to automatically synchronize the dataset for user's projects against the master datasets maintained in the system network database 9C1, within the data center 8 shown in FIG. 4A. This way, when using a native application, during off-line modes of operation, the user will be able to access and review relevant information regarding any building fire protection project, and make necessary decisions, even while off-line (i.e. not having access to the system network).

As shown and described herein, the system network 1 has been designed for several different kinds of user roles including, for example, but not limited to: (i) public and private property owners, residents, fire departments, local, county, state, and federal officials; and (ii) wild fire suppression administrators, contractors, technicians et al registered on the system network. Depending on which role, for which the user requests registration, the system network will request different sets of registration information, including name of user, address, contact information, etc. In the case of a web-based responsive application on the mobile computing device 11, once a user has successfully registered with the system network, the system network will automatically serve a native client GUI, or an HTML5 GUI, adapted for the registered user. Thereafter, when the user logs into the system network, using his/her account name and password, the system network will automatically generate and serve GUI screens described below for the role that the user has been registered with the system network.

In the illustrative embodiment, the client-side of the system network 1 can be realized as mobile web-browser application, or as a native application, each having a “responsive-design” and adapted to run on any client computing device (e.g. iPhone, iPad, Android, or other Web-enabled computing device) 11 and designed for use by anyone interested in managing, monitoring, and working to defend against the threat of wild fires.

### Specification Of Environmentally-Clean Aqueous-Based Liquid Fire Retardant Bio-Chemical Compositions And Formulations And Methods of Making The Same In Accordance With The Principles Of The Present Invention

Another object of the present invention is to provide new and improved family of environmentally-clean (i.e. “Green”) aqueous-based fire retardant biochemical solutions (i.e. wet concentrate liquid compositions, premixed “ready-to-use” liquid compositions, and dry concentrate powder compositions) for producing (i) mixed biochemical fire retardant products that demonstrate good immediate extinguishing effects when applied to extinguish a burning or smoldering fire, and (ii) very good long-term fire retarding effects when proactively applied on combustible surfaces so as to protect against the threat of fire ignition and flame spread, by forming thin fire retardant coatings on combustible surfaces comprising alkali metal potassium and sodium salt crystals mixed within the polysaccharide chains of the biomolecular polymer material added (as a viscosity thickener) to the mixed fire retarding biochemical liquid, providing a long duration of persistent fire protection long after the water molecules in the applied mixed retardant product have evaporated to the ambient environment.

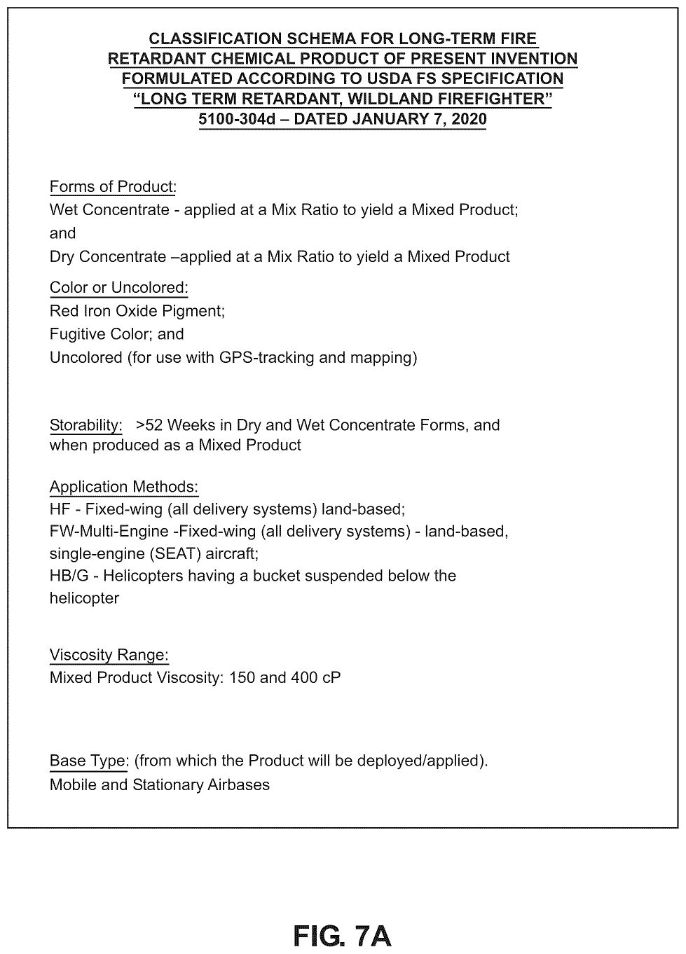

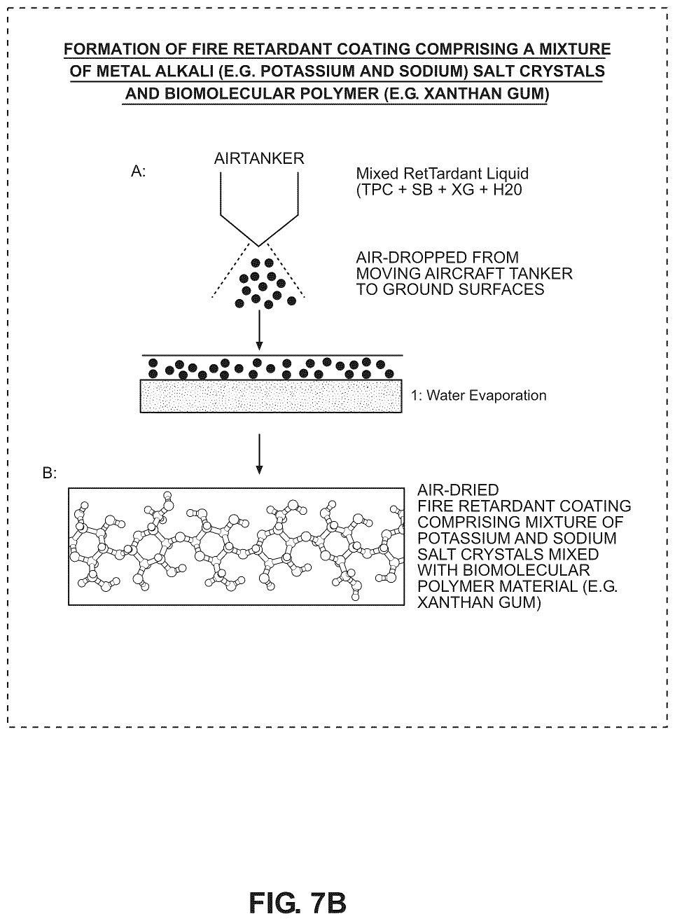

While a preferred formulation of the liquid fire retardant is the “ready-to-use” formulation, not requiring the addition of any water and/or mixing before use, the liquid fire retardant composition can also be produced in two forms: (i) a wet concentrate liquid form designed for mixing with a specified amount of water prior to use (according to a specified Wet Concentrate Mix Ratio) using mixing equipment and/or other suitable apparatus illustrated in FIG. 7.

In general, as illustrated in the generic chemical formulation model of FIG. 6, the new and improved environmentally-clean (“i.e. Green”) aqueous-based fire retarding biochemical composition of the present invention comprises: (i) a major amount of a first alkali metal salt (derived from a saturated non-polymerized carboxylic acid where the number of carbon atoms C is less than 7); (ii) a minor amount of a second alkali metal salt that functions as a secondar fire retarding agent and as a corrosion inhibiting agent for the protection of specific metals, (for example, 2024-T3 Aluminum, 4130 Steel, Bright Steel (a carbon steel alloy), Yellow Brass, and Az31B Magnesium, typically used to fabricate equipment shown in FIG. 7 during fire retardant product mixing, storage and delivery application operations) against surface corrosion caused by the presence of the alkali metal (e.g. potassium and sodium) ions dissolved in aqueous solution; (iii) a minor amount of thickening agent in the form of biomolecular polymer powder, such as Xanthan gum (XG) powder, consisting essentially of polysaccharides functioning to adjust the viscosity of the mixed fire retardant within the required USDA FS Specification (e.g. 150-400 cP or greater for Medium Viscosity and High Viscosity); (iv) a minor amount of a dispersing agent (e.g. triethyl citrate) for dispersing benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals and the metal alkali ions contributed by the fire inhibiting salts dissolved in aqueous solution; (v) a minor amount of a color-producing agent, such as fugitive red dye pigment powder (e.g. DayGlo ELX-2100FR hybrid pigment powder) or non-fugitive red iron oxide pigment (e.g. red iron oxide powder); wherein each said component is dissolved in (vi) a major amount of water so as to dissolve and disperse alkali metal (e.g. potassium and sodium) ions in aqueous solution with dissolved polysaccharides from the biomolecular polymer (i.e. viscosity thickener), so as to form a thin fire retardant coating comprising a mixture of alkali metal potassium and sodium salt crystals and polysaccharides (e.g. Xanthan gum material) applied to combustible surfaces, as water molecules evaporate from the applied mixed retardant to the atmosphere, to provide the combustible surface with proactive protection against fire ignition and flame spread, without producing toxic and/or otherwise detrimental effects to human, animal, and plant/botanical life.

When practicing the environmentally-clean fire retarding compositions of the present invention, the starting biochemical(s), namely the non-polymerized saturated carboxylic acid, are organic acids, each of which contains a carboxyl group (C(—O)OH) attached to an R-group (R=alkyl or aryl). Carboxylic acids (denoted by R—COOH) are weak acids, meaning they are not 100% ionized in water. Generally, only about 1% of the molecules of a carboxylic acid dissolved in water are ionized at any given time. The remaining molecules are undissociated in solution. Being “saturated” means in this case, that each carbon (C) atom is bonded to four other atoms (i.e. hydrogen or carbon)—the most possible, and that there are no double or triple bonds in the molecules. The word saturated has the same meaning for hydrocarbons as it does for the dietary fats and oils: the molecule has no carbon-to-carbon double bonds (C═C).

The carbon-hydrogen bond (C—H bond) in the saturated non-polymerized carboxylic acid is a chemical bond between carbon and hydrogen atoms that can be found in many organic compounds. This bond is a covalent, single bond, meaning that carbon shares its outer valence electrons with up to four hydrogens. This completes both of their outer shells, making them stable. The C—H bond in general is very strong, so it is relatively unreactive.

The term “non-polymerized” means that carbon and hydrogen atoms in the saturated carboxylic acid have not undergone polymerization or any process of reaction, in which relatively small molecules (monomer molecules) are reacted or combined chemically together in a chemical reaction to form very large chainlike or network molecule, called a polymer chains or three-dimensional network.

It is understood that there are many forms of polymerization and different systems exist to categorize them. For example, a tricarboxylic acid, by the name itself, says that it is a category of carboxylic acid which has 3 C (—O) OH groups. In a carboxylic acid group, a carbon (C) atom is bonded to an oxygen (O) atom by a double bond, and to a hydroxyl group (—OH) by a single bond i.e., its functional group represented as C(═O) OH. Carboxylic acids occur widely in nature and its derivatives are of utmost importance in various chemical reactions. Tricarboxylic acids belong to the class of carboxylic acids which contains 3 carboxyl groups (C(—O)OH) attached to R-groups (R=alkyl or aryl).

At this juncture, it will be helpful to briefly identify a few kinds of carboxylic acids that are found in nature and which are of significance for purposes of the present invention, namely: the citric acid compound, a weak acid naturally occurring in citric fruits, which carries 3 carboxyl groups (C(═O)OH) attached to the parent chain, and hence is a tricarboxylic acid, a weak acid which naturally occurs in citric fruits; malonic acid, which carries only 2 carboxyl groups (C(═O)OH), and therefore is a dicarboxylic acid; succinic acid, which carries only 2 carboxyl groups (C(—O)OH), and therefore is a dicarboxylic acid; and malic acid, which also carries only 2 carboxyl groups (C(—O)OH), and therefore is a dicarboxylic acid. Since tricarboxylic acids have 3 carboxyl groups (C(═O)OH) attached to R-groups, it does have the ability to form strong hydrogen bonds, and this results in their high boiling points. Reference is made to the published organic chemistry textbook titled “MARCH'S ADVANCED ORGANIC CHEMISTRY: Reactions, Mechanisms, and Structures (Eighth Edition)”, Michael B. Smith, published by John Wiley & Sons, Inc., 2020, and incorporated herein by reference. Whenever available, all chemical substances and compounds disclosed herein have been provided with their CAS Registration Nos. as registered in the CAS Common Chemistry Database https://commonchemistry.cas. org/In general, the novel environmentally-clean (i.e. “green”) fire retarding biochemical liquid compositions comprise a number of core elements, namely: (a) a dispersing agent in the form of a major quantity of water, for dispersing metal ions dissolved in water; (b) a major amount of a primary fire retarding agent in the form of a primary alkali metal salt of a nonpolymeric saturated carboxylic acid, for providing primary metal alkali ions dispersed in the water when the primary alkali metal potassium salt is dissolved in the water; (c) a minor amount of a secondary fire retarding agent in the form of a secondary alkali metal salt of a nonpolymeric saturated carboxylic acid, for example, benzoic acid, for providing secondary, benzoate ions dispersed in the water when the secondary alkali metal salt is dissolved in the water, for inhibiting the corrosion of specific metals, namely 2024-T3 Aluminum, 4130 Steel, Bright Steel, Yellow Brass, and Az31B Magnesium (used to fabricate retardant mixing, storage and delivery equipment) caused by the reaction of primary alkali metal (e.g. potassium and/or sodium) ions dispersed in the water with metallic components used during mixing, storing and application operations of the mixed retardant product; (d) a minor amount of a thickening agent in the form of a biomolecular polymer, such as Xanthan Gum, consisting essentially of polysaccharides for increasing the viscosity of the mixed retardant liquid during mixed retardant application operations; and (e) a minor amount of a dispersing agent (e.g. triethyl citrate) for dispersing benzoate ions present in the water when the at least one secondary alkali metal salt is dissolved in the mixed retardant solution, so as to promote the formation of a corrosion inhibiting coating on metals contacting the mixed retardant solution and inhibiting surface corrosion reactions involving said metals; and (f) a minor amount of a coloring agent, preferably in the form of a fugitive colorant dye pigment powder (e.g. U.S. Pat. No. 12,043,745 Assigned to Day-Glo Color Corp., incorporated herein by reference) or non-fugitive colorant pigment powder for imparting a visible color (e.g. red or green) when the mixed fire retarding biochemical liquid composition is being applied to combustible surfaces to be protected against fire, while water molecules in the mixed retardant liquid evaporate to the environment during drying, thereby forming thin fire retardant coatings comprising a mixture of alkali metal potassium and sodium salt crystals and polysaccharides of biomolecular polymer, such as Xanthan Gum or other biomolecular polymer material.

In the world of organic chemistry, there are many possible non-polymeric saturated carboxylic acids that can be used to derive and produce alkali metal salts thereof for use in producing environmentally-clean aqueous-based liquid fire retardants of the present invention, that can be applied to combustible surfaces (using aerial and ground methods) and form thin fire retardant coatings comprising a mixture of alkali metal potassium and sodium salt crystals and polysaccharides of biomolecular polymer that effectively inhibit fire ignition and flame spread.

Such possible carboxylic acids include, but are not limited to, the following carboxylic acids organized according to the number of carbon atoms (Ci) contained therein, namely:
(C1) The C1 Class of Carboxylic Acids having 1 carbon atom (C=1), including formic acid (i.e. methanoic acid) CH₂O₂, and carbonic acid (i.e. hydroxymethanoic acid) H₂CO₃;
(C2) The C2 Class of Carboxylic Acids having 2 carbon atoms (C=2), including acetic acid (ethanoic acid) CH₃COOH, glycolic acid (hydroxyacetic acid) C₂H₄O₃, and glyoxylic acid C₂H₂O₃;
(C3) The C3 Class of Carboxylic Acids having 3 carbon atoms (C=3), including propionic acid C₃H₆O₂, lactic acid C₃H₆O₃, glyceric acid C₃H₆O₄, pyruvic acid C₃H₄O₃, and tartaric acid C₃H₆O₆;
(C4) The C4 Class of Carboxylic Acids having 4 carbon atoms (C=4), including butyric acid CH₃(CH₂)₂COOH, malic acid C₄H₆O₅, and malonic acid C₃H₄O₄;
(C5) The C5 Class of Carboxylic Acids having 5 carbon atoms (C=5), including pivalic acid C₅H₁₀O₂;
(C6) The C6 Class of Carboxylic Acids having 6 Carbon Atoms (C=6), including caproic acid CH₃(CH₂)₄COOH, adipic (hexanedioic) acid HOOC(CH₂)₄COOH, citric acid HOC(COOH)((CH₂)COOH)₂, and d-gluconic acid C₆H₁₂O₇; and
(C7) The C7 Class of Carboxylic Acids having 7 carbon atoms (C=7), including benzoic acid C₇H₆O.

While many alkali metal salts can be produced from these carboxylic acids listed above, the alkali metal salts of citric acid under Group C6 are particularly preferred, as will be further explained hereinbelow.

While the efficacy of the alkali metal salts increases in the order of lithium, sodium, potassium, cesium and rubidium, the salts of potassium and the salts of sodium are preferred for cost of manufacturing reasons. Potassium carboxylates are very particularly preferred, but tripotassium citrate monohydrate (TPC) is the preferred primary alkali metal salt for use in formulating the environmentally-clean fire retarding biochemical compositions of the present invention.

While it is understood that other alkali metal salts are available to practice the biochemical compositions of the present invention, it should be noted that the selection of tripotassium citrate as the preferred alkali metal salt, includes the follow considerations: (i) the atomic ratio of carbon to potassium (the metal) in the utilized alkali metal salt (i.e. tripotassium citrate); (ii) that tripotassium citrate is relatively stable at transport and operating temperatures; (iii) tripotassium citrate is expected to be fully dissociated to citrate and potassium when dissolved in water, and that the dissociation constant is not relevant for the potassium ions, while citric acid/citrate has three ionizable carboxylic acid groups, for which pKa values of 3.13, 4.76 and 6.4 at 25° C. are reliably reported in the European Chemicals Agency (ECHA) handbook; and (iv) tripotassium citrate produces low carbon dioxide levels when dissolved in water.

Tripotassium citrate is an alkali metal salt of citric acid (a weak organic acid) that has the molecular formula C₆H₈O₇. While citric acid occurs naturally in citrus fruit, in the world of biochemistry, citric acid is an intermediate in the celebrated “Citric Acid cycle, also known as the Krebs Cycle (and the Tricarboxylic Acid Cycle), which occurs in the metabolism of all aerobic organisms. The role that citric acid plays in the practice of the preferred embodiments of the biochemical compositions and solutions of the present invention will be described in greater detail hereinafter.

Preferably, the secondary fire retarding agent is in the form of another alkali metal salt of a nonpolymeric saturated carboxylic acid, selected to provide inhibition to the corrosion of specific metals, namely, for example, 2024-T3 Aluminum, 4130 Steel, Bight Steel, Yellow Brass, and Az31B Magnesium, while functioning as a secondary fire retardant agent. When using tripotassium citrate (TPC) as the primary fire retarding agent, the use of sodium benzoate, potassium benzoate, calcium benzoate or magnesium benzoate, is preferred as a secondary fire retarding and anti-corrosion agent, as sodium, potassium, calcium or magnesium benzoate have good molecular and chemical compatibility with tripotassium citrate. Significantly, the benzoate ions produced when an alkali metal salt of benzoic acid (e.g. sodium benzoate, potassium benzoate, calcium benzoate or magnesium benzoate) is dissolved in water functions in the formation of a corrosion inhibiting layer or coating on the metal, inhibiting surface corrosion reactions involving specific metals used in the fabrication of mixing, storage and/or delivery equipment, in which the mixed fire retarding biochemical liquid of the present invention may come in surface contact during expected use. This involves the benzoate ions combining with other chemical species on the metal surface contacting the mixed liquid retardant to form thin films that function as barriers and inhibitors to the formation of chemical surface reactions involving such specific metals, namely, 2024-T3 Aluminum, 4130 Steel, Bright Steel, Yellow Brass, and Az31B Magnesium, in illustrative embodiment. Such chemical surface reactions involve oxidation and/or reduction of such metals which causes corrosion and other forms of deterioration which are undesirable, costly and should be avoided.

In the preferred application, the minor amount of a dispersing agent (e.g. triethyl citrate, CAS RN 77-93-0) is used for dispersing benzoate ions present in the water when the at least one alkali metal salt is dissolved in the mixed retardant solution. Triethyl citrate is available from Jungbunzlauer (JBL) of Switzerland, and functions to promote the formation of a corrosion inhibiting coating on metals contacting the mixed retardant solution and inhibiting surface corrosion reactions involving said metals.

In a preferred application, the use of a colorant, or coloring agent, may be advantageous with or without opacifying assistants, to the fire retarding chemical compositions of the present invention. Of advantage in many aerial applications are fugitive colorants, such as dyes and food dyes for example, which fade as the fire-retarding composition dries and gradually decompose or are otherwise easily removable, for example, by flushing with water. Fugitive coloring agents may be realized in the form of a fluorescent dye pigment powder (e.g. DayGlo ELX-2100FR by Day-Glo Color Corp.) made under U.S. Pat. No. 12,043,745, incorporated herein by reference. In an illustrative embodiment, the hybrid pigment comprises (i) Acid Red Dye 52 (CAS RN 1658-56-6) deposited on (ii) a natural polyamide material such as rice protein Oryza sativar, which is marketed by Axiom Foods, Inc. under the brand name Oryzatein™. The hybrid pigment material is made by depositing Acid Red Dye 52 onto rice protein substrate, and then milling the material into a fine powder of micron size for use as a fugitive coloring agent in a target chemical formulation. Preferably, the concentration of the colorant dye in the fire-retarding biochemical composition is preferably in the range from 0.005% to 10% by weight, more preferably in the range from 0.01% to 5% by weight, and most preferably in the range from 0.015% to 2% by weight.

Alternatively, the colorant may be realized in the form of a non-fugitive colorant, such as a non-fugitive colorant pigment powder (e.g. red iron oxide powder, or green iron oxide powder) for imparting a visible color (e.g. red) when the fire retardant is dispersed into the environment. When using a coloring agent, areas which have already been treated are easier to identify, for example, from the air. However, in some applications, no colorant may be used, and instead, GPS tracking and mapping methods as covered in Applicant's U.S. Pat. No. 10,653,904, incorporate herein by reference, may be used to track and map where fire retardant has been deposited for fire protection.

A preferred thickening agent, realized in the form of a biomolecular polymer consisting essentially of polysaccharides, may be any material selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan. Once selected, the thickening agent is added in minor amounts to the aqueous solution to thicken the mixed fire retarding biochemical liquid, and increase and/or control its viscosity (e.g. to within the range of 150-400 cP for Low Viscosity Applications, to within the range of 401-800 cP for Medium Viscosity Applications, to within the range of 801-1500 cP for High Viscosity Applications, or to within the range of 5-149 [cP] for Ultra-Low Viscosity Applications). The viscosity that will be required will depend on the delivery method and environmental conditions as discussed hereinabove.

In general, for aerial delivery, the viscosity of the mixed retardant liquid aboard an airtanker should be selected so that the mixed retardant liquid when dropped from the airtanker—moving at particular speed and altitude above the Earth's surface—will produce a cloud of liquid retardant droplets that will fall upon and adhere to combustible target surfaces, while being GPS-tracked and mapped, so that thin fire retardant coatings are formed, in the preferred embodiments, comprising potassium (and sodium) salt crystals mixed within the polysaccharide chains of the biomolecular polymer, to provide long duration proactive fire protection. Preferably, the concentration of the thickening agent used in the fire-retarding biochemical liquid composition is preferably in the range from 0.005% to 10% by weight, more preferably in the range from 0.01% to 5% by weight, and most preferably in the range from 0.015% to 2% by weight.

The fire retarding biochemical liquid compositions of the present invention are producible and prepared by mixing the components in specified amounts with water to produce the fire retarding composition products. The order of mixing is discretionary. It is advantageous to produce aqueous preparations by mixing the components other than water, into water.

The fire retarding biochemical liquid compositions of the present invention have a good long term fire retarding effect and a good immediate fire extinguishing effect, and are specially adapted for aerial delivery to ground-based surface targets. However, the fire retarding liquid can be used in ground spraying applications when its viscosity is suitably adapted for ground applications which typically will be in the in the Ultra-Low Viscosity range of 10 [cP]-149 [cP].

The compositions of the present invention are also useful as a fire extinguishing agent for fighting fires of Class A, B, C and D. For example, an aqueous biochemical solution of the present invention may be prepared and deployed for firefighting uses in diverse applications. However, as taught herein, the aqueous fire retardant biochemical composition can made in Concentrate Form and not mixed with the specified amount of water to produce Mixed Retardant until it is needed, and when so, by either (i) mixing Dry Concentrate powder with a quantity of water according to the Dry Concentrate Mix Ratio, or (ii) by mixing Wet Concentrate liquid with proportioned amounts of water according to a Wet Concentrate Mix Ratio, using a mixing nozzle, in a conventional manner.

### Specification Of Preferred Embodiments Of Aqueous-Based Fire Retardant Biochemical Compositions Of Matter

As indicated above, while there are many species of Applicant's aqueous-based fire retarding biochemical liquid solution, based on different kinds of non-polymeric saturated carboxylic acids and alkali metal salts dissolved in water for forming thin fire-retarding alkali metal salt crystal and polysaccharide based coatings, Applicant's preferred solutions and compositions are based on a mixture of alkali metal salts comprising (i) a major amount of alkali metal potassium salts derived from the citric carboxylic acid, (ii) a minor amount of alkali metal sodium, potassium, calcium or magnesium salts derived from benzoic acid, for providing benzoate ions in the solution to form a coating or layer on metal surfaces to inhibit corrosion reactions, (iii) a minor amount of the polysaccharides of a biomolecular polymer material, such as xanthan gum material, dissolved in a major amount of water, and (iv) a minor amount of benzoate ion dispersing agent realized as an ester of citric acid, such as triethyl citrate (TEC), for dispersing metal alkali ions and benzoate ions in the mixed retardant solution for enabling the formation of corrosion inhibition coatings on metal surfaces, and potassium salt crystals mixed with polysaccharide coatings formed on combustible surfaces. These preferred embodiments will be specified in great technical detail below.

In the first preferred embodiment of the fire retarding liquid biochemical composition/solution of the present invention, the components are realized as follows: (a) the dispersing agent is realized in the form of a major amount of water, for dispersing alkali metal ions dissolved in the water; (b) a major amount of a first fire retarding agent realized in the form of a first alkali metal salt of a nonpolymeric saturated carboxylic acid, specifically, tripotassium citrate, for providing metal (potassium) ions dispersed in the water when the at least one alkali metal salt is dissolved in the water to form a mixed retardant solution; (c) a minor amount of a second fire retarding agent realized in the form of a second alkali metal salt of a nonpolymeric saturated carboxylic acid, specifically, sodium benzoate, potassium benzoate, calcium benzoate or magnesium benzoate, for providing benzoate ions dispersed in the water when the at least one alkali metal salt is dissolved in the mixed retardant solution, for forming coatings and layers that inhibit surface corrosion reactions (i.e. oxidation and/or reduction) involving metals contacting the mixed retardant solution, including specific metals, namely, 2024-T3 Aluminum, 4130 Steel, Bright Steel, Yellow Brass, and Az31B Magnesium, while functioning as a secondary fire retardant agent; (d) a minor amount of thickening agent in the form of a biomolecular polymer consisting essentially of polysaccharides, for increasing the viscosity of the mixed retardant liquid during application operations; (e) a minor amount of a dispersing agent (e.g. triethyl citrate) for dispersing benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals; and (f) a minor amount of coloring agent in the form of fugitive red dye pigment powder, for imparting a visible color (e.g. red) when the fire retarding biochemical liquid composition is applied to a surface to be protected against fire, while water molecules in the retardant liquid evaporate during drying, to form a thin fire retardant coating having a characteristic visible color (e.g. red) and comprising a mixture of alkali metal salt crystals and the polysaccharide chains of the biomolecular polymer material, such as Xanthan gum material, deposited on the treated surfaces.

In the second preferred embodiment of the fire retarding biochemical liquid biochemical solution of the present invention, the components are realized as follows; (a) the dispersing agent is realized in the form of a major amount of water, for dispersing alkali metal ions dissolved in the water; (b) a major amount of a first fire retarding agent realized in the form of a first alkali metal salt of a nonpolymeric saturated carboxylic acid, specifically, tripotassium citrate, for providing metal (potassium) ions dispersed in the water when the at least one alkali metal salt is dissolved in the water to form a mixed retardant solution; (c) a minor amount of a second fire retarding agent realized in the form of a second alkali metal salt of a nonpolymeric saturated carboxylic acid, specifically, sodium benzoate, potassium benzoate, calcium benzoate or magnesium benzoate, for providing benzoate ions dispersed in the water when the at least one alkali metal salt is dissolved in the mixed retardant solution, for forming coatings and layers that inhibit surface corrosion reactions (i.e. oxidation and/or reduction) involving metals contacting the mixed retardant solution, including specific metals, namely 2024-T3Aluminum, 4130 Steel, Bright Steel, Yellow Brass, and Az31B Magnesium, while functioning as a secondary fire retardant agent; (d) a minor amount of thickening agent in the form of a biomolecular polymer consisting essentially of polysaccharide chains, for increasing the viscosity of the mixed retardant liquid during application operations, when the fire retarding biochemical liquid composition is applied to a surface to be protected against fire, while water molecules in the retardant liquid evaporate during drying; and (e) a minor amount of a dispersing agent (e.g. triethyl citrate) for dispersing benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals. When this mixed solution is applied to a surface to be treated, a thin fire retardant coating is formed not having a characteristic color (e.g. red) comprising alkali metal (potassium and sodium) salt crystals mixed within the polysaccharide chains of a biomolecular polymer material added to the mixed retardant liquid, to provide a long duration of proactive fire protection to the treated surfaces, long after the water molecules evaporate to the ambient environment.

Polysaccharides (or polycarbohydrates) are the most abundant carbohydrates found in food. They are large, long-chain, high-molecular weight polymer molecules, called polymeric carbohydrates, that are composed of from ten to thousands of monosaccharide units bound or joined together by glycosidic linkages. This polycarbohydrate can react with water (hydrolysis) using amylase enzymes as catalyst, which produces constituent sugars (monosaccharides, or oligosaccharides). They range in structure from linear to highly branched. Examples include (i) storage polysaccharides such as starch, glycogen and galactogen, and structural (ii) polysaccharides such as cellulose and chitin. Polysaccharides can be differentiated according to the nature of monosaccharides components, length of chains, and the branching of those chains.

As a rule of thumb, polysaccharides contain more than ten monosaccharide units, whereas oligosaccharides contain three to ten monosaccharide units, but the precise cutoff varies somewhat according to the convention. Polysaccharides are an important class of biological polymers. Their function in living organisms is usually either structure-related, or storage-related. Starch (a polymer of glucose) is used as a storage polysaccharide in plants, being found in the form of both amylose and the branched amylopectin. In animals, the structurally similar glucose polymer is the more densely branched glycogen, sometimes called “animal starch”. Glycogen's properties allow it to be metabolized more quickly, which suits the active lives of moving animals. In bacteria, they play an important role in bacterial multicellularity.

Bacteria and many other microbes, including fungi and algae, often secrete polysaccharides to help them adhere to surfaces and to prevent them from drying out. Humans have developed some of these polysaccharides into useful products, including xanthan gum, dextran, welan gum, gellan gum, diutan gum and pullulan.

Most of these polysaccharides exhibit useful viscoelastic properties when dissolved in water at very low levels. This makes various liquids used in everyday life, such as some foods, lotions, cleaners, and paints, viscous when stationary, but much more free-flowing when even slight shear forces are applied by stirring or shaking, pouring, wiping, or brushing. This property is named pseudoplasticity or shear thinning. The study of such matters is called rheology.

In view of the above, the thickening agent used in the fire retarding biochemical liquid to provide the biomolecular polymer consisting essentially of polysaccharides, can be realized using a wide variety of materials such as: storage polysaccharides such as starch, glycogen and galactogen; and structural polysaccharides such as cellulose and chitin. The storage polysaccharides include microbial polysaccharides produced by microorganisms such as bacteria, fungi, yeast, and algae, such as xanthan gum, dextran, welan gum, gellan gum, diutan gum and pullulan, and microbial polysaccharides accumulated inside the cells such as glycogen where they function as energy and carbon reserves. The structural polysaccharides include the abundant biopolymer, cellulose, which is a non-branched polysaccharide polymer consisting of a linear chain of several hundred to many thousands of β (1→4) linked D-glucose units. For wood fibers, the cellulose chain has an average length of 5 μm corresponding to a degree of polymerization (i.e., glucose units) of 10,000.

Preferably, wood cellulose fiber, produced from recycled wood fiber collected from trees removed during forest management, can be treated and conditioned to liberate cellulose from ground wood fibers and used as a thickening agent when making the Dry Concentrate, Wet Concentrate and Read-to-Use forms of the Mixed Retardant Products of the present invention. Wood cellulose fiber consists of cellulose fibers obtained from wood pulp through a series of chemical and mechanical processes. Wood cellulose fiber primarily consists of cellulose, hemicellulose, and lignin. However, cellulose is the dominant component, comprising up to 90% of the fiber. These fibers are incredibly fine, making wood cellulose fiber an ideal candidate for various applications. Wood cellulose fiber has remarkable properties, including high tensile strength, biodegradability, and excellent absorbency. In addition to being eco-friendly, sourced from sustainably managed forests, and biodegradable, wood cellulose fiber can be used as a thickening agent for controlling the viscosity of the mixed fire retarding biochemical liquid of the present invention.

In aerial and ground based retardant delivery applications, illustrated using the vehicles shown and described in FIGS. 8A through 10B, when the wood cellulose fiber is used as a thickening agent for the mixed retardant liquid, it is understood that the viscosity can be selected to be rather high (e.g. in the range between 401-800 [cP] Medium Viscosity, or between 801-1500 [cP] High Viscosity), in order to create and form relatively thick long term fire retardant coatings that serve as long term wildfire breaks and protection zones, formed around power and communication utility poles and related structures, and other building structures, and other strategic locations. In such applications, the minor amount of dispersant, such as triethyl citrate (TEC)(CAS RN 77-93-0), an ester of citric acid, that can be added to the mixed fire retardant formulation, should help reduce surface tension within the retardant liquid solution and enable the potassium and sodium ions dissolved in solution to more effectively penetrate and bind to the cellulose wood fiber material, especially dissolved polysaccharides associated with the wood cellulose fiber thickening agent. Through such surface penetration action, it will be possible to form and maintain more enduring fire retardant coatings when the water molecules in the applied retardant liquid coating evaporate to the environment, thereby enhancing the durability of the long term fire retardant coatings of the present invention under such circumstances.

In the preferred embodiment(s) of the present invention shown for use in aerial delivery operations, the preferred thickening agent used in the mixed fire retardant product(s) is Xanthan gum—the extracellular polysaccharide produced by the bacterium Xanthomonas. The primary structure of xanthan gum is a biomolecular polymer consisting of a cellulose backbone (of β-glucose-linked β-units substituted on glucose residues replaced by a side-chain trisaccharide) with branches of the sugars-galactose and mannose. However, unlike like starch, xanthan gum also builds viscosity over a wide variety of temperatures; but unlike starch, xanthan gum does not break down into simple sugars when consumed. Favorably, Xanthan gum can take on a helical structure as illustrated in Step B of FIG. 7B which provides a suitable structure for encapsulating and arranging potassium and sodium salt crystals within a polysaccharide matrix of sorts, forming the applied long term fire retardant coatings of the present invention.

Once the mixed retardant (liquid) solution of the present invention is prepared according to the formulations specified above, the mixed retardant product is stored in properly labeled containers, bottles, or totes (i.e. packages) suitable for end user applications in mind. Thereafter, the filled package of mixed retardant product should be sealed with appropriate sealing technology. The package of fire retardant product (in dry concentrate form) or mixed retardant product (ready-to-use or wet concentrate form) should be immediately labeled with a specification of (i) its biochemical components, with weight percent measures where appropriate, and the date and time of manufacture, printed and recorded in accordance with good quality control (QC) practices well known in the art. Where necessary or desired, barcode symbols and/or barcode/RFID identification tags and labels can be produced and applied to the sealed package to efficiently track each barcoded package containing a specified quantity of fire retardant biochemical composition. All products and QC information should be recorded in a globally accessible network database, for use in tracking the movement of the package as it moves along the supply chain from its source of manufacture, towards its end use at a GPS specified location.

### Specification Of Preferred Embodiments Of The Dry Fire Retardant Biochemical Compositions Of Matter Assembled As A Fire Retardant Biochemical Composition For Use With Specified Quantities of Water

In the third preferred embodiment of the fire retarding liquid biochemical solution of the present invention, the components are realized as follows: (a) the fire inhibiting agent is realized in the form of major amount of a first alkali metal salt of a nonpolymeric saturated carboxylic acid, specifically, tripotassium citrate (TPC), for providing metal potassium ions to be dissolved and dispersed in a quantity of water; (b) a minor amount of a second fire retarding agent realized in the form of a second alkali metal salt of a nonpolymeric saturated carboxylic acid, specifically, sodium benzoate, potassium benzoate, calcium benzoate or magnesium benzoate, for providing benzoate ions dispersed in the water when the at least one alkali metal salt is dissolved in the mixed retardant solution, for forming coating or layers on metal surfaces to be protected, and inhibiting surface corrosion reactions involving metals contacting the mixed retardant solution, including specific metals, namely 2024-T3 Aluminum, 4130 Steel, Yellow Brass, Bright Steel, and Az31B Magnesium, while functioning as a secondary fire retarding agent along with the potassium ions; (c) a minor amount of thickening agent in the form of a biomolecular polymer consisting essentially of polysaccharides (e.g. Xanthan gum) for increasing the viscosity of the mixed retardant liquid during application operations; (d) a minor amount of dispersing agent (i.e. triethyl citrate) for dispersing benzoate ions within the solution with polysaccharides, to help form a corrosion inhibiting coating on metals to be protected against corrosion; (e) a minor amount of coloring agent in the form of fugitive red dye powder for imparting a visible color (e.g. fluorescent red), of fugitive type, when the fire retarding biochemical liquid composition is applied to a surface to be protected against fire; wherein the dry powder components described above are mixed together and dissolved in a major amount of water to produce a mixed retardant solution in either ready-to-use non-diluted form, or wet concentrate form for mixing with a specified amount of water, to produce a mixed fire retardant product adapted for application to combustible surfaces by aerial delivery or ground application, while water molecules in the retardant liquid evaporate during drying, to form a thin fire retardant coating having a characteristic red color and comprising a mixture of alkali metal (potassium, and sodium, calcium or magnesium) salt crystals mixed with the polysaccharide chains of the biomolecular polymer material (e.g. Xanthan gum material) deposited on the treated combustible surfaces.

In the fourth preferred embodiment of the fire retarding biochemical liquid solution of the present invention, the components are realized as follows: (a) a major amount of a first fire retarding agent realized in the form of a first alkali metal salt of a nonpolymeric saturated carboxylic acid, specifically, tripotassium citrate, for providing metal potassium ions to be dissolved and dispersed in a quantity of water; (b) a minor amount of a second fire retarding agent realized in the form of a second alkali metal salt of a nonpolymeric saturated carboxylic acid, specifically, sodium benzoate, potassium benzoate, calcium benzoate or magnesium benzoate) for providing benzoate ions dispersed in the water when the at least one alkali metal salt is dissolved in the mixed retardant solution, and forming coatings or layers inhibiting surface corrosion reactions involving metals contacting the mixed retardant solution, including specific metals, namely 2024-T3 Aluminum, 4130 Steel, Bright Steel, Yellow Brass, and Az31B Magnesium, while functioning as a secondary fire retardant agent along with potassium ions from the first fire retarding; (d) a minor amount of thickening agent in the form of a biomolecular polymer consisting essentially of polysaccharides (e.g. Xanthan Gum (XG) material) for increasing the viscosity of the mixed retardant liquid during application operations; and (e) a minor amount of dispersing agent (i.e. triethyl citrate) for dispersing benzoate ions within the solution with polysaccharides, to help form a corrosion inhibiting coating on metals to be protected against corrosion, when the mixed retardant solution makes contact with the metal surfaces; wherein the dry powder components described above are mixed together and dissolved in a major amount of water to produce a mixed retardant solution in either read-to-use non-diluted form, or wet concentrate form for mixing with a specified amount of water, to produce a mixed fire retardant product adapted for application to combustible surfaces by aerial delivery or ground application, while water molecules in the retardant liquid evaporate during drying, while water molecules in the retardant liquid evaporate during drying, to form a thin fire retardant coating not having a characteristic color and comprising a mixture of alkali metal potassium and sodium salt crystals mixed within the polysaccharide chains of a biomolecular polymer material (e.g. Xanthan Gum material) deposited on the treated combustible surfaces.

### Selecting Tripotassium Citrate (TCP) As A Preferred Fire Retarding Agent For Use In The Fire Retarding Biochemical Compositions Of The Present Invention

In the preferred embodiments of the present invention, tripotassium citrate (TPC) is selected as an active fire retardant chemical component in fire inhibiting biochemical solution. In dry form, TPC is known as tripotassium citrate monohydrate (C₆H₅K₃O₇·H₂O) which is the common tribasic potassium salt of citric acid, also known as potassium citrate. It is produced by complete neutralization of citric acid with a high purity potassium source, and subsequent crystallization. Tripotassium citrate occurs as transparent crystals or a white, granular powder. It is an odorless substance with a cooling, salty taste. It is slightly deliquescent when exposed to moist air, freely soluble in water and almost insoluble in ethanol (96%).

Tripotassium citrate is a non-toxic, slightly alkaline salt with low reactivity. It is chemically stable if stored at ambient temperatures. In its monohydrate form, TPC is very hygroscopic and must be protected from exposure to humidity. Tripotassium citrate monohydrate is considered “GRAS” (Generally Recognized As Safe) by the United States Food and Drug Administration (FDA) without restriction as to the quantity of use within good manufacturing practice. CAS Registry Number for tripotassium citrate monohydrate: [6100 May 6]. E-Number: E332.

Tripotassium citrate monohydrate (TPC) is a non-toxic, slightly alkaline salt with low reactivity. It is a hygroscopic and deliquescent material. It is chemically stable if stored at ambient temperatures. In its monohydrate form, it is very hygroscopic and must be protected from exposure to humidity. Its properties are:
Monohydrate
White granular powder
Cooling, salty taste profile, less bitter compared to other potassium salts
Odorless
Very soluble in water
Potassium content of 36%
Slightly alkaline salt with low reactivity
Hygroscopic.
Chemically and microbiologically stable
Fully biodegradable
Allergen and GMO free

Jungbunzlauer (JBL), a leading Swiss manufacturer of biochemicals, manufactures and distributes TPC for food-grade, healthcare, pharmaceutical and over the counter (OTC) applications around the world. As disclosed in JBL's product documents, TPC is an organic mineral salt which is so safe to use around children and adults alike. Food scientists worldwide have added TPC to (i) baby/infant formula powder to improve the taste profile, (ii) pharmaceuticals/OTC products as a potassium source, and (iii) soft drinks as a soluble buffering salt for sodium-free pH control in beverages, improving stability of beverages during processing, heat treatment and storage.

### Specification Of Preferred Formulations For The Fire Retarding Biochemical Compositions of Matter According To The Present Invention

### Example #1: First Illustrative Embodiment of The Liquid-Based Fire Retardant Biochemical Composition Of The Present Invention

FIG. 6A1 illustrates the primary components of a first illustrative embodiment t of the environmentally-clean aqueous-based fire retarding liquid biochemical composition of the present invention (i.e. a “mixed ready-to-use” or “wet concentrate” fire retarding solution) consisting of tripotassium citrate (TPC), sodium benzoate (SB), Xanthan Gum (XG), triethyl citrate (TEC), and red dye pigment (i.e. DayGlo ELX-2100FR fluorescent red hybrid pigment), formulated with a major amount of water functioning as a solvent, carrier, and dispersant in the biochemical fire retardant composition.

Example 1: Schematically illustrated in FIG. 6A1: A fire-extinguishing and/or fire-retarding biochemical composition, in “mixed ready-to-use” or “wet concentrate” form, was produced by stirring the following components into 114.2 [Oz.] (7.13 [Lbs.]) of water of water at 72° F. temperature, volumetrically measuring 3258 [ml] or 0.860 [Gal US], to produce a total of 1.0 gallon [US Gal] of finished mixed retardant solution:
7.13 [Lbs.]=114.2 [Oz.]=3237.51 [gm] of water as solvent;
1.50 [Lbs.] (680.37 [gm]) of tripotassium citrate (TPC) as primary fire retarding agent (i.e. alkali metal salt);
3.00 [Oz.] (85.05 [gm]) of sodium benzoate (SB) as a secondary fire retarding agent and corrosion inhibiting agent;
0.265 [Oz.] (7.512 [gm]) of Xanthan gum (XG);
2.415 [Oz.] (68.46 [gm]) of triethyl citrate (TEC) ester; and
0.350 [Oz.] (9.92 [gm]) of DayGlo ELX-2100FR magenta hybrid pigment powder made under U.S. Pat. No. 12,043,745 (incorporated by reference) comprising Acid Red 52 Dye (CAS RN 3520-42-1) deposited on the biodegradable rice protein substrate, i.e. “protein hydrolysates” (CAS number 9015-54-7 covered under the EPA TSCA ID No. 16441), which is then milled into fine powder particles, as a fugitive red dye colorant.

The resultant mixed retardant (finished) solution has a total 1.0 gallon of volume, and total weight equaling 143.80 [Oz.]× 1/16 [Lbs./Oz.]=8.98 [lbs.]=4073.26 [gm], wherein the volumetric expansion factor of the mixed retardant solution is I/O.86=1.1627.

The weights and measures for CitroSafe™ MFB-30 Ready-To-Use (Wet Concentrate) Retardant Formulation are set forth as follows.

### Weights And Measures: Ready-To-Use/Wet Concentrate Formulation:

$$Major amount of Water : 114.2 [ Oz . ] ( 7.13 [ Lb . ] ) \times 28.349 [ gm / Oz . ] = 3237.51 [ gm ]$$

$$Major amount of Tripotassium Citrate ( TPC ) \text{} : 1.5 [ Lb . ] \times 16. / 1 [ Oz / Lb . ] = 24. [ Oz . ] \times 28.349$$

$$Minor amount of Sodium Benzoate \text{} : 3. [ Oz . ] \times 28.349 [ gm / Oz . ] = 85.047 [ gm ]$$

$$Minor amount of Triethyl Citrate ( TEC ) : 2.415 [ Oz . ] \times 28.349 [ gm / Oz . ] = 68.46 [ gm ]$$

$$Minor amount of Xanthan Gum \text{} : 0.265 [ Oz . ] \times 28.349 [ gm / Oz . ] - 7.512 [ gm ]$$

$$Minor amount of Fugitive Colorant ( ELX - 21000 FR ) : 0.35 [ Oz . ] \times 28.349 [ gm / Oz . ] = 9.92 [ gm ]$$

$$Total Weight of Dry Mix Ingredients ( including TEC ) = 852.31 [ gm ] = 1.88 [ Lb . ] = 30.08 [ Oz . ]$$

$$Total Weight of 1 Gallon of MFB - 30 Retardant ( Finished Product ) = 143.92 [ Oz . ] \times 1 / 16 [ Lb . / Oz . ] = 8.995 [ Lb . ] \text{=>} 143.92 [ Oz . ] \times 28.349 [ gm / Oz . ] = 4079.98 [ gm ]$$

$$Final Volume of {CitroSafe}^{TM} MFB \text{} - \text{} 30 Mixed Retardant ( Finished Product ) = 1. [ Gallon ]$$

$$Viscosity Measurement of Finished Product at 70 F - 240. [ cP ] ( [ mpa ] )$$

$$Volumetric Expansion Factor of the mixed retardant solution : 1 [ Gal ] / 0.86 [ Gal ] = 1.1627$$

### Summary Of Calculated Mass/Weight Percentage % Of Chemical Components Based On Formulation Of CitroSafe™ MFB-30 Ready-To-Use Liquid Chemical Fire Retardant

The Mass/Weight Percentage % by weight of the components used to make CitroSafe™ MFB-30 Ready-to-Use Retardant Formulation are set forth as follows:

$$The Mass / Weight Percentage \% of Triethyl Citrate : 68.46 [ gm ] / 4079.98 [ gm ] = 0.0167 \times 100 \text{=>} 1.67 \%$$

$$The Mass / Weight Percentage \% of Xanthan Gum \text{} : 7.512 [ gm ] / 4079.98 [ gm ] = 0.00184 \times 100 \text{=>} 0.18 \%$$

$$The Mass / Weight Percentage \% of Colorant ( ELX - 2100 FR ) \text{} : 9.92 [ gm ] / 4079.98 [ gm ] = 0.00243 \times 100 \text{=>} 0.24 \%$$

$$The Mass / Weight Percentage \% of Water : 3237.45 [ gm ] / 4079.98 [ gm ] = 0.7935 \times 100 \text{=>} 79.3 \%$$

$$The Mass / Weight Percentage \% of Tripotassium Citrate \text{} : 680.37 [ gm ] / 4079.98 [ gm ] = 0.1667 \times 100 \text{=>} 16.6 \%$$

$$The Mass / Weight Percentage \% of Sodium Benzoate \text{} : 85.047 [ gm ] / 4079.98 [ gm ] = 0.0208 \times 100 \text{=>} 2.08 \%$$

Total Mass/Weight Percentage of the Formulation: 100%

The Mass Density of CitroSafe™ MFB-30 Ready-to-Use (Premixed) Retardant Formulation is obtained as follows:

$$Mass Density ( i . e . Mass / Volume ) : 4079.98 [ gm ] / Gallon ] \to 4079.98 [ gm / Gallon ] * 1 / 453.592 [ Lb . / gm ] = 8.99 [ Lbs / Gallon ]$$

$$Mixing Ratio : Total Weight of Dry Chemical Ingredients \times Volumetric Expansion Ratio = 1.88 [ Lb . ] \times 1.162 [ 1 / Gal ] = 2.18 [ Lbs . / Gal ]$$

$$Mass Density of Retardant Salt ( Mass / Volume ) \text{} : [ \text{} 6.8 \text{.37} + 85.047 [ [ gm ] * 1 / 453.592 [ Lbs . / gm ] = 1.68 [ Lbs . / Gallon ]$$

### Example #2: Dry-Powder Fire Retarding Biochemical Composition

FIG. 6A2 illustrates the primary components of a fire retarding biochemical composition of the present invention, comprising: tripotassium citrate (TPC) dry powder, sodium benzoate (SB) dry powder, Xanthan gum (XG) dry powder, triethyl citrate (TEC) ester, and fugitive red dye powder components mixed and blended, in the specified amounts, for mixing with a predetermined quantity of water functioning as a solvent, carrier, and dispersant, (i.e. mixing 30.08 [Oz.]=852.31 [gm] of dry chemical ingredients, with 114.20 [Oz.]=3237.51 [gm] of water) to make up a predetermined quantity of environmentally-clean mixed fire retarding biochemical liquid composition of the present invention, for proactively protecting combustible products.

Example 2: Schematically Illustrated in FIG. 6A2, a fire-extinguishing and/or fire-retarding biochemical composition was produced by blending the following components, in amounts proportional to the Dry Concentrate Formulation set forth below, comprising:

680.37 [gm] of tripotassium citrate (TPC) powder as primary fire retarding agent (i.e. alkali metal salt);

85.04 [gm] of sodium benzoate (SB) powder as a secondary fire retarding agent and corrosion inhibitor involving specific metals, namely 2024-T3 Aluminum, 4130 Steel, Yellow Brass, and Az31B Magnesium;

7.51 [gm] of Xanthan gum (XG) powder;

68.46 [gm] of metal ion dispersing agent (e.g. triethyl citrate); and

9.92 [gm] of fugitive red dye pigment powder (DayGlo ELX-2100FR dye pigment powder);

wherein the blended components are packaged together in a container or package for mixing with 114.20 [Oz.] (3237.51 [gm]) of water, to produce a resultant mixed retardant solution having a total volume of 1.0 [US gallon], with a total weight equaling 143.80 [Oz.], wherein the Volumetric Expansion Factor (VEF) of the mixed retardant solution is I/O.86=1.1627.

### Total Mass/Weight Of Dry Concentrate To Be Mixed With 0.86 [US Gallon] Of Water:

$$Tripotassium Citrate ( TPC ) : 680.37 [ grams ]$$

$$Sodium Benzoate ( SB ) : 85.047 [ gm ]$$

$$Xanthan Gum ( XG ) : 7.512 [ gm ]$$

$$Triethyl Citrate : 2.415 [ Oz . ] \times 28.349 [ gm / Oz . ] - 68.46 [ gm ]$$

$$Colorant Pigment ( DayGlo ELX - 2100 FR ) \text{} : 0.35 [ Oz . ] \times 28.349 [ gm / Oz . ] = 9.92 [ gm ]$$

$$Total Mass / Weight of Dry Chemical Ingredients : 843.79 [ gm ] * 1 / 453.59 [ Lbs . / gm ] = 1.86 [ Lbs . ]$$

### Mass/Weight Percentage % Of Components In The CitroSafe™ MFB-30 “Dry Concentrate” Fire Retardant Formulation For Mixing With 0.86 [Gallon] Of Water

$$Tripotassium Citrate ( TPC ) powder ) : 680.37 [ gm ] / 851.74 [ gm ] = 0.7988 \times 100 = 79.88 \%$$

$$Sodium Benzoate ( SB ) Powder : 85.04 [ gm ] / 851.74 [ gm ] = 0.0998 \times 100 = 9.98 \%$$

$$Metal Ion Dispersing Agent ( e . g . triethyl citrate ) \text{} : 68.46 [ gm ] / 851.74 [ gm ] = 0.0803 = 8.03 \%$$

$$Xanthan Gum ( XG ) Powder : 7.512 [ gm ] / 851.74 [ gm ] = 0.00881 \times 100 = 0.881 \%$$

$$Fugitive Pigment Powder ( DayGlo ELX - 2100 FR ) \text{} : 9.92 [ gm ] / 851.74 [ gm ] = 0.0116 = 1.17 \%$$

$$Total Mass / Weight : 100. \%$$

### Use Level Analysis of the Dry Concentrate Formulation of CitroSafe™ MFB-30 Fire Retardant Product (2.18 Mix Ratio):

$$Mix Ratio : 1.88 [ Lbs . / Gal ] \times 1. / 0.86 [ Gal / Gal ] = 2.18 [ Lbs . / Gal ]$$

Dry Concentrate Mix Ratio (i.e. Amount Of Dry Concentrate CitroSafe™ MFB-30 Powder To Be Added Per Gallon Of Water): 2.18 [Lbs./Gallon Water]

### Dry Concentrate Yield of Mixed Retardant Liquid When Using CitroSafe™ MFB-30 (at Dry Concentrate Mix Ratio 2.18):

Using a 2.18 Mix Ratio for use with Dry Concentrate CitroSafe™ MFB-30 Fire Retardant, one 1 Ton (i.e. 2000 lbs.) of CitroSafe™ MFB-30 Dry Concentrate (dry powder form) can yield 1066 [Gallons] of CitroSafe MFB-30 Mixed Retardant. This Yield of 1066 [Gallons] would involve adding 917.45 [Gallons] of water into a Mixing Tank as shown in FIG. 8, and then adding 2000 [Lbs.] of CitroSafe™ MFB-30 Dry Concentrate Powder (however packaged) to the water in the Mixing Tank, while mixing together using paddle mixers in the tank until all of the solid powder components are dissolved in the water, and 1066 [gallons] of Mixed Retardant Liquid Product is produced. The Mixed Retardant Liquid Product is then ready for either: (i) storage in Storage Tanks during storing operations; or filling operations aboard Aircraft Retardant Delivery Vehicles (i.e. Airtankers) during filling operations to support aerial delivery of the Mixed Retardant Liquid to targeted ground surfaces, from a stationary or mobile air bases, as the case may be.

### Preferred Weights Percentages % Of The Components Of The Fire Retarding Biochemical Formulation Of The Present Invention

In the biochemical compositions of the present invention, the ratio of the sodium benzoate to the alkali metal salt of a nonpolymeric saturated carboxylic acid (e.g. tripotassium citrate) may be major amount between 1:100: to 1:1000 and is typically in the range from 1:1 to 1:100, preferably in the range from 1:2 to 1:50, more preferably in the range from 1:4 to 1:25.

In the liquid fire retarding biochemical formulations of the present invention, the weight percent ranges can be given as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid, is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides, is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent, is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent, is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

In a preferred embodiment of the liquid fire retarding biochemical formulation of the present invention, the range of weight percent of the components can be given as follows:
wherein said water is present in a major amount having a weight percent from about 70.00% to about 95.00% relative to the total weight of the mixed fire retarding biochemical liquid composition;
wherein said fire inhibiting agent is present in a major amount having a weight percent from about 5.00% to about 30.00% relative to the total weight of the mixed fire retarding biochemical liquid composition;
wherein said corrosion inhibiting agent is present in a minor amount having a weight percent from about 0.05% to about 10.00% relative to the total weight of the mixed fire retarding biochemical liquid composition;
wherein said dispersing agent is present in a minor amount having a weight percent from about 0.05% to about 5.00% relative to the total weight of the mixed fire retarding biochemical liquid composition;
wherein said thickening agent in the form of a biopolymer consisting of polysaccharides is present in a minor amount having a weight percent from about 0.01% from about 5.00% relative to the total weight of the mixed fire retarding biochemical liquid composition;
wherein the sum of the weight percent % of the chemical components in the mixed fire retarding biochemical liquid composition does not exceed 100% by weight.

In the dry concentrate fire retarding biochemical formulation of the present invention, the weight percent ranges can be given as follows:
the major amount of fire inhibiting agent in the form of at least one first alkali metal salt of a nonpolymeric saturated carboxylic acid, is from 60% to 95% by weight, preferably from 70% to 90% by weight, and more preferably from 75% to 85% by weight, relative to the total weight of the dry concentrate fire retarding biochemical composition;
the minor amount of corrosion inhibiting agent in the form of least one second alkali metal salt of a nonpolymeric saturated carboxylic acid, is from 4.0% to 20% by weight, preferably from 7.0% to 15% by weight, and more preferably from 8.0% to 13.0% by weight, relative to the total weight of the dry concentrate fire retarding biochemical composition;
the minor amount of thickening agent in form of a biopolymer consisting of polysaccharides, is from 0.10% to 5% by weight, preferably from 0.75% to 1.5% by weight, and more preferably from 0.8% to 1.0% by weight, relative to the total weight of the dry concentrate fire retarding biochemical composition;
the minor amount an (alkali metal ion) dispersing agent, is from 0.08% to 5% by weight, preferably from 0.1% to 2% by weight, and more preferably from 0.5% to 1.5% by weight, relative to the total weight of the dry concentrate fire retarding biochemical composition; and the minor amount of coloring agent, is from 0.10% to 5% by weight, preferably from 0.3% to 3% by weight, and more preferably from 0.9% to 1.5% by weight, relative to the total weight of the dry concentrate fire retarding biochemical composition;
wherein the sum of the weight percent % of the chemical components in the dry concentrate fire retarding biochemical composition should not exceed 100% by weight precent.

In a preferred embodiment of the dry concentrate fire retarding biochemical formulation of the present invention, the range of weight percent of the components can be given as follows:
the fire inhibiting agent is present in a major amount having a weight percent from about 60.00% to about 95.0% relative to the total weight of the dry concentrate fire retarding biochemical composition;
the corrosion inhibiting agent is present in a minor amount having a weight percent from about 0.50% to about 20.00% relative to the total weight of the dry concentrate fire retarding biochemical composition;
the dispersing agent is present in a minor amount having a weight percent from about 0.10% to about 10.00% relative to the total weight of the dry concentrate fire retarding biochemical composition;
the thickening agent in the form of a biopolymer consisting of polysaccharides is present in a minor amount having a weight percent from about 0.01% from about 5.00% relative to the total weight of the dry concentrate fire retarding biochemical composition.

In a preferred embodiment, the viscosity of the aqueous fire retarding biochemical liquid preparation is preferably at least 150.0 [cP] (or 150.0 millipascal-seconds, mPas, in SI units), where viscosity is defined as the internal friction of a liquid to the application of pressure or shearing stress determined using a rotary viscometer, and preferably not more than 400 [cP] for Low Viscosity Application Applications; preferably the viscosity of the fire retarding biochemical liquid is between 401-800 [cP] for Medium Viscosity Applications; preferably, the viscosity of the fire retarding biochemical liquid is between 801-1500 [cP] for High Viscosity Applications; and preferably, the viscosity of the fire retarding biochemical liquid is between 10-149 [cP] for Ultra-Low Viscosity Applications. Preferably, the pH of the mixed retardant solution is between 7.0 and 8.6, but may fall within the range of 6 to 9 in alternative embodiments of the present invention.

Depending on the airspeed of the aircraft tanker delivering the mixed fire retardant solution to targeted ground surfaces via aerial delivery, there may be a need for the mixed retardant liquid to have a significantly greater viscosity than water (1.0 [cP]) so that the mixed retardant liquid stream being dropped from the airtanker does not rapidly evaporate to the ambient environment during dropping operations. Also, a fire retardant delivery aircraft (i.e. airtanker) moving at sufficiently high speeds (e.g. 200 mph or more) may be able to more effectively deliver mixed retardant liquid to ground surface targets, if the viscosity of the mixed retardant liquid being dropped is sufficiently great (e.g. 150 [cP] rather than 50 [cP]) to enable spontaneous generation of microdroplets, in response to sheer forces acting on the dropping liquid stream, during liquid retardant dropping operations. Those skilled in the aerial liquid retardant dropping art will have the tools and know how to select the preferred viscosity of the liquid fire retardant that will produce a cloud of liquid retardant droplets that will fall down upon the targeted ground surface, as the airtanker (i) travels above the ground surface at a predetermined speed and altitude, and (ii) drops a stream of liquid fire retardant towards the targeted ground surface.

Specification of Various Species of Environmentally-Clean Aqueous-Based Liquid Fire Retardant Solutions Containing Dissolved Alkali Metal Salts Derived from Different Kinds of Non-Polymerized Saturated Carboxylic Acids Having Carbon-Atom Chain Lengths Less Than Eight (8)

While the preferred embodiment of the environmentally-clean aqueous-based biochemical fire retarding biochemical liquid solution is based on alkali metal salts of citric carboxylic acid and benzoic carboxylic acid, it is possible to formulate and produce many other species of the present invention, wherein each liquid fire retardant solution comprises: (i) a major amount of first and second alkali metal salt derived from different kinds of non-polymerized saturated carboxylic acids, dissolved in a major amount of water, and having carbon-atom chain lengths less than eight (8), which contributes to solubility of the alkali metal ions dissolved in water, while inhibiting the corrosion of specific metals, namely, 2024-T3 Aluminum, 4130 Steel, Bright Steel, Yellow Brass, and Az3 1B Magnesium, that may come in surface contact with the mixed retardant liquid during its use in mixing, storage and aerial delivery; (ii) minor amounts of a thickening agent in the form of a biomolecular polymer consisting essentially of polysaccharides dissolved in the water, for increasing the viscosity of the mixed retardant liquid for use during aerial delivery; and (iii) a minor amount of a dispersing agent (e.g. triethyl citrate) for dispersing benzoate ions present in the water when the at least one alkali metal salt is dissolved in the mixed retardant solution, promoting the formation of a corrosion inhibiting coating or layer on metal surfaces contacting the mixed retardant solution, and inhibiting surface corrosion reactions (i.e. oxidation and/or reduction) involving the metals.

In the preferred embodiment, sodium benzoate (SB)(or potassium benzoate, calcium benzoate or magnesium benzoate) is used to inhibit the corrosion of metal composites such as 2024-T3 Aluminum, 4130 Steel, Bright Steel, Yellow Brass, and Az3 1B Magnesium, in potassium citrate based mixed fire retardant solutions of the present invention. These metal composites are manufactured in a conventional manner and used to fabricate metal components employed in the equipment used to mix, store, pump and apply mixed retardant solution over combustible surfaces. The corrosion inhibition efficiency of benzoate (metal alkali) salts has been shown by scientific lab testing and investigation. It has been found that benzoate salt is an efficient corrosion inhibitor for 2024-T3 Aluminum, 4130 Steel, Bright Steel, Yellow Brass, and Az31B Magnesium composites, which are exposed to the potassium-citrate based mixed fire retardant solution of the present invention. Since sodium benzoate (SB), potassium benzoate, calcium benzoate or magnesium benzoate are adsorption type inhibitors, it is envisioned that an extremely thin layer of molecules adsorbs onto the metallic surfaces to be protected against corrosion, and suppresses oxidation and reduction associated with chemical reactions that cause metallic corrosion. Further, while not yet performed, the mechanism of corrosion inhibition by benzoate metal alkali salts can be illustrated using optical and scanning electron microscopy of corroded samples. While not intending to be bound or limited to a particular theory, it is believed that benzoate ions are absorbed on the metallic surface and bond with metal ions forming a hydrophobic layer on top of the exposed metal surface, thereby enhancing the protection of the metal surface against dissolved potassium ions in the mixed fire retardant solution.

When applied to combustible surfaces and allowed to dry, the new and improved fire retarding biochemical liquid solution of the present invention forms thin fire retarding coatings produced from a set of alkali metal salts derived from at least one carboxylic acid (R—COOH) selected from the group consisting of: formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

A wide variety of alkali metal salts can be produced from these nonpolymeric saturated carboxylic acids for inclusion in the fire retarding biochemical liquid composition of the present invention, including, but not limited to: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid. (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

The details of these different species of liquid fire inhibitor solutions of the present invention, and its underlying carboxylic acid and alkali metal salt(s), are specified in great technical detail in Applicant's copending U.S. patent application Ser. No. 18/669,077, incorporated herein by reference.

The alkali metal salts of benzoic acid offer the added advantage of metallic corrosion inhibition, when used with other alkali metal salts produced from the nonpolymeric saturated carboxylic acids listed below: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid. (x) alkali metal salts of malic acid; (xi) alkali metal salts of malonic acid; (xii) alkali metal salts of caproic acid; (xiii) alkali metal salts of adipic (hexanedioic) acid; and (xiv) alkali metal salts of citric acid.

### Specification Of Environmentally-Clean Aqueous-Based Long-Term Liquid Fire Retarding Bio-Chemical Compositions And Formulations (“Fire Retardants”), And Methods of Making The Same In Accordance With The Principles Of The Present Invention

A primary object of the present invention is to provide new and improved family of environmentally-clean (“i.e. Green”) aqueous-based long-term fire retarding (i.e. inhibiting) biochemical solutions (i.e. wet liquid compositions and dry powder composition formulation kits) for producing (i) biochemical fire retardant products that can be aerially or ground applied on target surfaces to be protected against fire ignition and flame spread, by formation of thin clear mixed alkali metal salt crystalline and polysaccharide coatings that remain and persist after water molecules evaporate to the environment.

While the preferred formulation of the liquid long term fire retardant is “ready-to-use” not requiring the addition of water and/or mixing before use, the liquid fire inhibitor solution of the present invention can also be produced in a concentrated liquid form designed for mixing with water prior to application using a proportional mixing nozzle and/or other suitable apparatus disclosed in U.S. Pat. Nos. 11,865,390, 11,865,394 incorporated herein by reference in its entirety.

In general, as illustrated in the generic chemical formulation model of FIG. 6, each new and improved environmentally-clean (“i.e. Green”) aqueous-based fire inhibiting biochemical solution of the present invention is made from a major amount of alkali metal salt (derived from a saturated non-polymerized carboxylic acid), dissolved in a major amount of water along with a minor amount of dispersing/coalescing agent suitable to disperse and coalesce alkali metal ions in solution to form ultra-thin alkali metal salt crystalline and polysaccharide coatings on combustible surfaces, as water molecules evaporate to the atmosphere and crystalline structures form on the surfaces, to provide the combustible surfaces with proactive protection against fire ignition and flame spread, without producing toxic and/or otherwise detrimental effects to human, animal, and plant/botanical life during and after spray application.

The starting biochemicals, namely the non-polymerized saturated carboxylic acid, is an organic acid which contains a carboxyl group (C(—O)OH) attached to an R-group (R=alkyl or aryl). Carboxylic acids (denoted by R—COOH) are weak acids, meaning they are not 100% ionized in water. Generally, only about 1% of the molecules of a carboxylic acid dissolved in water are ionized at any given time. The remaining molecules are undissociated in solution. Being “saturated” means in this case, that each carbon (C) atom is bonded to four other atoms (hydrogen or carbon)—the most possible, and that there are no double or triple bonds in the molecules. The word saturated has the same meaning for hydrocarbons as it does for the dietary fats and oils: the molecule has no carbon-to-carbon double bonds (C═C).

The carbon-hydrogen bond (C—H bond) in the saturated non-polymerized carboxylic acid is a chemical bond between carbon and hydrogen atoms that can be found in many organic compounds. This bond is a covalent, single bond, meaning that carbon shares its outer valence electrons with up to four hydrogens. This completes both of their outer shells, making them stable. The C—H bond in general is very strong, so it is relatively unreactive.

The term “non-polymerized” means that carbon and hydrogen atoms in the saturated carboxylic acid have not undergone polymerization or any process of reaction in which relatively small molecules (monomer molecules) are reacted or combined chemically together in a chemical reaction to form very large chainlike or network molecule, called a polymer chains or three-dimensional network. In understanding that there are many forms of polymerization and different systems exist to categorize them.

A tricarboxylic acid, by the name itself, says that it is a category of carboxylic acid which has 3 C(═O)OH groups. In a carboxylic acid group, a carbon (C) atom is bonded to an oxygen (O) atom by a double bond, and to a hydroxyl group (—OH) by a single bond i.e., its functional group represented as C(═O)OH. Carboxylic acids occur widely in nature and its derivatives are of utmost importance in various chemical reactions. Tricarboxylic acids belong to the class of carboxylic acids which contains 3 carboxyl groups (C(═O)OH) attached to R-groups (R=alkyl or aryl).

At this juncture, it will be helpful to briefly identify a few kinds of carboxylic acids that are found in nature and which are of significance for purpose of the present invention, namely: the citric acid compound, a weak acid naturally occurring in citric fruits, which carries 3 carboxyl groups (C(═O)OH) attached to the parent chain, and hence is a tricarboxylic acid, a weak acid which naturally occurs in citric fruits; malonic acid, which carries only 2 carboxyl groups (C(═O)OH), and therefore is a dicarboxylic acid; succinic acid, which carries only 2 carboxyl groups (C(—O)OH), and therefore is a dicarboxylic acid; and malic acid, which also carries only 2 carboxyl groups (C(═O)OH), and therefore is a dicarboxylic acid. Since tricarboxylic acids have 3 carboxyl groups (C(—O)OH) attached to R-groups, it does have the ability to form strong hydrogen bonds, and this results in their high boiling points. Reference is made to the published organic chemistry textbook titled “MARCH'S ADVANCED ORGANIC CHEMISTRY: Reactions, Mechanisms, and Structures (Eighth Edition)”, Michael B. Smith, published by John Wiley & Sons, Inc., 2020, and incorporated herein by reference. Whenever available, all chemical substances and compounds disclosed herein have been provided with their CAS Registration Nos. as registered in the CAS Common Chemistry Database https://commonchemistry.cas. org/In

In general, the novel environmentally-clean (i.e. “green”) liquid fire retarding biochemical solutions and compositions of the present invention comprise a number of core elements, namely: a dispersing agent realized in the form of a major amount of water, for dispersing alkali metal ions dissolved in the water; a major amount of a first fire retarding agent realized in the form of a first alkali metal salt of a nonpolymeric saturated carboxylic acid, specifically, tripotassium citrate, for providing potassium ions dispersed in the water when the at least one alkali metal salt is dissolved in the water to form a mixed retardant solution; a minor amount of a second fire retarding agent realized in the form of a second alkali metal salt of a nonpolymeric saturated carboxylic acid, specifically, sodium benzoate, potassium benzoate, calcium benzoate or magnesium benzoate, for providing benzoate ions dispersed in the water when the at least one alkali metal salt is dissolved in the mixed retardant solution, for inhibiting surface corrosion reactions involving metals contacting the mixed retardant solution, including specific metals, namely aluminum, steel, brass, and magnesium, while functioning as a secondary fire retardant agent; a minor amount of thickening agent in the form of a biomolecular polymer consisting essentially of polysaccharide chains, for increasing the viscosity of the mixed retardant liquid during application operations, when the fire retarding biochemical liquid composition is applied to a surface to be protected against fire; and a minor amount of a dispersing agent (e.g. triethyl citrate) for dispersing benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals; wherein while water molecules in the retardant liquid evaporate during drying, to a thin fire retardant coating is formed not having a characteristic color (e.g. red or green) comprising potassium (and sodium) salt crystals mixed within polysaccharide chains of biomolecular polymer material, to provide long duration fire protection on the treated surfaces.

In the world of organic chemistry, there are many possible non-polymeric saturated carboxylic acids that can be used to derive and produce alkali metal salts thereof for use in producing environmentally-clean aqueous-based liquid fire inhibitor that can be applied to combustible surfaces and form thin alkali metal salt crystalline and polysaccharide coatings that inhibit fire ignition and flame spread. Such possible carboxylic acids include, but are not limited to, the following carboxylic acids organized according to the number of carbon atoms (Ci) contained therein, namely:
(C1) The C1 Class of Carboxylic Acids having 1 carbon atom (C=1), including formic acid (i.e. methanoic acid) CH₂O₂, and carbonic acid (i.e. hydroxymethanoic acid) H₂CO₃;
(C2) The C2 Class of Carboxylic Acids having 2 carbon atoms (C=2), including acetic acid (ethanoic acid) CH₃COOH, glycolic acid (hydroxyacetic acid) C₂H₄O₃, and glyoxylic acid C₂H₂O₃;
(C3) The C3 Class of Carboxylic Acids having 3 carbon atoms (C=3), including propionic acid C₃H₆O₂, lactic acid C₃H₆O₃, glyceric acid C₃H₆O₄, pyruvic acid C₃H₄O₃, and tartaric acid C₃H₆O₆;
(C4) The C4 Class of Carboxylic Acids having 4 carbon atoms (C=4), including butyric acid CH₃(CH₂)₂COOH, malic acid C₄H₆O₅, and malonic acid C₃H₄O₄;
(C5) The C5 Class of Carboxylic Acids having 5 carbon atoms (C=5), including pivalic acid C₅H₁₀O₂;
(C6) The C6 Class of Carboxylic Acids having 6 Carbon Atoms (C=6), including caproic acid CH₃(CH₂)₄COOH, adipic (hexanedioic) acid HOOC(CH₂)₄COOH, citric acid HOC(COOH)((CH₂) COOH)₂, and d-gluconic acid C₆H₁₂O₇; and
(C7) The C7 Class of Carboxylic Acids having 7 carbon atoms (C=7), including benzoic acid C₇H₆O.

While many alkali metal salts can be produced from these carboxylic acids listed above, as indicated in the models shown in FIGS. 6C1 through 6V2, the alkali metal salts of citric acid under Group C6 are particularly preferred, as will be further explained hereinbelow.

While the efficacy of the alkali metal salts increases in the order of lithium, sodium, potassium, cesium and rubidium, the salts of potassium and the salts of sodium preferred for cost of manufacturing reasons. Potassium carboxylates are very particularly preferred, but tripotassium citrate monohydrate (TPC) is the preferred alkali metal salt for use in formulating the environmentally-clean fire inhibiting biochemical compositions of the present invention.

While it is understood that other alkali metal salts are available to practice the biochemical compositions of the present invention, it should be noted that the selection of tripotassium citrate as the preferred alkali metal salt, includes the follow considerations: (i) the atomic ratio of carbon to potassium (the metal) in the utilized alkali metal salt (i.e. tripotassium citrate); (ii) that tripotassium citrate is relatively stable at transport and operating temperatures; (iii) tripotassium citrate is expected to be fully dissociated to citrate and potassium when dissolved in water, and that the dissociation constant is not relevant for the potassium ions, while citric acid/citrate has three ionizable carboxylic acid groups, for which pKa values of 3.13, 4.76 and 6.4 at 25° C. are reliably reported in the European Chemicals Agency (ECHA) handbook; and (iv) tripotassium citrate produces low carbon dioxide levels when dissolved in water.

Tripotassium citrate is an alkali metal salt of citric acid (a weak organic acid) that has the molecular formula C₆H₈O₇. While citric acid occurs naturally in citrus fruit, in the world of biochemistry, citric acid is an intermediate in the celebrated “Citric Acid cycle, also known as the Krebs Cycle (and the Tricarboxylic Acid Cycle), which occurs in the metabolism of all aerobic organisms. The role that citric acid plays in the practice of the preferred embodiments of the biochemical compositions and solutions of the present invention will be described in greater detail hereinafter.

Preferably, the water-soluble coalescing agent should have a melting point at least 32 F (0° C.) or lower in temperature, and be soluble in water. The citric acid ester, triethyl citrate (TEC), is a preferred dispersing agent when used in combination with tripotassium citrate (TPC) having excellent molecular and chemical compatibility given that both chemical compounds are derived from citric acid.

The concentration of the coloring agent (e.g. pigment powder) used in formulating the fire-retarding biochemical composition is preferably in the range from 0.08% to 5% by weight, preferably from 0.1% to 3% by weight and more preferably from 0.5% to 2.0% by weight, relative to the total weight of the mixed fire retarding biochemical liquid composition.

Of advantage are dyes, food dyes for example, which can be used as fugitive coloring agents, in which the color characteristics fade as the fire-retarding composition (i) is exposed to sunlight, and/or (ii) gradually decomposes when exposed to sunlight.

The fire retarding liquid biochemical compositions of the present invention can be produced and prepared by mixing the components in specified amounts with water to produce the fire retardant composition in either a premixed ready-to-use form requiring no dilution prior to u, or a wet concentrate form designed of dilution with water before end use. While the order of mixing the components is discretionary, it is often advantageous to produce aqueous preparations by mixing the components other than water, into water.

The fire-retarding biochemical compositions of the present invention have a good fire inhibiting effect and, a good immediate fire extinguishing effect. This mixing of the constituent biochemical compounds can take place before or during their use. For example, an aqueous preparation may be produced, contained or packaged and shipped to a destination for use at any time, without requiring remixing or restirring in most cases. The aqueous preparation may be produced and deployed immediately for fire inhibiting use. However, it is also possible for the aqueous preparation to not be produced until it is prepared by diluting with water, during a fire defense deployment application.

The compositions of the present invention are also useful as a fire extinguishing agent for fighting fires of Class A, B, C and D. For example, an aqueous biochemical solution of the present invention may be prepared and deployed for firefighting uses in diverse applications. However, it is also possible for the aqueous biochemical composition to not to be produced until it is needed, and when so, by either (i) diluting and dissolving its dry and/or wet components with a prespecified quantity of water, during firefighting deployments, or (ii) by mixing concentrated solution with proportioned amounts of water, in a mixing nozzle, in a conventional manner.

Specification of Various Species of Environmentally-Clean Aqueous-Based Long-Term Fire Retardant Solutions For Aerial and Ground Delivery Containing Dissolved Alkali Metal Salts Derived from Different Kinds of Non-Polymerized Saturated Carboxylic Acids Having Carbon-Atom Chain Lengths Less Than Eight (8)

Hereinbelow methods will be described how to formulate and produce various species of environmentally-clean aqueous-based liquid fire retarding solutions in accordance with the principles of the present invention, wherein each liquid solution contains dissolved alkali metal salts derived from different kinds of non-polymerized saturated carboxylic acids having carbon-atom chain lengths less than eight (8), which contribute solubility of alkali metal ions in water, as an essential requirement of the present invention.

When applied onto combustible surfaces, the new and improved liquid fire retarding solution forms thin fire retarding mixed alkali metal salt crystalline and polysaccharide coatings, produced from alkali metal salts derived from a carboxylic acid (R—COOH) selected from the group consisting of: formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid: malic acid; malonic acid; caproic acid; adipic (hexanedioic) acid; citric acid; and benzoic acid.

A wide variety of alkali metal salts are produced from these nonpolymeric saturated carboxylic acids for inclusion in the biochemical composition, including, but not limited to: (i) alkali metal salts of formic acid (i.e. methanoic acid); (ii) alkali metal salts of carbonic acid (i.e. hydroxymethanoic acid); (iii) alkali metal salts of acetic acid (i.e. ethanoic acid); (iv) alkali metal salts of glycolic acid (i.e. hydroxyacetic acid); (v) alkali metal salts of glyoxylic acid; (vi) alkali metal salts of propionic acid; (vii) alkali metal salts of lactic acid; (viii) alkali metal salts of glyceric acid; (ix) alkali metal salts of tartaric acid. (x) alkali metal salts of malic acid; (xi) alkali metal salts of malonic acid; (xii) alkali metal salts of caproic acid; (xiii) alkali metal salts of adipic (hexanedioic) acid; (xiv) alkali metal salts of citric acid; and (xv) alkali metal salts of benzoic acid.

Referring to FIGS. 6A through 6V2, chemical model illustrations are disclosed for the carboxylic acids, alkali metal salts and esters, and liquid fire retardant solutions of the present invention that are formulated therewith, as captured, and described under the generic chemical model shown in FIG. 6. The details of each formulated species of liquid fire retardant solution of the present invention, and its underlying carboxylic acid and alkali metal salt(s) and ester(s), will be specified in great technical detail below.

For purposes of simplicity and clarity, the species of liquid fire retardant formulation are organized and classified according to the Carbon Atom Chain Length (Ci) of the underlying Non-Polymerized Saturated Carboxylic Acid, from which the corresponding alkali metal salts and ester are derived.

Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C1 Carboxylic Acid (R—COOH), Called Formic Acid (i.e. Methanoic Acid)

In FIGS. 6C1, 6C2, 6C3 and 6C4, schematic chemical models are provided for making liquid fire retardant solutions containing alkali metal salts derived from a C1 Class of Carboxylic Acid having 1 carbon atom, specifically, the C1 carboxylic acid (R—COOH) called formic acid (i.e. methanoic acid), CH₂O₂ (CAS RN: 4-18-6). The exemplary alkali metal salts derived from this C1 Class of Carboxylic Acid are: potassium formate CHKO₂; calcium formate Ca(HCO₂)₂; sodium formate HCOONa; and magnesium formate (dihydrate) Mg (HCO₂)₂.

As shown in FIGS. 6C31 through 6C4, an exemplary ester of formic acid is methyl formate characterized by chemical formula C₃H₆O₂ and CAS RN: 107-31-3. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C1 Class of Carboxylic Acid.

FIG. 6C1 illustrates the primary components of an environmentally-clean aqueous-based long-term file retardant liquid biochemical composition of the present invention for aerial and ground delivery applications, derived from the C1-Class of saturated non-polymerized carboxylic acid called formic acid, comprising: a major amount of potassium formate (CAS RN: 590-29-4) for dissolving in a major amount of water and producing potassium ions in aqueous solution; a minor amount of methyl formate (CAS RN: 107-31-3) or triethyl citrate (TEC)(CAS RN: 77-93-0) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP for medium viscosity fire retardants); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl formate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target ground surfaces, it forms thin coatings on treated ground surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6C2 illustrates the primary components of an environmentally-clean aqueous-based long-term fire retardant liquid biochemical composition of the present invention for aerial and ground delivery applications, derived from the C1-Class of saturated non-polymerized carboxylic acid called formic acid, comprising: a major amounts of calcium formate (CAS RN: 107-31-3) for amount of methyl formate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl formate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6C3 illustrates the primary components of an environmentally-clean aqueous-based long-term fire retardant liquid biochemical composition of the present invention for aerial and ground delivery applications, derived from the C1-Class of saturated non-polymerized carboxylic acid called formic acid, comprising: a major amounts of sodium formate for dissolving in a major amount of water and producing sodium ions in aqueous solution; a minor amounts of methyl formate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl formate or triethyl citrate) disperses benzoate ions present in the water when the at least one alkali metal salt is dissolved in the mixed retardant solution, so as to promote the formation of a corrosion inhibiting coating on metals (e.g. iron, steel, brass, and/or aluminum) contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6C4 illustrates the primary components of an environmentally-clean aqueous-based long-term fire retardant liquid biochemical composition of the present invention for aerial and ground delivery applications, derived from the C1-Class of saturated non-polymerized carboxylic acid called formic acid, comprising: a major amounts of magnesium formate (CAS RN: 557-39-1/6150-82-9 (dihydrate)) for dissolving in a major amount of water and producing magnesium ions in aqueous solution; a minor amounts of methyl formate or triethyl citrate (TEC) as a dispersing agent for dispersing benzoate ions in aqueous solution; a minor amount of one or more alkali metal salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. Xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl formate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C1 Carboxylic Acid (R—COOH), Called Carbonic Acid (i.e. Hydroxymethanoic Acid)

In FIGS. 6D1 and 6D2, schematic chemical models are provided for making liquid fire retardant solutions containing alkali metal salts derived from a C1 Class of Carboxylic Acid having 1 carbon atom, specifically, the C1 carboxylic acid (R—COOH) called carbonic acid, (i.e. hydroxymethanoic acid), CH₂O₃ (CAS RN: 463-79-6). The exemplary alkali metal salts derived from this C1 Class Carboxylic Acid are: potassium carbonate K₂CO₃; sodium carbonate Na₂CO₃; and magnesium carbonate MgCO₃.

As shown in FIGS. 6D1 and 6D2, the ester of citric acid called triethyl citrate, can be used as a dispersing agent with the alkali metal salt dissolved in water, to produce these aqueous-based liquid fire inhibiting solutions of the present invention, based on the above-referenced C1 Class of Carboxylic Acid.

FIG. 6D1 illustrates the primary components of an environmentally-clean aqueous-based long-term fire retardant liquid biochemical composition of the present invention for aerial and ground delivery applications, derived from the C1-Class of saturated non-polymerized carboxylic acid called carbonic acid, comprising: a major amount of potassium carbonate (CAS RN: 584-08-7/6381-79-9 sesquihydrate) for dissolving in a major amount of water and producing potassium ions in aqueous solution; a minor amount of triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. Xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6D2 illustrates the primary components of an environmentally-clean aqueous-based long-term fire retardant liquid biochemical composition of the present invention for aerial and ground delivery applications, derived from the C1-Class of saturated non-polymerized carboxylic acid called carbonic acid, comprising: a major amount of sodium (bi) carbonate (CAS RNs: 497-19-8/5968-11-6 monohydrate/6132-02-1 decahydrate) for dissolving in a major amount of water and producing sodium ions in aqueous solution; a minor amount of triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C2 Carboxylic Acid (R—COOH), Called Acetic Acid (i.e. Ethanoic Acid)

In FIGS. 6E1, 6E2, 6E3, and 6E4, schematic chemical models are provided for making liquid fire retardant solutions containing alkali metal salts derived from a C2 Class of Carboxylic Acid having two (2) carbon atoms, specifically, the C2 carboxylic acid (R—COOH) called acetic acid, C₄H₈O₂ (CAS RN: 64-19-7) The exemplary alkali metal salts derived from this C2 Class of Carboxylic Acid are: potassium acetate C₂H₃KO₂; calcium acetate C₄H₆CaO₄; sodium acetate C₂H₃NaO₂; and magnesium acetate Mg(CH₃COO)₂.

As shown in FIGS. 6E1 through 6E4, an exemplary ester of acetic acid (i.e. ethyl acetate or ethyl ethanoate) is characterized by chemical formula C₄H₈O₂ and CAS RN: 141-78-6. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C2 Class of Carboxylic Acid.

FIG. 6E1 illustrates the primary components of an environmentally-clean aqueous-based long-term fire retardant liquid biochemical composition of the present invention for aerial and ground delivery applications, derived from the C2-Class of saturated non-polymerized carboxylic acid called acetic acid, comprising: a major amount of potassium acetate (CAS RN: 127-08-2) for dissolving in a major amount of water and producing potassium ions in aqueous solution; a minor amount of ethyl acetate (ethyl ethanoate)(CAS RN: 141-78-6) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl acetate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6E2 illustrates the primary components of an environmentally-clean aqueous-based long-term fire retardant liquid biochemical composition of the present invention for aerial and ground delivery applications, derived from the C2-Class of saturated non-polymerized carboxylic acid called acetic acid, comprising: a major amount of calcium acetate (CAS RN: 62-54-4/5743-26-0 monohydrate) for dissolving in a major amount of water and producing calcium ions in aqueous solution; a minor amount of ethyl acetate (CAS RN: 1191-16-8) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl acetate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6E3 illustrate the primary components of an environmentally-clean aqueous-based long-term fire retardant liquid biochemical composition of the present invention for aerial and ground delivery applications, derived from the C2-Class of saturated non-polymerized carboxylic acid called acetic acid, comprising: a major amount of sodium acetate (CAS RN: 127-09-3) for dissolving in a major amount of water and producing sodium ions in aqueous solution; a minor amount of ethyl acetate (CAS RN: 141-78-6) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl acetate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6E4 illustrates the primary components of an environmentally-clean aqueous-based long-term fire retardant liquid biochemical composition of the present invention for aerial and ground delivery applications, derived from the C2-Class of saturated non-polymerized carboxylic acid called acetic acid, comprising: a major amount of magnesium acetate (CAS RN: 142-72-3) for dissolving in a major amount of water and producing magnesium ions in aqueous solution; a minor amount of ethyl acetate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl acetate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

### Specification Of New And Improved Aerial Liquid Fire Retardant Formulations For Forming Thin Fire Inhibiting Mixed Alkali Metal Salt Crystalline and Polysaccharide Coatings Sprayed Onto

Combustible Surfaces, And Produced From Alkali Metal Salts Derived From The C2 Carboxylic Acid (R—COOH), Called Glycolic Acid (i.e. Hydroxyacetic Acid)

In FIGS. 6F1, 6F2, 6F3 and 6F4, schematic chemical models are provided for making liquid fire retardant solutions containing alkali metal salts derived from a C2 Class of Carboxylic Acid having two carbon atoms, specifically, the C2 carboxylic acid (R—COOH) called glycolic acid (hydroxyacetic acid), C₂H₄O₃ (CAS RN: 79-14-1). The exemplary alkali metal salts derived from this C2 Class of Carboxylic Acid are: potassium glycolate C2H3KO3; calcium glycolate C₄H₆CaO₆; and sodium glycolate C₂H₃NaO₃.

As shown in FIGS. 6F1 through 6F4, an exemplary ester of glycolic acid is ethyl glycolate characterized by chemical formula C₄H₈O₃ and CAS RN: 623-50-7. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C2 Class of Carboxylic Acid.

FIG. 6F1 illustrates the primary components of an environmentally-clean aqueous-based long-term fire retardant liquid biochemical composition of the present invention for aerial and ground delivery applications, derived from the C2-Class of saturated non-polymerized carboxylic acid called glycolic acid, comprising: a major amount of potassium glycolate (CAS RN: 1932-50-9) for dissolving in a major amount of water and producing potassium ions in aqueous solution; a minor amount of ethyl glycolate (CAS RN: 623-50-7) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl glycolate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6F2 illustrates the primary components of an environmentally-clean aqueous-based long-term fire retardant liquid biochemical composition of the present invention for aerial and ground delivery applications, derived from the C2-Class of saturated non-polymerized carboxylic acid called glycolic acid, comprising: a major amount of calcium glycolate (CAS RN: 996-23-6) for dissolving in a major amount of water and producing calcium ions in aqueous solution; a minor amount of ethyl glycolate (CAS RN: 623-50-7) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl glycolate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6F3 illustrates the primary components of an environmentally-clean aqueous-based long-term fire retardant liquid biochemical composition of the present invention for aerial and ground delivery applications, derived from the C2-Class of saturated non-polymerized carboxylic acid called glycolic acid, comprising: a major amount of sodium glycolate (CAS RN: 2836-32-0) for dissolving in a major amount of water and producing sodium ions in aqueous solution; a minor amount of ethyl glycolate (CAS RN: 623-50-7) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl glycolate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From the C2 Carboxylic Acid (R—COOH), Called Glyoxylic Acid

In FIGS. 6G1, 6G2, 6G3 and 6G4, schematic chemical models are provided for making liquid fire retardant solutions containing alkali metal salts derived from a C2 Class of Carboxylic Acid having two (2) carbon atoms, specifically, the C2 carboxylic acid (R—COOH) called glyoxylic acid (i.e. oxoacetic acid), C₂H₂O₃ (CAS RN: 298-12-4). The exemplary alkali metal salts derived from this C2 Class of Carboxylic Acid are: potassium glyoxylate C₂H₃KO₃; calcium glyoxylate C₄H₂CaO₆; and sodium glyoxylate (monohydrate) C₂HNaO₃.

As shown in FIGS. 6G1 through 6G4, an exemplary ester of glyoxylic acid is ethyl glyoxylate, and characterized by chemical formula C₄H₆O₃ and CAS RN: 924-44-7. Because esters of glyoxylic acid are immiscible with water, the preferred alternative ester of citric acid called triethyl citrate, can be used as a dispersing agent with the alkali metal salt dissolved in water, to produce these aqueous-based liquid fire inhibiting solutions of the present invention, based on the above-referenced C2 Class of Carboxylic Acid.

FIG. 6G1 illustrates the primary components of an environmentally-clean aqueous-based long-term fire retardant liquid biochemical composition of the present invention for aerial and ground delivery applications, derived from the C2-Class of saturated non-polymerized carboxylic acid called glyoxylic acid, comprising: a major amount of potassium glyoxylate (Compound CID: 23669142/CAS RN 1932-50-9) for dissolving in a major amount of water and producing potassium ions in aqueous solution; a minor amount of triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6G2 illustrates the primary components of an environmentally-clean aqueous-based long-term fire retardant liquid biochemical composition of the present invention for aerial and ground delivery applications, derived from the C2-Class of saturated non-polymerized carboxylic acid called glyoxylic acid, comprising: a major amount of calcium glyoxylate (CAS RN 2990-19-4); a minor amount of triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6G3 illustrates the primary components of an environmentally-clean aqueous-based long-term fire retardant liquid biochemical composition of the present invention for aerial and ground delivery applications, derived from the C2-Class of saturated non-polymerized carboxylic acid called glyoxylic acid, comprising: a major amount of sodium glyoxylate (CAS RN 2706-75-4) for dissolving in a major amount of water and producing sodium ions in aqueous solution; a minor amount of triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

### Specification Of New And Improved Aerial Liquid Fire Retardant Formulations For Forming Thin Fire Inhibiting Mixed Alkali Metal Salt Crystalline and Polysaccharide Coatings Sprayed Onto

### Combustible Surfaces, And Produced From Alkali Metal Salts Derived From the C2 Carboxylic Acid (R—COOH), Called Oxalic Acid

In FIGS. 6H1, 6H2, 6 H3 and 6H4, schematic chemical models are provided for making liquid fire retardant solutions containing alkali metal salts derived from a C2 Class of Carboxylic Acid having 2 carbon atoms, specifically, the C2 Carboxylic Acid (R—COOH) called oxalic acid, with molecular formula H₂C₂O₄ and CAS RN: 144-62-7 anhydrous/6153-56-6 dihydrate. The exemplary alkali metal salts derived from this C2 Class of Carboxylic Acid are: potassium oxalate C₂H₂K₂O₅; calcium oxalate monohydrate CaC₂O₄; and (di) sodium oxalate (monohydrate) Na₂C₂O₄.

As shown in FIGS. 6H1 through 6H4, an exemplary ester of oxalic acid. dimethyl oxalate, is characterized by chemical formula: C₄H₆O₄ and CAS RN: 553-90-2. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C2 Class of Carboxylic Acid.

FIG. 6H1 illustrates the primary components of an environmentally-clean aqueous-based long-term fire retardant liquid biochemical composition of the present invention for aerial and ground delivery applications, derived from the C2-Class of saturated non-polymerized carboxylic acid called oxalic acid, comprising: a major amount of potassium oxalate (CAS RN: 6487-48-5) for dissolving in a major amount of water and producing potassium ions in aqueous solution; a minor amount of dimethyl oxalate (CAS RN: 553-90-2) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl oxalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6H2 illustrates the primary components of an environmentally-clean aqueous-based long-term fire retardant liquid biochemical composition of the present invention for aerial and ground delivery applications, derived from the C2-Class of saturated non-polymerized carboxylic acid called oxalic acid, comprising: a major amount of calcium oxalate (CAS RN: 5794-28-5 monohydrate) for dissolving in a major amount of water and producing calcium ions in aqueous solution; a minor amount of dimethyl oxalate (CAS RN: 553-90-2) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl oxalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6H3 illustrates the primary components of an environmentally-clean aqueous-based long-term fire retardant liquid biochemical composition of the present invention for aerial and ground delivery applications, derived from the C2-Class of saturated non-polymerized carboxylic acid called oxalic acid, comprising: a major amount of sodium oxalate (CAS RN: 62-76-0) for dissolving in a major amount of water and producing sodium ions in aqueous solution; a minor amount of dimethyl oxalate (CAS RN: 553-90-2) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl oxalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C3 Carboxylic Acid (R—COOH), Called Propionic Acid

In FIGS. 611, 612, 613 and 614, schematic chemical models are provided for making liquid fire retardant solutions containing alkali metal salts derived from a C1 Class of Carboxylic Acid having 3 carbon atoms, specifically, the C3 carboxylic acid (R—COOH) called propionic acid (i.e. propanoic acid, or ethanecarboxylic acid), C₃H₆O₂ with CAS RN: 79-09-04. The exemplary alkali metal salts derived from this C2 Class of Carboxylic Acid are: potassium propionate C₃H₅KO; calcium propionate C₆H₁₀CaO₄; sodium propionate C₃H₅NaO₂; and magnesium propionate C₆H₁₀MgO₄.

As shown in FIGS. 611 through 614, an exemplary ester of propionic acid is ethyl propionate characterized by chemical formula C₅H₁₀O₂ and CAS RN: 105-37-3. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C3 Class of Carboxylic Acid.

FIG. 611 illustrates the primary components of an environmentally-clean aqueous-based long-term fire retardant liquid biochemical composition of the present invention for aerial and ground delivery applications, derived from the C3-Class of saturated non-polymerized carboxylic acid called propionic acid, comprising: a major amount of potassium propionate (CAS RN: 327-62-8) for dissolving in a major amount of water and producing potassium ions in aqueous solution; a minor amount of ethyl propionate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl propionate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 612 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called propionic acid, comprising: a major amount of calcium propionate (CAS RN: 4075-81-4) for dissolving in a major amount of water and producing calcium ions in aqueous solution; a minor amount of ethyl propionate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl propionate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 613 illustrates the primary components of an environmentally-clean aqueous-based long-term fire retardant liquid biochemical composition of the present invention for aerial and ground delivery applications, derived from the C3-Class of saturated non-polymerized carboxylic acid called propionic acid, comprising: a major amount of sodium propionate (CAS RN: 137-40-6) for dissolving in a major amount of water and producing sodium ions in aqueous solution; a minor amount of ethyl propionate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. Xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl propionate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 614 illustrates the primary components of an environmentally-clean aqueous-based long-term fire retardant liquid biochemical composition of the present invention for aerial and ground delivery applications, derived from the C3-Class of saturated non-polymerized carboxylic acid called propionic acid, comprising: a major amount of magnesium propionate for dissolving in a major amount of water and producing magnesium ions in aqueous solution; a minor amount of ethyl propionate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl propionate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

### Specification Of New And Improved Aerial Liquid Fire Retardant Formulations For Forming Thin Fire Inhibiting Mixed Alkali Metal Salt Crystalline and Polysaccharide Coatings Sprayed Onto

Combustible Surfaces, And Produced From Alkali Metal Salts Derived From the C3 Carboxylic Acid (R—COOH), Called Lactic Acid

In FIGS. 6J1, 6J2, 6J3 and 6J4, schematic chemical models are provided for making liquid fire retardant solutions containing alkali metal salts derived from a C3 Class of Carboxylic Acid having 3 carbon atoms, specifically, the C3 carboxylic acid (R—COOH) called lactic acid, having a molecular formula C₃H₆O₃ with CAS RNs: 50-21-5/79-33-4 (L)/10326-41-7 (D), and being miscible in water. The exemplary alkali metal salts derived from this C3 Class of Carboxylic Acid are: potassium lactate C₃H₅KO₃; calcium lactate C₆H₁₀CaO₆; sodium lactate C₃H₅NaO₃; and magnesium lactate C₆H₁₀MgO₆.

As shown in FIGS. 6J1 through 6J4, an exemplary ester of lactic acid is ethyl lactate characterized by chemical formula C₅H₁₀O₃ and CAS RN: CAS RN: 97-64-3. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C3 Class of Carboxylic Acid.

FIG. 6J1 illustrates the primary components of an environmentally-clean aqueous-based long-term fire retardant liquid biochemical composition of the present invention for aerial and ground delivery applications, derived from the C3-Class of saturated non-polymerized carboxylic acid called lactic acid, comprising: a major amount of potassium lactate (CAS RN: 996-31-6/85895-78-9 (S)) for dissolving in a major amount of water and producing potassium ions in aqueous solution; a minor amount of ethyl lactate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl lactate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6J2 illustrates the primary components of an environmentally-clean aqueous-based long-term fire retardant liquid biochemical composition of the present invention for aerial and ground delivery applications, derived from the C3-Class of saturated non-polymerized carboxylic acid called lactic acid, comprising: a major amount of calcium lactate (CAS RN: 814-80-2) for dissolving in a major amount of water and producing calcium ions in aqueous solution; a minor amount of ethyl lactate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl lactate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6J3 illustrates the primary components of an environmentally-clean aqueous-based long-term fire retardant liquid biochemical composition of the present invention for aerial and ground delivery applications, derived from the C3-Class of saturated non-polymerized carboxylic acid called lactic acid, comprising: a major amount of sodium lactate (CAS RN: 72-17-3) for dissolving in a major amount of water and producing sodium ions in aqueous solution; a minor amount of ethyl lactate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl lactate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6J4 illustrates the primary components of an environmentally-clean aqueous-based long-term fire retardant liquid biochemical composition of the present invention for aerial and ground delivery applications, derived from the C3-Class of saturated non-polymerized carboxylic acid called lactic acid, comprising: a major amount of magnesium lactate (CAS RN: 18917-93-6) for dissolving in a major amount of water and producing magnesium ions in aqueous solution; a minor amount of ethyl lactate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl lactate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C3 Carboxylic Acid (R—COOH), Called Glyceric Acid

In FIGS. 6K1, 6K2, 6K3 and 6K4, schematic chemical models are provided for making liquid fire retardant solutions containing alkali metal salts derived from a C3 Class of Carboxylic Acid having 3 carbon atoms, specifically, the C3 carboxylic acid (R—COOH) called glyceric acid, having a molecular formula C₃H₆O₄ and CAS RNs: 473-81-4/6000-40-4 D-glyceric acid/28305-26-2-L-glyceric acid. The exemplary alkali metal salts derived from this C3-Class of Carboxylic Acid are: potassium glycerate C₃H₅KO₄; calcium glycerate C₆H₁₀CaO₈; and sodium glycerate C₃H₅NaO₄.

As shown in FIGS. 6K1 through 6K4, an exemplary ester of glyceric acid is ethyl glycerate characterized by chemical formula C₅H₁₀O₄ and CAS RN: 615-51-0. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C3 Class of Carboxylic Acid.

FIG. 6K1 illustrates the primary components of an environmentally-clean aqueous-based long-term fire retardant liquid biochemical composition of the present invention for aerial and ground delivery applications, derived from the C3-Class of saturated non-polymerized carboxylic acid called glyceric acid, comprising: a major amount of potassium glycerate (CAS RN: 43110-90-3) for dissolving in a major amount of water and producing potassium ions in aqueous solution; a minor amount of dimethyl glycerate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl glycerate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6K2 illustrates the primary components of an environmentally-clean aqueous-based long-term fire retardant liquid biochemical composition of the present invention for aerial and ground delivery applications, derived from the C3-Class of saturated non-polymerized carboxylic acid called glyceric acid, comprising: a major amount of calcium glycerate (CAS RN: 65644-56-6) for dissolving in a major amount of water and producing calcium ions in aqueous solution; a minor amount of dimethyl glycerate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl glycerate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6K3 illustrates the primary components of an environmentally-clean aqueous-based long-term fire retardant liquid biochemical composition of the present invention for aerial and ground delivery applications, derived from the C3-Class of saturated non-polymerized carboxylic acid called glyceric acid, comprising: a major amount of sodium glycerate (CAS RN: 383-86-8) for dissolving in a major amount of water and producing sodium ions in aqueous solution; a minor amount of dimethyl glycerate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g.

dimethyl glycerate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C3 Carboxylic Acid (R—COOH), Called Pyruvic Acid

In FIGS. 6L1, 6L2, 6L3 AND 6L4, schematic chemical models are provided for making liquid fire retardant solutions containing alkali metal salts derived from a C3 Class of Carboxylic Acid having 3 carbon atoms, specifically, the C3 carboxylic acid (R—COOH) called pyruvic acid, (i.e. 2-oxopropanoic acid) having the molecular formula C₃H₄O₃ and CAS RN: 127-17-3, a smell similar to that of acetic acid, and miscible with water. The exemplary alkali metal salts derived from this C3 Class of Carboxylic Acid are: potassium pyruvate C₃H₃KO₃; calcium pyruvate C₃H₆CaO₃; sodium pyruvate C₃H₃NaO₃; and magnesium pyruvate C₆H₆MgO₆.

As shown in FIGS. 6L1 through 6L4, an exemplary ester of pyruvic acid is ethyl pyruvate characterized by chemical formula C₅H₈O₃ and CAS RN: 617-35-6, and water solubility. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C3-Class of Carboxylic Acid.

FIG. 6L1 illustrates the primary components of an environmentally-clean aqueous-based long-term fire retardant liquid biochemical composition of the present invention for aerial and ground delivery applications, derived from the C3-Class of saturated non-polymerized carboxylic acid called pyruvic acid, comprising: a major amount of potassium pyruvate (CAS RN: 4151-33-1) for dissolving in a major amount of water and producing potassium ions in aqueous solution; a minor amount of ethyl pyruvate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl pyruvate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6L2 illustrates the primary components of an environmentally-clean aqueous-based long-term fire retardant liquid biochemical composition of the present invention for aerial and ground delivery applications, derived from the C3-Class of saturated non-polymerized carboxylic acid called pyruvic acid, comprising: a major amount of calcium pyruvate (CAS RN: 52009-14-0) for dissolving in a major amount of water and producing calcium ions in aqueous solution; a minor amount of ethyl pyruvate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl pyruvate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6L3 illustrates the primary components of an environmentally-clean aqueous-based long-term fire retardant liquid biochemical composition of the present invention for aerial and ground delivery applications, derived from the C3-Class of saturated non-polymerized carboxylic acid called pyruvic acid, comprising: a major amount of sodium pyruvate (CAS RN: 113-24-6) for dissolving in a major amount of water and producing sodium ions in aqueous solution; a minor amount of ethyl pyruvate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl pyruvate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6L4 is a schematic representation illustrating the primary components of an environmentally-clean aqueous-based long-term fire retardant liquid biochemical composition of the present invention for aerial and ground delivery applications, derived from the C3-Class of saturated non-polymerized carboxylic acid called pyruvic acid, comprising: a major amount of magnesium pyruvate for dissolving in a major amount of water and producing magnesium ions in aqueous solution; a minor amount of ethyl pyruvate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl pyruvate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From the C3 Carboxylic Acid (R—COOH), Called Tartaric Acid

In FIGS. 6M1, 6M3, 6M3 and 6M4, schematic chemical models are provided for making liquid fire retardant solutions containing alkali metal salts derived from a C3-Class of Carboxylic Acid having 3 carbon atoms, specifically, the C3 carboxylic acid (R—COOH) called tartaric acid having a molecular formula C₄H₆O₆ and CAS RNs: 87-89-4 R, R isomer/S,S isomer 147-71-7/racemic 133-37-9/meso-isomer 147/73-9, and soluble in water. The exemplary alkali metal salts derived from this C3 Class of Carboxylic Acid are: potassium tartrate (potassium bitartrate) C₄H₄K₂O₆; calcium tartrate CaC₄H₄O₆: sodium tartrate C₄H₈Na₂O₈; and magnesium tartrate C₄H₄MgO₆.

As shown in FIGS. 6M1 through 6M4, an exemplary ester of tartaric acid is diethyl tartrate (DET) characterized by chemical formula C₈H₁₄O₆ and CAS RN: 408332-88-7). This ester (i.e. group of stereo-isomers), and/or the alternative ester of citric acid called triethyl citrate, can be used as a dispersing agent with the alkali metal salt dissolved in water, to produce these aqueous-based liquid fire inhibiting solutions of the present invention, based on the above-referenced C3 Class of Carboxylic Acid.

FIG. 6M1 illustrates the primary components of an environmentally-clean aqueous-based long-term fire retardant liquid biochemical composition of the present invention for aerial and ground delivery applications, derived from the C3-Class of saturated non-polymerized carboxylic acid called tartaric acid, comprising: a major amount of potassium tartrate (CAS RN: 589-39-1) for dissolving in a major amount of water and producing potassium ions in aqueous solution; a minor amount of diethyl tartrate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl tartrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6M2 illustrates the primary components of an environmentally-clean aqueous-based long-term fire retardant liquid biochemical composition of the present invention for aerial and ground delivery applications, derived from the C3-Class of saturated non-polymerized carboxylic acid called tartaric acid, comprising: a major amount of calcium tartrate (CAS RN: 5743-36-2) for dissolving in a major amount of water and producing calcium ions in aqueous solution; a minor amount of diethyl tartrate or triethyl citrate (TEC) as a dispersing agent for dispersing benzoate ions in aqueous solution; (iii) a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl tartrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6M3 illustrates the primary components of an environmentally-clean aqueous-based long-term fire retardant liquid biochemical composition of the present invention for aerial and ground delivery applications, derived from the C3-Class of saturated non-polymerized carboxylic acid called tartaric acid, comprising: a major amount of sodium tartrate (CAS RN: 156-54-7) for dissolving in a major amount of water and producing sodium ions in aqueous solution; a minor amount of diethyl tartrate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl tartrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals. When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6M4 illustrates the primary components of an environmentally-clean aqueous-based long-term fire retardant liquid biochemical composition of the present invention for aerial and ground delivery applications, derived from the C3-Class of saturated non-polymerized carboxylic acid called tartaric acid, comprising: a major amount of magnesium tartrate (CAS RN: 20752-56-1) for dissolving in a major amount of water and producing magnesium ions in aqueous solution; a minor amount of diethyl tartrate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl tartrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From the C4 Carboxylic Acid (R—COOH), Called Butyric Acid

In FIGS. 6N1, 6N2, 6N3, and 6N4, schematic chemical models are provided for making liquid fire retardant solutions containing alkali metal salts derived from a C4 Class of Carboxylic Acid having 4 carbon atoms, specifically, the C4 carboxylic acid (R—COOH) called butyric acid, having a molecular formula C₃H₇COOH and CAS RN: 107-92-6. The exemplary alkali metal salts derived from this C4 Class of Carboxylic Acid are: potassium butyrate (or butanoate) C₄H₇KO₂; calcium butyrate C₈H₁₄CaO₄; sodium butyrate C₄H₇NaO₂; and magnesium butyrate C₄H₈MgO₂.

As shown in FIGS. 6N1 through 6N4, an exemplary ester of butyric acid is ethyl butyrate characterized by chemical formula C₆H₁₂O₂, CAS RN: 105-54-4, a fruity odor, and being water soluble. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C4 Class of Carboxylic Acid.

FIG. 6N1 illustrates the primary components of an environmentally-clean aqueous-based long-term fire retardant liquid biochemical composition of the present invention for aerial and ground delivery applications, derived from the C4-Class of saturated non-polymerized carboxylic acid called butyric acid, comprising: a major amount of potassium butyrate (CAS RN: 589-39-9) for dissolving in a major amount of water and producing potassium ions in aqueous solution; a minor amount of ethyl butyrate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl butyrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6N2 illustrates the primary components of an environmentally-clean aqueous-based long-term fire retardant liquid biochemical composition of the present invention for aerial and ground delivery applications, derived from the C4-Class of saturated non-polymerized carboxylic acid called butyric acid, comprising: a major amount of calcium butyrate (CAS RN: 5743-36-2) for amount of ethyl butyrate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl butyrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6N3 illustrates the primary components of an environmentally-clean aqueous-based long-term fire retardant liquid biochemical composition of the present invention for aerial and ground delivery applications, derived from the C4-Class of saturated non-polymerized carboxylic acid called butyric acid, comprising: a major amount of sodium butyrate (CAS RN: 156-54-7) for dissolving in a major amount of water and producing sodium ions in aqueous solution; a minor amount of ethyl butyrate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl butyrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6N4 illustrates the primary components of an environmentally-clean aqueous-based long-term fire retardant liquid biochemical composition of the present invention for aerial and ground delivery applications, derived from the C4-Class of saturated non-polymerized carboxylic acid called butyric acid, comprising: a major amount of magnesium butyrate (CAS RN: 556-45-6) for dissolving in a major amount of water and producing magnesium ions in aqueous solution; a minor amount of ethyl butyrate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo

ELX-2100FR fugitive pigment powder) added to the aqueous solution for imparting a particular color (e.g. red) to the aqueous solution during application of the product, wherein the dispersing agent (e.g. ethyl butyrate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From the C4 Carboxylic Acid (R—COOH), Called Malic Acid

In FIGS. 6O1, 6O2, 6O3 and 6O4, schematic chemical models are provided for making liquid fire retardant solutions containing alkali metal salts derived from a C4 Class of Carboxylic

Acid having 4 carbon atoms, specifically, the C4 carboxylic acid (R—COOH) called malic acid, having a molecular formula C₄H₆O₅ and CAS RN: 6915-15-7), and highly water soluble. The exemplary alkali metal salts derived from this C4 Class of Carboxylic Acid are: potassium malate C₄H₄K₂O₅; calcium malate C₄H₄CaO₈; sodium malate C₄H₄Na₂O₅; and magnesium malate C₄H₄MgO₅.

As shown in FIGS. 601 through 604, an exemplary ester of malic acid is diethyl maleate characterized by chemical formula C₈H₁₂O₄ and CAS RN: 141-05-9. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C4 Class of Carboxylic Acid.

FIG. 6O1 illustrates the primary components of an environmentally-clean aqueous-based long-term fire retardant liquid biochemical composition of the present invention for aerial and ground delivery applications, derived from the C4-Class of saturated non-polymerized carboxylic acid called malic acid, comprising: a major amount of potassium maleate (CAS RN: 585-09-1) for dissolving in a major amount of water and producing potassium ions in aqueous solution; a minor amount of diethyl maleate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl maleate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6O2 illustrates the primary components of an environmentally-clean aqueous-based long-term fire retardant liquid biochemical composition of the present invention for aerial and ground delivery applications, derived from the C4-Class of saturated non-polymerized carboxylic acid called malic acid, comprising: a major amount of calcium maleate (CAS RN: 16426-50-9) for dissolving in a major amount of water and producing sodium ions in aqueous solution; a minor amount of diethyl maleate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl maleate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6O3 illustrates the primary components of an environmentally-clean aqueous-based long-term fire retardant liquid biochemical composition of the present invention for aerial and ground delivery applications, derived from the C4-Class of saturated non-polymerized carboxylic acid called malic acid, comprising: a major amount of sodium maleate (CAS RN: 676-46-0) for dissolving in a major amount of water and producing sodium ions in aqueous solution; a minor amount of diethyl maleate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl maleate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6O4 is a schematic representation illustrating the primary components of an environmentally-clean aqueous-based long-term fire retardant liquid biochemical composition of the present invention for aerial and ground delivery applications, derived from the C4-Class of saturated non-polymerized carboxylic acid called malic acid, comprising: a major amount of magnesium maleate (CAS RN: 141-05-9) for dissolving in a major amount of water and producing magnesium ions in aqueous solution; a minor amount of diethyl maleate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. Xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl maleate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution; and 114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C4 Carboxylic Acid (R—COOH), Called Malonic Acid

In FIGS. 6P1, 6P2, 6P3 and 6P4, schematic chemical models are provided for making liquid fire retardant solutions containing alkali metal salts derived from a C4 Class of Carboxylic Acid having 4 carbon atoms, specifically, the C4 carboxylic acid (R—COOH) called malonic acid, C₃H₄O₄ (CAS RN: 55514 Nov. 19). The exemplary alkali metal salts derived from this C4\ Class of Carboxylic Acid are: potassium malonate; calcium malonate C₃H₂CaO₄; sodium malonate C₃H₂O₄Na₂; and di-magnesium malonate Mg₂(OH)₂C₄H₄O₅.

As shown in FIGS. 6P1 through 6P4, an exemplary ester of malonic acid is diethyl malonate (DEM) characterized by chemical formula C7H₁₂O₄ and CAS RN: 105-53-3. As this ester has negligible or low water solubility, and is most commonly used in the fragrance industry, its use and performance as a surface-chemistry coalescing agent may not be as desirable as the surface chemistry performance by the ester of citric acid, called triethyl citrate (TEC) described hereinabove, which may be used as a dispersing agent with the alkali metal salts dissolved in water to produce these aqueous-based liquid fire inhibiting solutions of the present invention, based on the above-referenced C4-Class of Carboxylic Acid called Malonic Acid.

FIG. 6P1 illustrates the primary components of an environmentally-clean aqueous-based long-term fire retardant liquid biochemical composition of the present invention for aerial and ground delivery applications, derived from the C4-Class of saturated non-polymerized carboxylic acid called malonic acid, comprising: a major amount of potassium malonate (CAS RN: 13095-67-5) for dissolving in a major amount of water and producing potassium ions in aqueous solution; a minor amount of diethyl malonate (DEM) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl malonate (DEM) or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6P2 illustrates the primary components of an environmentally-clean aqueous-based long-term fire retardant liquid biochemical composition of the present invention for aerial and ground delivery applications, derived from the C4-Class of saturated non-polymerized carboxylic acid called malonic acid, comprising: a major amount of calcium malonate (CAS RN: 19455-76-6); a minor amount of diethyl malonate (DEM) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl malonate (DEM) or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6P3 illustrates the primary components of an environmentally-clean aqueous-based long-term fire retardant liquid biochemical composition of the present invention for aerial and ground delivery applications, derived from the C4-Class of saturated non-polymerized carboxylic acid called malonic acid, comprising: a major amount of sodium malonate (CAS RN: 141-95-7) for dissolving in a major amount of water and producing sodium ions in aqueous solution; a minor amount of diethyl malonate (DEM) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl malonate (DEM) or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6P4 illustrates the primary components of an environmentally-clean aqueous-based long-term fire retardant liquid biochemical composition of the present invention for aerial and ground delivery applications, derived from the C4-Class of saturated non-polymerized carboxylic acid called malonic acid, comprising: a major amount of magnesium malonate (CAS RN: 671197-50-5) for dissolving in a major amount of water and producing magnesium ions in aqueous solution; a minor amount of diethyl malonate (DEM) or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. diethyl malonate (DEM) or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution; and
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C5 Carboxylic Acid (R—COOH), Called Pivalic Acid

In FIGS. 6Q1, 6Q2, 6Q3 and 6Q4, schematic chemical models are provided for making liquid fire retardant solutions containing alkali metal salts derived from a C5 Class of Carboxylic Acid having 5 carbon atoms, specifically, the C5 carboxylic acid (R—COOH) called pivalic acid, (i.e. trimethylacetic acid; neopentanoic acid), C₅H₁₀O₂ (CAS RN: 75-98-9). The exemplary alkali metal salts derived from this C5 Class of Carboxylic Acid are: potassium pivalate C₅H₉KO₂; calcium pivalate C₁₀H₁₈CaO₄; sodium pivalate C₅H₉NaO₂; and magnesium pivalate C₁₀H₂₀MnO₄

As shown in FIGS. 6Q1 through 6Q4, an exemplary ester of pivalic acid is methyl pivalate characterized by chemical formula C₆H₁₂O₂ and CAS RN: 598-98-1. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C5 Class of Carboxylic Acid.

FIG. 6Q1 illustrates the primary components of an environmentally-clean aqueous-based long-term fire retardant liquid biochemical composition of the present invention for aerial and ground delivery applications, derived from the C5-Class of saturated non-polymerized carboxylic acid called pivalic acid, comprising: a major amount of potassium pivalate (CAS RN: 19455-23-3) for dissolving in a major amount of water and producing potassium ions in aqueous solution; a minor amount of methyl pivalate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl pivalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6Q2 illustrates the primary components of an environmentally-clean aqueous-based long-term fire retardant liquid biochemical composition of the present invention for aerial and ground delivery applications, derived from the C5-Class of saturated non-polymerized carboxylic acid called pivalic acid, comprising: a major amount of calcium pivalate (CAS RN: 598-98-1) for amount of methyl pivalate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl pivalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6Q3 illustrates the primary components of an environmentally-clean aqueous-based long-term fire retardant liquid biochemical composition of the present invention for aerial and ground delivery applications, derived from the C5-Class of saturated non-polymerized carboxylic acid called pivalic acid, comprising: a major amount of sodium pivalate (CAS RN: 1184-88-9) for dissolving in a major amount of water and producing sodium ions in aqueous solution; a minor amount of methyl pivalate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl pivalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6Q4 illustrates the primary components of an environmentally-clean aqueous-based long-term fire retardant liquid biochemical composition of the present invention for aerial and ground delivery applications, derived from the C5-Class of saturated non-polymerized carboxylic acid called pivalic acid, comprising: a major amount of magnesium pivalate for providing magnesium ions when magnesium pivalate is dissolved in water; a minor amount of methyl pivalate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl pivalate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution;
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From the C6 Carboxylic Acid (R—COOH), Called Caproic Acid

In FIGS. 6R1, 6R2, 6R3, and 6R4 schematic chemical models are provided for making liquid fire retardant solutions containing alkali metal salts derived from a C6 Class of Carboxylic

Acid having 6 carbon atoms, specifically, the C6 carboxylic acid (R—COOH) called caproic acid, CH₃(CH₂)₄COOH (CAS RN: 142-62-1). The exemplary alkali metal salts derived from this C6 Class of Carboxylic Acid are: potassium caproate (hexanoate) C₁₀H₁₉O₂.K; calcium caproate C₈H₁₅NaO; sodium caproate C₈H₁₅NaO₂; and magnesium caproate C₁₂H₂₂MgO₄.

As shown in FIGS. 6R1 through 6R4, an exemplary ester of caproic acid is ethyl caprocate characterized by chemical formula C₈H₁₆O₂ and CAS RN: 123-66-0. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C6 Class of Carboxylic Acid.

FIG. 6R1 illustrates the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising: a major amount of potassium caproate (CAS RN: 19455-00-6) for dissolving in a major amount of water and producing potassium ions in aqueous solution; a minor amount of ethyl caproate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl caproate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6R2 illustrates the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising: a major amount of calcium caproate (CAS RN: 38708-95-1) for dissolving in a major amount of water and producing sodium ions in aqueous solution; a minor amount of ethyl caproate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl caproate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6R3 illustrates the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising: a major amount of sodium caproate (CAS RN: 10051-44-2) for dissolving in a major amount of water and producing sodium ions in aqueous solution; a minor amount of ethyl caproate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl caproate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6R4 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising: a major amount of magnesium caproate (CAS RN: 3386-57-0) for dissolving in a major amount of water and producing magnesium ions in aqueous solution; a minor amount of ethyl caproate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl caproate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution; and
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C6 Carboxylic Acid (R—COOH), Called Adipic (Hexanedioic) Acid

In FIGS. 6S1, 6S2, 6S3 and 6S4, schematic chemical models are provided for making liquid fire retardant solutions containing alkali metal salts derived from a C6 Class of Carboxylic Acid having 6 carbon atoms, specifically, the C6 carboxylic acid (R—COOH) called adipic (hexanedioic) acid having a molecular formula C₆H₁₀O₄, and CAS RN: 124-04-9 and being soluble in water. The exemplary alkali metal salts derived from this C6 Class of Carboxylic Acid are: potassium adipate C₆H₈K₂O₄; calcium adipate C₆H₈CaO₄; sodium adipate C₆H₈Na₂O₄; and magnesium adipate C₆H₈MgO₄.

As shown in FIGS. 6S1 through 6S4, an exemplary ester of adipic acid is dimethyl adipate characterized by chemical formula C₈H₁₄O₄ and CAS RN: 627-93-0 and low water solubility. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C6 Class of Carboxylic Acid called Adipic (i.e. Hexanedioic) Acid.

FIG. 6S1 illustrates the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising: a major amount of potassium adipic (CAS RN: 19147-16-1) for dissolving in a major amount of water and producing potassium ions in aqueous solution; a minor amount of dimethyl adipate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl adipate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6S2 illustrates the primary components of an environmentally-clean aqueous-based fire inhibiting liquid biochemical composition of the present invention derived from the C6-Class of saturated non-polymerized carboxylic acid called caproic acid, comprising: a major amount of calcium adipic (CAS RN: 7486-40-0) for dissolving in a major amount of water and producing calcium ions in aqueous solution; a minor amount of dimethyl adipate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl adipate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metal.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6S3 illustrates the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising: a major amount of sodium adipic (CAS RN: 23311-84-4) for dissolving in a major amount of water and producing sodium ions in aqueous solution; a minor amount of dimethyl adipate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl adipate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6S4 illustrates the primary components of an environmentally-clean aqueous-based long-term fire retardant liquid biochemical composition of the present invention for aerial and ground delivery applications, derived from the C6-Class of saturated non-polymerized carboxylic acid called caproic acid, comprising: a major amount of magnesium adipic (CAS RN: 7486-39-7) for dissolving in a major amount of water and producing magnesium ions in aqueous solution; a minor amount of dimethyl adipate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. dimethyl adipate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution; and
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From the C6 Carboxylic Acid (R—COOH), Citric Acid

In FIGS. 6T1, 6T2, 6T3 AND 6T4, schematic chemical models are provided for making liquid fire retardant solutions containing alkali metal salts derived from a C6 Class of Carboxylic Acid having 6 carbon atoms, specifically, the C6 carboxylic acid (R—COOH) called citric acid, having a molecular formula HOC(CO₂H)(CH₂CO₂H)₂ and CAS RN: 77-92-9 anhydrous/5949-29-1 monohydrate, and being highly soluble in water. The exemplary alkali metal salts derived from this C6 Class of Carboxylic Acid are: (tri) potassium Citrate C₆H₅K₃O₇; calcium citrate Ca₃(C₆H₅O₇)₂; sodium citrate C₆H₅Na₃O₇; and magnesium citrate C₆H₆MgO₇.

As shown in FIGS. 6T1 through 6T4, an exemplary ester of citric acid is triethyl citrate (TEC) characterized by chemical formula C₁₂H₂₀O₇ and CAS RN: 77-93-0. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C6 Class of Carboxylic Acid.

FIG. 6T1 illustrates the primary components of an environmentally-clean aqueous-based long-term fire retardant liquid biochemical composition of the present invention for aerial and ground delivery applications, derived from the C6-Class of saturated non-polymerized carboxylic acid called citric acid, comprising:

a major amount of tripotassium citrate (TPC)(CAS RN: 866-84-2) for dissolving in a major amount of water and producing potassium ions in aqueous solution; a minor amount triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6T2 illustrates the primary components of an environmentally-clean aqueous-based long-term fire retardant liquid biochemical composition of the present invention for aerial and ground delivery applications, derived from the C6-Class of saturated non-polymerized carboxylic acid called citric acid, comprising: a major amount of calcium citrate (CAS RN: 813-94-5) for dissolving in a major amount of water and producing calcium ions in aqueous solution; a minor amount triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6T3 illustrates the primary components of an environmentally-clean aqueous-based long-term fire retardant liquid biochemical composition of the present invention for aerial and ground delivery applications, derived from the C6-Class of saturated non-polymerized carboxylic acid called citric acid, comprising: a major amount of sodium citrate (CAS RN: 68-04-2) for dissolving in a major amount of water and producing sodium ions in aqueous solution; a minor amount triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6T4 is a schematic representation illustrating the primary components of an environmentally-clean aqueous-based long-term fire retardant liquid biochemical composition of the present invention for aerial and ground delivery applications, derived from the C6-Class of saturated non-polymerized carboxylic acid called citric acid, comprising: a major amount of magnesium citrate (CAS RN: 779-25-1) for dissolving in a major amount of water and producing magnesium ions in aqueous solution; a minor amount triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. Xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution; and
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From The C6 Carboxylic Acid (R—COOH), D-Gluconic Acid

In FIGS. 6U1, 6U2, 6U3 and 6U4, schematic chemical models are provided for making liquid fire retardant solutions containing alkali metal salts derived from a C6 Class of Carboxylic Acid having 6 carbon atoms, specifically, the C6 carboxylic acid (R—COOH) called D-Gluconic Acid, having a molecular formula C₆H₁₂O₇ and CAS RN: 526-95-4) and highly soluble in water. The exemplary alkali metal salts derived from this C6 Class of Carboxylic Acid are: potassium gluconate C₆H₁₁KO₇; calcium gluconate C₁₂H₂₂CaO₁₄; sodium gluconate C₆H₁₁NaO₇; and magnesium gluconate C₁₂H₂₂MgO₁₄.

As shown in FIGS. 6U1 through 6U4, an exemplary ester of d-gluconic acid is methyl gluconate characterized by the chemical/molecular formula C₇H₁₄O and CAS RN: 131797-36-9. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C6 Class of Carboxylic Acid.

FIG. 6U1 illustrates the primary components of an environmentally-clean aqueous-based long-term fire retardant liquid biochemical composition of the present invention for aerial and ground delivery applications, derived from the C6-Class of saturated non-polymerized carboxylic acid called d-gluconic acid, comprising: a major amount of potassium gluconate (CAS RN: 299-27-4) for dissolving in a major amount of water and producing potassium ions in aqueous solution; a minor amount methyl gluconate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl gluconate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6U2 illustrates the primary components of an environmentally-clean aqueous-based long-term fire retardant liquid biochemical composition of the present invention for aerial and ground delivery applications, derived from the C6-Class of saturated non-polymerized carboxylic acid called d-gluconic acid, comprising: a major amount of calcium gluconate (CAS RN: 299-28-5) for dissolving in a major amount of water and producing calcium ions in aqueous solution; a minor amount methyl gluconate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl gluconate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6U3 illustrates the primary components of an environmentally-clean aqueous-based long-term fire retardant liquid biochemical composition of the present invention for aerial and ground delivery applications, derived from the C6-Class of saturated non-polymerized carboxylic acid called d-gluconic acid, comprising: a major amount of sodium gluconate (CAS RN: 527-07-1) for dissolving in a major amount of water and producing sodium ions in aqueous solution; a minor amount methyl gluconate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP) and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl gluconate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6U4 illustrates the primary components of an environmentally-clean aqueous-based long-term fire retardant liquid biochemical composition of the present invention for aerial and ground delivery applications, derived from the C6-Class of saturated non-polymerized carboxylic acid called d-gluconic acid, comprising: a major amount of magnesium gluconate (CAS RE: 3632-91-5), for dissolving in a major amount of water and producing magnesium ions in aqueous solution; a minor amount methyl gluconate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. methyl gluconate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution; and
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.
   Specification Of New And Improved Aerial Liquid Fire Retardant Formulations For Forming Thin Fire Inhibiting Mixed Alkali Metal Salt Crystalline and Polysaccharide Coatings Sprayed Onto Combustible Surfaces, And Produced From Alkali Metal Salts Derived From the C7 Carboxylic Acid (R—COOH), Benzoic Acid

In FIGS. 6V1, 6V2, 6V3, 6V4 and 6V5, schematic chemical models are provided for making liquid fire retardant solutions containing alkali metal salts derived from a C7 Class of Carboxylic Acid having 7 carbon atoms, specifically, the C7 carboxylic acid (R—COOH) called benzoic acid, (benzenecarboxylic acid), having a molecular formula C₇H₆O₂, CAS RN: 65-85-0 and high water solubility. The exemplary alkali metal salts derived from this C7 Class of Carboxylic Acid are: potassium benzoate C₇H₅KO₂; calcium benzoate Ca(C—H502)₂; sodium benzoate C₇H₅NaO₂; and magnesium benzoate C₁₄H₁₀MgO₄.

As shown in FIGS. 6V1 through 6V5, an exemplary ester of benzoic acid is ethyl benzoate characterized by chemical formula CoH₁₀O₂, CAS RN: 93-89-0 and poor water solubility. This ester, and/or the alternative ester of citric acid called triethyl citrate, can be used as a dispersing agent with the alkali metal salt dissolved in water, to produce these aqueous-based liquid fire inhibiting solutions of the present invention, based on the above-referenced C7 Class of Carboxylic Acid.

FIG. 6V1 illustrates the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising: a major amount of potassium benzoate (CAS RN: 582-25-2) for dissolving in a major amount of water and producing potassium ions in aqueous solution; a minor amount ethyl benzoate or triethyl citrate (TEC) as a dispersing agent for dispersing benzoate ions in aqueous solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl benzoate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6V2 illustrates the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising: a major amount of calcium benzoate (CAS RN: 2090 May 3) for dissolving in a major amount of water and producing calcium ions in aqueous solution; a minor amount ethyl benzoate or triethyl citrate (TEC) as a dispersing agent for dispersing benzoate ions in solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl benzoate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6V3 illustrates the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising: a major amount of sodium benzoate (CAS RN: 532-32-1) for dissolving in a major amount of water and producing sodium ions in aqueous solution; a minor amount ethyl benzoate or triethyl citrate (TEC) as a dispersing agent for dispersing benzoate ions in solution; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl benzoate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

FIG. 6V4 illustrates the primary components of another embodiment of the environmentally-clean aqueous-based long-term fire retardant liquid biochemical composition, derived from the C7-Class of saturated non-polymerized carboxylic acid called benzoic acid. As shown and illustrated in FIG. 6V4, the environmentally-clean aqueous-based long-term fire retardant liquid biochemical composition comprises: (i) a major amount of sodium benzoate which, when dissolved in a major amount of water, provides sodium ions to inhibit ignition of fire and flame spread, and benzoate ions to promote the formation of a corrosion inhibiting coating or layer on the surface of a metal used or supported by the application; and (ii) a minor amount ethyl benzoate or triethyl citrate (TEC) as a dispersing agent for dispersing benzoate ions in aqueous solution, to promote the benzoate ions to form a corrosion inhibiting coating or layer on the surface of the metal that inhibits metal alkali ions in the aqueous solution from undergoing chemical reactions with the metals used in the application.

FIG. 6V5 illustrating the primary components of an environmentally-clean aqueous-based long-term fire retardant liquid biochemical composition of the present invention for aerial and ground delivery applications, derived from the C7-Class of saturated non-polymerized carboxylic acid called benzoic acid, comprising: a major amount of magnesium benzoate (CAS RN: 553-70-8) for dissolving in a major amount of water and producing sodium ions in aqueous solution; a minor amount ethyl benzoate or triethyl citrate (TEC) as a dispersing agent for dispersing benzoate ions; a minor amount of one or more metal alkali salts derived from another saturated non-polymerized carboxylic acid, specifically, sodium benzoate, potassium benzoate, calcium benzoate or magnesium benzoate, for providing benzoate ions to promote formation of a corrosion inhibiting coating or layer on the surface of the metal, thereby inhibiting metal alkali ions in the aqueous solution from undergoing chemical reactions with the metal ions present in the surfaces of metal components used in mixing, pumping, storing and applying mixed fire retardant solution during use and application; a minor amount of biomolecular polymer (e.g. xanthan gum (XG)) added to the aqueous solution for thickening the solution and increasing its viscosity to a desired amount (e.g. 150-400 cP); and a minor amount of colorant (e.g. DayGlo ELX-2100FR fugitive pigment powder) added to the aqueous solution for imparting a particular color (e.g. red) to the aqueous solution during application of the product, wherein the dispersing agent (e.g. ethyl benzoate or triethyl citrate) disperses benzoate ions present in the water when the at least one alkali metal salt is dissolved in the mixed retardant solution, so as to promote the formation of a corrosion inhibiting coating on metals contacting the mixed retardant solution and inhibiting surface corrosion reactions involving said metals.

When the mixed aqueous retardant solution is aerially delivered and applied to combustible target surfaces, it forms thin coatings on treated surfaces comprising metal alkali salt crystals mixed within biomolecular polymer constructed from polysaccharide chains, upon the evaporation of water molecules from the applied aqueous mixed retardant solution, thereby providing protection against fire ignition and flame spread without polluting or harming the environment.

In the above fire retardant solutions, the weights and measures of the constituents are specified generally in terms of major and minor mass amounts which, in preferred embodiments, may be substantially proportional to the following formulation below, namely:
1.50 [Lb.] by weight of at least one primary alkali metal salt of a nonpolymeric saturated carboxylic acid (e.g. potassium, calcium, sodium and/or magnesium citrate);
3.00 [Oz.] by weight of at least one secondary alkali metal salt of a nonpolymeric saturated carboxylic acid (e.g. potassium, calcium, sodium and/or magnesium benzoate);
0.265 [Oz.] by weight of thickening agent (e.g. Xanthan gum) for increasing the viscosity of the resulting solution;
2.415 [Oz.] by weight of an ester of saturated non-polymerized carboxylic acid (e.g. ester of citric acid, namely ethyl citrate) functioning as a dispersing agent for dispersing benzoate ions in aqueous solution; and
114.2 [Oz.] by weight of water (0.86 [US Gallon] by volume) to produce a resultant solution of 1.0 [US Gallon] having a total weight of 143.80 [Oz.] (8.99 [Lb.]).

In the above fire retardant solutions, the weights and measures of the constituents may be specified generally as follows:
a major amount of water as a solvent and dispersant is from 60% to 95% by weight, preferably from 60% to 90% by weight, and more preferably from 65% to 85% by weight, relative to the total weight of the mixed fire retarding biochemical liquid composition;
a major amount of fire inhibiting agent in the form of at least one first alkali metal salt of a nonpolymeric saturated carboxylic acid (i.e. potassium, calcium, sodium and/or magnesium salt derived from the carboxylic acid used in the formulation), is from 5% to 40% by weight, preferably from 10% to 30% by weight, and more preferably from 15% to 20% by weight, relative to the total weight of the mixed fire retarding biochemical liquid composition;
a minor amount of corrosion inhibiting agent in the form of least one second alkali metal salt of a nonpolymeric saturated carboxylic acid (i.e. (e.g. sodium benzoate, potassium benzoate, calcium benzoate or magnesium benzoate) and functioning as an auxiliary fire retarding salt and as a corrosion inhibitor when dissolved in water, is from 0.10% to 5% by weight, preferably from 0.5% to 3% by weight, and more preferably from 0.7% to 2.0% by weight, relative to the total weight of the mixed fire retarding biochemical liquid composition;
a minor amount of thickening agent in form of a biopolymer consisting of polysaccharides (e.g. Xanthan gum (XG) powder), is from 0.08% to 5% by weight, preferably from 0.1% to 2% by weight, and more preferably from 0.5% to 1.0% by weight, relative to the total weight of the mixed fire retarding biochemical liquid composition;
a minor amount an (alkali metal ion) dispersing agent (e.g. triethyl citrate or ester of the carboxylic acid used in the formulation), is from 0.08% to 5% by weight, preferably from 0.1% to 2% by weight, and more preferably from 0.5% to 1.5% by weight, relative to the total weight of the mixed fire retarding biochemical liquid composition; and
a minor amount of coloring agent (fugitive colorant or non-fugitive colorant), is from 0.08% to 5% by weight, preferably from 0.1% to 3% by weight, and more preferably from 0.5% to 2.0% by weight, relative to the total weight of the mixed fire retarding biochemical liquid composition;
wherein the sum of the weight percent % of the chemical components in the mixed fire retarding biochemical liquid composition should not exceed 100% by weight precent.

### Physical Examination And Fire-Performance Testing Of The Thin Metal Salt Crystalline Structures Formed Using The Biochemical Compositions and Methods And Apparatus Of The Present Invention

One method of viewing the resulting metal salt crystal structures formed upon a surface substrate to be protected against fire, using the liquid solution of the present invention would be by using atomic force microscope to form atomic force microscopy (AFM) images of the biochemical coatings safely applied to the combustible surfaces in accordance with the principles of the present invention. Another method of viewing the resulting metal salt crystal structures would be to use a scanning electron microscope to form scanning electron microscopy (SEM) images.

FIG. 7B illustrates the process used to form mixed alkali metal crystalline and biopolymer structure coatings on treated ground surfaces that will be proactively protected against ignition and flame spread of incident fire.

As indicated at Step A in FIG. 7B, a liquid coating of a biochemical solution of the present invention is air dropped from a moving airtanker to ground surface to be treated. Once applied, the water molecules are evaporate at a rate determined by ambient temperature and wind currents, and will form a thin mixed fire-inhibiting alkali metal salt crystalline and biopolymer coating having a dry coating thickness significantly less than the applied wet coating thickness, and dependent on various biochemical parameters of the fire retardant liquid solution, as well as environmental and atmospheric parameters (e.g. temperature, relative humidity, pressure, etc.) present at the time of the coating formation process.

FIG. 7A illustrates the process involved during the formation of thin fire retardant coatings on treated ground surfaces to be proactively protected against ignition and flame spread of incident fire.

At Step A, a discharge chute (or alternative, a very-wide wide-open nozzle) aboard an aircraft tanker carrying the mixed retardant liquid is used to drop liquid fire retardant (of a specified retardant salt concentration % by weight, and viscosity) while the aircraft tanker is moving at high speed (e.g. 120-250 mph). While the stream of liquid fire retardant is flowing, shear forces cause the liquid to form or explode into a cloud of small liquid droplets of liquid retardant (of a particular size) and cover a target ground surface and form a liquid coating of a retardant solution onto combustible surfaces to be protected by the retarding salts in the composition, once water molecules therein are evaporated, at a rate determined by ambient temperature, prevailing wind currents, and atmospheric turbulence caused by any nearby wildfires.

While not shown, it is well known that airtanker delivery of fire retardant fluids causes the dispersal of many gallons of liquid fire retardant into a cloud of droplets that settles onto the natural fuel on the ground. Measurements of the viscosity, elasticity, surface tension, and density of the fluid allows an estimate of droplet size ultimately delivered to the targeted ground surface. This information can be used to predict the performance of various liquid fire retardants and in selecting the viscosities and concentrations of their retardant components. Preferably, a computer-based Aerial Drop Modelling System is used for real-time simulation, control and management of aerial drops from a fixed-wing aircraft and other aircraft, involving a wide range of product viscosities, from water to highly thickened long-term liquid fire retardants. The computer-based Aerial Drop Modelling System can be used to simulate the continuous stripping of droplets from the liquid jet stream of liquid fire retardant being dropped from the airtanker due to aerodynamic forces, and provides an improved understanding and prediction of the behavior and effectiveness of aerially delivered firefighting liquids.

At Step B, as water molecules evaporate, potassium and sodium salt crystals and polysaccharides from the biomolecular polymer material (e.g. Xanthan gum) form a thin fire retardant coating that adheres to the combustible surface, to which the mixed retardant liquid was applied in Step A during the aerial delivery process. The thin coating of fire retarding biochemical liquid contains potassium and sodium salt crystals mixed within an extracellular polysaccharide structure. The dried fire retardant coating that forms will have a dry coating thickness that is less than the applied wet coating thickness, and will be dependent on (i) various biochemical parameters of the fire retarding liquid, as well as (ii) environmental and atmospheric parameters (e.g. temperature, relative humidity, pressure, etc.) present at the time of application and coating formation process.

Artificial Intelligence (AI) and Machine Intelligence can be used with the Aerial Drop Modelling System to provide an AI-Based Aerial Drop Modelling System capable of: (i) real-time monitoring of the actual size of microdroplets of liquid fire retardant produced during aerial retardant dropping operations under a specified set of conditions; (ii) determining the optimal viscosity for mixed fire retarding biochemical liquid being aerially delivered from an airtanker moving a specific airspeed at a specific altitude high above a target ground surface to be treated with fire retardant chemistry of the present invention; and (iii) generating and sending instructions to the supporting airbase where the mixed retardant liquid is being mixed and produced for use in aerial dropping operations.

To determine and confirm that the liquid compositions of the present invention produce fire inhibiting/retarding surfaces with certain measures of fire inhibiting protection, it is necessary to test such treated surface specimens according to specific fire protection standards. In the USA, ASTM E84 Flame Spread and Smoke Development Testing can be used to test how well treated/coated surfaces perform during E84 testing, and then compared against industry benchmarks.

The Biochemical Long Term Aerial Fire Retardant Products Of The Present Invention (i.e. Mixed Ready-to-Use and Dry Concentrate Formulations) Are Environmentally Clean and 100% Biodegradable

Each chemical ingredient used to formulate the long term liquid fire retardant of the present invention (e.g. Water, Tripotassium Citrate, Sodium Benzoate, Triethyl Citrate, Xanthan Gum and Fugitive Colorant ELX-21000FR by DayGlo Color Corp.) should be biodegradable and environmentally-safe, meaning that it is capable of being broken down by living organisms, such as bacteria, fungi, or water molds, and reabsorbed by the natural environment. By being 100% biodegradable, this ensures that the long term fire retardant does not contribute to environmental pollution which is a primary objective of the US EPA.

### Methods Of Blending, Making And Producing The Biochemical Liquid Formulations

The fire retarding liquid compositions illustrated in FIGS. 6A1, 6A2, 6B1, 6B2 are reproducible by mixing the components described and shown in FIG. 7. Preferably, during field mixing operations on or about a permanent or mobile air base, the Dry Concentrate Retardant will be mixed with water according to a specified Mix Ratio (pounds of Dry Concentrate Retardant with each gallon of water) to make a Mixed Retardant solution for loading onto aircraft for aerial delivery, or storage for subsequent delivery according to schedule. While the order of mixing is discretionary, it is advantageous to produce aqueous preparations by mixing the components other than water, into the quantity of water in the mixing tank.

### Specification Of The Methods Of Preparing And Applying The Fire Retardant Biochemical Compositions Of The Present Invention

Once the fire retarding compositions are prepared in accordance with the formulations described above, the mixture is then stirred for several minutes at room temperature, and subsequently, the mixture is then packaged, barcoded with chain of custody information and then either stored, or shipped to its intended destination for use and application in accordance with present invention. As described herein, the preferred method of delivery/application involves using, for example, an aircraft tanker carrying a sufficient supply of mixed retardant liquid/solution (product) that can be dropped from the moving airtanker to targeted ground surfaces of GPS-specified property.

During aerial dropping methods, the viscosity of the mixed retardant liquid will depend on several factors including: (i) the height from which the airtanker will drop its fire retarding biochemical liquid; (ii) the speed at which the airtanker will be traveling during fire retarding biochemical liquid dropping operations; (iii) the ambient temperature into which the fire retarding biochemical liquid will be dropped; (iv) the aerodynamic turbulence of the air stream through which the fire retarding biochemical liquid stream will pass during dropping operations and experience sheering, that causes droplet formation during aerial retardant delivery operations; (v) etc. The USDA FS Specification 5100-304d has defined three different ranges of viscosity for Mixed Retardant liquid, namely: Low Viscosity (i.e. 150 to 400 [cP]); Medium Viscosity (i.e. 401 and 800 [cP]); and High Viscosity (i.e. 801 and 1500 [cP]).

In the illustrative embodiment, the preferred range of viscosity for the mixed retardant liquid is from 150 to 400 [cP] to cover and support aerial dropping using the Low Viscosity Application range. However, the viscosity can be increased to a greater viscosity value in the Medium Viscosity range, or in the High Viscosity Range, as the aerial delivery application, working environment and conditions may require.

Increasing the viscosity of the mixed fire retarding biochemical liquid from the Low Viscosity range to the Medium Viscosity range can be achieved by adding an increased amount of biomolecular polymer powder (e.g. Xanthan gum powder) to the Dry Concentrate formulation so that the Mixed Retardant Product has a viscosity somewhere between 401 and 800 [cP], to meet the application requirements without undue experimentation and laboratory testing. Also, increasing the viscosity of the mixed fire retarding biochemical liquid from the Low Viscosity range to the High

Viscosity range can be achieved by adding an increased amount of biomolecular polymer powder (e.g. Xanthan gum powder) to the Dry Concentrate formulation so that the Mixed Retardant Product has a viscosity somewhere between 801 and 1500 [cP], to meet the application requirements without undue experimentation and laboratory testing.

In some aerial delivery applications, for example involving low altitude flying aircraft such as un-manned retardant applying drones as shown in FIGS. 9A and 9B, it may be desired or otherwise advantageous to use a mixed fire retarding biochemical liquid having a viscosity in the Ultra-Low Viscosity Applicant range (i.e. 10-149 [cP]). Also, in some ground delivery applications, as shown in FIG. 10, for example, involving a ground-based tanker equipped with appropriate spray nozzles, where it may be desired or otherwise advantageous to use a mixed fire retarding biochemical liquid having a viscosity in the Ultra-Low Viscosity Applicant range (i.e. 10-149 [cP]) so as to be able to spray the fire retarding biochemical liquid onto ground surfaces containing native fuel requiring fire protection.

In general, the methods of and apparatus for delivering and GPS-tracking of fire retarding biochemicals of the present invention taught herein, as shown in FIGS. 8A through 10B, can be used with excellent results, provided that mixed retardant liquids are used with viscosity properties that meet the requirements for aerial delivery, or ground delivery, as the application requires.

During examination and testing protocols, all fire retarding biochemical formulations of the present invention are proactively applied to combustible wood surfaces, allowed to dry, and are then analyzed and tested for adhesion properties in a conventional manner, as well as subjected to strict ASTM E84 fire protection testing to ensure the fire retarding potassium and sodium salt crystal and polysaccharide coatings meet Class A Fire Protection Standards, if and as required by the application at hand

### Useful Applications For The Fire Retarding Biochemical Liquid Compositions Of The Present Invention

As disclosed, the fire retarding biochemical compositions of the present invention are very useful in two ways: (i) producing fire retarding coatings formed by thin alkali metal (potassium and sodium) salt crystals and polysaccharides from a biomolecular polymer (e.g. Xanthan gum), deposited on surfaces during “retardant drops” on land to be protected against fire; and (ii) extinguishing active fires by application of the fire retarding biochemical composition of the present invention onto the fire during “suppression drops” to suppress and extinguish the wildfire (i.e. bushfire). The biochemical compositions of the present invention can be used for firefighting in forests, tire warehouses, landfill sites, coal stocks, oil fields, timberyards, and mines, for proactively fighting wildfires from the air, by airplanes and helicopters and drone. Also, the clean wildfire chemistry of the present invention can be used around animal such as horses, dogs, cats, and other pets without posing any health risk to such creatures, while mitigating the risks that raging wildfires will present to their lives. Also, and most significantly, the fire retarding biochemical compositions are substantially free of the many disadvantages and dangers associated with the use of phosphorus-based and nitrogen-based compounds, including ammonium-based compounds, which historically have been used in forest firefighting, and which may at the same time have an adverse effect as fertilizers in watercourses.

Furthermore, the fire retarding biochemical compositions of the present invention are very resistant to freezing when used or applied in sub-zero temperatures (e.g. less than 32 F). Thus, it is possible to obtain an aqueous biochemical composition according to the present invention which is still sprayable at temperatures below 0° C.

Notably, the liquid biochemical compositions of the present invention are non-corrosive, especially when coming in physical contact with specific metals, such as 2024-T3 Aluminum, 4130 Steel, Yellow Brass, and Az3 1B Magnesium, and other metals that may be used as containers for the biochemical solutions of the present invention, especially during mixing, storage, and application operations. This feature is of particular importance when proactively defending wild fires from the air using the GPS-tracked aircraft-based application/delivery vehicles (e.g. airplanes and helicopters) shown in FIGS. 8A and 8B.

The mixed fire retarding biochemical products can also be used to proactively fight wildfire fires from the air using drones shown in FIGS. 9A and 9B, by applying and GPS-tracking the application of environmentally-clean fire retarding biochemical liquid over ground and property surfaces to create and maintain clean-chemistry fire breaks and barriers where wildfire is not to be permitted to targeted property to be protected, in accordance with the principles of the present invention. In such applications, it is best to use a mixed fire retardant solution having a formulation with the lowest viscosity as possible so that the liquid retardant will flow easily and be sprayable onto ground surfaces using a suitable nozzle technology well known in the art.

The biochemical mixed retarding products of the present invention can be used for proactively firefighting wildfires and fires that may break out in many places including, but not limited to, forests, WUI regions, tire warehouses, landfill sites, coal stocks, timberyards and even mines. The biochemical mixed retarding products of the present invention are effective in the dry state (long-term action) retarding fire ignition and flame spread on combustible surfaces treated with these mixed retardant products.

Specification Of GPS-Tracked Aircraft (i.e. Helicopter) For Aerial Dropping Mixed Retardant Liquid On Ground Surfaces

FIG. 9A shows a mobile GPS-tracked manned aircraft (i.e. helicopter) system 50 adapted for aerial delivery of environmentally-clean mixed fire retarding biochemical liquid of the present invention to ground surfaces in accordance with the principles of the present invention. As shown, the aircraft system 50 comprises: a lightweight airframe 50A0 supporting a propulsion subsystem 50I provided with a set of axially-mounted helicopter blades 50A1-50A2 and 50A5, driven by combustion-engine and controlled and navigated by a GPS-guided navigation subsystem 5012; an integrated supply tank 50B supported on the airframe 50A0, and connected to a gasoline/diesel operated motor-driven delivery pump, 50C; a control assembly 50D connected to the delivery pump 50C by way of a conduit 50E, for releasing a stream of environmentally-clean fire retarding biochemical liquid under the control of GPS-specified coordinates defining its programmed flight path during aerial dropping operations.

FIG. 9B shows the GPS-tracked fire retardant delivery system 50 of FIG. 9A as comprising a number of subcomponents, namely: a GPS-tracked and remotely-monitored AF chemical liquid delivery control subsystem 50F; a micro-computing platform or subsystem 50G interfaced with the GPS-tracked and remotely-monitored AF chemical liquid spray control subsystem 50F by way of a system bus 501; a wireless communication subsystem 50H interfaced to the micro-computing platform 50G via the system bus 501; and a vehicular propulsion and navigation subsystem 501 employing propulsion subsystem 5011, and AI-driven or manually-driven navigation subsystem 5012.

As configured in the illustrative embodiment, the GPS-tracked fire retardant delivery system 50 enables and supports (i) the remote monitoring of the application of fire retarding chemical product from the system 50 when located at specific GPS-indexed location coordinates, and (ii) the logging of all such GPS-indexed spray application operations, and recording the data transactions thereof within a local database maintained within the micro-computing platform 50G, as well as in the remote network database 9C1 maintained at the data center 8 of the system network 1.

As shown in FIG. 9B, the micro-computing platform 50G comprises: data storage memory 50G1; flash memory (firmware storage) 50G2; a programmable microprocessor 50G3; a general purpose I/O (GPIO) interface 50G4; a GPS transceiver circuit/chip with matched antenna structure 50G5; and the system bus 401 which interfaces these components together and provides the necessary addressing, data and control signal pathways supported within the system 50. As such, the micro-computing platform 50G is suitably configured to support and run a local control program 50G2-X on microprocessor 50G3 and memory architecture 50G1, 40G2 which is required and supported by the enterprise-level mobile application 12 and the suite of services supported by the system network 1 of the present invention.

As shown in FIG. 9B, the wireless communication subsystem 50H comprises: an RF-GSM modem transceiver 50H1; a T/X amplifier 50H2 interfaced with the RF-GSM modem transceiver 50H1; and a WIFI interface and a Bluetooth wireless interface 50H3 for interfacing with WIFI and Bluetooth data communication networks, respectively, in a manner known in the communication and computer networking art.

As shown in FIG. 9B, the GPS-tracked and remotely-controllable fire retardant delivery control subsystem 50F comprises: retardant chemical liquid supply sensor(s) 50F1 installed in or on the retardant chemical liquid supply tank 50B to produce an electrical signal indicative of the volume or percentage of the retardant liquid supply tank containing fire retarding biochemical liquid at any instant in time, and providing such signals to the retardant delivery system control interface 50F4; a power supply and controls 50F2 interfaced with the retardant liquid pump subsystem 50C, and also the retardant delivery system control interface 50F4; manually-operated retardant pump controls interface 50F3, interfaced with the retardant delivery system control interface 50F4; and the retardant delivery system control interface 50F4 interfaced with the micro-computing subsystem 50G, via the system bus 501. The flash memory storage 50G2 contains microcode for a control program that runs on the microprocessor 50G3 and realizes the various GPS-specified retardant delivery control, monitoring, data logging and management functions supported by the system 50.

### Specification Of GPS-Tracked Autonomously-Driven Drone System Adapted For Spraying Anti-Fire (AF) Liquid On Buildings And Ground Surfaces

FIG. 10A shows a mobile GPS-tracked unmanned airborne system (UAS) or drone 40 adapted for applying environmentally-clean retardant chemical liquid of the present invention on exterior building surfaces and ground surfaces in accordance with the principles of the present invention.

As shown, the drone vehicle system 40 comprises: a lightweight airframe 40A0 supporting a propulsion subsystem 40I provided with a set of eight (8) electric-motor driven propellers 40A1-40A8, driven by electrical power supplied by a rechargeable battery module 409, and controlled and navigated by a GPS-guided navigation subsystem 4012; an integrated supply tank 40B supported on the airframe 40A0, and connected to either rechargeable-battery-operated electric-motor driven spray pump, or gasoline/diesel or propane operated motor-driven retardant pump, 40C; a control assembly 40D connected to the retardant pump 40C by way of a flexible hose 40E, for delivering environmentally-clean retardant liquid under the control of GPS-specified coordinates defining its programmed flight path during aerial delivery operations.

FIG. 10B shows the GPS-tracked retardant liquid spraying system 40 of FIG. 10A as comprising a number of subcomponents, namely: a GPS-tracked and remotely-monitored retardant chemical liquid delivery control subsystem 40F; a micro-computing platform or subsystem 40G interfaced with the GPS-tracked and remotely-monitored retardant chemical liquid delivery control subsystem 40F by way of a system bus 401; a wireless communication subsystem 40H interfaced to the micro-computing platform 40G via the system bus 401; and a vehicular propulsion and navigation subsystem 401 employing propulsion subsystem 4011, and AI-driven or manually-driven navigation subsystem 4012.

As configured in the illustrative embodiment, the GPS-tracked retardant liquid delivering system 40 enables and supports (i) the remote monitoring of the delivery of retardant chemical liquid from the system 40 when located at specific GPS-indexed location coordinates, and (ii) the logging of all such GPS-indexed spray application operations, and recording the data transactions thereof within a local database maintained within the micro-computing platform 40G, as well as in the remote network database 9C1 maintained at the data center 8 of the system network 1.

As shown in FIG. 10B, the micro-computing platform 40G comprises: data storage memory 40G1; flash memory (firmware storage) 40G2; a programmable microprocessor 40G3; a general purpose I/O (GPIO) interface 40G4; a GPS transceiver circuit/chip with matched antenna structure 40G5; and the system bus 401 which interfaces these components together and provides the necessary addressing, data and control signal pathways supported within the system 40. As such, the micro-computing platform 40G is suitably configured to support and run a local control program 40G2-X on microprocessor 40G3 and memory architecture 40G1, 40G2 which is required and supported by the enterprise-level mobile application 12 and the suite of services supported by the system network 1 of the present invention.

As shown in FIG. 10B, the wireless communication subsystem 30H comprises: an RF-GSM modem transceiver 40H1; a T/X amplifier 40H2 interfaced with the RF-GSM modem transceiver 40H1; and a WIFI interface and a Bluetooth wireless interface 40H3 for interfacing with WIFI and Bluetooth data communication networks, respectively, in a manner known in the communication and computer networking art.

As shown in FIG. 10B, the GPS-tracked and remotely-controllable retardant chemical liquid delivery control subsystem 40F comprises: retardant chemical liquid supply sensor(s) 40F1 installed in or on the retardant chemical liquid supply tank 30B to produce an electrical signal indicative of the volume or percentage of the retardant liquid supply tank containing retardant chemical liquid at any instant in time, and providing such signals to the retardant liquid delivery system control interface 40F4; a power supply and controls 40F2 interfaced with the liquid pump spray subsystem 40C, and also the retardant liquid delivery system control interface 40F4; manually-operated spray pump controls interface 40F3, interfaced with the retardant liquid delivery system control interface 30F4; and the retardant liquid delivery system control interface 40F4 interfaced with the micro-computing subsystem 40G, via the system bus 40I. The flash memory storage 40G2 contains microcode for a control program that runs on the microprocessor 40G3 and realizes the various GPS-specified retardant chemical liquid delivery control, monitoring, data logging and management functions supported by the system 40.

Specification Of GPS-Tracked Manned Or Autonomous Vehicle For Ground Delivery of Mixed Fire retarding biochemical liquid On Ground Surface Targets

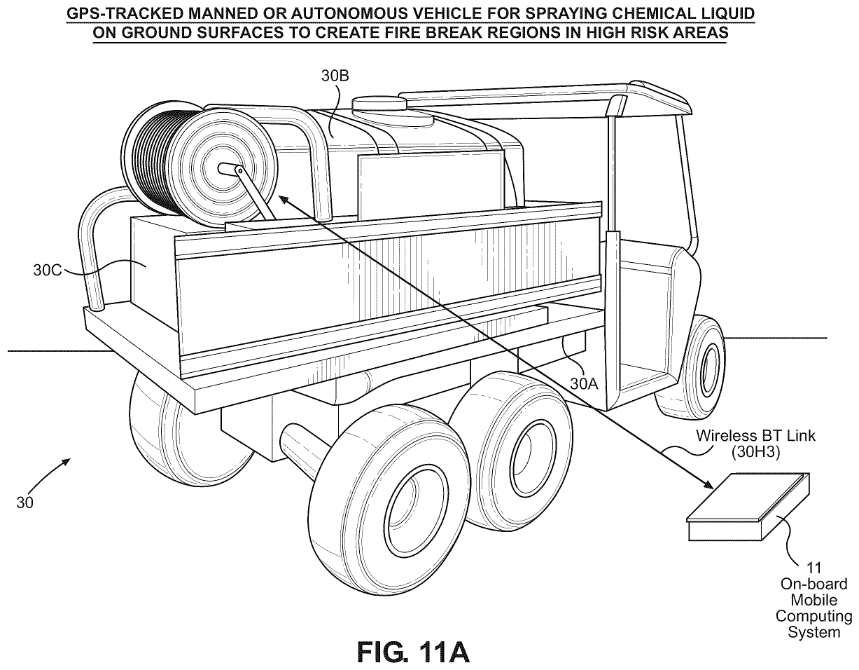

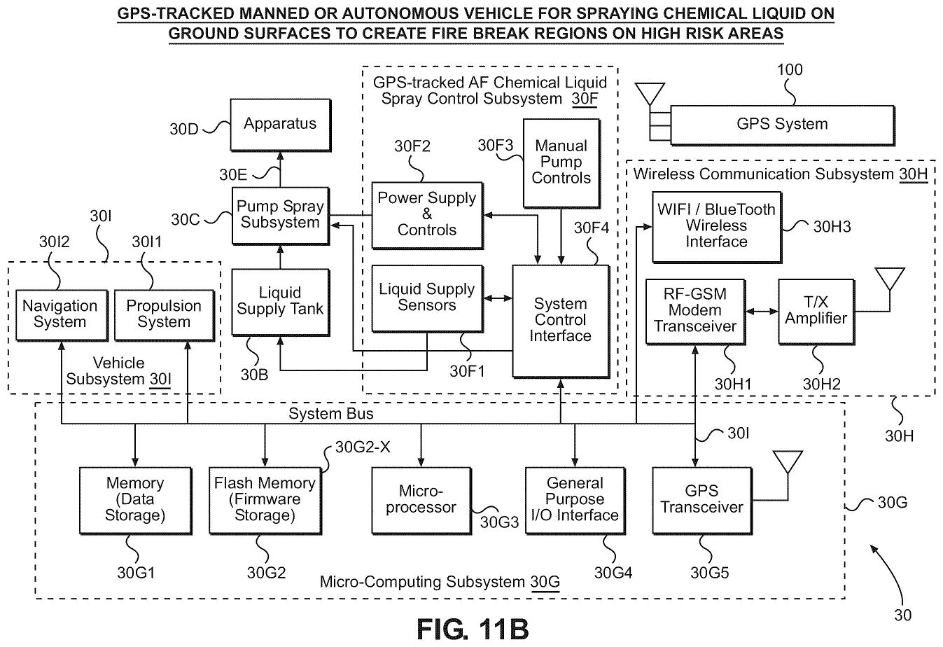

FIG. 11A shows a mobile GPS-tracked manned or autonomous retardant delivery vehicle system 30 for applying environmentally-clean retardant chemical liquid on exterior building surfaces and ground surfaces in accordance with the principles of the present invention. As shown, the vehicle system 30 is supported on a set of wheels 30A driven by a propulsion drive subsystem 30 and navigated by GPS-guided navigation subsystem 301, and carrying an integrated supply tank 30B with either rechargeable-battery-operated electric-motor driven pump, or gasoline/diesel or propane operated motor-driven hydraulic pump, 30C, for deployment on private and public property parcels having building structures, for delivering environmentally-clean retardant liquid of the present invention disclosed herein (illustrated in FIGS. 6 to 7) to combustible surface targets (e.g. road exit ramps, road corridors, etc.) using a spray nozzle assembly 30D connected to the hydraulic pump 30C by way of a flexible hose 30E.

FIG. 11B shows the GPS-tracked mobile retardant delivery system 30 of FIG. 11A as comprising a number of subcomponents, namely: a GPS-tracked and remotely-monitored retardant chemical liquid delivery control subsystem 30F; a micro-computing platform or subsystem 30G interfaced with the GPS-tracked and remotely-monitored retardant chemical liquid delivery control subsystem 30F by way of a system bus 301; a wireless communication subsystem 30H interfaced to the micro-computing platform 30G via the system bus 301; and a vehicular propulsion and navigation subsystem 301 employing a propulsion subsystem 3011 and AI-driven or manually-driven navigation subsystem 3012.

As configured in the illustrative embodiment, the GPS-tracked mobile retardant liquid delivery system 30 enables and supports (i) the remote monitoring of the delivering retardant chemical liquid from the system 30 when located at specific GPS-indexed location coordinates, and (ii) the logging of all such GPS-indexed spray application operations, and recording the data transactions thereof within a local database maintained within the micro-computing platform 30G, as well as in the remote network database 9C1 maintained at the data center 8 of the system network 1.

As shown in FIG. 11B, the micro-computing platform 30G comprises: data storage memory 30G1; flash memory (firmware storage) 30G2; a programmable microprocessor 30G3; a general purpose I/O (GPIO) interface 30G4; a GPS transceiver circuit/chip with matched antenna structure 30G5; and the system bus 301 which interfaces these components together and provides the necessary addressing, data and control signal pathways supported within the system 30. As such, the micro-computing platform 30G is suitably configured to support and run a local control program 30G2-X on microprocessor 30G3 and memory architecture 30G1, 30G2 which is required and supported by the enterprise-level mobile application 12 and the suite of services supported by the system network 1 of the present invention.

As shown in FIG. 11B, the wireless communication subsystem 30H comprises: an RF-GSM modem transceiver 30H1; a T/X amplifier 30H2 interfaced with the RF-GSM modem transceiver 30H1; and a WIFI interface and a Bluetooth wireless interface 30H3 for interfacing with WIFI and Bluetooth data communication networks, respectively, in a manner known in the communication and computer networking art.

As shown in FIG. 11B, the GPS-tracked and remotely-controllable retardant chemical liquid delivery control subsystem 30F comprises: retardant chemical liquid supply sensor(s) 30F1 installed in or on the anti-fire chemical liquid supply tank 30B to produce an electrical signal indicative of the volume or percentage of the retardant liquid supply tank containing retardant chemical liquid at any instant in time, and providing such signals to the retardant liquid delivery system control interface 30F4; a power supply and controls 30F2 interfaced with the liquid pump spray subsystem 30C, and also the retardant liquid delivery system control interface 30F4; manually-operated spray pump controls interface 30F3, interfaced with the retardant liquid delivery system control interface 30F4; and the retardant liquid spraying system control interface 30F4 interfaced with the micro-computing subsystem 30G, via the system bus 301. The flash memory storage 30G2 contains microcode for a control program that runs on the microprocessor 20G3 and realizes the various GPS-specified retardant chemical liquid delivery control, monitoring, data logging and management functions supported by the system 30.

### Using GPS-Tracking, Mapping And Recording Techniques To Know Where Clean-Chemistry Wild Fire Breaks And Zones Were Formed By Whom, And When

Using the cloud-based wildfire defense network's integrated GPS-tracking, mapping and recording techniques, as illustrated in FIGS. 4A to 5B, and 9A to 11B, fire jurisdictions can plan, create and maintain clean-chemistry wildfire breaks and zones to proactively protect property and life from raging wildfires—by effectively inhibiting specific regions of combustible fuel from ignition, along the path towards targeted property and life to be protected from the incidence of wildfire. Proactive wildfire protection according to the principles of the present invention is simple. Wherever combustible ground cover is coated with the fire retarding biochemical composition of the present invention, the combustible phase of wildfire will be interrupted, taking the energy out of a raging wildfire, by reducing fire ignition and flame spread, thereby protecting property that has been treated in advance of a wildfire incidence.

In hot dry climates, conditioned by hot dry prevailing winds, the relative humidity will be expectedly low, and in the absence of rain, the all-natural (clear) wild fire retardant dropped over targeted ground surfaces to create chemical-based wild fire breaks and zone regions, will last for long durations into weeks and months in many situations. However, whenever rain occurs, the Network will know and advise fire departments and homeowner alike that clean-chemistry wildfire breaks and zones need to be maintained by an additional application of wildfire retarding biochemical liquid, while being GPS-tracked, mapped and recorded for management purposes.

### Modifications To The Present Invention Which Readily Come To Mind

While the preferred embodiments of the present invention are shown and described as being formulated using a multiple alkali metal salts derived from non-polymeric saturated carboxylic acids having a carbon chain length less than eight (8) to meet practical solubility requirements, it is understood that three or more alkali metal salts derived from different non-polymeric saturated carboxylic acids may be further combined together and dissolved in aqueous solution, along with a suitable thickening agent and coloring agent, to produce additional embodiments of the water-based retardant solutions of the present invention that can perform with excellent long term fire retarding functions. Such modifications fall within the scope and spirit of the present invention.

The illustrative embodiments disclose the formulation, application and use of environmentally-clean fire retarding biochemical solutions and compositions of matter. Such biochemical solutions and compositions, and aerial-based methods and apparatus for dispensing and applying the same, are disclosed and taught herein for use in proactively coating the combustible surfaces such as existing on wood, lumber, and timber, and other combustible matter, wherever fire may exist or wherever wild fires may travel. However, it is understood that alternative clean fire retarding biochemical liquids may be used to practice the various wild fire prevention methods according to the principles of the present invention.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

1-48. (canceled)

49. A mixed fire retarding biochemical liquid composition for use in forming thin fire retarding metal alkali salt crystal coatings on combustible ground surfaces to be protected against wildfire, said mixed fire retarding biochemical liquid composition comprising:
a dispersing agent in the form of water for providing an aqueous solution;
a fire inhibiting agent in the form of at least one first alkali metal salt dissolved in the water, functioning as a fire inhibiting agent, and derived from a first non-polymerized saturated carboxylic acid characterized by having carbon chain length of less than eight carbon atoms (C1-C7), wherein the alkali metal contained in said alkali metal salt is selected from the group consisting of potassium, calcium, sodium and/or magnesium;
a corrosion inhibiting agent in the form of an alkali metal such as sodium, potassium, calcium, or magnesium salt derived from a second non-polymerized saturated carboxylic acid, namely benzoic acid, and dissolved in the water to produce benzoate ions in the aqueous solution that promote the formation of a corrosion inhibiting coating on metal surfaces contacting the mixed retardant solution and inhibiting surface corrosion reactions involving said metal surfaces;
a dispersing agent derived from said saturated non-polymerized carboxylic acid and/or another saturated non-polymerized carboxylic acid, for dispersing benzoate ions present in the mixed retardant solution, so as to promote the formation of said corrosion inhibiting coating on metal surfaces contacting the mixed fire retarding biochemical liquid composition and inhibiting surface corrosion reactions involving said metal surfaces; and
wherein said mixed fire retarding biochemical liquid composition can be delivered to combustible ground surfaces to form thin fire retarding coatings comprising alkali metal potassium salt crystals so as to provide proactive wildfire protection to treated ground surfaces;
wherein said water is present in a major amount having a weight percent from about 70.00% to about 95.00% relative to the total weight of the mixed fire retarding biochemical liquid composition;
wherein said fire inhibiting agent is present in a major amount having a weight percent from about 5.00% to about 30.00% relative to the total weight of the mixed fire retarding biochemical liquid composition;
wherein said corrosion inhibiting agent is present in a minor amount having a weight percent from about 0.05% to about 10.00% relative to the total weight of the mixed fire retarding biochemical liquid composition;
wherein said dispersing agent is present in a minor amount having a weight percent from about 0.05% to about 5.00% relative to the total weight of the mixed fire retarding biochemical liquid composition; and
wherein the sum of the weight percent % of the chemical components in the mixed fire retarding biochemical liquid composition does not exceed 100% by weight.

50. The mixed fire retarding biochemical liquid composition of claim 49, which further comprises a thickening agent in the form of a biomolecular polymer consisting essentially of polysaccharides dissolved in the aqueous solution, so as to form a wet concentrate liquid that can be used as is in ready-to-use form, or diluted with additional water according to a wet concentrate mix ratio.

51. The mixed fire retarding biochemical liquid composition of claim 51, wherein said thickening agent is biomolecular polymer selected from the group consisting of starch, glycogen, and galactogen, and cellulose, wood cellulose fiber, chitin, and one or more microbial polysaccharides produced by microorganisms selected from the group consisting of xanthan gum, dextran, welan gum, gellan gum, diutan gum and pullulan.

52. The mixed fire retarding biochemical liquid composition of claim 51, wherein said thickening agent is realized in the form of a biopolymer consisting of polysaccharides present in a minor amount having a weight percent from about 0.01% from about 5.00% relative to the total weight of the mixed fire retarding biochemical liquid composition.

53. The mixed fire retarding biochemical liquid composition of claim 52, wherein said thickening agent in form of a biopolymer consisting of polysaccharides, is present in a minor amount ranging from 0.08% to 5% by weight, preferably from 0.1% to 2% by weight, and more preferably from 0.5% to 1.0% by weight, relative to the total weight of the mixed fire retarding biochemical liquid composition.

54. The mixed fire retarding biochemical liquid composition of claim 49, which further comprises a coloring agent dissolved in said water for imparting a visible color of the fugitive or non-fugitive type when the mixed fire retarding biochemical liquid composition is applied to a surface to be protected against fire.

55. The mixed fire retarding biochemical liquid composition of claim 54, wherein said coloring agent is present in a minor amount having a weight percent from about 0.01% to about 2.00% relative to the total weight of the mixed fire retarding biochemical liquid composition.

56. The mixed fire retarding biochemical liquid composition of claim 54, wherein said minor amount of coloring agent (fugitive colorant or non-fugitive colorant) is present from 0.08% to 5% by weight, preferably from 0.1% to 3% by weight, and more preferably from 0.5% to 2.0% by weight, relative to the total weight of the mixed fire retarding biochemical liquid composition.

57. The mixed fire retarding biochemical liquid composition of claim 49, wherein said specific metals are selected from the group consisting of Aluminum, Steel, Bright Steel, Yellow Brass, and Magnesium.

58. The mixed fire retarding biochemical liquid composition of claim 49, wherein said mixed fire retarding biochemical liquid composition has a viscosity suitable for use in aerial delivery of said mixed fire retarding liquid composition from an airtanker flying at a speed and altitude relative to ground surface targets to form said thin fire retarding coatings comprising alkali metal salt crystals to provide proactive wildfire protection to said treated ground surfaces.

59. The mixed fire retarding biochemical liquid composition of claim 49, wherein said mixed fire retarding biochemical liquid composition has a viscosity suitable for use in ground-based delivery of said mixed fire retarding liquid composition from a ground-based tanker moving at a speed relative to ground surface targets to form said thin fire retarding coatings comprising alkali metal salt crystals to provide proactive wildfire protection to said treated ground surfaces.

60. The mixed fire retarding biochemical liquid composition of claim 49, wherein said at least one first alkali metal salt is derived from the non-polymeric saturated carboxylic acid (R—COOH) selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

61. The mixed fire retarding biochemical liquid composition of claim 49, wherein said at least one first alkali metal salt, derived from said nonpolymeric saturated carboxylic acid, is selected from the group consisting of:
(i) Alkali metal salts produced from the C1 carboxylic acid (R—COOH) called formic acid (i.e. methanoic acid), specifically: potassium formate; calcium formate; sodium formate; and
magnesium formate;
(ii) Alkali metal salts produced from the C1 carboxylic acid (R—COOH) called carbonic acid (i.e. hydroxymethanoic acid); specifically: potassium carbonate; sodium bicarbonate;
magnesium carbonate;
(iii) Alkali metal salts produced from the C2 carboxylic acid (R—COOH) called acetic acid (ethanoic acid), specifically: potassium acetate; calcium acetate; sodium acetate; and
magnesium acetate;
(iv) Alkali metal salts produced from the C2 carboxylic acid (R—COOH) called glycolic acid (hydroxyacetic acid); specifically: potassium glycolate; calcium glycolate; and sodium glycolate;
(v) Alkali metal salts produced from the C2 carboxylic acid (R—COOH) called glyoxylic acid, specifically: potassium glyoxylate; calcium glyoxylate; sodium glyoxylate (monohydrate);
(vi) Alkali metal salts produced from the C3 carboxylic acid (R—COOH) called propionic acid, specifically: potassium propionate; calcium propionate; sodium propionate; and magnesium propionate;
(vii) Alkali metal salts produced from the C3 carboxylic acid (R—COOH) called lactic acid, specifically: potassium lactate; calcium lactate; sodium lactate; and magnesium lactate;
(viii) Alkali metal salts produced from the C3 carboxylic acid (R—COOH) called glyceric acid, specifically: potassium glycerate; calcium glycerate; and sodium glycerate;
(ix) Alkali metal salts produced from the C3 carboxylic acid (R—COOH), pyruvic acid, specifically: potassium pyruvate; calcium pyruvate; sodium pyruvate; and magnesium pyruvate;
(x) Alkali metal salts produced from the C3 carboxylic acid (R—COOH) called, tartaric acid C₃H₄₅, specifically: potassium tartrate (potassium bitartrate): calcium tartrate: sodium tartrate; and magnesium tartrate;
(xi) Alkali metal salts produced from the carboxylic acid (R—COOH) called butyric acid, specifically: potassium butyrate (or butanoate);_calcium butyrate; sodium butyrate C₄H₇NaO₂;
and magnesium butyrate;
(xii) Alkali metal salts produced from the C4 carboxylic acid (R—COOH) called malic acid specifically: potassium malate; calcium malate; sodium malate; and magnesium malate;
(xiii) Alkali metal salts produced from the C4 carboxylic acid (R—COOH) called malonic acid, specifically: potassium malonate; calcium malonate; sodium malonate; and di-magnesium malonate;
(xiv) Alkali metal salts produced from the C5 carboxylic acid (R—COOH) called pivalic acid, specifically: potassium pivalate; calcium pivalate; sodium pivalate; and magnesium pivalate;
(xv) Alkali metal salts produced from the C6 carboxylic acid (R—COOH) called caproic acid, specifically: potassium caproate (hexanoate); calcium caproate; sodium caproate; and
magnesium caproate;
(xvi) Alkali metal salts produced from the C6 carboxylic acid (R—COOH) called adipic (hexanedioic) acid, specifically: potassium adipate; calcium adipate; sodium adipate; and
magnesium adipate;
(xvii) Alkali metal salts produced from the C6 carboxylic acid (R—COOH) called citric acid, specifically: (tri) potassium citrate; calcium citrate; sodium citrate; and magnesium citrate; and
(xviii) Alkali metal salts produced from the C6 carboxylic acid (R—COOH) called d-gluconic acid, specifically: potassium gluconate; calcium gluconate; sodium gluconate; and
magnesium gluconate.

62. The mixed fire retarding biochemical liquid composition of claim 49, wherein said first alkali metal salt is realized in the form of tripotassium citrate, functioning as a first fire retarding agent for providing potassium ions dispersed in the water when the first one alkali metal salt is dissolved in the water to form a mixed retardant solution; and wherein said corrosion inhibiting agent is realized in the form of sodium, potassium, calcium, or magnesium salt derived from benzoic acid and dissolved in the water to produce (i) benzoate ions in the aqueous solution that promote the formation of a corrosion inhibiting coating on metal surfaces contacting the mixed retardant solution and inhibiting surface corrosion reactions involving said metal surfaces, and (ii) metal alkali ions dispersed in the mixed retardant solution, functioning as a secondary fire retardant agent.

63. The mixed fire retarding biochemical liquid composition of claim 49, wherein
said major amount of water as a solvent and dispersant is from 60% to 95% by weight, preferably from 60% to 90% by weight, and more preferably from 65% to 85% by weight, relative to the total weight of the mixed fire retarding biochemical liquid composition;
said major amount of fire inhibiting agent in the form of at least one first alkali metal salt of a nonpolymeric saturated carboxylic acid, is from 5% to 40% by weight, preferably from 10% to 30% by weight, and more preferably from 15% to 20% by weight, relative to the total weight of the mixed fire retarding biochemical liquid composition;
said minor amount of corrosion inhibiting agent in the form of least one second alkali metal salt of a nonpolymeric saturated carboxylic acid, is from 0.10% to 5% by weight, preferably from 0.5% to 3% by weight, and more preferably from 0.7% to 2.0% by weight, relative to the total weight of the mixed fire retarding biochemical liquid composition;
said minor amount an (alkali metal ion) dispersing agent, is from 0.08% to 5% by weight, preferably from 0.1% to 2% by weight, and more preferably from 0.5% to 1.5% by weight, relative to the total weight of the mixed fire retarding biochemical liquid composition; and
wherein the sum of the weight percent % of the chemical components in the mixed fire retarding biochemical liquid composition should not exceed 100% by weight precent.

64. A mixed fire retarding biochemical liquid composition for use in forming thin fire retarding metal alkali salt crystal coatings on combustible ground surfaces to be protected against wildfire, said mixed fire retarding biochemical liquid composition comprising:
a dispersing agent in the form of water for providing an aqueous solution;
a fire inhibiting agent in the form of at least one first alkali metal salt dissolved in the water, functioning as a fire inhibiting agent, and derived from a first non-polymerized saturated carboxylic acid characterized by having carbon chain length of less than eight carbon atoms (C1 C7), wherein the alkali metal contained in said alkali metal salt is selected from the group consisting of potassium, calcium, sodium and/or magnesium;
a corrosion inhibiting agent dissolved in the water to promote the formation of a corrosion inhibiting coating on metal surfaces contacting the mixed retardant solution and inhibiting surface corrosion reactions involving said metal surfaces;
a dispersing agent for dispersing ions present in the mixed retardant solution, so as to promote the formation of said corrosion inhibiting coating on metal surfaces contacting the mixed fire retarding biochemical liquid composition and inhibiting surface corrosion reactions involving said metal surfaces; and
wherein said mixed fire retarding biochemical liquid composition can be delivered to combustible ground surfaces to form thin fire retarding coatings comprising alkali metal potassium salt crystals so as to provide proactive wildfire protection to treated ground surfaces.

65. The mixed fire retarding biochemical liquid composition of claim 64, wherein said water is present in a major amount having a weight percent from about 70.00% to about 95.00% relative to the total weight of the mixed fire retarding biochemical liquid composition;
wherein said fire inhibiting agent is present in a major amount having a weight percent from about 5.00% to about 30.00% relative to the total weight of the mixed fire retarding biochemical liquid composition;
wherein said corrosion inhibiting agent is realized in the form of an alkali metal such as sodium, potassium, calcium, or magnesium salt derived from a second non-polymerized saturated carboxylic acid, namely benzoic acid, and dissolved in the water to produce benzoate ions in the aqueous solution, and is present in a minor amount having a weight percent from about 0.05% to about 10.00% relative to the total weight of the mixed fire retarding biochemical liquid composition;
wherein said dispersing agent is derived from said saturated non-polymerized carboxylic acid and/or another saturated non-polymerized carboxylic acid, for dispersing benzoate ions present in the mixed fire retarding biochemical liquid composition, so as to promote the formation of said corrosion inhibiting coating on metal surfaces contacting the mixed fire retarding biochemical liquid composition and inhibiting surface corrosion reactions involving said metal surfaces, and wherein said dispersing agent is present in a minor amount having a weight percent from about 0.05% to about 5.00% relative to the total weight of the mixed fire retarding biochemical liquid composition; and
wherein the sum of the weight percent % of the chemical components in the mixed fire retarding biochemical liquid composition does not exceed 100% by weight.

66. The mixed fire retarding biochemical liquid composition of claim 64, wherein said specific metals are selected from the group consisting of Aluminum, Steel, Bright Steel, Yellow Brass, and Magnesium.

67. The mixed fire retarding biochemical liquid composition of claim 64, wherein said at least one first alkali metal salt is derived from the non-polymeric saturated carboxylic acid (R—COOH) selected from the group consisting of formic acid (i.e. methanoic acid); carbonic acid (i.e. hydroxymethanoic acid); acetic acid (ethanoic acid); glycolic acid (hydroxyacetic acid); glyoxylic acid; propionic acid; lactic acid; glyceric acid; tartaric acid, malic acid; malonic acid; caproic acid; adipic (hexanedioic) acid; citric acid; and benzoic acid.

68. The mixed fire retarding biochemical liquid composition of claim 64, wherein said at least one first alkali metal salt, derived from said nonpolymeric saturated carboxylic acid, is selected from the group consisting of:
(i) Alkali metal salts produced from the C1 carboxylic acid (R—COOH) called formic acid (i.e. methanoic acid), specifically: potassium formate; calcium formate; sodium formate; and magnesium formate;
(ii) Alkali metal salts produced from the C1 carboxylic acid (R—COOH) called carbonic acid (i.e. hydroxymethanoic acid); specifically: potassium carbonate; sodium bicarbonate; magnesium carbonate;
(iii) Alkali metal salts produced from the C2 carboxylic acid (R—COOH) called acetic acid (ethanoic acid), specifically: potassium acetate; calcium acetate; sodium acetate; and magnesium acetate;
(iv) Alkali metal salts produced from the C2 carboxylic acid (R—COOH) called glycolic acid (hydroxyacetic acid); specifically: potassium glycolate; calcium glycolate; and sodium glycolate;
(v) Alkali metal salts produced from the C2 carboxylic acid (R—COOH) called glyoxylic acid, specifically: potassium glyoxylate; calcium glyoxylate; sodium glyoxylate (monohydrate);
(vi) Alkali metal salts produced from the C3 carboxylic acid (R—COOH) called propionic acid, specifically: potassium propionate; calcium propionate; sodium propionate; and magnesium propionate;
(vii) Alkali metal salts produced from the C3 carboxylic acid (R—COOH) called lactic acid, specifically: potassium lactate; calcium lactate; sodium lactate; and magnesium lactate;
(viii) Alkali metal salts produced from the C3 carboxylic acid (R—COOH) called glyceric acid, specifically: potassium glycerate; calcium glycerate; and sodium glycerate;
(ix) Alkali metal salts produced from the C3 carboxylic acid (R—COOH), pyruvic acid, specifically: potassium pyruvate; calcium pyruvate; sodium pyruvate; and magnesium pyruvate;
(x) Alkali metal salts produced from the C3 carboxylic acid (R—COOH) called, tartaric acid C₃H₄₅, specifically: potassium tartrate (potassium bitartrate): calcium tartrate: sodium tartrate; and magnesium tartrate;
(xi) Alkali metal salts produced from the carboxylic acid (R—COOH) called butyric acid, specifically: potassium butyrate (or butanoate);_calcium butyrate; sodium butyrate C₄H₇NaO₂; and magnesium butyrate;
(xii) Alkali metal salts produced from the C4 carboxylic acid (R—COOH) called malic acid specifically: potassium malate; calcium malate; sodium malate; and magnesium malate;
(xiii) Alkali metal salts produced from the C4 carboxylic acid (R—COOH) called malonic acid, specifically: potassium malonate; calcium malonate; sodium malonate; and di-magnesium malonate;
(xiv) Alkali metal salts produced from the C5 carboxylic acid (R—COOH) called pivalic acid, specifically: potassium pivalate; calcium pivalate; sodium pivalate; and magnesium pivalate;
(xv) Alkali metal salts produced from the C6 carboxylic acid (R—COOH) called caproic acid, specifically: potassium caproate (hexanoate); calcium caproate; sodium caproate; and magnesium caproate;
(xvi) Alkali metal salts produced from the C6 carboxylic acid (R—COOH) called adipic (hexanedioic) acid, specifically: potassium adipate; calcium adipate; sodium adipate; and magnesium adipate;
(xvii) Alkali metal salts produced from the C6 carboxylic acid (R—COOH) called citric acid, specifically: (tri) potassium citrate; calcium citrate; sodium citrate; and magnesium citrate; and
(xviii) Alkali metal salts produced from the C6 carboxylic acid (R—COOH) called d-gluconic acid, specifically: potassium gluconate; calcium gluconate; sodium gluconate; and magnesium gluconate.

69. The mixed fire retarding biochemical liquid composition of claim 64, wherein said mixed fire retarding biochemical liquid composition has a viscosity suitable for use in aerial delivery of said mixed fire retarding liquid composition from an airtanker flying at a speed and altitude relative to ground surface targets to form said thin fire retarding coatings comprising alkali metal salt crystals to provide proactive wildfire protection to said treated ground surfaces.

70. The mixed fire retarding biochemical liquid composition of claim 64, wherein said mixed fire retarding biochemical liquid composition has a viscosity suitable for use in ground-based delivery of said mixed fire retarding liquid composition from a ground-based tanker moving at a speed relative to ground surface targets to form said thin fire retarding coatings comprising alkali metal salt crystals to provide proactive wildfire protection to said treated ground surfaces.
